(19) United States
(12) Patent Application Publication
(10) Pub. No.: US 2013/0144715 A1
(43) Pub. Date: Jun. 6, 2013

(54) UNIFIED SYSTEM, METHODS, AND COMPUTER PROGRAM PRODUCTS ENABLING THE PROCESSING OF ONE OR MORE EVENTS ASSOCIATED WITH A TRANSACTION EXECUTING THE PURCHASE AND/OR USE OF ONE OR MORE PRODUCTS

(71) Applicants: Art Kranzley, Princeton, NJ (US); Lehmann Li, Darien, CT (US); Gregory Zancewicz, Melissa, TX (US)

(72) Inventors: Art Kranzley, Princeton, NJ (US); Lehmann Li, Darien, CT (US); Gregory Zancewicz, Melissa, TX (US)

(21) Appl. No.: 13/693,015

(22) Filed: Dec. 3, 2012

Related U.S. Application Data
(60) Provisional application No. 61/566,488, filed on Dec. 2, 2011.

(51) Int. Cl. G06Q 30/02

(52) U.S. Cl. CPC G06Q 30/0251
USPC 705/14.49

(57) ABSTRACT

A unified system, one or more methods, and one or more computer program products capable of automatically: (a) identifying the product or the product including the product attribute values requested in a user query; (b) identifying one or more retailers offering the product of interest; (c) identifying one or more qualifying offers; (c) authorizing, clearing, and settling a transaction in a unified system; (d) redeeming one or more qualifying offers; and/or (e) executing functions related to the product after purchase.

### RELATED APPLICATIONS

This application claims the benefit of U.S. Provisional Patent Application No. 61/566,488, entitled “A unified system, methods, and computer program products enabling the processing of one or more events associated with a transaction executing the purchase and/or use of one or more products”, filed on Dec. 2, 2011, which this application incorporates by reference in its entirety.

This application is related to the following application: (a) U.S. patent application Ser. No. 12/904,159, “Apparatuses, methods, and computer program products enabling association of related product data and execution of transaction”, filed Oct. 14, 2010; and (b) U.S. patent application Ser. No. 13/502,028, entitled “Apparatuses, methods, and computer program products enabling association of related product data and execution of transaction”, filed Apr. 13, 2012, both of which this application incorporates by reference herein.

### BACKGROUND

Currently, different systems enable: (a) functions a party would execute to determine which product meets the party's needs; (b) functions a party would execute to identify one or more offers associated with a product of interest; (c) functions a party would execute to purchase the product of interest; and (d) functions a party would execute after the purchase of the product of interest.

One system can enable a party to learn about features of a candidate product, e.g., an advertisement displayed on a client device specifying one or more features of a candidate product. Another system can enable a party to search for one or more offers associated with a product of interest, e.g., transmitting a query in a search engine for any offers associated with a product of interest. Another system can enable a party to purchase the product of interest, e.g., swiping a card with a magnetic stripe at a point-of-sale device or positioning a client device with the capability of exchanging data with the point-of-sale device enabling payment for the product of interest. Another system can enable a party to receive reimbursement for part or all of the price paid for the product of interest, e.g., transmitting a request for reimbursement to an insurer or employer. Another system can enable a party to redeem a first class of offers, e.g., transmitting a rebate through physical mail. Another system can enable a party to redeem a second class of offers, e.g., filing an income tax return claiming a deduction or credit associated with the product of interest. Another system can enable a party to redeem a class of offers after the purchase of the product of interest, e.g., filing a claim for loss of the product of interest in an insured event. Another system can enable a party to register for a warranty of the product of interest. Another system can enable a party to produce the product of interest, e.g., receiving instructions for printing locally the product of interest.

One or more parties would benefit from a unified system, one or more methods, and one or more computer program products which can automatically: (a) identify a product which meets the party's needs; (b) identify one or more offers associated with a product of interest; (c) transfer funds among a plurality of parties transmitting and/or receiving funds and/or executing offers associated with the purchase and/or use of the product of interest; and/or (d) execute functions related to the product of interest after purchase.

### SUMMARY

The invention can enable a unified system, one or more methods, and one or more computer program products automatically to: (a) identify a product which meets the patty's needs; (b) identify one or more offers associated with a product of interest; (c) transfer funds among a plurality of parties transmitting and/or receiving funds and/or executing offers associated with the purchase and/or use of the product of interest; and/or (d) execute functions related to the product of interest after purchase.

In one embodiment, the invention claims a system for identifying a product for which the value(s) of one or more attributes is equal to or inclusive of the value(s) associated with the equal or equivalent attributes specified by a user, identifying one or more offers associated with a product of interest, transferring funds among a plurality of parties transmitting and/or receiving funds and/or executing offers associated with the purchase and/or use of the product of interest, and/or executing functions related to the product of interest after purchase.

In another embodiment, the invention claims a method for identifying a product for which the value(s) of one or more attributes is equal to or inclusive of the value(s) associated with the equal or equivalent attributes specified by a user, identifying one or more offers associated with a product of interest, transferring funds among a plurality of parties transmitting and/or receiving funds and/or executing offers associated with the purchase and/or use of the product of interest, and/or executing functions related to the product of interest after purchase.

In another embodiment, the invention claims any computer-readable medium that comprises instructions, which when executed by a processor, operate to identify a product for which the value(s) of one or more attributes is equal to or inclusive of the value(s) associated with the equal or equivalent attributes specified by a user, identify one or more offers associated with a product of interest, transfer funds among a plurality of parties transmitting and/or receiving funds and/or executing offers associated with the purchase and/or use of the product of interest, and/or execute functions related to the product of interest after purchase.

### BRIEF DESCRIPTION OF THE DRAWINGS

The accompanying drawings, which this application incorporates herein and form a part of the specification, illustrate embodiments of the invention described herein and, together with the description, further serve to: (a) explain the principles of embodiments of the invention; and (b) enable any person with ordinary skill in the art to make and use embodiments of the invention. In the drawings, the two leftmost digits of a reference number identifies the drawing in which the reference number first appears.

FIG. 01 depicts a block diagram of an exemplary Data Processing System (defined herein) that can be used to implement the entities described herein.

FIG. 02A depicts a block diagram of an exemplary apparatus (e.g., a distributed apparatus performing distributed computing), Apparatus 02000A, enabling the exchange and processing of data to determine the product requested in a User Query (defined herein) among at least one of each of a Client Device 02100, an Exchange Server 02200, and a Retailer Server 02300, according to one embodiment.

FIG. 02B depicts a block diagram of an exemplary apparatus (e.g., a distributed apparatus performing distributed computing), Apparatus 02000B, enabling the exchange and processing of data to determine the product requested in a User Query among the components of Apparatus 02000A and one or more Producer Servers 02400, according to one embodiment.

FIG. 02C depicts a block diagram of an exemplary apparatus (e.g., a distributed apparatus performing distributed computing), Apparatus 02000C, enabling the exchange and processing of data to determine the product requested in a User Query among the components of Apparatus 02000B and one or more Product Evaluation Servers 02500, according to one embodiment.

FIG. 02D depicts a block diagram of an exemplary apparatus (e.g., a distributed apparatus performing distributed computing), Apparatus 02000D, enabling the exchange and processing of data, including data received, stored, processed, and/or transmitted by Product Sensor 02600, to determine the product requested in a User Query among the components of Apparatus 02000C and one or more Product Sensors 02600, according to one embodiment.

FIG. 02E depicts a block diagram of an exemplary apparatus (e.g., a distributed apparatus performing distributed computing), Apparatus 02000E, enabling the exchange and processing of data to determine the product requested in a User Query among the components of Apparatus 02000D and one or more Retailer Servers 02301, according to one embodiment.

FIG. 02F depicts a block diagram of an exemplary apparatus (e.g., a distributed apparatus performing distributed computing), Apparatus 02000F, enabling the exchange and processing of data to determine the product requested in a User Query among the components of Apparatus 02000E and one or more Insurer Servers 02700, according to one embodiment.

FIG. 02G depicts a block diagram of an exemplary apparatus (e.g., a distributed apparatus performing distributed computing), Apparatus 02000G, enabling the exchange and processing of data to determine the product requested in a User Query among the components of Apparatus 02000F and one or more Payment Issuer Servers 02800, according to one embodiment.

FIG. 02H depicts a block diagram of an exemplary apparatus (e.g., a distributed apparatus performing distributed computing), Apparatus 02000H, enabling the exchange and processing of data to determine the product requested in a User Query among the components of Apparatus 02000G and one or more Tax Servers 02900, according to one embodiment.

FIG. 03A depicts a block diagram of an exemplary apparatus (e.g., a distributed apparatus performing distributed computing), Apparatus 03000A, enabling the exchange and processing of data to identify one or more Qualifying Offers among at least one of each of a Client Device 02100, an Exchange Server 02200, and a Retailer Server 02300, according to one embodiment.

FIG. 03B depicts a block diagram of an exemplary apparatus (e.g., a distributed apparatus performing distributed computing), Apparatus 03000B, enabling the exchange and processing of data to identify one or more Qualifying Offers among the components of Apparatus 03000A and one or more Producer Servers 02400, according to one embodiment.

FIG. 03C depicts a block diagram of an exemplary apparatus (e.g., a distributed apparatus performing distributed computing), Apparatus 03000C, enabling the exchange and processing of data to identify one or more Qualifying Offers among the components of Apparatus 03000B and one or more Payment Issuer Servers 02800, according to one embodiment.

FIG. 03D depicts a block diagram of an exemplary apparatus (e.g., a distributed apparatus performing distributed computing), Apparatus 03000D, enabling the exchange and processing of data to identify one or more Qualifying Offers among the components of Apparatus 03000C and one or more Affinity Servers 03100, according to one embodiment.

FIG. 03E depicts a block diagram of an exemplary apparatus (e.g., a distributed apparatus performing distributed computing), Apparatus 03000E, enabling the exchange and processing of data to identify one or more Qualifying Offers among the components of Apparatus 03000D and one or more Insurance Servers 02700, according to one embodiment.

FIG. 03F depicts a block diagram of an exemplary apparatus (e.g., a distributed apparatus performing distributed computing), Apparatus 03000F, enabling the exchange and processing of data to identify one or more Qualifying Offers among the components of Apparatus 03000E and one or more Employer Servers 03200, according to one embodiment.

FIG. 03G depicts a block diagram of an exemplary apparatus (e.g., a distributed apparatus performing distributed computing), Apparatus 03000G, enabling the exchange and processing of data to identify one or more Qualifying Offers among the components of Apparatus 03000F and one or more Sales Tax Servers 02910, one or more Income Tax Servers 02920, and/or one or more Property Tax Servers 02930, according to one embodiment.

FIG. 03H depicts a block diagram of an exemplary apparatus (e.g., a distributed apparatus performing distributed computing), Apparatus 03000H, enabling the exchange and processing of data to identify one or more Qualifying Offers among the components of Apparatus 03000G and one or more Government Benefit Servers 03300, according to one embodiment.

FIG. 03I depicts a block diagram of an exemplary apparatus (e.g., a distributed apparatus performing distributed computing), Apparatus 03000I, enabling the exchange and processing of data to identify one or more Qualifying Offers among the components of Apparatus 03000H and one or more Shipper Servers 03400, according to one embodiment.

FIG. 03J depicts a block diagram of an exemplary apparatus (e.g., a distributed apparatus performing distributed computing), Apparatus 03000J, enabling the exchange and processing of data to identify one or more Qualifying Offers among the components of Apparatus 03000I and one or more Distributor Servers 03500, according to one embodiment.

FIG. 03K depicts a block diagram of an exemplary apparatus (e.g., a distributed apparatus performing distributed computing), Apparatus 03000K, enabling the exchange and processing of data to identify one or more Qualifying Offers among the components of Apparatus 03000J and one or more Component Servers 03600, according to one embodiment.

FIG. 04A depicts a block diagram of an exemplary apparatus (e.g., a distributed apparatus performing distributed computing), Apparatus 04000A, enabling the exchange and processing of data to execute a purchase of a Product of Interest and/or process one or more Qualifying Offers among at least one of each of a Client Device 02100, an Exchange Server 02200, a Retailer Server 02300, a Producer Server 02400, a Payment Issuer Server 02800, an Acquirer Server 02811, a Payment Network Server 02820, and a Retailer Bank Server 02830, according to one embodiment.

FIG. 04B depicts a block diagram of an exemplary apparatus (e.g., a distributed apparatus performing distributed computing), Apparatus 04000B, enabling the exchange and processing of data to execute a purchase of a Product of Interest and/or process one or more Qualifying Offers among at least one of each of a Client Device 02100, an Exchange Server 02200, a Retailer Server 02300, a Producer Server 02400, a Payment Issuer Server 02800, a Retailer Bank Server 02830, and a Producer Bank Server 02840, according to one embodiment.

FIG. 04C depicts a block diagram of an exemplary apparatus (e.g., a distributed apparatus performing distributed computing), Apparatus 04000C, enabling the exchange and processing of data to execute a purchase of a Product of Interest and/or process one or more Qualifying Offers among the components of Apparatus 04000B and one or more Other Bank Servers 02850, Insurer Servers 02700, Tax Servers 02900, Affinity Servers 03100, Employer Servers 03200, Government Benefit Servers 03300, and/or Shipper Servers 03400, according to one embodiment.

FIG. 05A depicts a block diagram of an exemplary apparatus (e.g., a distributed apparatus performing distributed computing), Apparatus 05000A, enabling the exchange and processing of data to execute a purchase of a Product of Interest, process one or more Qualifying Offers, and/or execute any function related to the Product of Interest after purchase among at least one of each of a Client Device 02100, an Exchange Server 02200, a Retailer Server 02300, a Producer Server 02400, and/or a Payment Issuer Server 02800, according to one embodiment.

FIG. 05B depicts a block diagram of an exemplary apparatus (e.g., a distributed apparatus performing distributed computing), Apparatus 05000B, enabling the exchange and processing of data to execute a purchase of a Product of Interest, process one or more Qualifying Offers, and/or execute any function related to the Product of Interest after purchase among the components of Apparatus 05000A and one or more Affinity Servers 03100, according to one embodiment.

FIG. 05C depicts a block diagram of an exemplary apparatus (e.g., a distributed apparatus performing distributed computing), Apparatus 05000C, enabling the exchange and processing of data to execute a purchase of a Product of Interest, process one or more Qualifying Offers, and/or execute any function related to the Product of Interest after purchase among the components of Apparatus 05000B and one or more Insurer Servers 02700, according to one embodiment.

FIG. 05D depicts a block diagram of an exemplary apparatus (e.g., a distributed apparatus performing distributed computing), Apparatus 05000D, enabling the exchange and processing of data to execute a purchase of a Product of Interest, process one or more Qualifying Offers, and/or execute any function related to the Product of Interest after purchase among the components of Apparatus 05000C and one or more Employer Servers 03200, according to one embodiment.

FIG. 05E depicts a block diagram of an exemplary apparatus (e.g., a distributed apparatus performing distributed computing), Apparatus 05000E, enabling the exchange and processing of data to execute a purchase of a Product of Interest, process one or more Qualifying Offers, and/or execute any function related to the Product of Interest after purchase among the components of Apparatus 05000D and one or more Tax Servers 02900, Sales Tax Servers 02910, and/or Income Tax Servers 02920, according to one embodiment.

FIG. 05F depicts a block diagram of an exemplary apparatus (e.g., a distributed apparatus performing distributed computing), Apparatus 05000F, enabling the exchange and processing of data to execute a purchase of a Product of Interest, process one or more Qualifying Offers, and/or execute any function related to the Product of Interest after purchase among the components of Apparatus 05000E and one or more Government Benefit Servers 03300, according to one embodiment.

FIG. 05G depicts a block diagram of an exemplary apparatus (e.g., a distributed apparatus performing distributed computing), Apparatus 05000G, enabling the exchange and processing of data to execute a purchase of a Product of Interest, process one or more Qualifying Offers, and/or execute any function related to the Product of Interest after purchase among the components of Apparatus 05000F and one or more Distributor Servers 03500 and/or Component Servers 03600, according to one embodiment.

FIG. 05H depicts a block diagram of an exemplary apparatus (e.g., a distributed apparatus performing distributed computing), Apparatus 05000H, enabling the exchange and processing of data to execute a purchase of a Product of Interest, process one or more Qualifying Offers, and/or execute any function related to the Product of Interest after purchase among the components of Apparatus 05000G and one or more Product Sensors 02600 and Regulatory Agency Servers 05100, according to one embodiment.

FIG. 05I depicts a block diagram of an exemplary apparatus (e.g., a distributed apparatus performing distributed computing), Apparatus 05000I, enabling the exchange and processing of data to execute a purchase of a Product of Interest, process one or more Qualifying Offers, and/or execute any function related to the Product of Interest after purchase among the components of Apparatus 05000H and one or more Media Devices 05200, according to one embodiment.

FIG. 05J depicts a block diagram of an exemplary apparatus (e.g., a distributed apparatus performing distributed computing), Apparatus 05000J, enabling the exchange and processing of data to execute a purchase of a Product of Interest, process one or more Qualifying Offers, and/or execute any function related to the Product of Interest after purchase among the components of Apparatus 05000I and one or more Printing Devices 05300, according to one embodiment.

FIG. 06 depicts a block diagram of an exemplary apparatus (e.g., a distributed apparatus performing distributed computing), Apparatus 06000, enabling the exchange and processing of data to determine the Product requested in a User Query, identify one or more Retailers selling a Product of Interest, identify one or more Qualifying Offers, Authenticate one or more Data Processing Systems and/or Data Structures (defined herein) related to aa Transaction (defined herein), Authorize (defined herein) the withdrawal of funds from and deposit funds to one or more Qualifying Fund Accounts (defined herein), Clear (defined herein) aa Transaction, and/or Settle (defined herein) a Transaction, according to one embodiment.

FIG. 07 depicts a flow chart of an exemplary computer-implemented method, Method 07000, that when executed can exchange and process data to determine the Product requested in a User Query, identify one or more Retailers selling a Product of Interest, identify one or more Qualifying Offers, Authenticate one or more parties related to a Transaction, Authorize the withdrawal of funds from one of more Qualifying Fund Accounts, Clear a Transaction, and/or Settle a Transaction, according to one embodiment.

FIG. 08 depicts a chart illustrating the flow of data in and executions of functions by an exemplary computer-implemented method, Method 07000, among a Client Device 02100, Exchange Server 02200, and one or more other Data Processing Systems, according to one embodiment.

FIG. 09 depicts a block diagram of an exemplary apparatus (e.g., a distributed apparatus performing distributed computing), Apparatus 09000, enabling the exchange and processing of data to identify one or more Qualifying Offers, according to one embodiment.

FIG. 10 depicts a block diagram of an exemplary apparatus (e.g., a distributed apparatus performing distributed computing), Apparatus 10000, enabling the exchange and processing of data to Authenticate one or more Data Processing Systems and/or Data Structures related to a Transaction, according to one embodiment.

FIG. 11A and FIG. 11B depict a flow chart of an exemplary computer-implemented method, Method 11000, that when executed can exchange and process data to Authenticate one or more Data Processing Systems and/or Data Structures related to a Transaction, according to one embodiment.

FIG. 12 depicts a chart illustrating the flow of data in and executions of functions by an exemplary computer-implemented method, Method 11000, among a Client Device 02100, Exchange Server 02200, and one or more other Data Processing Systems, according to one embodiment.

FIG. 13A depicts a diagram of an exemplary Data Structure, User Data Structure 13000A, that when stored on a Computer-Readable Medium (defined herein) can cause a Processor to execute any of the methods, steps, and/or instructions described herein, in general, and/or to execute User Data Structure operations, in particular, according to one embodiment.

FIG. 13B depicts a diagram of an exemplary Data Structure, Offer Data Structure 13000B, that when stored on a Computer-Readable Medium can cause a Processor to execute any of the methods, steps, and/or instructions described herein, in general, and/or to execute Offer Data Structure operations, in particular, according to one embodiment.

FIG. 14 depicts a diagram of an exemplary Data Structure, Offer Data Structure 14000, that when stored on a Computer-Readable Medium can cause a Processor to execute any of the methods, steps, and/or instructions described herein, in general, and/or to identify one or more Qualifying Offers, in particular, according to one embodiment.

FIG. 15A and FIG. 15B depicts a diagram of a flow chart of an exemplary computer-implemented method, Method 15000, that when executed can exchange and process data to identify a plurality of equal or equivalent Offer Condition Attributes, according to one embodiment.

FIG. 16A depicts a block diagram of an exemplary apparatus (e.g., a distributed apparatus performing distributed computing), Apparatus 16000, enabling the exchange and processing of data to detect any creation, update, and/or deletion operation on one or more Offer Data Structures, according to one embodiment.

FIG. 16B depicts a diagram of a flow chart of an exemplary computer-implemented method, Method 16000, that when executed can exchange and process data to detect any creation, update, and/or deletion operation on one or more Offer Data Structures, according to one embodiment.

FIG. 17 depicts a diagram of a flow chart of an exemplary computer-implemented method, Method 17000, that when executed can exchange and process data to identify one or more Qualifying Offers and/or determine a Qualifying Retailer/Offer Combination (defined herein) which can minimize or decrease below a predefined threshold the Net Price, according to one embodiment.

FIG. 18 depicts a block diagram of an exemplary apparatus (e.g., a distributed apparatus performing distributed computing), Apparatus 18000, enabling the exchange and processing of data to determine a set of Qualifying User Fund Accounts (defined herein) and Withdrawal Amounts (defined herein) which can minimize or decrease the Total User Fund Account Withdrawal Cost (defined herein) and/or maximize or increase the Total User Fund Account Withdrawal Benefit (defined herein), according to one embodiment.

FIG. 19 depicts a diagram of a flow chart of an exemplary computer-implemented method, Method 19000, that when executed can exchange and process data to identify one or more Qualifying User Fund Accounts and determine a Qualifying User Fund Account Combination (defined herein) and Withdrawal Amounts thereof which can minimize or decrease below a predefined threshold the Total User Fund Account Withdrawal Cost and/or maximize or increase above a predefined threshold the Total User Fund Account Withdrawal Benefit, according to one embodiment.

FIG. 20 depicts a chart illustrating the flow of data in and executions of functions by an exemplary computer-implemented method, Method 19000, among a Client Device 02100, Exchange Server 02200, and one or more other Data Processing Systems, according to one embodiment.

FIG. 21 depicts a block diagram of an exemplary apparatus (e.g., a distributed apparatus performing distributed computing), Apparatus 21000, enabling the exchange and processing of data to Authorize the withdrawal of funds from one or more Qualifying Fund Accounts, according to one embodiment.

FIG. 22 depicts a flow chart of an exemplary computer-implemented method, Method 22000, that when executed can exchange and process data to Authorize the withdrawal of funds from one of more Qualifying Fund Accounts, according to one embodiment.

FIG. 23 depicts a chart illustrating the flow of data in and executions of functions by an exemplary computer-implemented method, Method 22000, among a Client Device 02100, Exchange Server 02200, and one or more other Data Processing Systems, according to one embodiment.

FIG. 24 depicts a block diagram of an exemplary apparatus (e.g., a distributed apparatus performing distributed computing), Apparatus 24000, enabling the exchange and processing of data to Clear a Transaction, according to one embodiment.

FIG. 25 depicts a flow chart of an exemplary computer-implemented method, Method 25000, that when executed can exchange and process data to Clear a Transaction, according to one embodiment.

FIG. 26 depicts a chart illustrating the flow of data in and executions of functions by an exemplary computer-implemented method, Method 25000, among a Client Device 02100, Exchange Server 02200, and one or more other Data Processing Systems, according to one embodiment.

FIG. 27A depicts a block diagram of an exemplary apparatus (e.g., a distributed apparatus performing distributed computing), Apparatus 27000A, enabling the exchange and processing of data to Settle a Transaction, according to one embodiment.

FIG. 27B depicts a block diagram of an exemplary apparatus (e.g., a distributed apparatus performing distributed computing), Apparatus 27000B, enabling the exchange and processing of data to Authorize, Clear, and/or Settle a Transaction where one or more functions can be executed in one or more other Payment Networks, according to one embodiment.

FIG. 28 depicts a flow chart of an exemplary computer-implemented method, Method 28000, that when executed can exchange and process data to Settle a Transaction, according to one embodiment.

FIG. 29 depicts a chart illustrating the flow of data in and executions of functions by an exemplary computer-implemented method, Method 28000, among a Client Device 02100, Exchange Server 02200, and one or more other Data Processing Systems, according to one embodiment.

FIG. 30A through FIG. 30E depict a flow chart of an exemplary computer-implemented method, Method 30000, that when executed can exchange and process data to determine the Product requested in a User Query, identify one or more Qualifying Offers, execute the purchase of at least the Product of Interest, process the one or more Qualifying Offers, transfer funds among a plurality of Qualifying Fund Accounts, and execute any function related to the Product of Interest after purchase, according to one embodiment.

FIG. 31A and FIG. 31B depict a chart illustrating the flow of data in and execution of functions by an exemplary computer-implemented method, Method 30000, among a Client Device 02100, Exchange Server 02200, and one or more other Date Processing Systems, according to one embodiment.

FIG. 32 depicts a diagram of an exemplary display of data comparing the Retailer Price (defined herein) and value(s) of associated Qualifying Offers for each of a plurality of candidate Retailers of Interest, according to one embodiment.

FIG. 33 depicts a diagram of an exemplary display of data comparing the benefits and costs of each of a plurality of candidate Products of Interest, according to one embodiment.

FIG. 34 depicts a block diagram of an exemplary apparatus (e.g., a distributed apparatus performing distributed computing), Apparatus 34000, enabling the exchange and processing of data to identify one or more Qualifying Offers, execute the purchase of at least the Product of Interest, process the one or more Qualifying Offers, transfer funds among a plurality of Qualifying Fund Accounts, and execute any function related to the Product of Interest after purchase where the Product of Interest is a health Product comprising one or more goods and/or one or more services, according to one embodiment.

FIG. 35 depicts an exemplary display of data comparing the Retailer Price and value(s) of associated Qualifying Offers for each of a plurality of candidate Retailers of Interest where the Product of Interest is a health Product comprising one or more goods and/or one or more services, according to one embodiment.

### DETAILED DESCRIPTION

### Definitions

Acquirer means a party which can accept a Payment Method (defined herein) on behalf of a Retailer (defined herein). In a Card Association (defined herein) system, an Acquirer or a Retailer Bank (defined herein) can store funds in a Retailer Fund Account (defined herein), transmit funds from Retailer Fund Account to an account of another party, e.g., a User of Client Device 02100 (defined herein), and/or receive funds from an account of another party, e.g., a Payment Issuer (defined herein) transmitting the payment of a User of Client Device 02100 for a Product of Interest sold by the Retailer.

Affinity Party means a party which can offer to members of an affinity group one or more Offers (defined herein) associated with a Product of Interest. Affinity Party can be any group of members, where the group can include without limitation: (a) a group based on one or more activities, e.g., one for travel or emergency auto repair; (b) a group based on one or more experiences, e.g., attendance at an educational institution or service as a veteran; (c) a group based on one or more properties, e.g., residence in a unit like an apartment building; and/or (d) a group based on membership of a demographic group, e.g., senior citizens or students.

Authenticate or Authentication means to execute or the execution of, respectively, one or more functions confirming any attribute of a Transaction including without limitation: (a) any Transaction Attribute Value (defined herein) associated with a Transaction Attribute (defined herein); (b) any Data Processing System 01000 executing one or more functions related to a Transaction; and/or (c) the association of a Fund Account with a party on behalf of whom the Fund Account Administrator administers the Fund Account.

Authorize or Authorization means to execute or the execution of, respectively, one or more functions approving the transfer of funds in a Transaction including without limitation: (a) approving the withdrawal of a Withdrawal Amount from a Qualifying Fund Account; (b) reserving for a predefined period the Withdrawal Amount from the Current Account Balance in the Qualifying Fund Account; and/or (c) approving the deposit of a Deposit Amount (defined herein) to a Qualifying Fund Account.

A Fund Account can respond to an Authorization Request at three phases of a Transaction including without limitation: (a) Prior Authorization; (b) Concurrent Authorization; and/or Post Authorization. These classes of Authorization differ by the time when a User, Producer Server 02400, and/or Retailer Server 02300 can obtain approval from the party associated with the Fund Account from which the User, Producer Server 02400, and/or Retailer Server 02300 wishes to receive funds. Prior Authorization means obtaining approval before Product Good Reception (defined herein) or Product Service Reception (defined herein). Concurrent Authorization means obtaining approval within a predefined time period including Product Good Reception or Product Service Reception. Post Authorization means obtaining approval after Product Good Reception or Product Service Reception.

Authorization Attribute means any attribute associated with an Authorization Request which can include without limitation: (a) a Product Attribute associated with an Authorization Attribute Value specifying the set of one or more Products purchased and/or used in a Transaction; (b) a Product Class Attribute associated with an Authorization Attribute Value specifying the set of one or more Product Classes including the Product purchased and/or used in a Transaction; (c) a Recipient Attribute associated with an Authorization Attribute Value specifying the set of one or more parties associated with each Fund Account to which the Authorization Request specifies a deposit; (d) a Date/Time Attribute associated with an Authorization Attribute Value specifying the data and/or time of the Authorization Request; and/or (e) a Withdrawal Amount Attribute associated with an Authorization Attribute Value specifying the Withdrawal Amount from the User Fund.

Authorization Attribute Value means the one or more values associated with each Authorization Attribute.

Authorization Request means a request transmitted to a Qualifying Fund Account to execute an Authorization associated with a Transaction.

Authorization Response means a response transmitted by a Qualifying Fund Account that it has executed an Authorization associated with a Transaction.

Bank means a financial institution which can administer a Fund Account. Each Bank can be associated with a unique identifier which can include without limitation: (a) an identifier assigned within a standard classification system, e.g., a Routing Transit Number (“RTN”) assigned to each financial institution in the United States or a Society for Worldwide Interbank Financial Telecommunication (“SWIFT”) bank identifier under the ISO 9362 numbering standard assigned to a financial institution for use in transferring funds among financial institutions, particularly for international funds transfers; and/or (b) an identifier assigned within a proprietary classification system.

Brand means a name including one or more words identifying one or more classes of Products offered by one Producer (defined herein). For example, a Sony® DSC-T110/B Cybershot Digital Camera can include a plurality of brands including without limitation: (a) “Sony®” which can identify one or more classes of Products offered by the Producer, Sony®; and/or (b) “Cybershot” which can identify one or more classes of Products, e.g., digital cameras, offered by the Producer, Sony®.

Brand Identifier means any identifier which uniquely identifies a Brand within one classification system. The classification systems can include without limitation: (a) a standard classification system in which a party assigns for use by any other party an identifier to each Brand; and/or (b) a proprietary classification system in which a party assigns for its own use an identifier to each Brand, e.g., a Retailer assigning for its own use an identifier to each Brand.

Clear or Clearing means to execute or the execution of, respectively, one or more functions between the Authorization of a Transaction and the Settlement of a Transaction which can include without limitation: (a) transmitting a Clearing Message 06930 to each Qualifying Fund Account Administrator; (b) computing the Net Withdrawal Amount (defined herein) for a Qualifying Fund Account from which one or more embodiments of the invention can withdraw funds; (c) computing the Net Deposit Amount (defined herein) for a Qualifying Fund Account to which one or more embodiments of the invention can deposit Funds; (d) managing the exposure of a Qualifying Fund Account to any exceptions in a Transaction; and/or (e) generating and transmitting to each party in a Transaction a Uniform Transaction Clearing Record 24100.

Component Vendor means a party can produce one or more components used by a Producer.

Computer Program Product (“CPP”) means a product comprising one or more functions enabling or causing the execution of one or more methods described herein. When loaded, stored, encoded, recorded, or embodied in a Computer-Readable Medium, a CPP can cause a computer, general-purpose Processor 01200, special-purpose Application Processor 01202, Specialized Processor 01204, and/or other hardware to execute any of the methods, steps, and/or instructions described herein. A Computer-Readable Medium encoded with a CPP “is a computer element which defines structural and functional interrelationships between the computer program and the rest of the computer which permit the computer program's functionality to be realized.” (U.S. Patent and Trademark Office Manual of Patent Examining Procedure, Section 2106.01)

Computer-Readable Medium means a medium which can store data and/or instructions in a format that can be read, accessed, written to, and/or executed by one or more Data Processing Systems 01000, in general, e.g., a computer, and/or one or more Processors, in particular, e.g., Processor 01200. Computer-Readable Medium can be a medium readable by a computer, accessible by a computer, readable by a machine, accessible by a machine, and/or to which a computer can write. Computer-Readable Medium can include without limitation: (a) any type of magnetic storage, e.g., floppy disks, or hard disks; (b) optical disks, e.g., compact disk (“CD”), CD-ROMs, or digital versatile disk (“DVD”); (c) any type of magneto-optical disks; (d) any type of memory, flash memory, cache, and/or registers, e.g., random access memory (“RAM”), static RAM (“SRAM”), dynamic RAM (“DRAM”), read-only memory (“ROM”), programmable ROM (“PROM”), erasable programmable ROM (“EPROM”), electrically erasable programmable ROM (“EEPROM”), NOR flash memory, or NAND flash memory; (e) magnetic or optical cards; (f) any type of media capable of storing, transmitting, and/or receiving data and/or instructions, including, wireless channels, wired channels, and/or a combination of wireless and wired channels; and/or (g) any other type of media capable of storing logic, instructions, and/or data causing the execution of one or more methods described herein.

Customer Identifier means any identifier which uniquely identifies a party purchasing or using one or more Products (defined herein) within one classification system. The classification systems can include without limitation: (a) a standard classification system in which a party assigns for use by any other party an identifier to each User, e.g., a Taxpayer identifier; and/or (b) a proprietary classification system in which a party assigns for its own use an identifier to User, e.g., a Retailer issuing a loyalty membership to a customer and assigning an identifier uniquely identifying the customer. One or more embodiments of the invention can generate a universal identifier which can uniquely identify a party purchasing or using one or more Products within one classification system and map the universal identifier to a Customer Identifier assigned in each of one or more other classification systems (“Universal Customer Identifier”).

Data Structure means “a physical or logical relationship among data elements designed to support specific data manipulation functions” (U.S. Patent and Trademark Office Manual of Patent Examining Procedure, Section 2106.01), e.g., executing functions in a Data Processing System 01000. When loaded, stored, encoded, recorded, or embodied in a Computer-Readable Medium, a Data Structure can cause a computer, general-purpose Processor 01200, special-purpose Application Processor 01202, Specialized Processor 01204, and/or other hardware to execute any of the methods, steps, and/or instructions described herein. A Computer-Readable Medium encoded with a Data Structure “defines structural and functional interrelationships between the data structure and the computer software and hardware components which permit the data structure's functionality to be realized.” (U.S. Patent and Trademark Office Manual of Patent Examining Procedure, Section 2106.01) A Data Structure can include a Repository Data Structure storing physical data, including without limitation: repository libraries storing data related to objects and/or object instances, and/or tables to manage the relationships among objects.

A Computer-Readable Medium encoded with a Data Structure can store data in one or more tables of a Relational Database Management System (“RDBMS”) in any form, including without limitation: (a) a raw non-normalized form; (b) a form, e.g., First Normal Form (“1NF”), meeting one or more conditions including without limitation: (i) a table includes no duplicative columns; (ii) a table includes no duplicative rows; (iii) each cell in a table contains only one value from an applicable domain; and/or (iv) a table includes one column containing for any row a unique value or a plurality of columns containing for any row a unique combination of values (“Unique Key”); (c) a form, e.g., Second Normal Form (“2NF”), meeting one or more conditions including without limitation: (i) execution of all the functions of a 1NF; and/or (ii) no non prime attribute depends on any subset of any candidate key of the table (where a Candidate Key of a relation is a minimal Super Key for such relation and where a Super Key of a relation is a set of attributes whose combination of values can uniquely identify a row); (d) a form, e.g., Third Normal Form (“3NF”), meeting one or more conditions including without limitation: (i) execution of all the functions of a 2NF; and/or (ii) every non prime attribute depends only on a Super Key of the table; (e) a form, e.g., a Third And Half Form (“3.5NF”) or Boyce-Codd Normal Form, meeting one or more conditions including without limitation: (i) execution of all the functions of a 3NF; and/or (ii) every attribute depends only on a Super Key of the table; (f) a form, e.g., a Fourth Normal Form (“4NF”), meeting one or more conditions including without limitation: (i) execution of all the functions of a 3.5NF; and/or (ii) every non-trivial multivalued dependency depends on a Super Key of the table; (g) a form, e.g., a Fifth Normal Form (“5NF”), meeting one or more conditions including without limitation: (i) execution of all the functions of a 4NF; and/or (ii) every non-trivial join dependency depends on a Candidate Key of the table; (h) a form, e.g., a Sixth Normal Form (“6NF”), meeting one or more conditions including without limitation: (i) execution of all the functions of a 5NF; and/or (ii) there are no non-trivial join dependencies; (i) a form, e.g., any normal form with at least one condition in addition to 6NF (“>6NF”), meeting one or more conditions including without limitation: (i) execution of all the functions of a 6NF; and/or (ii) one or more additional conditions including without limitation: (1) any functional dependency other than a functional dependency expressed in a prior form; (2) any multivalued dependency other than a multivalued dependency expressed in a prior form; and/or (3) any dependency other than a functional dependency or a multivalued dependency.

A Computer-Readable Medium encoded with a Data Structure can store data on which a computer, general-purpose Processor 01200, special-purpose Application Processor 01202, Specialized Processor 01204, and/or other hardware can execute one or more operations including without limitation: (a) a create operation or any equivalent operation adding data to a Data Structure (“Create Operation”); (b) a read operation or any equivalent operation querying data from a Data Structure (“Read Operation”); (c) an update operation or any equivalent operation modifying data in a Data Structure (“Update Operation”); (d) a delete operation or any equivalent operation deleting data from a Data Structure (“Delete Operation”); and/or (e) any other operation on data in a Data Structure.

Distributor means a party which can distribute one or more Products for a Producer.

Employer means a party which can employ one or more Users of Client Device 02100 or represent employees. Employer can execute one or more functions including without limitation: (a) offer to its employees one or more Offers associated with a Product of Interest; (b) make available to its employees one or more Offers associated with a Product of Interest where the Offer is made by a party other than the Employer; (c) pay its employees; (d) transmit funds to a User Fund Account (defined herein); (e) receive funds from a User Fund Account; (f) exclude from taxable income of its employees one or more classes of expenses, e.g., health insurance premiums or transportation expenses; (g) withhold income of its employees for any tax liability; and/or (h) reimburse its employees. Employer can be a public entity, e.g., a governmental organization, a private entity, e.g., a business, or a combination of a public and private entity. Employer can be a non-profit organization, e.g., a college or university. Employer can be a party representing employees, e.g., a labor union.

Fund Account means an account associated with a unique party capable of receiving, storing, holding, and/or transmitting funds. Fund Account can be such an account for any party including without limitation: an Affinity Party Fund Account, a Component Vendor Fund Account, a Distributor Fund Account, an Employer Fund Account, a Government Benefit Authority Fund Account, an Insurer Fund Account, a Producer Fund Account, a Retailer Fund Account, a Shipper Fund Account, a Tax Authority Fund Account (which can include without limitation an Income Tax Authority Fund Account, a Property Tax Authority Fund Account, and/or a Sales Tax Authority Fund Account), a Transaction Fee Fund Account, and/or a User Fund Account. A party can have one or more Fund Accounts, e.g., one User can have a first User Fund Account in the form of a credit card and a second User Fund Account in the form of a Tax-Favored Savings Account (defined herein), or an Employer can have a first Employer Fund Account in the form of a Checking Account available for receiving, storing, holding, and/or transmitting funds for any class of revenue or expense and a second Employer Fund Account dedicated to receiving, storing, holding, and/or transmitting funds for a Flexible Spending Arrangement (“FSA”) account. While a Bank typically administers a Fund Account, the invention is not limited to that embodiment and can enable any party licensed by the appropriate authority to administer a Fund Account. Each Fund Account shall be associated with a unique identifier which can include without limitation: (a) an identifier assigned within a standard classification system, e.g., a 16-account number complying with a standard, e.g., the ISO 7812 numbering standard, used to identify uniquely a User of a credit, debit, or charge card; and/or (b) an identifier assigned within a proprietary classification system, e.g., an account number which can be of varying length assigned by a financial institution to identify uniquely a User of a Fund Account it administers. A Fund Account can receive, store, hold, and/or transmit any class of funds including without limitation: (a) funds in the form of cash; and/or (b) funds in the form of non-cash, e.g., points, miles, kilometers, and/or credits.

Fund Account Administrator means any party authorized to administer a Fund Account.

Fund Account Attribute means any property of the Fund Account related to the use of funds in the Fund Account to pay for part or all of one or more Products purchased in a Transaction or receive part or all of the funds for one or more Products sold in a Transaction. Fund Account Attribute can include without limitation: (a) a property of the Product in a Transaction, e.g., the Qualifying Product Identifier (defined herein) of each of one or more Products for which funds in a Fund Account can pay like a Qualifying Product Identifier associated with student Loan Account requiring the use of any funds disbursed for the purchase only of Products (e.g., tuition or a textbook) associated with the Qualifying Product Identifier; (b) a property of the party associated with the Fund Account to which the administrator can transfer funds, e.g., a Qualifying Recipient Identifier of the party associated with the Fund Account to which the administrator can transfer funds in compliance with any requirement limiting the parties which can receive funds; (c) the current amount of funds stored in a Fund Account (“Current Account Balance”); (d) the maximum amount of funds from which the administrator can withdraw from a Fund Account independent of the Current Account Balance (“Maximum Account Balance”); (e) the Initial Date (defined herein) for use of funds in a Fund Account, e.g., a beginning date for use of funds from a Loan (defined herein); and/or (f) the Expiration Date (defined herein) for use of funds in a Fund Account, e.g., an Expiration Date in a Stored Value Account.

Fund Account Benefit Attribute means any benefit of withdrawing funds from or depositing funds to a Fund Account. Fund Account Benefit Attribute can include without limitation: (a) any cash or non-cash benefit for initializing the Fund Account (“Origination Benefit”); (b) any cash or non-cash benefit for maintaining a minimum Current Account Balance in the Fund Account (“Minimum Current Account Balance Maintenance Benefit”); and/or (c) any cash or non-cash benefit for each withdrawal in the Fund Account (“Activity Benefit”). Total User Fund Account Withdrawal Benefit means the sum of Fund Account Benefit associated with each User Fund Account from which one or more embodiments of the invention withdraws the Withdrawal Amount in any given Transaction.

Fund Account Condition Attribute means a term or condition limiting the withdrawal and/or deposit of funds for a given Authorization Request to the Authorization Request with one or more values for each of one or more Authorization Attributes. A Fund Account Condition Attribute limits the withdrawal and/or deposit of funds where the Authorization Attribute Value associated with the Authorization Attribute equal or equivalent to the Fund Account Condition Fund Account Condition Attribute; or (b) at least one value within a set of Fund Account Condition Attribute Values associated with the Fund Account Condition Attribute.

Fund Account Condition Attribute can include without limitation:
(a) a Product Condition limiting the withdrawal and/or deposit of funds for a given Authorization Request to the Authorization Request associated with the purchase and/or use of one or more Products, each of which is associated with the Product Identifier and/or Universal Product Identifier specified in the Fund Account Condition Attribute Value (“Qualifying Product Identifier”), e.g., if a Fund Account Condition Attribute is a Product Condition in an NDC (defined herein) format and the Fund Account Condition Attribute Value is a set of NDC identifiers 00071015000:00071015999, the Fund Account can Authorize the withdrawal and/or deposit of funds only for the purchase and/or use of a set of the drug Lipitor® in one or more strengths.
(b) a Product Class Condition limiting the withdrawal and/or deposit of funds for a given Authorization Request to the Authorization Request associated with the purchase and/or use of one or more Products in the Product Class associated with the Product Class Identifier specified in the Fund Account Condition Attribute Value, e.g., if a Fund Account Condition Attribute is a Product Class Condition in a Unique Ingredient Identifier (“UNIT”) format classified by the United States Food and Drug Administration (“FDA”) and the Fund Account Condition Attribute Value is the UNIT identifier “36209ITL9D”, the Fund Account can Authorize the withdrawal and/or deposit of funds only for the purchase and/or use of a set of drugs which include the unique ingredient Acetaminophen;
(c) a Recipient Condition limiting the withdrawal and/or deposit of funds for a given Authorization Request to the Authorization Request associated with the deposit of funds to the Fund Account held by one or more parties, each of which is associated an identifier specified in the Fund Account Condition Attribute Value (“Qualifying Recipient Identifier”), e.g., if a Fund Account Condition Attribute is a Recipient Condition in a MID format and the Fund Account Condition Attribute Value is a set of MID identifiers 1234567890:1234567899, the Fund Account can Authorize the withdrawal only for deposit of funds to the Fund Account held by the specified recipients.
(d) a Date/Time Condition, i.e., date and/or time or range of dates and/or times, limiting the withdrawal and/or deposit of funds for a given Authorization Request to the Authorization Request at the date and/or time or within a range of dates and/or times specified in the Fund Account Condition Attribute Value, which can include without limitation: (i) a start date in any date/time format, e.g., a YYYY/MM/DD date format, limiting the withdrawal and/or deposit of funds not earlier than the date/time specified in the Fund Account Condition Attribute Value (“Initial Date”), e.g., if a Fund Account Condition Attribute is a Date/Time Condition requiring the Initial Date in a YYYY/MM/DD date format and the Fund Account Condition Attribute Value equals, e.g., 2011/01/01, the Initial Date equals Jan. 1, 2011; and/or (ii) an end date in any date/time format, e.g., a YYYY/MM/DD date format, limiting the withdrawal and/or deposit of funds not later than the date/time specified in the Fund Account Condition Attribute Value (“Expiration Date”), e.g., if a Fund Account Condition Attribute is a Date/Time Condition requiring the Expiration Date in a YYYY/MM/DD date format and the Fund Account Attribute Value equals, e.g., 2011/12/31, the Expiration Date equals Dec. 31, 2011.
(e) a Maximum Withdrawal Condition limiting the withdrawal of funds for a given Authorization Request to the Authorization Request associated with the withdrawal of an Withdrawal Amount equal or less than a Fund Account Condition Attribute Value equal to the difference between the Maximum Account Balance and the Current Account Balance (“Maximum Withdrawal Amount”), e.g., if a Fund Account Condition Attribute is a Maximum Withdrawal Condition in a currency format and the Fund Account Condition Attribute Value is $2,948.78 equal to the difference between a Maximum Account Balance of $10,000.00 and a Current Account Balance of $7,051.22, the Fund Account can Authorize the withdrawal of funds up to $2,948.78.

Fund Account Cost Attribute means any cost of withdrawing funds from or depositing funds to a Fund Account. Fund Account Cost Attribute can include without limitation: (a) a fee for initializing the Fund Account (“Origination Fee”); (b) a fee for terminating the Fund Account (“Termination Fee”); (c) a periodic fee for use of funds in the Fund Account (“Interest Fee”); (d) a fee for processing a withdrawal when the Withdrawal Amount exceeds the Current Account Balance (“Insufficient Funds Fee”); (e) a fee for violating any term in the contract for use of the Fund Account (“Penalty Fee”); (f) a fee for excess activity, e.g., withdrawals, in the Fund Account over any time period (“Excess Activity Fee”); (g) a fee for insufficient activity, e.g., withdrawals, in the Fund Account over any time period (“Inactivity Fee”); and/or (h) a fee for withdrawing funds from or depositing funds to a Fund Account (“Transfer Fee”) which can include without limitation a fee for withdrawing funds to pay for a Transaction (“Transaction Transfer Fee”) and/or a fee for withdrawing funds to receive cash (“Cash Transfer Fee”). Total User Fund Account Withdrawal Cost means the sum of Fund Account Cost associated with each User Fund Account from which one or more embodiments of the invention withdraws the Withdrawal Amount in any given Transaction.

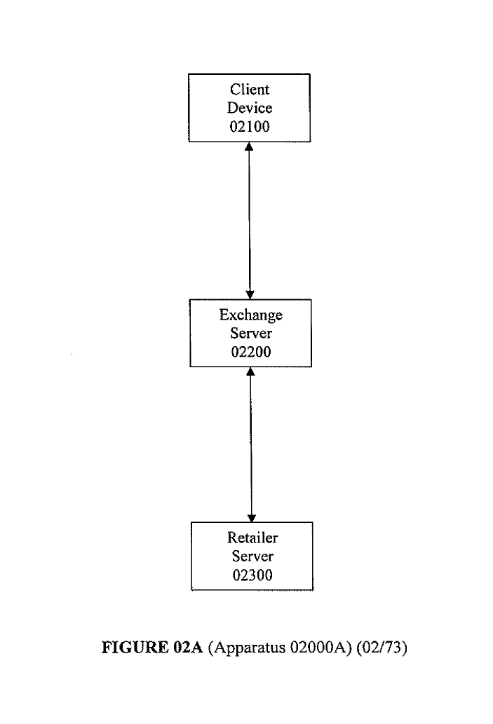

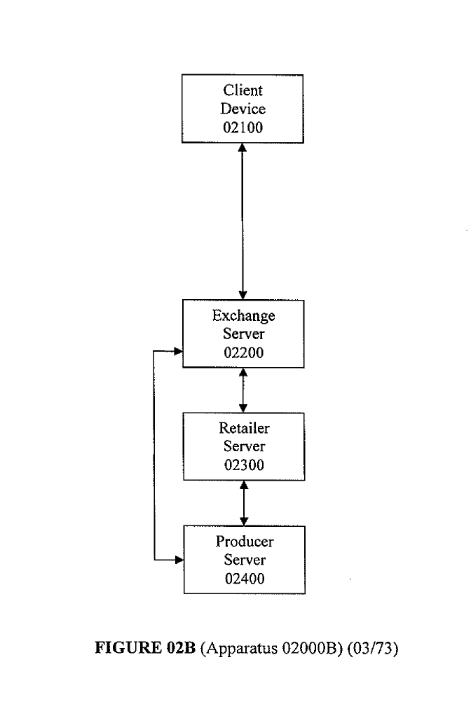

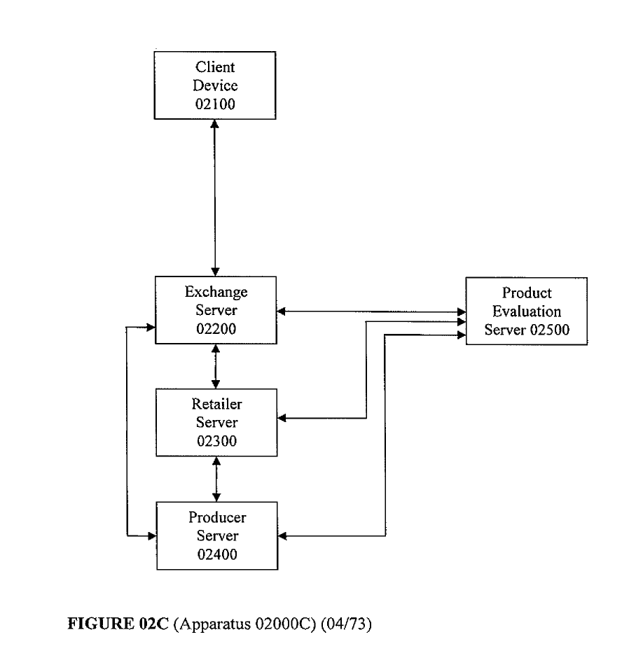

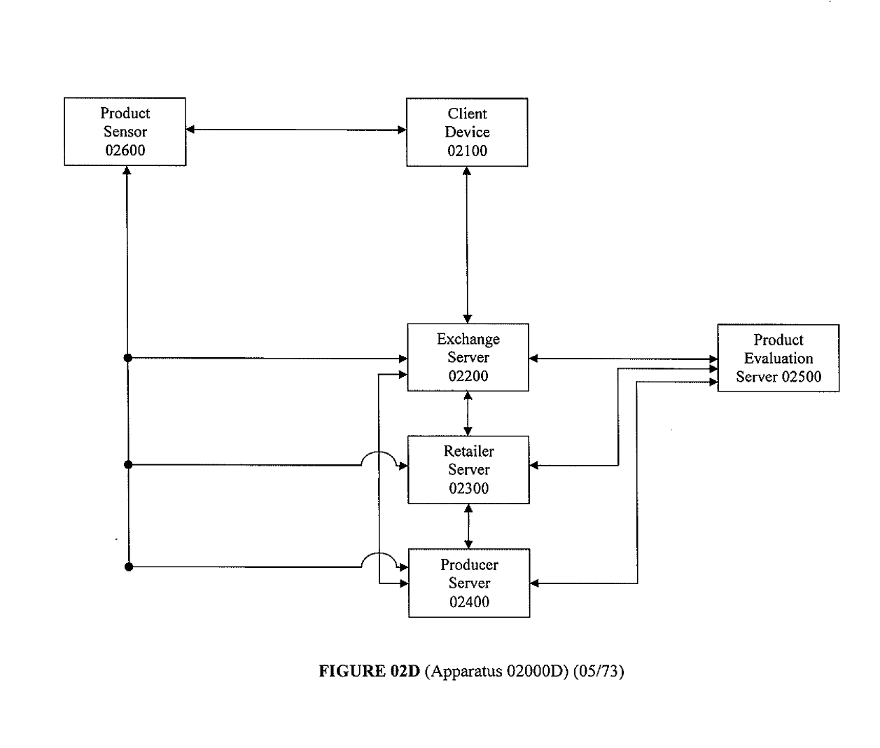

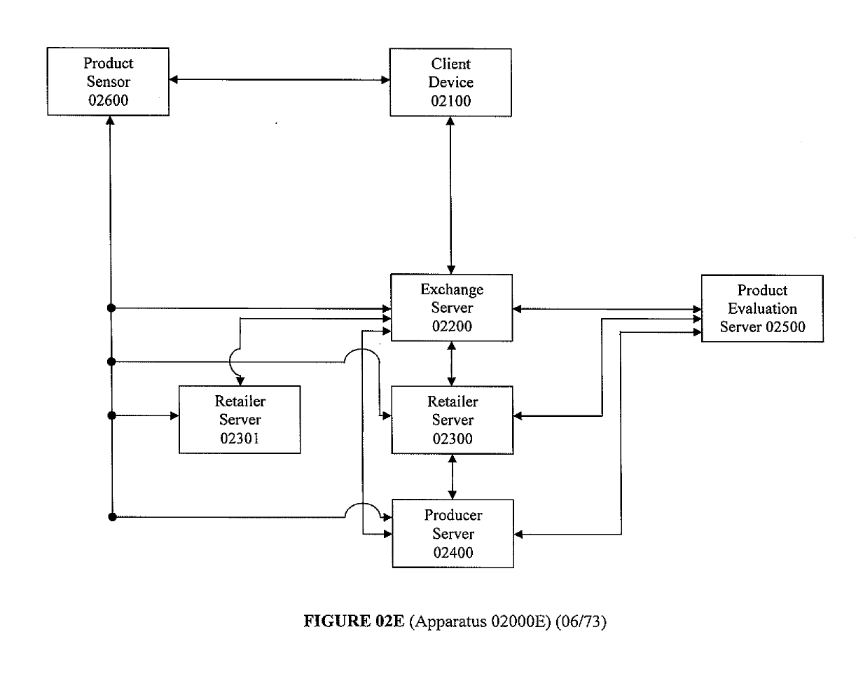

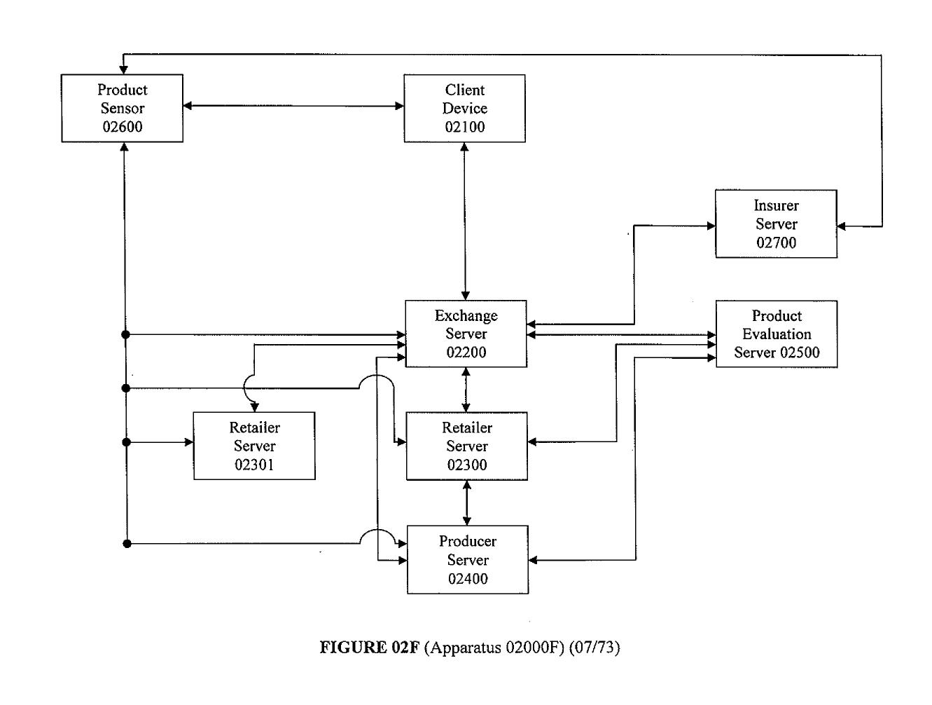

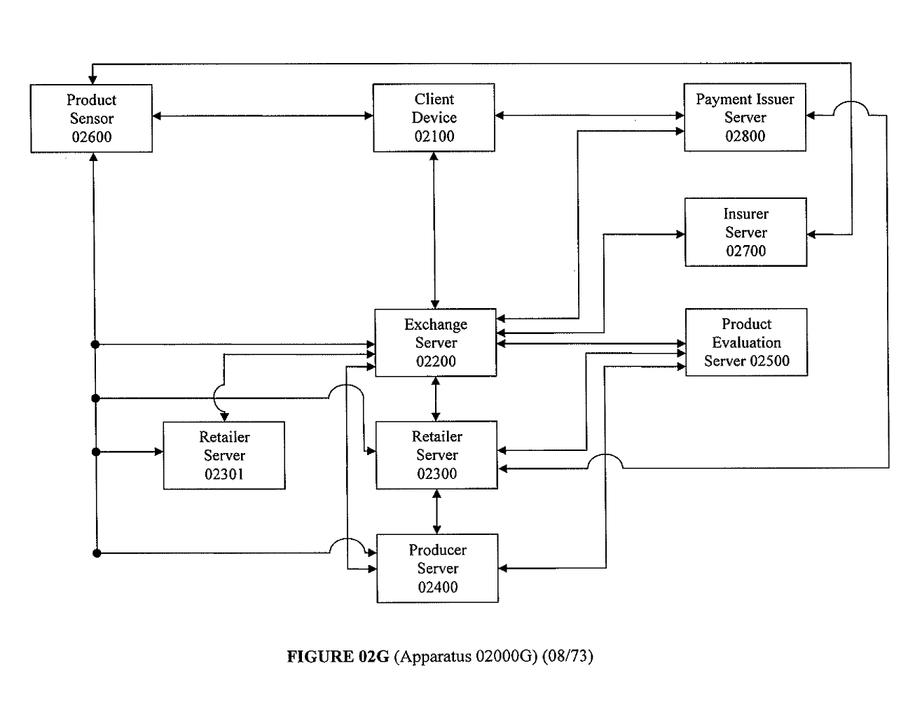

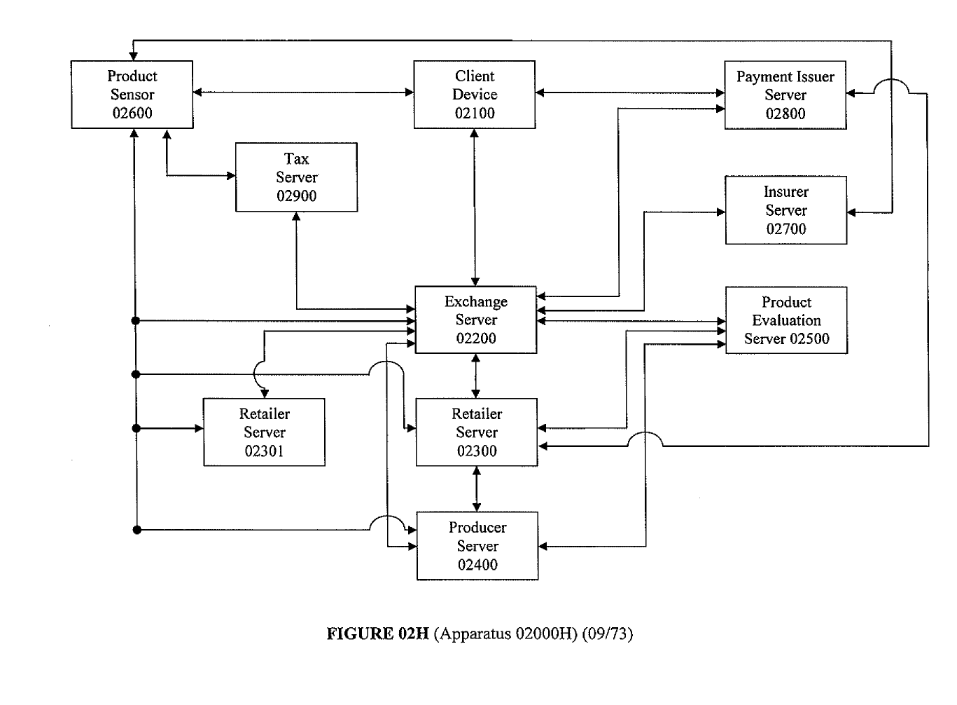

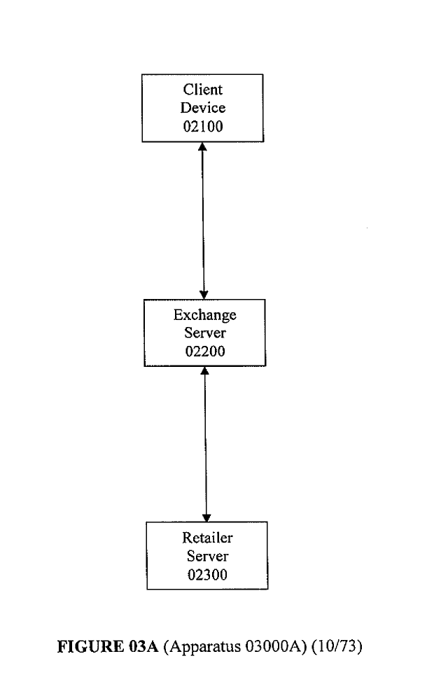

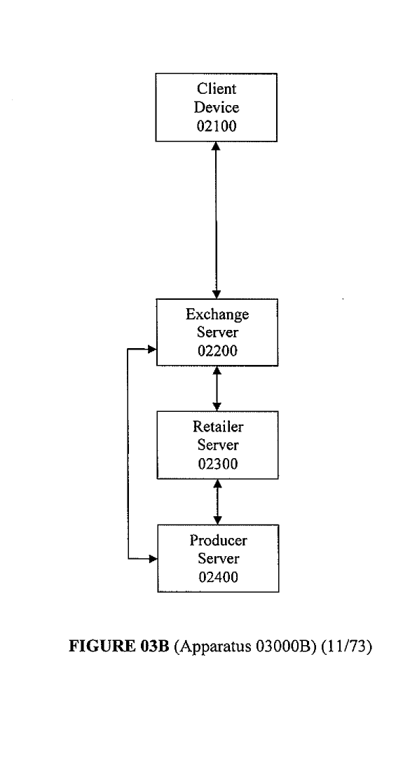

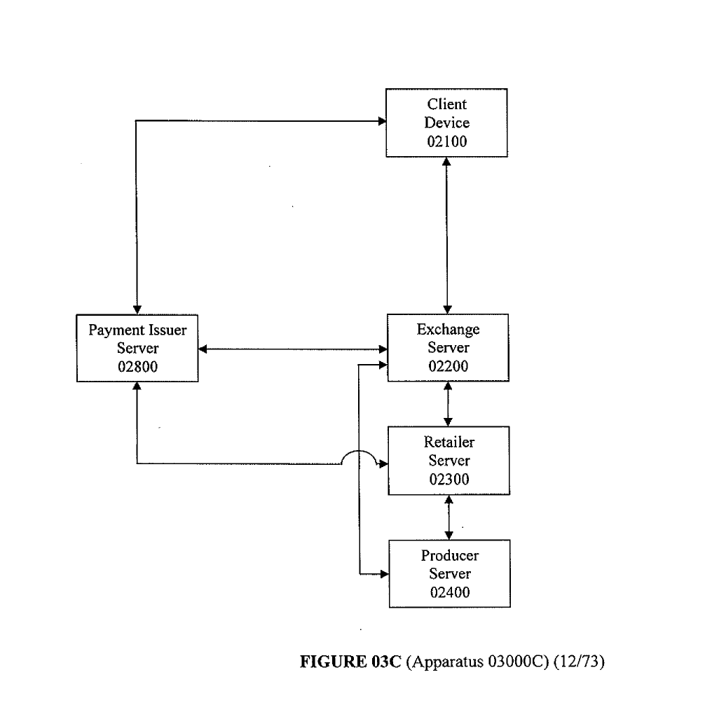

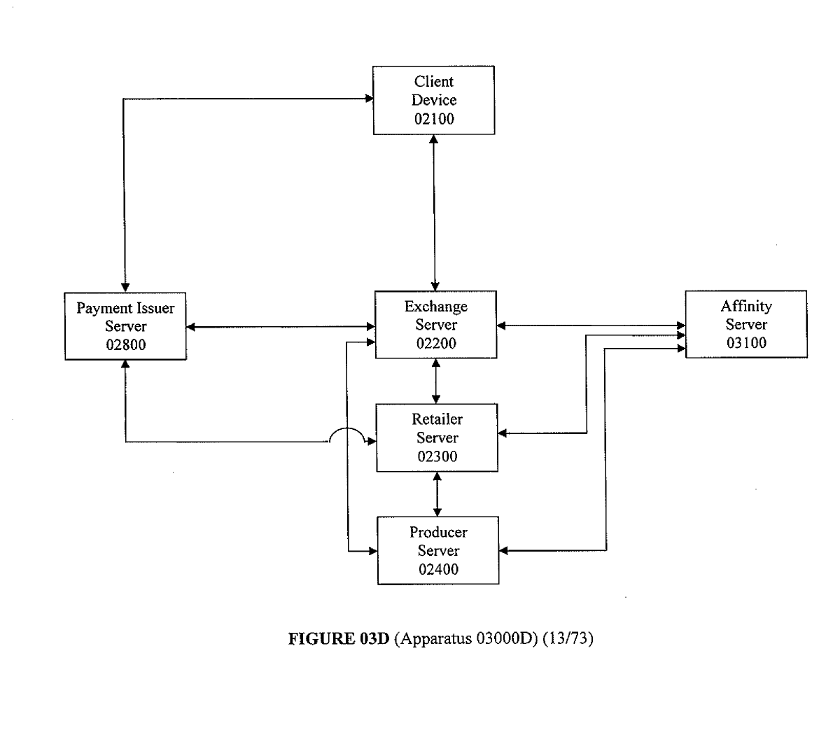

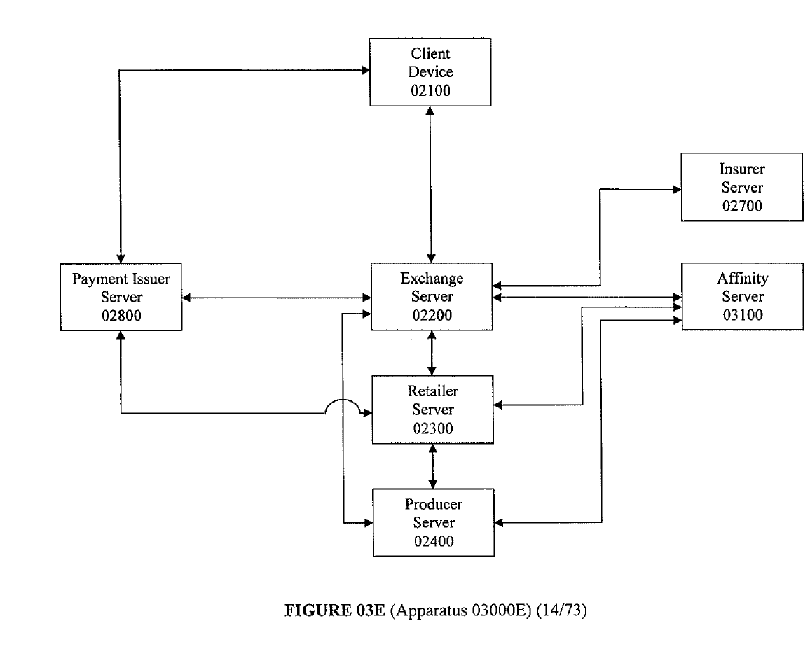

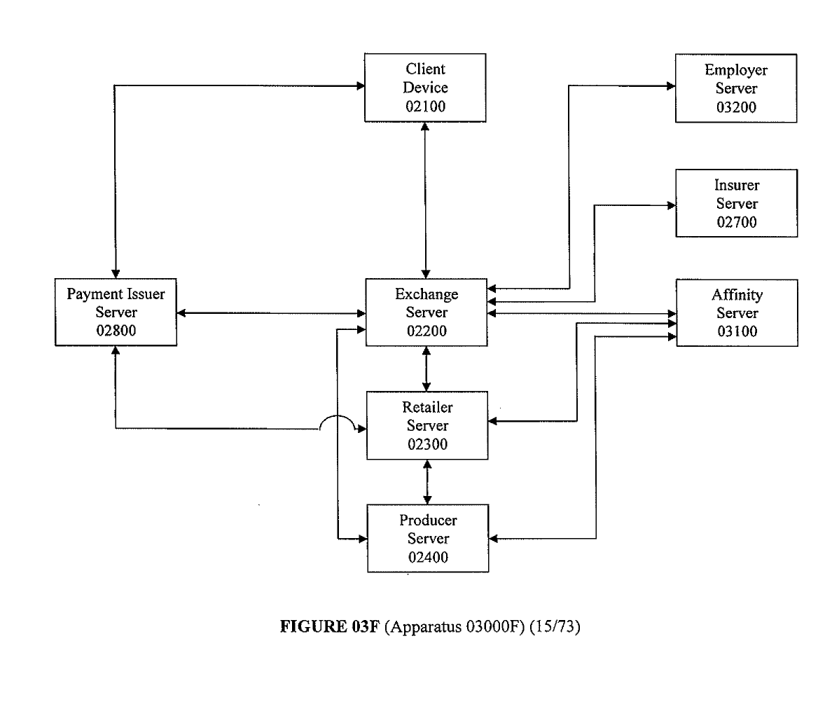

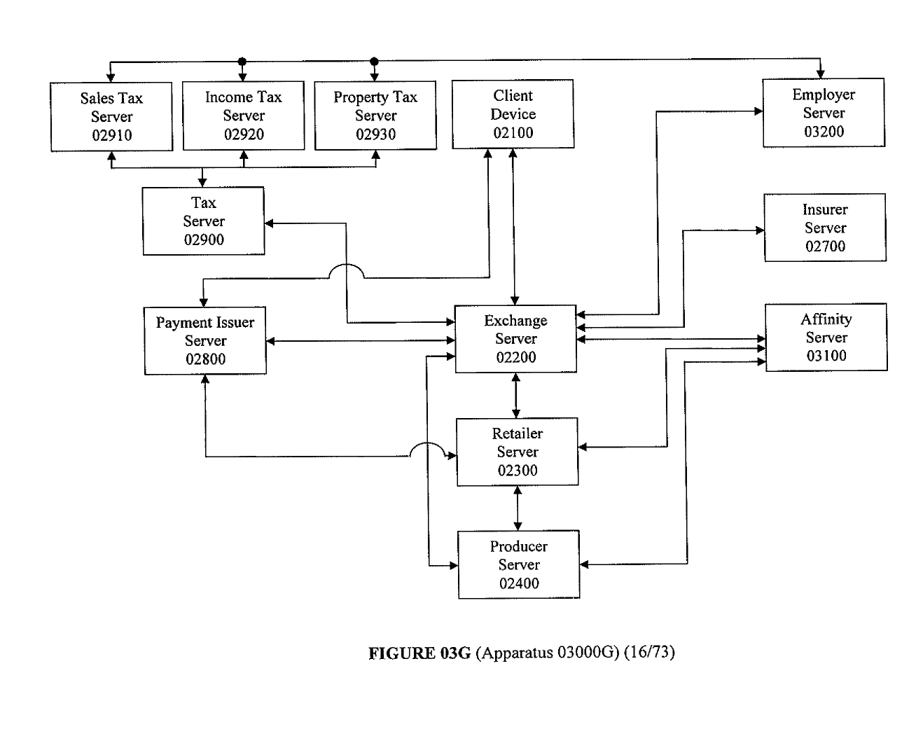

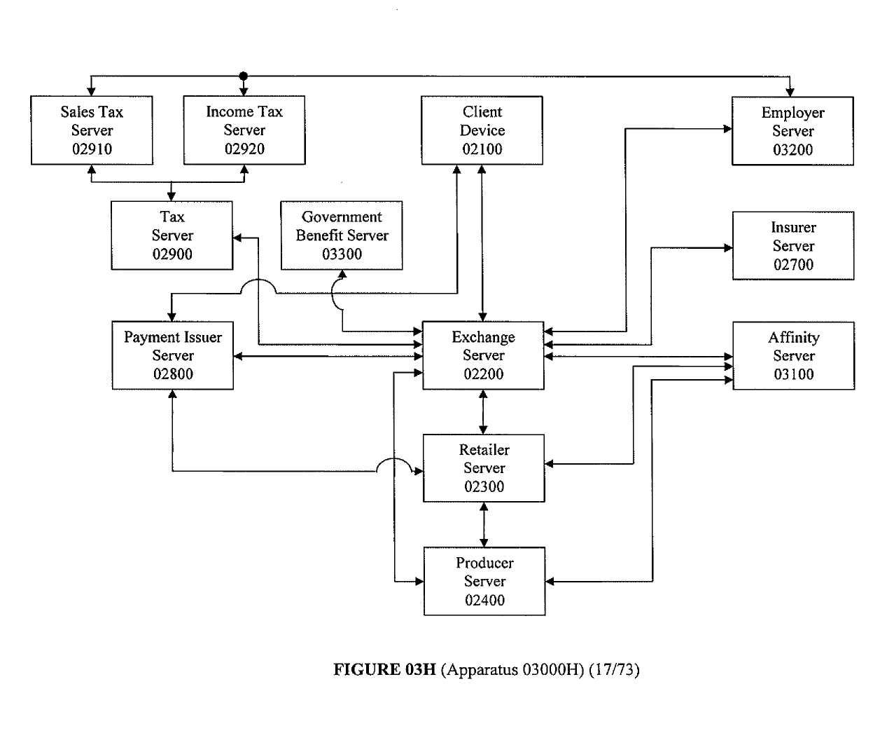

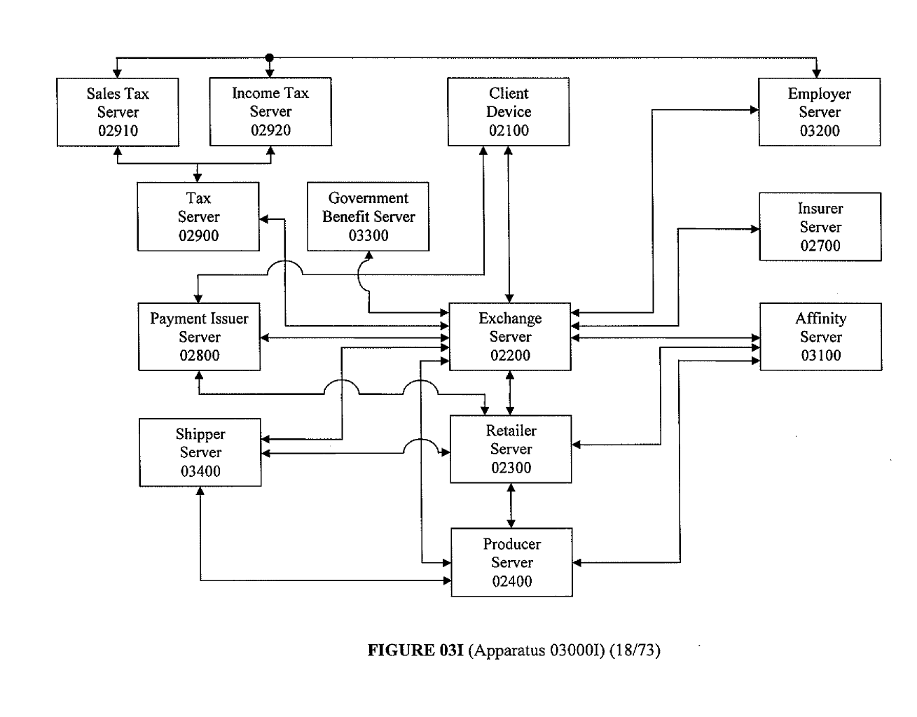

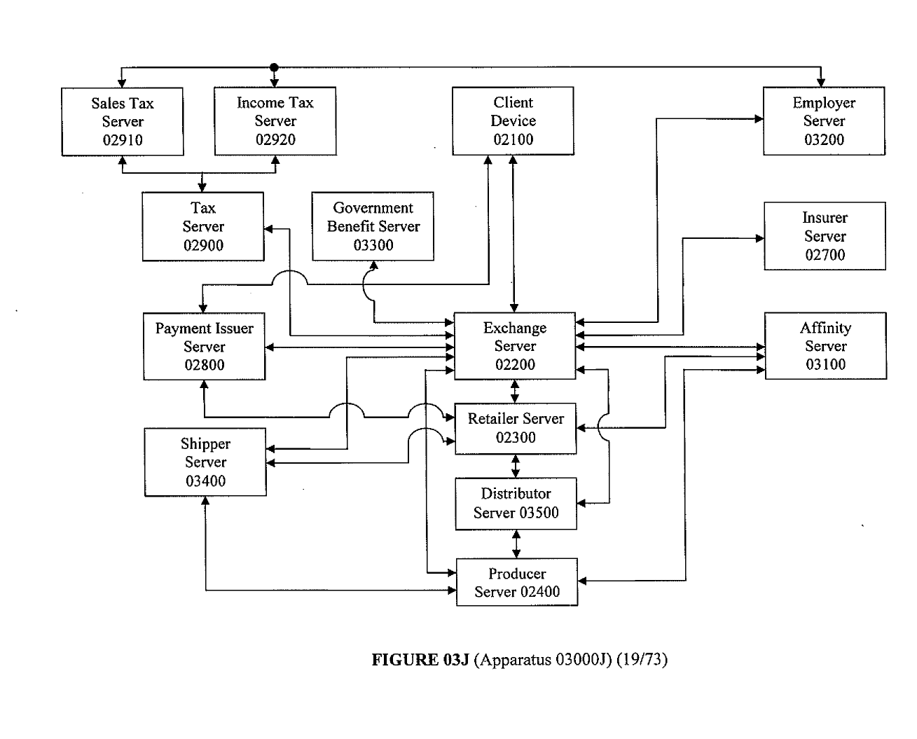

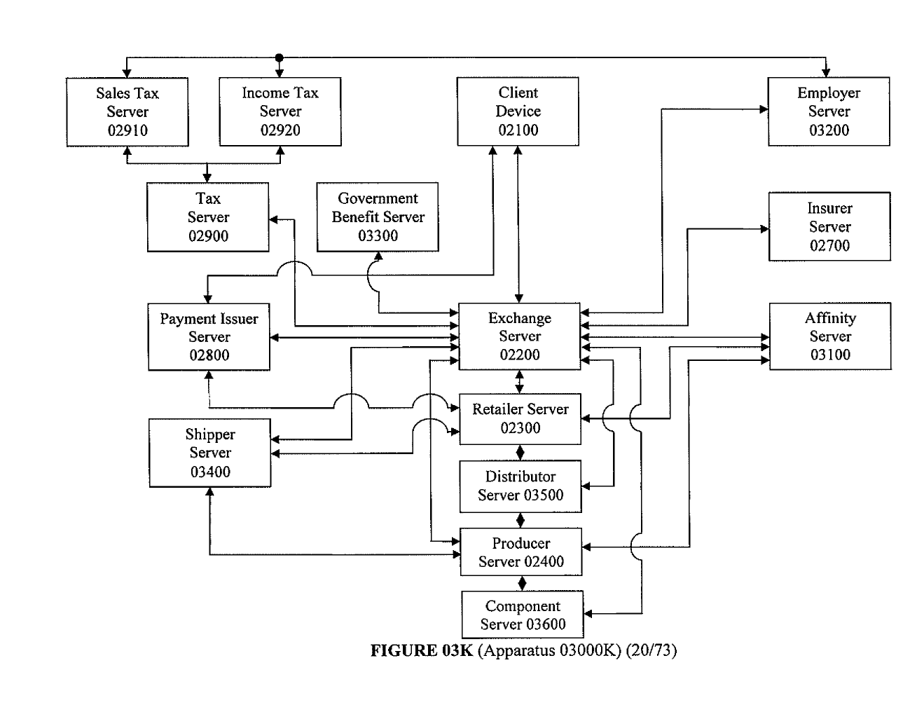

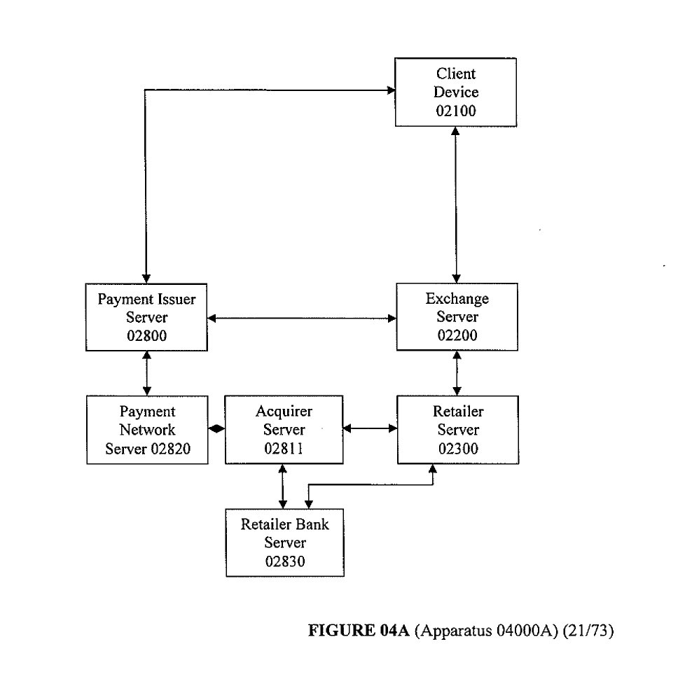

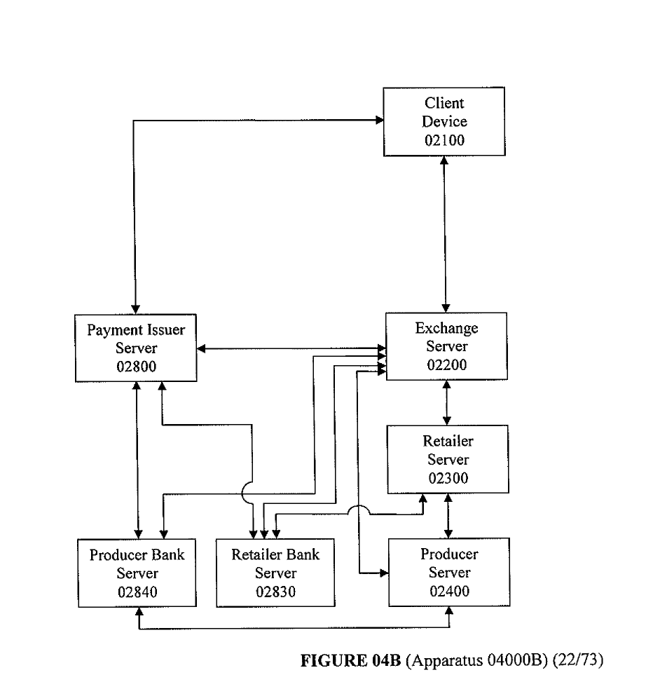

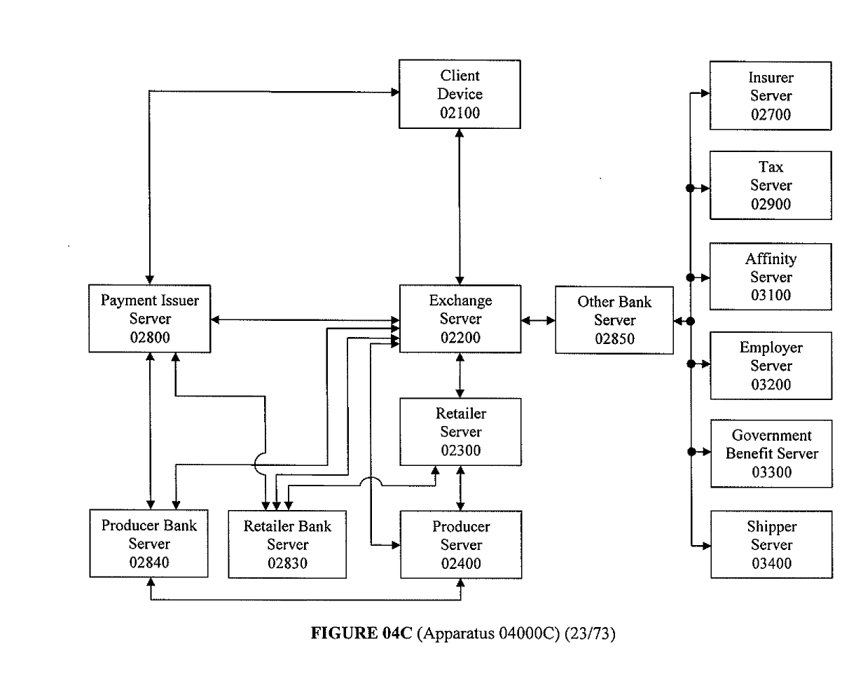

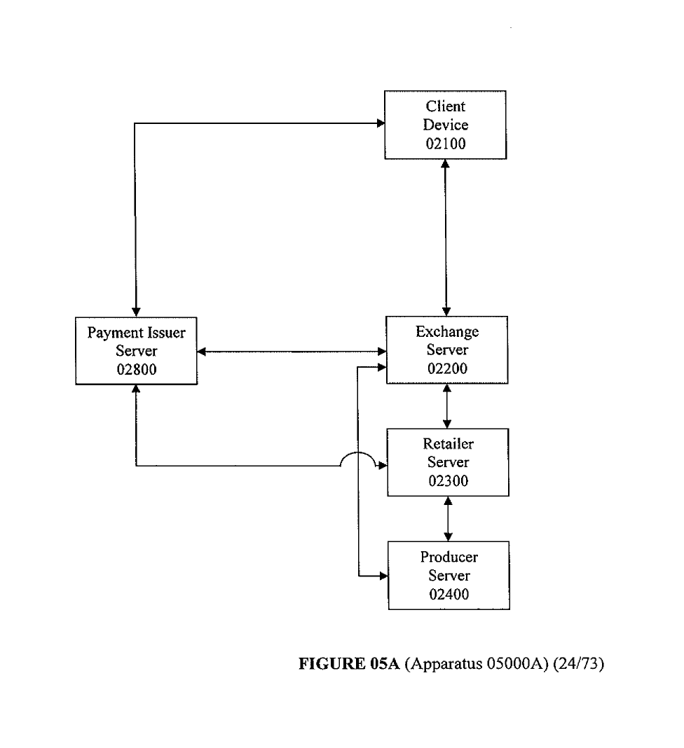

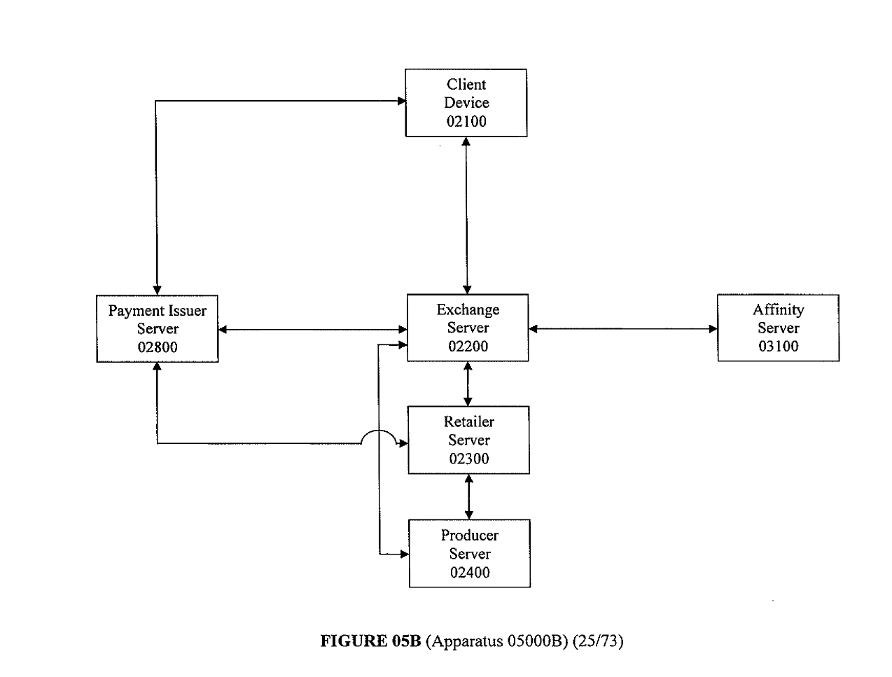

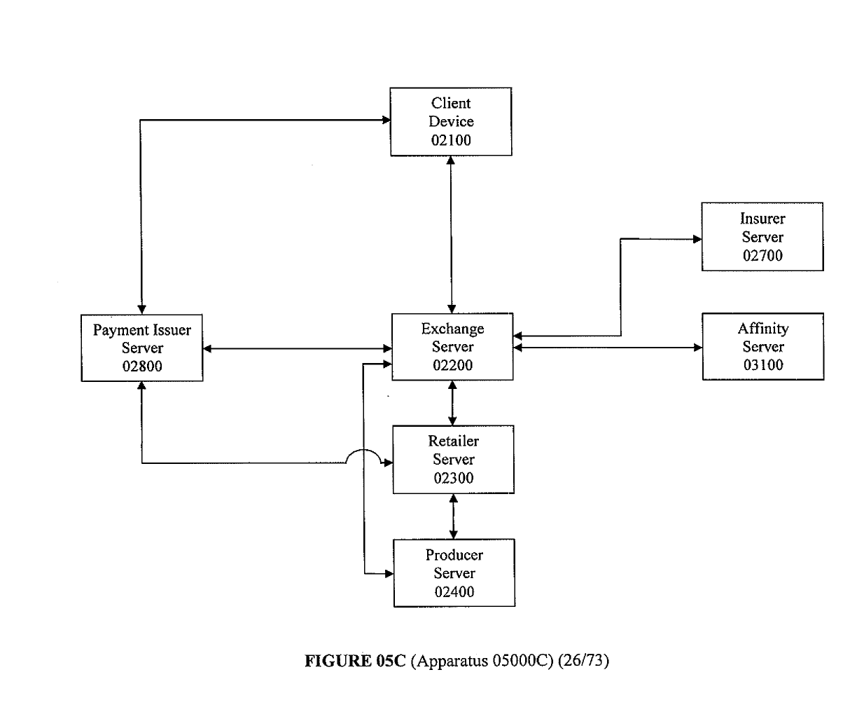

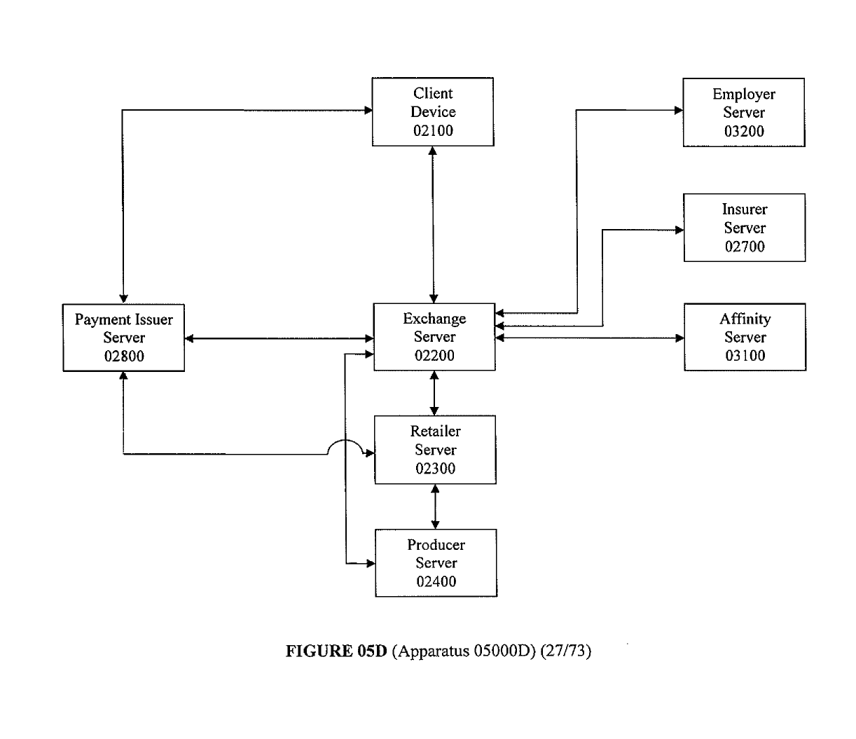

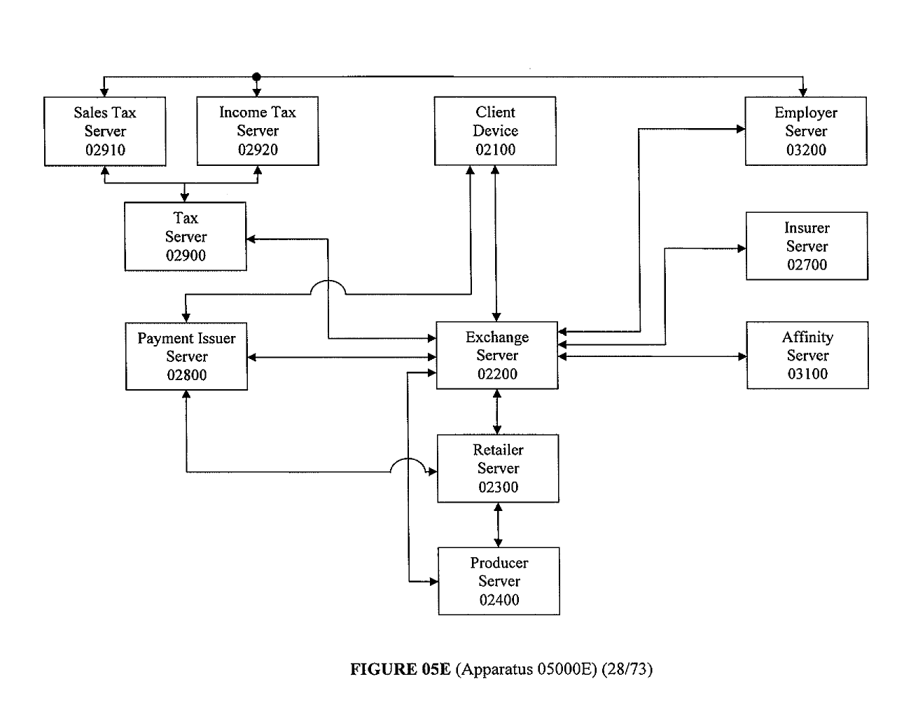

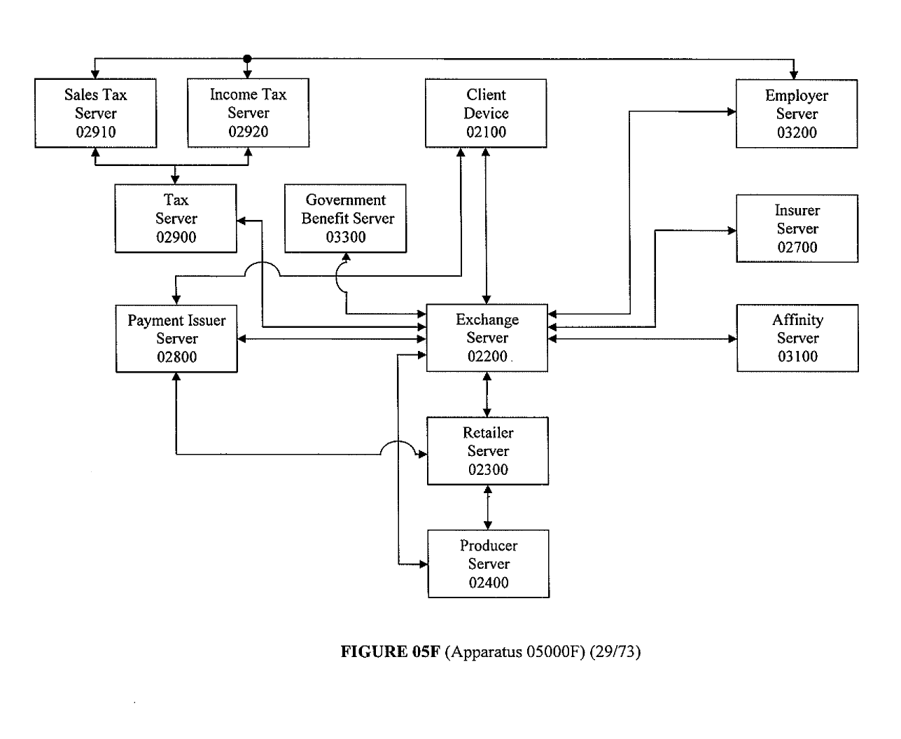

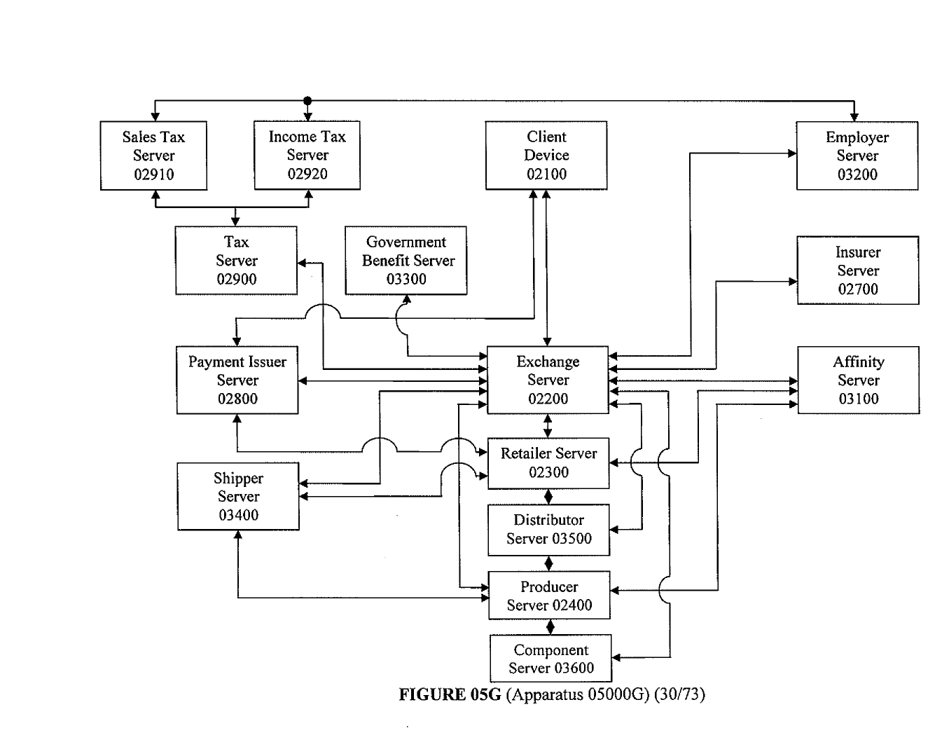

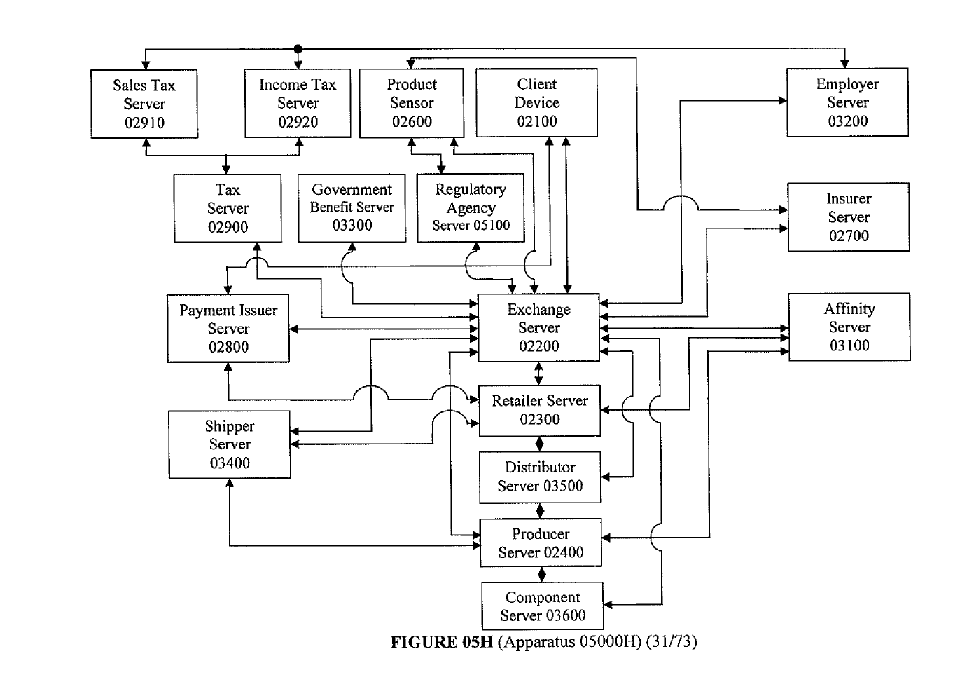

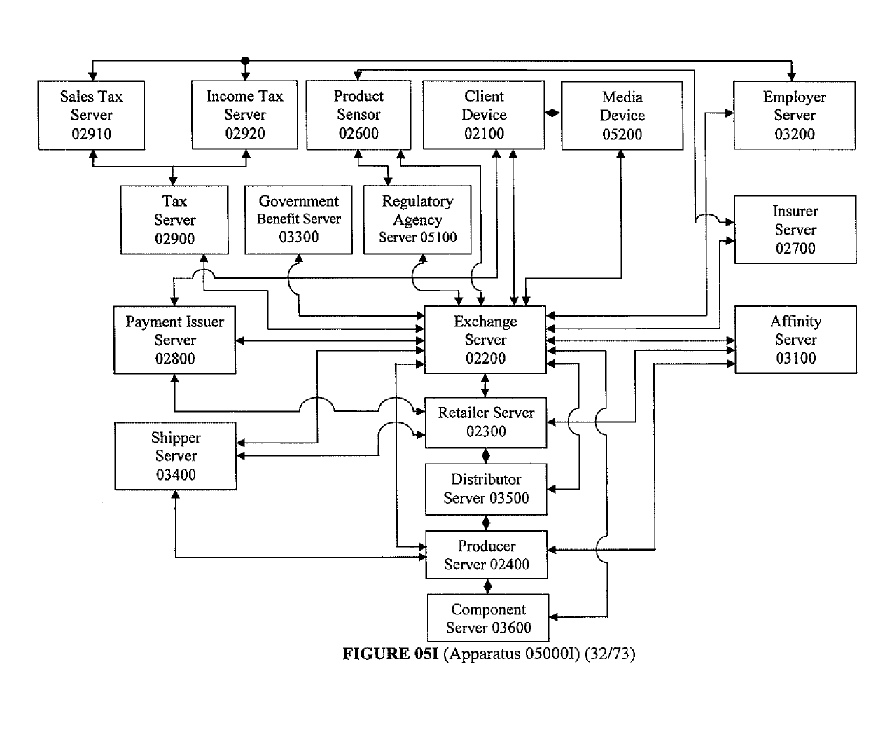

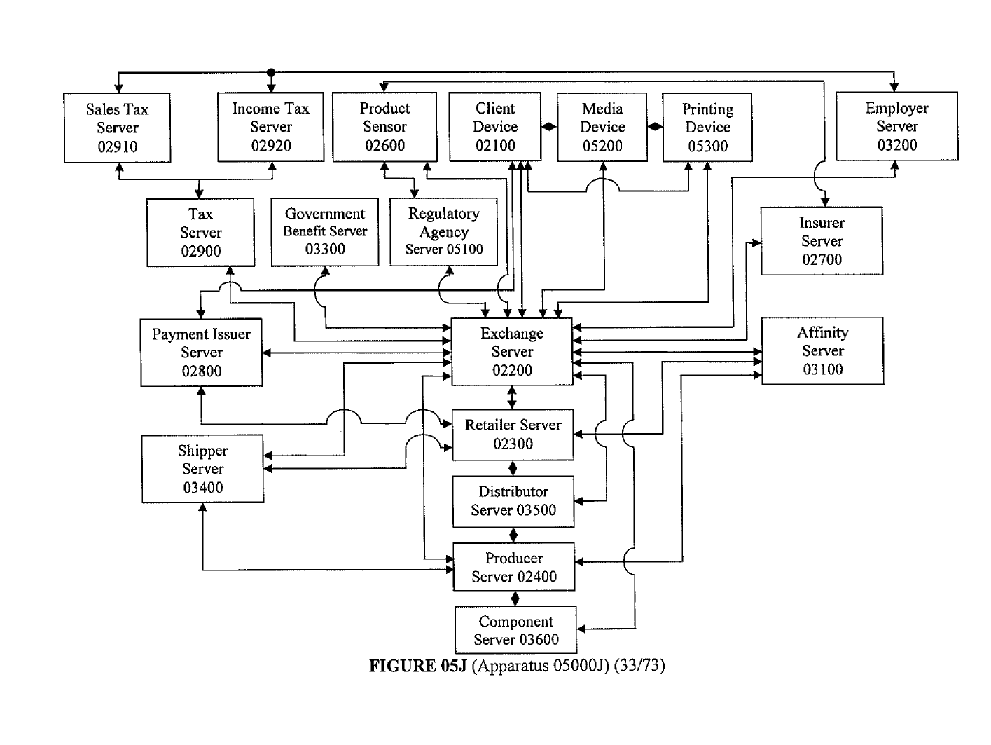

Fund Account Data Structure means a Data Structure, which can be stored on a Computer-Readable Medium, including a set of data elements associated with one or more Fund Accounts, which can include with limitation: (a) any User Fund Account; (b) a Retailer Fund Account, and/or a Fund Account held by any party illustrated in FIG. 2H, FIG. 3K, FIG. 04C, and/or FIG. 05J. For example, the data elements can include without limitation: (a) a Fund Account Identifier; (b) one or more Fund Account Attributes which can include without limitation: (i) Current Account Balance; and/or (ii) Maximum Account Balance; (c) one or more Fund Account Benefit Attributes; (d) one or more Fund Account Cost Attributes; (e) the number of units of a Fund Account Benefit Attribute available (“Fund Account Available Unit”), e.g., a Fund Account Administrator can limit the number of benefits to the first 1,000 customers purchasing a Product using the Fund Account; and/or (f) the total value of a Fund Account Benefit Attribute available (“Fund Account Available Value”), e.g., a Fund Account Administrator can limit the value of benefits to a predefined amount, e.g., $1 million.

Fund Transfer means the withdrawal of a Withdrawal Amount from a Qualifying Fund Account or the deposit of a Deposit Amount to a Qualifying Fund Account. Fund Transfer can include without limitation: (a) the withdrawal of a Withdrawal Amount and/or the deposit of a Deposit Amount in the form of cash; (b) the withdrawal of a Withdrawal Amount and/or the deposit of a Deposit Amount in a form other than cash, e.g., points, miles, kilometers, and/or credits (“Non-Cash Fund Transfer”); and/or (c) the withdrawal of a Withdrawal Amount and/or deposit of a Deposit Amount after the User takes possession of the Product purchased in a Transaction (“Deferred Fund Transfer”).

Government Benefit Authority means a party which has the authority to distribute public funds to any party. The Government Benefit Authority can be any party operating at any level of government, e.g., international, federal, state, county, or local. The Government Benefit Authority can be a party operating as: (a) a governmental entity, e.g., a party governing a state; or (b) a non-governmental entity, e.g., a party authorized by a government, a private group, or any other party to distribute public funds to any party. A party to which a Government Benefit Authority can distribute public funds can include without limitation: (a) an individual Taxpayer; (b) a business Taxpayer; and/or (c) a Taxpayer which is not an individual or a business. The Government Benefit Authority can distribute public funds to any party related to a purchase of a Product of Interest alone or in addition to one or more other Government Benefit Authorities and/or a party which is not a Government Benefit Authority. For example, a User of Client Device 02100 can qualify for coverage of health care expenses under a plurality of programs including without limitation: the United States Medicare program, the United States Medicaid program, a state pharmaceutical assistance program, and/or a private Insurer.

Insurer means a party which can offer one or more Products that can insure another party, i.e., an individual or a party other than an individual, against one or more risks. Insurer can offer a Product insuring against any risk associated with an activity, a behavior, and/or an asset including without limitation: health, property, travel, and/or life. Insurer can receive payment, e.g., one or more premiums, for the Product insuring against a risk from a Payer, which can include without limitation: (a) the party insured (“Beneficiary”) where the payment can be in any form including without limitation: (i) a payment directly by the Beneficiary, e.g., a cash payment or a deduction from payroll; and/or (ii) a payment on behalf of the Beneficiary, e.g., a cash payment from an Employer of the Beneficiary; (b) the Employer of the Beneficiary; (c) a party administering an insurance program other than the Employer or a Regulatory Agency, e.g., a Voluntary Employee Beneficiary Association (“VEBA”); and/or (d) a Regulatory Agency, e.g., the United States government administering a federal insurance program like Medicare, TRICARE, or Federal Employees Health Benefits Program, a state insurance program like Workers' Compensation, and/or a federal government and state government administering jointly an insurance program like Medicaid. Insurer can offer one or more Products that provide primary insurance (“Primary Insurance Product”) or supplemental insurance, i.e., coverage of expenses not covered by the primary insurance Product (“Supplemental Insurance Product”). Insurer can be a party which is a government entity, e.g., a party governing a country, where an exemplary entity can be the United States government administering a federal insurance program like Medicare; or (b) a non-governmental entity, e.g., a private Insurer or a party authorized by a government to administer a government insurance program. Insurer can be a party whose primary purpose is to offer one or more insurance programs or a party whose primary purpose is not to offer one or more insurance programs, e.g., an Employer of the Beneficiary offering one or more insurance programs directly to the Beneficiary like a self-insured Employer.

Different Insurers can sell different classes of Products insuring another party against the same class of risk. That is, different classes of insurance Products can insure against the same class of risk. For example, different classes of Products can insure a party against the risk of incurring expenses for health care. A first class of insurance Products can directly insure for health care expenses, e.g., a Health Insurance Product, policy, or plan. A second class of insurance Products can directly insure for risks associated with driving an automobile, e.g., an Automobile Insurance Product, policy, or plan, one risk of which is injury to a party in an automobile, e.g., a passenger, or a party external to the automobile, e.g., a passenger in another automobile or a pedestrian involved in an accident, including injury leading to the incurring of health care expenses. A third class of insurance Products can directly insure for risks associated with working at a job, e.g., Workers' Compensation, one risk of which is injury to an employee, including injury leading to the incurring of health care expenses. A fourth class of insurance Products can directly insure for risks associated with travel, e.g., a Travel Insurance Product, policy, or plan, one risk of which is injury to the traveler, including injury leading to the incurring of health care expenses. A fifth class of insurance Products can directly insure for risks associated with ownership of a real property, e.g., a Property Insurance Product, policy, or plan, one risk of which is injury to a person living in or visiting the real property, e.g., slipping or falling.

Insurer Customer Data Structure means a Data Structure, which can be stored on a Computer-Readable Medium, including a set of data elements associated with one or more customers of an Insurer. For example, the data elements can include without limitation: (a) a customer identifier; (b) a residential address; and/or (c) one or more prior Transactions.

Insurer Product Data Structure means a Data Structure, which can be stored on a Computer-Readable Medium, including a set of data elements associated with one or more Products whose purchase is covered by an Insurer. For example, the data elements can include without limitation: (a) a Product Identifier (defined herein) and/or a Universal Product Identifier (defined herein); (b) a description of the Product; and/or (c) the amount of coverage for any Product, which can depend on factors including without limitation: (i) any deductible amount paid by the customer before the Insurer covers part or all of the purchase of a Product; (ii) any fixed copayment amount a customer must pay for the purchase of a Product; and/or (iii) any percentage coinsurance amount a customer must pay for the purchase of a Product.

Insurer Transaction Data Structure means a Data Structure, which can be stored on a Computer-Readable Medium, including a set of data elements associated with one or more Transactions executed by an Insurer. For example, the data elements can include without limitation: (a) a Transaction Identifier (defined herein); (b) one or more Products whose purchase an Insurer covers in a Transaction; and/or (c) the Total Value (defined herein) of a Transaction.

Loan means any agreement in which a User is obligated to repay a lender the funds specified. Loan can include without limitation: a credit line, an installment loan, and/or a revolving loan.

Loyalty Program means any program which can reward a User of a product. The reward can be in any form.

Media Device means any: (a) Data Processing System 01000 which can output in any form data and/or instructions associated with a Product; or (b) any device other than a Data Processing System 01000, e.g., a physical medium which can include without limitation, a billboard, a magazine, and/or a newspaper. The output can be in any form including without limitation: (a) the display of data and/or instructions, e.g., the display of a video on a television display or the display of a code on a physical newspaper; (b) the transmission to another Data Processing System 01000 of data and/or instructions, e.g., the transmission of data over the NFC (defined herein) protocol from a first Data Processing System 01000 like a poster with a NFC device to a second Data Processing System 01000 like a mobile phone; and/or (c) the transmission of data and/or instructions in any other form.

Net Price means the price of a Product of Interest after adding or subtracting the value of all Qualifying Offers to or from, respectively, a Retailer Price.

Offer means an offer of anything of value directly or indirectly associated with a purchase and/or use of a Product of Interest. The value of an Offer can be in any form including without limitation: (a) cash, e.g., a decrease in the Net Price of a Product of Interest; (b) non-cash, e.g., points, miles, kilometers, and/or credits earned in a Loyalty Program; and/or (c) cash and non-cash. An Offer can have a negative value, i.e., a value which decreases the Net Price of a Product of Interest, a discount offered by Payment Issuer Server 02800, or a positive value, i.e., a value which increases the Net Price of a Product of Interest, e.g., a cost assessed by Shipper Server 03400. An Offer can apply to the purchase and/or use of a Product of Interest by any party including without limitation: (a) an individual; and/or (b) a party other than an individual including without limitation: (i) a business; (ii) a government; and/or (iii) a non-profit organization.

Offer Condition Attribute means a term or condition limiting the applicability of an Offer to a given Transaction with one or more values for each of one or more Transaction Attributes and/or Post-Transaction Attributes. An Offer Condition Attribute limits the applicability of the Offer where a Transaction Attribute Value associated with a Transaction Attribute equal or equivalent to the Offer Condition Attribute is equal to either: (a) the Offer Condition Attribute Value (defined herein) associated with the Offer Condition Attribute; or (b) at least one value within a set of Offer Condition Attribute Values associated with the Offer Condition Attribute.

Offer Condition Attribute can include without limitation:
(a) a Product Condition limiting the applicability of the Offer to the purchase and/or use of one or more Products, each of which is associated with the Product Identifier and/or Universal Product Identifier specified in the Offer Condition Attribute Value, e.g., if an Offer Condition Attribute is a Product Condition in an NDC format and the Offer Condition Attribute Value is a set of NDC identifiers 00071015000:00071015999, the Offer is limited to the purchase and/or use of a set of the drug Lipitor® in one or more strengths;
(b) a Brand Condition limiting the applicability of the Offer to the purchase and/or use of one or more Brands, each of which is associated with the Brand Identifier specified in the Offer Condition Attribute Value, e.g., if an Offer Condition Attribute is a Brand Condition in an alphanumeric character format and the Offer Condition Attribute Value is a set of Brand Identifiers “Lipitor®” or “Sony®”, the Offer is limited to the purchase and/or use of a set of the Products associated with or members of the Brand “Lipitor®” or “Sony®” respectively;
(c) a Product Class Condition limiting the applicability of the Offer to the purchase and/or use of one or more Products in the Product Class associated with the Product Class Identifier specified in the Offer Condition Attribute Value, e.g., if an Offer Condition Attribute is a Product Class Condition in a UNI™ format classified by the FDA and the Offer Condition Attribute Value is the UNH identifier “362O91TL9D”, the Offer is limited to the purchase and/or use of a set of drugs which include the unique ingredient Acetaminophen;
(d) a Product Unit Condition, i.e., a predefined threshold of the number of units of a Product purchased or used in a Transaction, limiting the applicability of the Offer to the purchase and/or use of a minimum, specific, or maximum number of units of a Product purchased or used in a Transaction where the number of units and Product are specified in the Offer Condition Attribute Value, e.g., if an Offer Condition Attribute is a Product Unit Condition requiring a minimum number of units of a specified Product purchased or used in a Transaction in an integer format and the Offer Condition Attribute Value equals a value of three, the Offer is limited to the purchase and/or use of at least three units of a specified Product in a Transaction;
(e) a Product Unit Price Condition, i.e., a predefined threshold of the unit price of a Product purchased or used in a Transaction, limiting the applicability of the Offer to the purchase and/or use of a Product with a minimum or maximum unit price where the unit price is specified in the Offer Condition Attribute Value, e.g., if an Offer Condition Attribute is a Product Unit Price Condition requiring a minimum unit price of a specified Product in a Transaction in a currency format and the Offer Condition Attribute Value equals a value of $50, the Offer is limited to the purchase and/or use of a specified Product with a unit price of $50 or higher;
(f) a Transaction Total Value Condition, i.e., a predefined threshold of the Total Value, which can exclude one or more of one or more components, including without limitation shipping or delivery expenses or tax expenses, of Products purchased or used in a Transaction, limiting the applicability of the Offer to the purchase and/or use of one or more Products in one Transaction whose Total Value is higher than a minimum Total Value or lower than a maximum Total Value specified in the Offer Condition Attribute Value, e.g., (i) in a first example, if an Offer Condition Attribute is a Transaction Total Value Condition requiring a minimum Total Value of a Transaction in a currency format and the Offer Condition Attribute Value equals a value of $50, the Offer is limited to the purchase and/or use of one or more Products whose Total Value is $50 or higher; and/or (ii) in a second example, if an Offer Condition Attribute is a Transaction Total Value Condition setting a maximum Total Value of a Transaction, e.g., coverage of one or more specified Products in one automobile accident, in a currency format, e.g., an Automobile Insurance Product limiting the maximum amount paid to a person per limited to the purchase and/or use of the Automobile Insurance Product in one automobile accident whose Total Value, i.e., the maximum amount paid to a person, is $500,000 or lower.
(g) a Cumulative Transaction Value Condition, i.e., a predefined threshold of the Cumulative Transaction Value, which can equal a maximum or minimum cumulative value of Transactions executed by a User in an account over a predefined time period, limiting the applicability of the Offer to the purchase and/or use of one or more Products where the Cumulative Transaction Value equals either: (i) no more than the maximum cumulative value of Transactions executed by a User in an account over a predefined time period, e.g., a limit; or (ii) at least the minimum cumulative value of Transactions executed by a User in an account over a predefined time period, e.g., a deductible, e.g., (i) in a first example, if an Offer Condition Attribute is a Cumulative Transaction Value Condition setting a maximum cumulative value of Transactions using a specified Payment Method, e.g., Capital One® Visa® Platinum Credit Card, executed by a User in an account over a predefined time period, e.g., one year, in a currency format and the Offer Condition Attribute Value equals a value of $5,000, the Offer is limited to the purchase and/or use of one or more Products where the Cumulative Transaction Value is less than the $5,000 limit; and/or (ii) in a second example, if an Offer Condition Attribute is a Cumulative Transaction Value Condition setting a minimum cumulative value of Transactions covered by an Insurer Product, e.g., a Health Insurance Product offered by Humana®. Health Plans, executed by a User in an account over a predefined time period, e.g., a calendar year, in a currency format and the Offer Condition Attribute Value equals a value of $1,500, the Offer is limited to the purchase and/or use of one or more Products where the Cumulative Transaction Value is at least the $1,500 deductible;
(h) a Date/Time Condition, i.e., date and/or time or range of dates and/or times, limiting the applicability of the Offer to the purchase and/or use of one or more Products at the date and/or time or within a range of dates and/or times specified in the Offer Condition Attribute Value, which can include without limitation: (i) a start date for the Offer in any date/time format, e.g., a YYYY/MM/DD date format, limiting the applicability of the Offer to the purchase and/or use of one or more Products not earlier than the date/time specified in the Offer Condition Attribute Value, e.g., if an Offer Condition Attribute is a Date/Time Condition requiring the start date for an Offer in a YYYY/MM/DD date format and the Offer Condition an end date for the Offer in any date/time format, e.g., a YYYY/MM/DD date format, limiting the applicability of the Offer to the purchase and/or use of one or more Products not later than the date/time specified in the Offer Condition Attribute Value, e.g., if an Offer Condition Attribute is a Date/Time Condition requiring the end date for an Offer in a YYYY/MM/DD date format and the Offer Condition Attribute Value equals, e.g., 2011/12/31, the Offer end date equals Dec. 31, 2011;
(i) a Geographic Condition limiting the applicability of the Offer to the purchase and/or use of one or more Products in any set of geographic locations specified in the Offer Condition Attribute Value which can include without limitation: (i) the geographic location of the physical store at which a Retailer executes a Transaction; and/or (ii) the geographic location of the shipping address to which the Retailer ships one or more Products in a Transaction; e.g., if an Offer Condition Attribute is a Geographic Condition requiring a set of qualifying shipping addresses in an abbreviated character format and the Offer Condition Attribute Value equals the set of states in an abbreviated character format to which the Retailer can ship one or more Products in a Transaction, the Offer is limited to the purchase and/or use of one or more Products which can be shipped to the set of states;
(j) a User Class Condition limiting the applicability of the Offer to the purchase and/or use of one or more Products by a member of one or more User Classes, each of which is associated with the User Class Identifier specified in the Offer Condition Attribute Value, e.g., if an Offer Condition Attribute is an exemplary User Class Condition in the: (i) age domain in an integer format and the Offer Condition Attribute Value is a set of age values 50 years and over, e.g., one or more states can require an Insurer providing automobile insurance to a Beneficiary over a specified age value completing a state-approved driver improvement course to offer a specified discount, the Offer, e.g., the specified discount, is limited to the purchase and/or use of the one or more Products, e.g., automobile insurance, by a customer or User, e.g., a Beneficiary completing the course, with an age value of 50 years or higher; (ii) Payment Method domain in an integer format and the Offer Condition Attribute Value is a set of one or more names of a Payment Method program, e.g., Capital One® Visa® Platinum Credit Card, or one or more identifiers of the Payment Method other than the name, e.g., the Issuer Identification Number (defined herein), the Offer is limited to the purchase and/or use of the one or more Products executed with the Payment Method specified; or (iii) an Insurer and/or Insurer Product domain in an alphanumeric character format and the Offer Condition Attribute Value is a set of one or more names of an Insurer and/or Insurer Product, e.g., Insurer XYZ and/or Insurer XYZ Health Maintenance Organization (“HMO”) Plan, or one or more identifiers of the Insurer and/or Insurer Product other than the name, the Offer is limited to the purchase and/or use of the one or more Products by a User who is a member of the Insurer and/or Insurer Product specified;
(k) a User Property Condition limiting the applicability of the Offer to the purchase and/or use of one or more Products by a User associated with a User Property value meeting a predefined one or more values specified in the Offer Condition Attribute Value where a User Property means a characteristic of the party purchasing and/or using the Product, e.g., (i) in a first example, if an Offer Condition Attribute is a User Property Condition specifying a property of the party (like a level of blood pressure of a Beneficiary below a predefined threshold in a fractional format in units of millimeters of mercury or mmHg) purchasing or using one or more Products (like a Health Insurance Product) in a Transaction and the Offer Condition Attribute Value equals, e.g., 140/90 mmHg, the Offer is limited to the purchase and/or use of the one or more Products (like the Health Insurance Product or qualifying for a specified price or premium of the Health Insurance Product) by a User associated with the User Property value meeting the predefined one or more User Property values specified (like those Users with a blood pressure level below 140/90 mmHg); and/or (ii) in a second example, if an Offer Condition Attribute is a User Property Condition specifying a property of the party (like a credit score above a predefined threshold) purchasing or using one or more Products (like a Loan Product) in a Transaction and the Offer Condition Attribute Value equals, e.g., a FICO® score of 670, the Offer is limited to the purchase and/or use of the one or more Products (like the Loan Product) by a User associated with the User Property value meeting the predefined one or more User Property values specified (like those Users with a credit score above 670);
(l) a User Action Condition limiting the applicability of the Offer to the purchase and/or use of one or more Products by a User associated with a User Action value meeting a predefined one or more values specified in the Offer Condition Attribute Value where a User Action means an action executed by the party purchasing and/or using the Product, e.g., (i) in a first example, if an Offer Condition Attribute is a User Action Condition specifying an action executed by the party (like the User reducing his/her frequency of smoking to a predefined threshold of cigarettes per time period) purchasing and/or using one or more Products (like a Health Insurance Product) in a Transaction and the Offer Condition Attribute Value equals, e.g., 0 cigarettes per day), the Offer is limited to the purchase and/or use of the one or more Products (like the Health Insurance Product) by a User associated with the User Action value meeting the predefined one or more User Action values specified (like those Users who reduce his/her frequency of smoking to 0 cigarettes per day); and/or (ii) in a second example, if an Offer Condition Attribute is a User Action Condition specifying an action executed by the party (like a velocity in an integer format of a first automobile driven by the User given one or more conditions including without limitation: (i) the distance in an integer format between the first automobile and a second automobile in front of the first automobile; (ii) the braking distance in an integer format associated with the Product Identifier identifying the first automobile; and (iii) the coefficient of friction (“COF”) in a decimal format between the tires of the first automobile and the road surface (whose value in turn can be a function of the type of road and the weather condition at the location and time of measurement, e.g., the COF between tires and a dry surface is typically higher than the COF between the same tires and a wet surface)) purchasing or using one or more Products (like an Automobile Insurance Product) in a Transaction and the Offer Condition Attribute Value equals, e.g., a 65 mph velocity of the first automobile, a distance between the first automobile and the second automobile equaling 50 feet, a braking distance associated with the Product Identifier identifying the first automobile equaling 150 feet at the specified velocity, and a COF equaling 1.7 for the specified tires and specified road surface, the Offer is limited to the purchase and/or use of the one or more Products (like the Automobile Insurance Product or the price or premium of the Automobile Health Insurance Product) by a User associated with the User Action value meeting the predefined one or more User Action values specified (like those Users driving the first automobile at a velocity of 65 mph or less given the distance between the first automobile and the second automobile is 50 feet or less, a braking distance associated with the specified first automobile equaling 150 feet at a 65 mph velocity, and a COF equaling 1.7);
(m) a Retailer Condition limiting the applicability of the Offer to the purchase and/or use of one or more Products purchased or used at one or more Retailers, each of which is associated with the Retailer Identifier specified in the Offer Condition Attribute Value, e.g., in a first example, if an Offer Condition Attribute is a Retailer Condition in an alphanumeric format (“MID”) a Payment Network, Card Association, or Acquirer Server 02811 issues to Retailers in its network, a second MID, and a third MID, e.g., a set of Retailers each of which has agreed to charge a specified price for one or more Products, the Offer is limited to the purchase and/or use of a set of the one or more Products purchased or used by the Retailer identified by the first MID, the second MID, and the third MID, respectively; in a second example, if an Offer Condition Attribute is a Retailer Condition in an alphanumeric format and the Offer Condition Attribute Value is a set of Retailer names, Retailer A, Retailer B, and Retailer C, e.g., a set of Retailers in a network of Retailers each of which has agreed to charge a specified price for one or more Products, the Offer is limited to the purchase and/or use of a set of the one or more Products purchased or used at Retailer 1, Retailer 2, or Retailer 3;
(n) a Producer Condition limiting the applicability of the Offer to the purchase and/or use of one or more Products produced by one or more Producers, each of which is associated with the Producer Identifier specified in the Offer Condition Attribute Value, e.g., if an Offer Condition Attribute is a Producer Condition in an alphanumeric format and the Offer Condition Attribute Value is a set of Producer Identifiers, a first National Provider Identifier (“NPI”) the United States Centers for Medicare and Medicaid Services (“CMS”) assigns to each health care provider in the United States, a second NPI, and a third NPI, e.g., a set of Producers in a network of Producers each of which has agreed to charge a specified price for one or more Products, the Offer is limited to the purchase and/or use of a set of the one or more Products produced by the Producer identified by the first NPI, the second NPI, and the third NPI, respectively;
(o) a Producer/Retailer Property Condition limiting the applicability of the Offer to the purchase and/or use of one or more Products each of which is produced by a Producer and/or each of which is sold by a Retailer associated with a Producer/Retailer Property value meeting a predefined one or more values specified in the Offer Condition Attribute Value where a Producer/Retailer Property means a characteristic of the Producer producing and/or the Retailer selling the Product, e.g., if an Offer Condition Attribute is a Producer/Retailer Property Condition specifying a property of the Producer producing the Product (like holding a government license to produce the Product, e.g., a physician holding a state license to practice medicine) and/or the Retailer selling the Product (like holding a government license to sell the Product, e.g., a Retailer holding a license to sell liquor) in a Transaction, the Offer is limited to the purchase and/or use of the one or more Products each of which is produced by a Producer and/or each of which is sold by a Retailer associated with the Producer/Retailer Property Condition value meeting the predefined one or more Producer/Retailer Property Condition values specified (like those Producers and/or Retailers holding a license to produce or sell, respectively, the Product);
(p) a Producer/Retailer Action Condition limiting the applicability of the Offer to the purchase and/or use of one or more Products each of which is produced by a Producer and/or each of which is sold by a Retailer associated with a Producer/Retailer Action value meeting a predefined one or more values specified in the Offer Condition Attribute Value where a Producer/Retailer Action means an action executed by the Producer producing and/or the Retailer selling the Product, e.g., if an Offer Condition Attribute is a Producer/Retailer Action Condition specifying an action executed by the Producer producing the Product and/or the Retailer selling the Product (like the Producer completing production of a Product by a specified date, e.g., a Producer like a home builder completing the production of a home by a specified date) in a Transaction, the Offer is limited to the purchase and/or use of the one or more Products each of which is produced by a Producer and/or each of which is sold by a Retailer associated with the Producer/Retailer Action Condition value meeting the predefined one or more Producer/Retailer Action values specified (like those Producers completing production of the Product by the specified date);
(q) a Product Property Condition: (i) (in the case of a Product being a good) limiting the applicability of the Offer to the purchase and/or use of one or more Products each of which is associated with a Product Property value meeting a predefined one or more values specified in the Offer Condition Attribute Value where a Product Property means a characteristic of the Product, e.g., if an Offer Condition Attribute is a Product Property Condition specifying a property (like the Product inclusion of an active ingredient Acetaminophen associated with a UNII equal to 362O9ITL9D) of the Product (like Excedrin®) in a Transaction, the Offer is limited to the purchase and/or use of the one or more Products associated with the Product Property Condition value meeting the predefined one or more Product Property values specified (like those Products including the active ingredient identified by a UNH equal to 362O9ITL9D); and/or (ii) (in the case of a Product being a service) limiting the applicability of the Offer to the purchase and/or use of one or more Products each of which is associated with a Product Property value meeting a predefined one or more values specified in the Offer Condition Attribute Value where a Product Property means a characteristic of the Product, e.g., if an Offer Condition Attribute is a Product Property Condition specifying a property (like the Product providing a minimum and maximum total number of minutes for one or more sessions per day) of the Product (like an outpatient pulmonary rehabilitation program service comprising one or more sessions treating Chronic Obstructive Pulmonary Disease (“COPD”)) in a Transaction, the Offer is limited to the purchase and/or use of the one or more Products (like a pulmonary rehabilitation program) associated with the Product Property Condition value meeting the predefined one or more Product Property values specified (like those Products providing a minimum number of minutes for each daily one or more sessions equal to 31 minutes and a maximum number of minutes for each daily one or more sessions equal to 120 minutes specified by the CMS);
(r) a Product Action Condition: (i) (in the case of a Product being a good) limiting the applicability of the Offer to the purchase and/or use of one or more Products each of which is associated with a Product Action value meeting a predefined one or more values specified in the Offer Condition Attribute Value where a Product Action means an action executed by the Product, e.g., if an Offer Condition Attribute is a Product Action Condition specifying an action (like the Product providing relief for a predefined duration) of the Product (like a short-acting bronchodilator) in a Transaction, the Offer is limited to the purchase and/or use of the one or more Products associated with the Product Action Condition value meeting the predefined one or more Product Action values specified (like those Products providing relief for a time period equal to a minimum of four hours after inhalation); and/or (ii) (in the case of a Product being a service) limiting the applicability of the Offer to the purchase and/or use of one or more Products each of which is associated with a Product Action value meeting a predefined one or more values specified in the Offer Condition Attribute Value where a Product Action means an action executed by the Product, e.g., if an Offer Condition Attribute is a Product Action Condition specifying an action (like the Product increasing the maximum exercise capacity of the User in units of Watts after n number sessions of the Product) executed by the Product (like an outpatient pulmonary rehabilitation program service comprising one or more sessions treating COPD) in a Transaction, the Offer is limited to the purchase and/or use of the one or more Products (like a pulmonary rehabilitation program) associated with the Product Action Condition value meeting the predefined one or more Product Action values specified (like those Products increasing the maximum exercise capacity of the User after n number of sessions to at least 10 Watts);
(s) an Offer Combination Condition limiting the applicability of the Offer based on a rule specifying any combination of Offers specified in the Offer Condition Attribute Value including without limitation: (i) the Offer; and/or (ii) the Offer combined with one or more additional Offers; and/or
(t) an Offer Priority Condition limiting the applicability of the Offer depending on a rule specified in the Offer Condition Attribute Value specifying the sequence in which a plurality of Offers should be applied to the purchase and/or use of one or more Products purchased and/or used in a Transaction, e.g., if there are three Offers which can qualify for the purchase and/or use of one or more Products in a Transaction, a Primary Insurance Product, a Supplemental Insurance Product, and a tax credit, one or more embodiments of the invention would apply each Offer in a specified sequence according to a rule. For example, assume that a Social Security Act, as amended, specifies that a Medicaid plan does not have to pay for any expense incurred for Medicare cost-sharing if the Medicare payment exceeds the amount which the Medicaid plan would have paid, such that Medicare pays first for such expense and then Medicaid pays second for such expense. An exemplary rule would limit an Offer to the purchase and/or use of the one or more Products in a Transaction in which the first Fund Account specified in the Offer Priority Condition pays a first specified amount, the second Fund Account specified in the Offer Priority Condition pays a second specified amount, the third Fund Account specified in the Offer Priority Condition pays a third specified amount, etc., which one or more embodiments of the invention would convert into a rule determining the one or more conditions and the sequence of Fund Accounts in which one or more embodiments of the invention would withdraw funds.

While one or more embodiments of the invention lists the above Offer Condition Attributes (a)-(t), one or more embodiments of the invention is not limited to those embodiments. One or more embodiments of the invention can include other Offer Condition Attributes including without limitation: any limitation to a new User which one or more embodiments of the invention can define as any User associated with a User Identifier not stored in a User Data Structure at the time of a User Query, e.g., “limited to new customers”; any limitation of the number of times a User can qualify for an Offer, e.g., “limited to one customer per household”; and/or a limitation of an Offer to a User learning of the Offer through one Media Device 05200 or one class of Content, e.g., “limited to XYZ viewers”.

One or more embodiments of the invention can distinguish the following Offer Condition Attributes (User Property Condition, User Action Condition, Producer/Retailer Property Condition, Producer/Retailer Action Condition, Product Property Condition, and Product Action Condition) as follows. One or more embodiments of the invention can define: (a) the User Property as a characteristic of the User separate from characteristics of: (i) the Producer producing the Product; (ii) the Retailer selling the Product; and/or (iii) the Product; (b) the User Action as an action executed by the User separate from actions executed by: (i) the Producer producing the Product; (ii) the Retailer selling the Product; and/or (iii) the Product; (c) the Producer/Retailer Property as a characteristic of the Producer producing the Product and/or Retailer selling the Product separate from characteristics of: (i) the User purchasing and/or using the Product, and/or (ii) the Product; (d) the Producer/Retailer Action as an action executed by the Producer producing the Product and/or the Retailer selling the Product separate from the actions executed by: (i) the User purchasing and/or using the Product; and/or (ii) the Product; (e) the Product Property as a characteristic of the Product separate from the characteristics of: (i) the User purchasing and/or using the Product; (ii) the Producer producing the Product; and/or (iii) the Retailer selling the Product; and/or (f) the Product Action as an action executed by the Product separate from the actions executed by: (i) the User purchasing and/or using the Product; (ii) the Producer producing the Product; and/or (iii) the Retailer selling the Product.

In an example of an Offer Condition Attribute applicable to an Offer covering part or all of the cost of an outpatient pulmonary rehabilitation program service comprising one or more sessions treating COPD, an Offer Condition Attribute can limit the Offer as follows:
(a) An Offer Condition Attribute can limit an Offer to the purchase and/or use of the one or more Products to a User whose User Property value or User Action value meets the predefined one or more values specified in the respective Offer Condition Attribute Value before the purchase, use, and/or continued use of the one or more Products. In a first example, one or more embodiments of the invention can limit an Offer covering part or all of the cost of the outpatient pulmonary rehabilitation program service to the purchase and/or use of the Product by a User whose User Property value meets the predefined one or more values specified in the Offer before the purchase or at any time during use of the Product, i.e., the pulmonary rehabilitation service. In a second example, one or more embodiments of the invention can limit an Offer covering part or all of the cost of the outpatient pulmonary rehabilitation program service to the purchase and/or use of the Product by a User whose User Action value meets the predefined one or more values specified in the Offer Condition Attribute Value, e.g., a User attending a number of sessions of the pulmonary rehabilitation service for any time period during use of the Product, i.e., the pulmonary rehabilitation service. That is, the User Action is separate from the Product Action, i.e., an action executed by the Product. The number of sessions attended by the User is not a function of the Product executing an action or causing a change in a User Property value.
(b) An Offer Condition Attribute can limit an Offer to the purchase and/or use of the one or more Products each of which is produced by a Producer and/or each of which is sold by a Retailer associated with a Producer/Retailer Property value or Producer/Retailer Action value meeting a predefined one or more values specified in the Offer Condition Attribute Value before, at the time of, and/or after the purchase and/or use of the one or more Products. In a first example, one or more embodiments of the invention can limit an Offer covering part or all of the cost of the outpatient pulmonary rehabilitation program service to the purchase and/or use of the Product produced by a Producer whose Producer/Retailer Property value meets the predefined one or more values specified in the Offer Condition Attribute Value, e.g., a Producer like a physician holding a state license to practice medicine before, at the time of, and/or after the purchase of the Product, i.e., the pulmonary rehabilitation service. In a second example, one or more embodiments of the invention can limit an Offer covering part or all of the cost of the outpatient pulmonary rehabilitation program service to the purchase and/or use of the one or more Products each of which is produced by a Producer whose Producer/Retailer Action value meets the predefined one or more values specified in the Offer Condition Attribute Value, e.g., a Producer achieving a meaningful use of certified Electronic Health Record (“EHR”) technology above a predefined threshold before, at the time of, and/or after the purchase of the Product, i.e., the pulmonary rehabilitation service.
(c) An Offer Condition Attribute can limit an Offer to the purchase and/or use of the one or more Products each of which is associated with a Product Property value or Product Action value meeting a predefined one or more values specified in the respective Offer or more Products. In a first example, one or more embodiments of the invention can limit an Offer covering part or all of the cost of an outpatient pulmonary rehabilitation program service to the purchase and/or use of the one or more Products each of which is associated with a Product Property value meeting the predefined one or more values specified in the Offer Condition Attribute Value, e.g., an outpatient pulmonary rehabilitation program service comprising sessions with a minimum number of minutes for each session equal to 31 minutes at any time during use of the Product, i.e., the pulmonary rehabilitation service. In a second example, one or more embodiments of the invention can limit an Offer covering part or all of the cost of an outpatient pulmonary rehabilitation program service to the purchase and/or use of the one or more Products each of which is associated with a Product Action value meeting the predefined one or more values specified in the Offer Condition Attribute Value, e.g., an outpatient pulmonary rehabilitation program service increasing the maximum exercise capacity of the User after n number of sessions to at least 10 Watts. While a Product Action can include an action executed by the User of the Product, e.g., the User can attend the sessions, the User can execute actions prescribed by a physician administering the sessions, or the User can participate in a test of his/her maximum exercise capacity, one or more embodiments of the invention can distinguish a User Action from a Product Action by defining: (a) a User Action as an action executed by the User that is not caused by the User purchasing and/or using the Product; and/or (b) a Product Action as an action execute by the Product which can cause a change in a User Property value and/or a User Action value.

Offer Condition Attribute Value means any one or more values including without limitation: (a) a value of an Offer Condition Attribute which must equal a Transaction Attribute Value associated with a Transaction Attribute which is equal or equivalent to the Offer Condition Attribute in order to qualify the Offer, e.g., if an Offer Condition Attribute is a Product condition in an NDC format and the Offer Condition Attribute Value is the NDC identifier 00071015000, the Offer is limited to the purchase and/or use of the drug Lipitor® associated with the NDC identifier 00071015000; (b) the value of an Offer Condition Attribute which a Transaction Attribute Value associated with a Transaction Attribute equal or equivalent to the Offer Condition Attribute must equal or be greater than in order to qualify the Offer, e.g., if an Offer Condition Attribute is a minimum total Transaction value condition in a currency format and the use of one or more Products whose Total Value is $50 or higher; (c) the value of an Offer Condition Attribute which a Transaction Attribute Value associated with a Transaction Attribute equal or equivalent to the Offer Condition Attribute must equal or be less than in order to qualify the Offer, e.g., if an Offer Condition Attribute is a maximum unit price condition in a currency format and the Offer Condition Attribute Value equals a value of $1,000, the Offer is limited to the purchase and/or use of a Product whose unit price is $1,000 or lower; and/or (d) the set of continuous values of an Offer Condition Attribute between which at least one Transaction Attribute Value associated with a Transaction Attribute equal or equivalent to the Offer Condition Attribute must equal in order to qualify the Offer, e.g., if an Offer Condition Attribute is a Product condition in an NDC format and the Offer Condition Attribute Value is the set of NFC identifiers 00071015000:00071015999, the Offer is limited to the purchase and/or use of the set of the drug Lipitor® in one or more strengths.

Offer Data Structure means a Data Structure, which can be stored on a Computer-Readable Medium, including a set of data elements associated with one or more Offers offered by any party, which can include without limitation: (a) an Affinity Party; (b) a Component Vendor; (c) a Distributor; (d) an Employer; (e) a Government Benefit Authority; (f) an Insurer; (g) a Payment Issuer; (h) a Producer; (i) a Retailer; (j) a Shipper; and/or (k) Tax Authority. For example, the data elements can include without limitation: (a) the Offer Value, e.g., the redemption value specified in the Value Code of the Basic Coupon Code; (b) one or more Offer Condition Attributes; (c) the Offer Condition Attribute Value associated with each Offer Condition Attribute; (d) the number of units of the Offer available for redemption (“Offer Available Unit”), e.g., a party can specify that it will redeem an Offer for each of the first 1 million Transactions purchasing a Product; (e) the total value of Offers available for redemption (“Offer Available Value”), e.g., a party can specify that it will redeem an Offer up to a total value of Offers of $1 million; and/or (f) an identifier uniquely identifying the Offer, e.g., the Basic Coupon Code as part of the GS1-128 Coupon Extended Code. Offer Data Structure can be stored at a single Data Processing System 01000, e.g., Exchange Server 02200, or be distributed across a plurality of Data Processing Systems 01000, e.g., Exchange Server 02200, Retailer Server 02300 storing a Data Structure including one or more Offers offered by the Retailer, and Insurer Server 02700 storing a Data Structure including one or more Offers offered by the Insurer.

Offer Identifier means any identifier which uniquely identifies an Offer within one classification system. The classification systems can include without limitation: (a) a standard system of classifying Offers adopted by a plurality of parties; and/or (b) a proprietary system of classifying Offers used by a party. One or more embodiments of the invention can generate a universal identifier which can uniquely identify an Offer within one classification system and map the universal identifier to an Offer Identifier assigned in each of one or more other classification systems (“Universal Offer Identifier”).

Offer Value means the amount of value in any class of value in an Offer including without limitation: (a) cash transmitted to the purchaser or User of a Product of Interest or the User Fund Account or a decrease in a liability of the purchaser or User of the Product of Interest which can decrease the price of the Product of Interest or any one or more other Products by any party including without limitation: (i) the Retailer offering the Product of Interest; (ii) the Producer producing the Product of Interest; and/or (iii) any party not the Retailer or the Producer, e.g., the Payment Issuer enabling the User to pay for the Product of Interest; (b) any instrument used by the purchaser or User of a Product of Interest representing cash which can decrease the price of the Product of Interest or any one or more other Products, e.g., a coupon, a rebate, a refund, a voucher, and/or stored-value account like a gift card, where the instrument can be in any form including without limitation: (i) physical, e.g., a paper-based coupon or voucher; and/or (ii) non-physical, e.g., a digital-based coupon or voucher; (c) any store of value other than cash which the User can redeem after the purchase of a Product of Interest, e.g., points, miles, kilometers, or credits which the User can convert into value applied to the purchase and/or use of one or more Products; (d) one or more units of the Product of Interest received by the purchaser or User of a Product of Interest in addition to the unit(s) of the Product of Interest purchased or used, e.g., a “two-for-one” Offer or “buy one, get one free” Offer; (e) one or more units of a Product received by the purchaser or User of a Product of Interest different from the Product of Interest purchased or used, e.g., an Offer providing the purchaser or User of product A like an automobile one or more units of product B like free gasoline or a decrease in interest rate on an automobile Loan; (f) any payment or reimbursement of part or all of the price of a Product of Interest before, at, and/or after a Transaction by a party on behalf of the User of the Product of Interest, where the party can include without limitation: (i) an Insurer; (ii) an Employer; and/or (iii) a Government Benefit Authority; and/or (g) any decrease in a tax liability of the purchaser or User of the Product of Interest including without limitation: (i) an exclusion or deduction from income subject to taxation by a Tax Authority, e.g., the United States Internal Revenue Service and/or a state Tax Authority, (“Taxable Income”), e.g., an exclusion from Taxable Income for the purchase of a qualifying Product of Interest using funds stored in a FSA or a deduction from Taxable Income of the price of a qualifying Product of Interest by the User purchasing the Product of Interest for which the User can itemize a deduction; (ii) a credit against income tax liability for which a purchase of a Product of Interest would qualify, e.g., a credit against income tax liability for the purchase of a qualifying Product of Interest like an alternative motor vehicle or a qualifying Product of Interest enabling the conversion of a motor vehicle to a qualified plug-in electric drive motor vehicle; and/or (iii) an exclusion from sales tax liability by a Tax Authority, e.g., an exemption from a state and/or local sales tax by a party purchasing a Product of Interest for incorporation in a Product subsequently resold in the usual course of its business, for example, a party issued a Uniform Sales and Use Tax Exemption Certification by the Multistate Tax Commission. The class of Offer Value can include without limitation: (a) any class of value received by the purchaser or User of a Product of Interest; and/or (b) any class of value not taken from the purchaser or User of a Product of Interest. An Offer Value can include without limitation: (a) a Static Offer Value, i.e., an Offer Value whose value is fixed in an Offer Data Structure at the time of a query of the Offer Data Structure to identify any Qualifying Offers; and/or (b) a Dynamic Offer Value, i.e., an Offer Value whose value can change depending on the value of any event in an event-condition-action rule stored in an Offer Data Structure.

Payment Issuer means a party issuing a User a Payment Method enabling the User to pay for a Product of Interest. Payment Issuer can execute one or more functions including without limitation: (a) storing funds in a User Fund Account; (b) transmitting funds from User Fund Account to an account of each of one or more another parties, e.g., a Retailer; (c) transmitting funds on behalf of the User to an account of another party, e.g., a Retailer, and crediting a liability to the User Fund Account; and/or (d) receiving funds from an account of each of one or more other parties other than the User, e.g., a Producer transmitting the value of an Offer associated with the purchase of a Product of Interest, an Insurer transmitting the value of an Offer reimbursing the User for part or all of the price of a Product of Interest covered by an Insurance Product, an Employer transmitting the value of a paycheck, or a Government Benefit Authority transmitting the value of a benefit. User Fund Account can receive funds from any other account of the User including without limitation: (a) a deposit of cash; (b) a deposit of a check or transfer from a checking account; (c) transfer from any non-checking account, e.g., a credit card, a debit card, or a charge card; and/or (d) a transfer from a stored value card.

Payment Issuer can be a party: (a) directly storing funds in the User Fund Account, e.g., a Bank or non-Bank issuing a Payment Method, i.e., a means of enabling payment for one or more Products in a Transaction, which can include without limitation: (i) a credit card; (ii) a debit card; (iii) a charge card; (iv) a stored value card; (v) an electronic benefit transfer card; and/or (vi) any method of transferring funds directly to (e.g., a direct deposit) and/or from (e.g., a direct withdrawal) a User Fund Account without using a Payment Network like a Card Association; or (b) issuing a Payment Method like a credit card or debit card, e.g., a Retailer issuing a store card, and contracting with another party, e.g., a Bank or a non-Bank, to store funds in the User Fund Account.

In the case of a Payment Method in the form of a credit, debit, or charge card, an account number complying with a standard, e.g., the ISO/IEC 7812 numbering standard, is typically 16 digits in length, comprising: (a) a first digit specifying the Major Industry Identifier (“MII”), e.g., a first digit “4” specifies the issuer in the banking class and a first digit “6” specifies the issuer in the Retailer class; (b) the first six digits including the MII digit specifying the Payment Issuer issuing the Payment Method to the customer (“Issuer Identification Number”) which can further specify a particular product offered by the Payment Issuer, e.g., the “486236” Issuer Identification Number specifies a Visa® Platinum Credit Card issued by Capital One®; (c) the next nine digits typically specifying the customer to which the Payment Issuer issued the Payment Method; and (d) the last digit representing a check digit.

Payment Network means a party which can connect at least one or more parties each administering one or more Fund Accounts, e.g., a Payment Issuer Server 02800, from which the Payment Network can withdraw funds and one or more parties each administering one or more Fund Accounts, e.g., a Retailer Bank Server 02830, to which the Payment Network can deposit funds. Payment Network can execute one or more functions including without limitation, the Authentication, Authorization, Clearing, and/or Settlement of Transactions associated with the purchase of a Product of Interest. A first class of Payment Networks is a network connecting a plurality of Payment Issuer Servers 02800 and a plurality of Acquirer Servers 02811. A second class of Payment Networks is a batch funds transfer system like an Automated Clearing House (“ACH”) which connects a plurality of Originating Depository Financial Institutions (“ODFI”) and a plurality of Receiving Depository Financial Institutions (“RDFI”). A third class of Payment Networks is a real-time funds transfer system like Fedwire® Funds Service. A fourth class of Payment Networks is a Card Association. A fifth class of Payment Networks is a system for processing coupons (“Coupon Network”). A sixth class of Payment Networks is exemplified by Apparatus 06000 which this application describes herein.

Printing Device means any Data Processing System 01000 which can receive data and/or instructions enabling the production of a good and can produce the good. The good can be a single layer of component constituting the good or a plurality of layers of components constituting the good.

Processor means a general- or special-purpose means of executing data and/or instructions. Processor can include without limitation: general-purpose Processor 01200, special-purpose Application Processor 01202, Specialized Processor 01204, and/or other hardware executing any of the methods, steps, and/or instructions described herein.

Producer means a party which can produce a Product. Producer can produce a good and deliver directly or indirectly through one or more other parties the good to a User of the Product. Producer can develop and transmit the instructions for producing a good to a User of the Product for the User to produce directly the Product. Producer can produce a service and deliver directly or indirectly through one or more other parties the service to a User of the Product. In the case where a Producer can sell a good and/or service directly to a User of the Product, one or more embodiments of the invention can classify the Producer as a Retailer.

Producer Bank means a party which can enable a Producer to transmit, hold, store, and/or receive funds associated with the purchase of a Product of Interest. Producer Bank can execute one or more functions including without limitation: (a) storing funds in a Fund Account of the Producer (“Producer Fund Account”); (b) transmitting funds from Producer Fund Account to a Fund Account of another party, e.g., the User Fund Account held by a User; (c) transmitting funds on behalf of the Producer to a Fund Account of another party, e.g., the User and crediting a liability to the Producer Fund Account; and/or (d) receiving funds from a Fund Account of another party, e.g., the User Fund Account held by a User purchasing a Product of Interest from the Retailer selling the Product of Interest produced by the Producer.

Producer Identifier means any identifier which uniquely identifies a Producer within one classification system. The classification systems can include without limitation: (a) a standard classification system in which a party assigns for use by any other party an identifier to each Producer, e.g., the Manufacturer ID GS1 US™ issues to Producers in the United States and/or the D-U-N-S Dun & Bradstreet® issues to Producers internationally; and/or (b) a proprietary classification system in which a party assigns for its own use an identifier to each Producer. One or more embodiments of the invention can generate a universal identifier which can uniquely identify a Producer within one classification system and map the universal identifier to a Producer Identifier assigned in each of one or more other classification systems (“Universal Producer Identifier”).

Product means one or more goods and/or one or more services consumed by a User or User of a Client Device 02100.

A Product can include without limitation: (a) one or more goods, which can include without limitation: (i) a physical good, e.g., a house for purchase, a motor vehicle, a computer, a factory, an oil tanker, a highway, a DVD, a computer, or a loaf of bread; or (ii) a non-physical good, e.g., data representing music or video, cash, or virtual good used for an application; (b) one or more services, which can include without limitation: (i) a service associated with purchasing and/or using a physical good, e.g., a house for rental, renting a car, insuring against one or more risks of operating a car, insuring against one or more risks of owning a home, insuring against one or more risks of operating an oil tanker, providing electricity to a factory, constructing a highway, renting a room in a hotel, subscribing to a communications plan with a TV or phone, repairing a furnace, or eating a meal in a restaurant; and/or (ii) a service associated with anything other than using a physical good, which can include without limitation: (1) a function of a party excluding the use of a physical good, e.g., (A) insuring against one or more risks of a function of a person like travel insurance (i.e., the person executing the function of travel); (B) providing advice like legal, financial, accounting, or dating advice; or (C) transferring value like cash from a first account to a second or other account; and/or (2) a property of a party excluding the use of a physical good, e.g., (A) insuring against one or more risks of a property of a person (i.e., the person's health) like a Health Insurance Product; or (B) monitoring therapeutic exercise for a property of a person (i.e., the person's physical functionality) like physical rehabilitation; and/or (c) a combination of one or more goods and one or more services, e.g., (i) a combination of a good like an automobile and a service like an automobile repair contract offered as a single Product by one or more Producers and/or Retailers, or (ii) a combination of a good like a router and a plurality of services like television service, Internet telecommunication service, voice landline telecommunication service, and/or wireless telecommunication service.

An exemplary Product that is a combination of one or more goods and/or one or more services can be a single Product comprising a combination of one or more goods and/or one or more services treating the condition COPD. The exemplary single Product can include without limitation: (a) a health care service comprising one or more sessions diagnosing and/or treating COPD purchased and/or used over a period of time offered by one or more Producers which can be one or more primary and/or specialist physicians; (b) a smoking cessation good comprising a single unit or a plurality of units purchased and/or used over a period of time offered by a Producer and/or Retailer; (c) a peak flow meter good comprising a single unit purchased and/or used over a period of time offered by a Producer and/or Retailer; (d) a first inhaler good dispensing a second bronchodilator good comprising a single unit or plurality of units purchased and/or used over a period of time; and/or (e) an outpatient pulmonary rehabilitation program service comprising one or more sessions treating COPD purchased and/or used over a period of time offered by a Producer and/or Retailer of pulmonary rehabilitation program services, which in turn can comprise one or more Producers providing one or more components of a pulmonary rehabilitation program service, which can include without limitation: (i) one or more physicians; (ii) one or more nurses; (iii) one or more respiratory therapists; (iv) one or more physical therapists; (v) one or more occupational therapists; and/or (vi) one or more psychologists. The exemplary single Product can be offered by: (a) one Producer which in turn coordinates the supply of the one or more goods and/or one or more services constituting the single Product; (b) a third party which in turn coordinates the supply of the one or more goods and/or one or more services constituting the single Product; and/or (c) a plurality of Producers supplying the one or more goods and/or one or more services constituting the single Product. The Producer(s) offering the exemplary single Product can offer: (a) a single price for the one or more goods and/or one or more services constituting the single Product; and/or (b) a price for each of the one or more goods and/or one or more services constituting the single Product. The Producer(s) offering the exemplary single Product can bill: (a) one party which can include without limitation: (i) the party using the single Product, e.g., the User of Client Device 02100; and/or (ii) the one or more parties paying for the single Product, e.g., the User, the Employer of the Sser, and/or the Insurer of the User. The Producer(s) offering the exemplary single Product can transmit: (a) one bill for the one or more goods and/or one or more services constituting the single Product; and/or (b) a plurality of bills, each of which is for the one or more goods and/or one or more services constituting the single Product. The one or more parties paying for the single Product can transmit: (a) one payment for the single Product before, at, or after the purchase and/or use of the one or more goods and/or one or more services constituting the single Product; and/or (b) a plurality of payments for the single Product before, at, or after the purchase and/or use of the one or more goods and/or one or more services constituting the single Product.

Product Class means any class of Products including values of an attribute set within a predefined threshold of a Transaction Attribute Values specified in a User Query. The number of Products in one Product Class can vary depending on how narrow or broad is the definition of the need or degree to which Products in the same Product Class can serve as substitutes. For example, a first classification system can limit the scope of a Product Class for long-distance transportation to airlines providing transportation service between a source location and a destination location. However, a second classification system can expand the scope of a long-distance transportation Product Class to include classes of vendors other than airlines which can provide the same transportation service, e.g., vendors of train service or vendors of bus service.

Product Class Identifier means any identifier which uniquely identifies a Product Class within one classification system. The classification systems can include without limitation: (a) a standard classification system in which a party assigns for use by any other party an identifier to each Product Class, which can include without limitation: (i) Standard Industrial Classification (“SIC”); (ii) North American Industry Classification System (“NAICS”); (iii) North American Product Classification System (“NAPCS”); (iv) Products associated with each class of International Statistical Classification of Diseases and Related Health Problems (commonly known as ICD); and/or (iv) Major Diagnostic Categories (“MDC”); and/or (b) a proprietary classification system in which a party assigns for its own use an identifier to each Product Class, e.g., a Retailer assigning for its own use an identifier to each Product Class and classify each Product to one or more Product Classes. One or more embodiments of the invention can generate a universal identifier which can uniquely identify a Product Class within one classification system and map the universal identifier to a Product Class Identifier assigned in each of one or more other classification systems (“Universal Product Class Identifier”).

Product Identifier means any identifier which uniquely identifies a Product within one classification system and/or one or more derivatives. The classification systems can include without limitation: (a) Global Trade Item Number (“GTIN”); (b) Universal Product Code (“UPC”); (c) European Article Number (“EAN”); (d) Japanese Article Number (“JAN”); (e) GS1 DataBar; (f) Electronic Product Code (“EPC”) as specified by the EPCglobal Tag Data Standard; (g) Stock Keeping Unit (“SKU”); (h) a classification system used by a Retailer to classify the Products it offers, which can include without limitation: (i) Amazon Standard Identification Number (“ASIN”); or (ii) DePartment Class Item (“DPCI”); (i) Code on Dental Procedures and Nomenclature (“CDT”); (j) Diagnosis-Related Group (“DRG”); (k) National Drug Code (“NDC”); (l) Healthcare Common Procedure Coding System (“HCPCS”); (m) Anatomical Therapeutic Chemical Classification System (“AT” or “ATC/DDD”); (n) International Standard Book Number (“ISBN”); (o) International Standard Serial Number (“ISSN”); (p) Vehicle Identification Number (“VIN”); (q) Multiple Listing Service (“MLS”); (r) Real Property Unique Identifier (“RPUID”); and/or (s) a classification system used by Cinema Source to classify a unique movie (“MovieID”). The classification systems can include either an original classification system and/or one or more derivatives of the original classification system. For example, a classification system can include the NDC in a 10-digit integer string format and one or more derivatives, e.g., an NDC derivative used by the CMS in an 11-digit integer string format.

One or more embodiments of the invention can generate a universal identifier which can enable one or more embodiments of the invention to execute one or more of the following functions (“Universal Product Identifier”) including without limitation: (a) uniquely identifying a Product Identifier within one classification system and mapping the identified Product Identifier to the Product Identifier assigned for the same Product in each of one or more other classification systems; (b) uniquely identifying a plurality of goods and/or services which collectively can constitute a single Product for which there may or may not be an existing identifier; and/or (c) identifying a plurality of attributes associated with the Universal Product Identifier including without limitation: (i) the unique Product associated with a Product Identifier within one classification system; and/or (ii) the unique Producer producing the Product associated with a Producer Identifier within one classification system (collectively, “Universal Product Identifier Functions”).

Enabling one or more embodiments of the invention to execute Universal Product Identifier Function (a) produces a well-defined, particular, immediate, and real-world benefit to the public because of the benefits discussed at 30004B.

Enabling one or more embodiments of the invention to execute Universal Product Identifier Function (b) produces a well-defined, particular, immediate, and real-world benefit to the public because identifying uniquely a combination of one or more goods and/or the one or more services constituting a single Product, e.g., the combination of one or more goods and/or one or more services treating COPD, for which an existing classification system does not assign an identifier can enable one or more embodiments of the invention to execute one or more functions including without limitation: (a) identifying the combination of one or more goods and/or one or more services constituting a single Product, e.g., a combination treating COPD where the values of the attributes of the combination meet the values of the attributes of a User Query; (b) identifying the one or more Offers associated with each of and the combination of one or more goods and/or one or more services constituting a single Product, e.g., a combination treating COPD; (c) facilitating the transfer of funds among the Producers of the one or more goods and/or one or more services constituting a single Product, e.g., a combination treating COPD; and/or (d) executing functions related to the combination after purchase and/or use of the single Product. For example, one or more embodiments of the invention can assign a Universal Product Identifier to an exemplary single Product comprising a combination of one or more goods and/or one or more services treating COPD including without limitation: (a) a health care service uniquely identified, e.g., by a HCPCS; (b) a smoking cessation good uniquely identified, e.g., by a UPC; (c) a peak flow meter good uniquely identified, e.g., by a UPC; (d) a bronchodilator and inhaler good uniquely identified, e.g., by a NDC; and/or (e) an outpatient pulmonary rehabilitation program service uniquely identified, e.g., by a HCPCS.

Enabling one or more embodiments of the invention to execute Universal Product Identifier Function (c) produces a well-defined, particular, immediate, and real-world benefit to the public because uniquely identifying not only a Product, but also the one or more Producers of the Product, can enable one or more embodiments of the invention to execute one or more functions including without limitation: (a) identifying more accurately and/or quickly a unique Product offered by a unique Producer which can qualify for one or more Offers, since an Offer can be limited to a set of one or more Producers; (b) enabling the more accurate transfer of funds among the one or more Producers of the Product; and/or (c) executing functions related to the Product after the purchase and/or use of the Product where the functions require identification of the one or more Producers of the Product. Some Product Identifier classification systems assign an identifier which uniquely identifies not only a Product, but also the Producer of the Product. For example, the UPC can include a five-digit code uniquely identifying the manufacturer or Producer of the Product. However, the identifier assigned by other Product Identifier classification systems does not uniquely identify the Producer of the Product. For example, the HCPCS uniquely identifies a Product, but does not include any code uniquely identifying the Producer of the Product.

Product of Interest means a Product for which a Client Device 02100 transmits data associated with the Product, e.g., a query about a Product in which the User of a Client Device 02100 is interested.

Post-Transaction Attribute means any attribute associated with a Transaction which occurs after a Transaction.

Qualifying Fund Account means a Fund Account in which every Fund Account Condition Attribute qualifies for a Transaction. That is, one or more embodiments of the invention can identify a Qualifying Fund Account by applying comparator logic to: (a) compare each Authorization Attribute Value to the Fund Account Condition Attribute Value (where the Fund Account Condition Attribute specifies a single value) or set of Fund Account Condition Attribute Values associated with a Fund Account Condition Attribute equal or equivalent to the Authorization Attribute; and (b) select the Fund Account for which: (i) every Fund Account Condition Attribute Value equals the Authorization Attribute Value (where the Fund Account Condition Attribute specifies a single value); and (ii) every set of Fund Account Attribute Values includes the Authorization Attribute Value ((b)(i) and (b)(ii) collectively “Fund Account Match”).

In a first embodiment, the invention identifies a Qualifying Fund Account by selecting only those Fund Accounts where the comparator logic produces a Fund Account Match. The first embodiment should ensure that the identification of a Qualifying Fund in which every Fund Account Condition Attribute qualifies for a Transaction. In a second embodiment, the invention can identify a Qualifying Fund Account where the comparator logic does not produce a Fund Account Match. Identifying a Qualifying Fund Account with fewer than all Fund Account Condition Attribute matches can yield a benefit where the holder of the Fund Account may still want to Authorize a withdrawal of funds from and/or deposit of funds to the Fund Account. For example, the holder of a User Fund Account may still want to Authorize a withdrawal of funds from the User Fund Account even where the comparator logic matches fewer than all Fund Account Condition Attributes. The User Fund Account holder may be willing to incur an overdraft fee to purchase the Product in a Transaction.

Qualifying Fund Account can include any Fund Account qualifying for a Transaction including without limitation: (a) a Qualifying User Fund Account which can include with limitation: (i) a TAV-Dependent User Fund Account (defined herein); and/or (ii) a TAV-Independent User Fund Account (defined herein); and/or (b) a Qualifying Fund Account not a Qualifying User Fund Account.

Qualifying Offer means an Offer in which every Offer Condition Attribute qualifies for a Transaction. That is, one or more embodiments of the invention can identify a Qualifying Offer by applying comparator logic to: (a) compare each Transaction Attribute Value to the Offer Condition Attribute Value (where the Offer Condition Attribute specifies a single value) or set of Offer Condition Attribute Values associated with an Offer Condition Attribute equal or equivalent to a Transaction Attribute; and (b) select the Offer for which: (i) every Offer Condition Attribute Value equals a Transaction Attribute Value (where the Offer Condition Attribute specifies a single value); and (ii) every set of Offer Condition Attribute Values includes a Transaction Attribute Value ((b)(i) and (b)(ii) collectively “Offer Match”).

In a first embodiment, the invention identifies a Qualifying Offer by selecting only those Offers where the comparator logic produces an Offer Match. The first embodiment allows identification of a Qualifying Offer in which every Offer Condition Attribute qualifies for a Transaction. In a second embodiment, the invention can identify a Qualifying Offer where the comparator logic does not produce an Offer Match. Identifying a Qualifying Offer with fewer than all Offer Condition Attribute matches can yield a potential benefit where the party making an Offer may still want a User to qualify for the Offer. For example, the party making an Offer may still want the User to qualify for the Offer even where the comparator logic matches fewer Offer Condition Attribute Value, e.g., the End Date which effectively extends the Offer, to encourage the User to purchase the Product in a Transaction.

Qualifying Producer means a Producer which offers the Product of Interest included in a User Query and has available for sale directly and/or indirectly through at least one Retailer at least the number of units of the Product of Interest requested in the User Query.

Qualifying Retailer means a Retailer which offers the Product of Interest included in a User Query and has available for sale at least the number of units of the Product of Interest requested in the User Query.

Qualifying Retailer/Offer Combination means a combination of a Qualifying Retailer and one or more Qualifying Offers which can be associated with a Qualifying Retailer.

Qualifying User Fund Account means a Qualifying Fund Account held by a User.

Qualifying User Fund Account Combination means a combination of a plurality of Qualifying User Fund Accounts.

Registration means the enrollment of a party participating in a Transaction and providing of one or more data associated with the party used to execute one or more functions in a Transaction.

Regulatory Agency means a party which can regulate the activity of one or more other parties related to the purchase, ownership, and/or use of a Product of Interest. Regulatory Agency can be a party operating at any level of government including without limitation: international, federal, state, county, or local. The Tax Authority can be a party operating as: (a) a governmental entity, e.g., a party governing a state; or (b) a non-governmental entity, e.g., a party authorized by a government, a private group, or any other party to regulate the activity of any party. The activity can be any type of activity including without limitation: (a) a purchase of a Product; (b) ownership or non-ownership, e.g., rental, of a Product; and/or (c) a use of a Product. A party on which a Tax Authority can assess a tax can include without limitation: (a) an individual; (b) a business; and/or (c) a party which is not an individual or a business.

Retailer means a party which can sell one or more Products. Retailer can sell a Product through one or more channels including without limitation: (a) a physical channel, i.e., a physical store at which a User of a Client Device 02100 can view, order, and/or purchase a Product, e.g., a specific physical store operated by the Retailer (“Retailer PHY Store”) associated with an identifier of the Retailer PHY Store (“Retailer PHY Store Identifier”); (b) a data channel, i.e., a virtual store viewable through an electronic network, e.g., the Internet, at which a User of a Client Device 02100 can view, order, and/or purchase a Product; (c) a voice channel, i.e., a call center enabling a User of a Client Device 02100 to inquire about, order, and/or purchase a Product; or (d) a mail channel, i.e., a paper-based catalog enabling a User to view, order, and/or purchase a Product. In the case where a Producer can sell a good and/or a service directly to a User of the Product, one or more embodiments of the invention can classify the Producer as a Retailer.

Retailer Bank means a party which can enable a Retailer to transmit, hold, store, and/or receive funds associated with the purchase of a Product of Interest. Retailer Bank can execute one or more functions including without limitation: (a) storing funds in a Fund Account of the Retailer (“Retailer Fund Account”), (b) transmitting funds from Retailer Fund Account to a Fund Account of another party, e.g., the User Fund Account held by a User, (c) transmitting funds on behalf of the Retailer to a Fund Account of another party, e.g., the User and crediting a liability to the Retailer Fund Account; and/or (d) receiving funds from a Fund Account of another party, e.g., the User Fund Account held by a User purchasing a Product of Interest from the Retailer.

Retailer Customer Data Structure means a Data Structure, which can be stored on a Computer-Readable Medium, including a set of data elements associated with one or more customers of a Retailer. For example, the data elements can include without limitation: (a) a customer identifier; (b) a shipping address; and/or (c) one or more prior Transactions.

Retailer Class Identifier means any identifier which uniquely identifies a Retailer Class within one classification system. The classification systems can include without limitation: (a) Merchant Category Code (“MCC”); (b) Standard Industrial Classification (“SIC”); (c) North American Industry Classification System (“NAICS”); and/or (d) North American Product Classification System (“NAPCS”). One or more embodiments of the invention can generate a universal identifier which can uniquely identify a Retailer Class within one classification system and map the universal identifier to a Retailer Class Identifier assigned in each of one or more other classification systems (“Universal Retailer Class Identifier”).

Retailer Identifier means any identifier which uniquely identifies a Retailer within one classification system. The classification systems can include without limitation: (a) a standard classification system in which a party assigns for use by any other party an identifier to each Retailer, e.g., the MID a Payment Network, Card Association, or Acquirer Server 02811 issues to Retailers in its network; and/or (b) a proprietary classification system in which a party assigns for its own use an identifier to each Retailer. One or more embodiments of the invention can generate a universal identifier which can uniquely identify a Retailer within one classification system and map the universal identifier to a Retailer Identifier assigned in each of one or more other classification systems (“Universal Retailer Identifier”).

Retailer of Interest means a Retailer for which a Client Device 02100 transmits data associated with the Product, e.g., a query if a Retailer offers a Product in which the User of a Client Device 02100 is interested.

Retailer Product Data Structure means a Data Structure, which can be stored on a Computer-Readable Medium, including a set of data elements associated with one or more Products offered by a Retailer. For example, the data elements can include without limitation: (a) a Product Identifier and/or a Universal Product Identifier; (b) a description of the Product (“Product Description”); (c) the price at which the Retailer offers to sell the Product (“Retailer Price”); and/or (d) the number of units of the Product available for sale (“Retailer Available Unit”).

Retailer Transaction Data Structure means a Data Structure, which can be stored on a Computer-Readable Medium, including a set of data elements associated with one or more Transactions executed by a Retailer. For example, the data elements can include without limitation: (a) a Transaction Identifier; (b) one or more Products purchased or used in a Transaction; (c) the price at which the Retailer sold the Product in a Transaction; and/or (d) the Total Value of a Transaction.

Settle or Settlement means to execute or the execution of, respectively, one or more functions transferring funds among all Qualifying Fund Accounts for one or more Transactions over any time period which can include without limitation: (a) withdrawing the Net Withdrawal Amount for a Qualifying Fund Account from which one or more embodiments of the invention can withdraw funds; and/or (b) depositing the Net Deposit Amount for a Qualifying Fund Account to which one or more embodiments of the invention can deposit funds.

Tax Authority means a party which has the authority to assess a tax on the activity of any party. The Tax Authority can be a party operating at any level of government including without limitation: international, federal, state, county, city, town, and/or neighborhood. The Tax Authority can be a party operating as: (a) a governmental entity, e.g., a party governing a state; or (b) a non-governmental entity, e.g., a party authorized by a government, a private group, or any other party to assess a tax on the activity of any party. The activity can be any type of activity including without limitation: (a) income of a User; (b) a sale of a Product; (c) a use of a Product; and/or (d) an asset held by a User, e.g., real property or non-real property. A party on which a Tax Authority can assess a tax can include without limitation: (a) an individual Taxpayer; (b) a business Taxpayer; and/or (c) a Taxpayer which is not an individual or a business. The Tax Authority means a party which has the authority to assess any class of tax including without limitation: an Income Tax Authority whose functions can be executed by a Income Tax Server 02920, a Sales Tax Authority whose functions can be executed by a Sales Tax Server 02910, a Property Tax Authority whose functions can be executed by a Property Tax Server 02930, and/or any other class of Tax Authority.

Taxpayer means a party which can incur a liability (which may or may not be incurred) to pay tax (“Tax Liability”) to a Tax Authority. A Taxpayer can include: (a) an individual Taxpayer; (b) a business Taxpayer; and/or (c) a Taxpayer which is not an individual or a business.

Total Settlement Cost means the sum of at least: (a) the cost of reserving a Withdrawal Amount in the Current Account Balance of each Qualifying Fund Account; (b) the cost of any Qualifying Fund Account becoming insolvent between the time of Authorization and the time of Settlement; and (c) the cost of transferring each Withdrawal Amount and Deposit Amount for each of one or more Transactions over any time period.

Transaction means the process for enabling the purchasing of and/or payment for a Product.

Transaction Attribute means any attribute associated with a Transaction which can include without limitation: (a) a Product Attribute associated with a Transaction Attribute Value specifying the set of one or more Products purchased and/or used in a Transaction, e.g., a Transaction Attribute Value can include a set of Product Identifiers and/or Universal Product Identifiers, each of which is associated with one Product purchased and/or used in a Transaction; (b) a Brand Attribute associated with a Transaction Attribute Value specifying the set of one or more Brands purchased and/or used in a Transaction, e.g., a Transaction Attribute Value can include a set of Brand Identifiers, each of which is associated with one Product purchased and/or Value specifying one or more Product Classes including a Product purchased and/or used in a Transaction, e.g., a Transaction Attribute Value can include a set of Product Class Identifiers, each of which is associated with one Product purchased and/or used in a Transaction; (d) a Product Unit Attribute associated with a Transaction Attribute Value specifying the number of units of each Product purchased and/or used in a Transaction; (e) a Product Unit Price Attribute associated with a Transaction Attribute Value specifying the unit price of each Product purchased and/or used in a Transaction; (f) a Transaction Total Value Attribute associated with a Transaction Attribute Value specifying the Total Value of the one or more Products purchased and/or used in a Transaction; (g) a Cumulative Transaction Value Attribute associated with a Transaction Attribute Value specifying the Cumulative Transaction Value of Transactions executed by a User in an account over a predefined time period; (h) a Date/Time Attribute associated with a Transaction Attribute Value specifying the date and/or time of a Transaction; (i) a Geographic Attribute associated with a Transaction Attribute Value specifying the geographic location of either the physical store at which the Retailer executes a Transaction or a shipping address to which the Retailer ships one or more Products in a Transaction; (j) a Customer Attribute or User Attribute associated with a Transaction Attribute Value specifying the party purchasing and/or using one or more Products in a Transaction, e.g., a Transaction Attribute Value can include a Customer Identifier and/or a User Identifier associated with the customer or User purchasing and/or using the one or more Products purchased and/or used in a Transaction; (k) a User Property Attribute associated with a Transaction Attribute Value specifying a property of the party purchasing and/or using one or more Products in a Transaction; (l) a User Action Attribute associated with a Transaction Attribute Value specifying an action executed by the party purchasing and/or using one or more Products in a Transaction; (m) a Retailer Attribute associated with a Transaction Attribute Value specifying a party selling one or more Products in a Transaction, e.g., a Retailer Attribute can include a Retailer Identifier associated with the Retailer selling one or more Products in a Transaction; (n) a Producer Attribute associated with a Transaction Attribute Value specifying a party producing one or more Products in a Transaction, e.g., a Producer Attribute can include a Producer Identifier associated with the Producer producing one or more Products in a Transaction; (o) a Producer/Retailer Property Attribute associated with a Transaction Attribute Value specifying a property of the Producer producing one or more Products and/or the Retailer selling one or more Products in a Transaction; (p) a Producer/Retailer Action Attribute associated with a Transaction Attribute Value specifying an action executed by the Producer producing one or more Products and/or the Retailer selling one or more Products in a Transaction; (q) a Product Property Attribute associated with a Transaction Attribute Value specifying a property of the Product in a Transaction; (r) a Product Action Attribute associated with a Transaction Attribute Value specifying an action executed by the Product in a Transaction; (s) an Offer Redemption Attribute associated with an Offer Redemption Attribute Value specifying the one or more Offers redeemed in a Transaction, e.g., an Offer Redemption Attribute can include one or more Offer Identifiers, each of which is associated with one Offer redeemed in a Transaction; and/or (t) an Offer Redemption Priority Attribute associated with an Offer Redemption Priority Attribute Value specifying the sequence in which a plurality of Offers was applied to the purchase and/or use of one or more Products purchased and/or used in a Transaction.

Transaction Attribute Value means the one or more values associated with each Transaction Attribute.

Transaction Event means the one or more functions executed to process a Transaction. Transaction Event can include without limitation: (a) the determination of the Product requested in a User Query; (b) the Authentication of one or more parties which must execute one or more functions to complete a Transaction; (c) the identification of one or more Qualifying Retailers; (d) the identification of one or more Qualifying Producers; (e) the identification of one or more Qualifying Offers; (f) the transfer of possession of the Product from Retailer and/or Producer to the User where the Product is a good (“Product Good Reception”) or the User reception from Retailer and/or Producer of the one or more functions constituting the Product where the Product is a service (“Product Service Reception”); (g) the Authorization of withdrawal of a Withdrawal Amount from each Qualifying Fund Account; (h) the Clearing of a Transaction; (i) the execution of operations on one or more Data Structures recording a Transaction; (j) the Settlement of a Transaction; and/or (k) the execution of any function related to the Product after Product Good Reception and/or Product Service Reception.

Transaction Fee means one or more fees assessed by each of one or more Data Processing Systems 01000 enabling the execution of a Transaction (“Transaction Enabler”). Transaction Enabler can include without limitation: an ACH Operator, e.g., the Federal Reserve Bank (“FRB”), a Card Association, Exchange Server 02200, any other Payment Network, and/or each Fund Account Administrator which has an agreement with one or more parties in a Transaction to receive a Transaction Fee. Each Transaction Enabler can associate a Fund Account to which one or more embodiments of the invention can deposit any Transaction Fee.

Transaction Identifier means any identifier which uniquely identifies a Transaction within one classification system. The classification systems can include without limitation: (a) a standard system of classifying Transactions adopted by a plurality of Retailers; and/or (b) a proprietary system of classifying Transactions used by a Retailer. One or more embodiments of the invention can generate a universal identifier which can uniquely identify a Transaction within one classification system and map the universal identifier to a Transaction Identifier assigned in each of one or more other classification systems (“Universal Transaction Identifier”). Because a Transaction can include the purchase and/or use of one or more Products, one or more embodiments of the invention can generate and/or use any identifier which uniquely identifies the purchase and/or use of one or more Products in a Transaction. For example, a Transaction can include: (a) the purchase of a Product, e.g., an outpatient pulmonary rehabilitation program service; and/or (b) the use of a Product, e.g., one or more sessions constituting the outpatient pulmonary rehabilitation program service. One or more embodiments of the invention can generate and/or use an identifier uniquely identifying the purchase of the Product and/or an identifier uniquely identifying the use, e.g., a session identifier.

Transaction Authorization Record means the data and/or instructions required to Authorize the withdrawal and/or deposit of a Transaction Clearing Amount from and/or to each Qualifying Fund Account for each Transaction. Transaction Authorization Record can include without limitation data and/or instructions related to: (a) each Qualifying Fund Account from which one or more embodiments of the invention can withdraw a Withdrawal Amount; (b) the Withdrawal Amount for the Qualifying Fund Account; (c) each Qualifying Fund Account to which one or more embodiments of the invention can deposit a Deposit Amount; (d) the Deposit Amount for the Qualifying Fund Account; (e) each Fund Account held by a Transaction Enabler; and/or (1) any Transaction Fee(s). At any time before transmitting an Authorization Request 06910, one or more embodiments of the invention can receive from each party related to a Transaction any instructions for associating the correct Qualifying Fund Account. For example, a party making an Offer can associate a Fund Account dedicated to receiving deposits and/or transmitting withdrawals associated with a Transaction, e.g., an Employer can register at Registration that Exchange Server 02200 should deposit any Deposit Amount and/or withdraw any Withdrawal Amount associated with a Transaction into and/or from a Fund Account dedicated to receiving and/or transmitting funds associated with the Offer like a Fund Account storing funds dedicated to an FSA account for the employees of the Employer.

Transaction Clearing Record means the data and/or instructions required to execute one or more functions after Authorization for each Transaction. Transaction Clearing Record can include without limitation data and/or instructions related to: (a) each Qualifying Fund Account from which one or more embodiments of the invention withdraws a Withdrawal Amount, e.g., transmitting a message to the Qualifying Fund Account notifying it of the User purchasing the Product in a Transaction and providing it the data necessary to record the actual withdrawal of the Withdrawal Amount; (b) the Withdrawal Amount for the Qualifying Fund Account; (c) each Qualifying Fund Account to which one or more embodiments of the invention deposits a Deposit Amount, e.g., transmitting a message to the Qualifying Fund Account notifying it of the User purchasing the Product in a Transaction and providing it the data necessary to record the actual deposit of the Deposit Amount; (d) the Deposit Amount for the Qualifying Fund Account; (e) one or more Retailer Data Structures associated with the Qualifying Retailer selected in a Transaction to which one or more embodiments of the invention can execute one or more write operations, e.g., a create operation creating a new record (e.g., creating a new customer record purchasing the Product), a delete operation deleting an existing record, and/or an update operation updating an existing record (e.g., updating Retailer Available Units); (f) one or more Offer Data Structures associated with each Qualifying Offer selected in a Transaction to which one or more embodiments of the invention can execute one or more write operations, e.g., a create operation creating a new record (e.g., creating a new record of a customer redeeming the Qualifying Offer), a delete operation deleting an existing record, and/or an update operation updating an existing record (e.g., updating Offer Available Units); and/or (g) one or more Fund Account Data Structures associated with each Qualifying Fund Account selected in a Transaction to which one or more embodiments of the invention can execute one or more write operations, e.g., a create operation creating a new record (e.g., creating a new record of a party receiving funds in a Transaction), a delete operation deleting an existing record, and/or an update operation updating an existing record (e.g., updating a Current Account Balance).

Transaction Clearing Amount means the amount of funds one or more embodiments of the invention withdraws from or deposits to each Qualifying Fund Account for each transfer in a Transaction. One or more embodiments of the invention can compute for each Transaction the amount of funds it should: (a) withdraw from (i) each Qualifying Fund Account transmitting an Authorization to withdraw funds associated with a Qualifying Retailer and/or Qualifying Offer (e.g., a Qualifying Fund Account held by the party making a Qualifying Offer in the form of cash back from Payment Issuer Server 02800) in each Qualifying Retailer/Offer Combination; and/or (ii) each Qualifying User Fund Account transmitting an Authorization to withdraw funds from which one or more embodiments of the invention determines a withdrawal of funds for a given Transaction (the amount of which can be computed and the set of Qualifying User Fund Accounts can be determined using any method, e.g., Method 19000) ((a) representing a “Withdrawal Amount”); and (b) deposit to (i) each Qualifying Fund Account held by a Qualifying Retailer and/or the party making the Qualifying Offer (e.g., a Qualifying Fund Account held by the party making a Qualifying Offer in the form of a sales tax assessed by Sales Tax Server 02910) in each Qualifying Retailer/Offer Combination; and/or (ii) each Qualifying User Fund Account to which one or more embodiments of the invention determines a deposit of funds for a given Transaction (the amount of which can be computed and the set of Qualifying User Fund Accounts can be determined using any method, e.g., Method 19000) ((b) representing a “Deposit Amount”). One or more embodiments of the invention may withdraw a Withdrawal Amount from a Qualifying Retailer in a Qualifying Retailer/Offer Combination even though the Qualifying Retailer is selling the Product in a Transaction and should typically receive funds, because a Qualifying Retailer can provide a Qualifying Offer representing funds transferred to the User, e.g., a rebate.

Transaction Settlement Amount means the net amount of funds one or more embodiments of the invention withdraws from each Qualifying Fund Account for one or more Transactions during any predefined Settlement cycle (“Net Withdrawal Amount”) and the net amount of funds one or more embodiments of the invention deposits to each Qualifying Fund Account for one or more Transactions during any predefined Settlement cycle (“Net Deposit Amount”).

User means any party querying about a Product of Interest and/or purchasing and/or using a Product. A User can include without limitation: (a) an individual; and/or (b) a party other than an individual including without limitation: (i) a business; (ii) a government; and/or (iii) a non-profit organization. While the application typically illustrates the apparatuses, methods, and CPPs described herein for use by a User as an individual, the invention is not limited to that embodiment and can apply to a non-individual as well.

User Class means any class of Users with the same one or more values for an attribute equal or equivalent to an attribute of an Offer limiting the Offer to members of a class of Users. For example, if an Offer includes at least one Offer Condition Attribute limiting the Offer to a class of Users whose age is 65 years or greater, the equal or equivalent User Class is the class of Users whose age is 65 years or greater. The attributes can include without limitation:
(a) attributes in a demographic domain, which can include without limitation: (i) an age domain whose values can include any data representing age and/or a set of ages which can include without limitation: the birthdate, the number of years, the number of months, and/or the number of days old of a User, e.g., a Producer can limit an Offer to Users whose age falls within the set of years between 31 and 40 or an Advertiser can query the number of Transactions executed by Users whose age falls within the set of years between 18 and 49; (ii) a gender domain whose values can include male or female; (iii) an income domain whose values can include the amount of income and/or a set of amounts of income earned over any time period, e.g., a United States Regulatory Agency can limit an Offer for participation in a government benefit program like public housing to Users whose income value falls below a predefined threshold; (iv) a financial asset domain whose values can include the amount of assets and/or a set of amount of assets held as of any date and/or time, e.g., a United States Regulatory Agency can limit an Offer for participation in a government benefit program like Medicaid to Users whose financial asset value falls below a predefined threshold; (v) an education domain whose values can include any data representing the highest degree completed and/or a number of years or set of numbers of years of education completed; (vi) a housing domain whose values can include any data representing the class of housing which can include without limitation: (1) whether the User is or is not a homeowner; and/or (2) the classes of residence of the User, e.g., a single family home or an apartment; (vii) an occupation domain whose values can include any data representing an occupation, e.g., the data representing each occupation in the Standard Occupational Classification (“SOC”) system assigned by the United States Bureau of Labor Statistics; (viii) a military service domain whose values can include any data representing military service which can include without limitation: (1) whether the User is or was a member of the military services; (2) whether the User is a member of a household including a member of the military services; and/or (3) the classes and/or duration of military service of the User; and/or (ix) a disability domain whose values can include any data representing whether the User is or is not disabled and, if disabled, the class of disability;
(b) attributes in a geography domain, which can include without limitation: (i) a shipping address domain whose values can include any data representing any geographic location and/or set of geographic locations which can include without limitation: (1) a jurisdiction domain whose values can include without limitation: country; state; county; city; and/or neighborhood; and/or (2) a mailing address domain whose values can include any data representing a geographical location and/or set of geographic locations, e.g., the zip code identifying a specific geographical location; and/or (ii) a real-time geographical location domain whose values can include any data representing a real-time geographical position and/or a set of real-time geographical positions of a Client Device 02100, e.g., the latitude, longitude, and/or elevation in a geographic coordinate system and/or the coordinates in the Universal Transverse Mercator (“UTM”) system specifying a real-time geographical position of Client Device 02100;
(c) attributes in a Transaction domain, which can include without limitation: (i) a Product Loyalty domain whose values can include any data representing the degree of loyalty of a User to any attribute of a Product, Producer, and/or Retailer where the attribute can include without limitation: (1) the provider of the Product, e.g., the Producer or Retailer; (2) the Brand associated with a Product; and/or (3) the Product name identifying a Product; for example, a User Prior Transaction Data Structure storing on a Computer-Readable Medium a plurality of data associated with prior Transactions of the User can include data on which one or more embodiments of the invention can execute one or more methods to determine the degree of loyalty of the User to a Producer, Brand, or Product, e.g., one or more embodiments of the invention can execute one or more methods disclosed in U.S. patent application Ser. No. 12/129,646 to classify a User into a plurality of Loyalty classes which can include without limitation: (1) Customer: New to Product Class; (2) Customer: Loyal to Competitor Product; or (3) Customer: Loyal to Vendor Product; and then depending on the Loyalty class of which a User is a member generate an Offer customized for the User; and/or (ii) a Purchase Commitment domain whose values can include any data representing the willingness of a User to purchase a plurality of units of a Product of Interest over some time period after the date of a Transaction, e.g., one or more embodiments of the invention can execute one or more methods to classify a User into a plurality of Purchase Commitment classes based on data in the User Prior Transaction Data Structure, e.g., a User subscribing to a program automatically purchasing a book every month can be more likely than Users not subscribing to such subscription programs to subscribe to a program automatically purchasing a Product in a Product Class other than books;
(d) attributes in a Retailer domain, which can include without limitation: (i) a Retailer party domain whose values can include any data representing a Retailer which can include without limitation: (1) the name of the Retailer; and/or (2) an identifier of the Retailer other than the name, e.g., a MID a Payment Network, Card Association, or an Acquirer Server 02811 assigns to a Retailer or an identifier of the Retailer assigned by a party in a Product Class like the NPI the CMS assigns to Producers producing and/or Retailers selling health care Products in the United States; (ii) a domain of a Loyalty Program offered by a Retailer whose values can include any data representing the Loyalty Program which can include without limitation: (1) the name of the Loyalty Program, e.g., Retailer XYZ Rewards Program; and/or (2) an identifier of the Loyalty Program other than the name; and/or (iii) a domain of a Warranty (defined herein) program offered by a Retailer whose values can include any data representing the Warranty program which can include without limitation: (1) the name of the Warranty program; and/or (2) an identifier of the Warranty Program other than the name;
(e) attributes in a Producer domain, which can include without limitation: (i) a Producer party domain whose values can include any data representing a Producer which can include without limitation: (1) the name of the Producer; and/or (2) an identifier of the Producer other than the name, e.g., an identifier of the Producer assigned by a party across a plurality of Product Classes like the Manufacturer ID the GS1 US™ assigns to Producers in the United States or an identifier of the Producer assigned by a party in a Product Class like the NPI the CMS assigns to Producers producing and/or Retailers selling health care Products in the United States; (ii) a domain of a Loyalty Program offered by a Producer whose values can include any data representing the Loyalty Program which can include without limitation: (1) the name of the Loyalty Program, e.g., Producer XYZ Rewards Program; and/or (2) an identifier of the Loyalty Program other than the name; (iii) a domain of a Warranty program offered by a Producer whose values can include any data representing the Warranty program which can include without limitation: (1) the name of the Warranty program, e.g., Producer XYZ Bumper-to-Bumper 5-year 50,000 miles Warranty; and/or (2) an identifier of the Warranty program other than the name;
(f) attributes in a Payment Method domain, which can include without limitation: (i) a Payment Issuer domain whose values can include any data representing a Payment Issuer which can include without limitation: (1) the name of the Payment Issuer; and/or (2) an identifier of the Issuer other than the name, e.g., the Issuer Identification Number; and/or (ii) a Payment Method domain whose values can include any data representing the class of Payment Method issued by a Payment Issuer which can include without limitation: (1) the name of a Payment Method program, e.g., Capital One® Visa® Platinum Credit Card; and/or (2) an identifier of the Payment Method other than the name, e.g., the Issuer Identification Number; for example, a Payment Issuer like a Bank or non-Bank can limit an Offer for participation in a reward program like cash back to Users using a specific Payment Method for a Transaction or a Payment Issuer like a Retailer can limit an Offer for participation in a discount program like percent off the Retailer price to Users using the Payment Method issued by the Retailer for a Transaction;
(g) attributes in an Affinity domain, which can include without limitation: (1) an Affinity Party domain whose values can include any data representing an Affinity Party which can include without limitation: (1) the name of the Affinity Party, e.g., the American Automobile Association (“AAA”) or the American Association of Retired Persons (“AARP”); and/or (2) an identifier of the Affinity Party other than the name; and/or (ii) a domain of a Loyalty Program offered by an Affinity Party whose values can include any data representing the Loyalty Program which can include without limitation: (1) the name of the Loyalty Program, e.g., Affinity Party XYZ Rewards Program; and/or (2) an identifier of the Loyalty Program other than the name;
(h) attributes in an Insurer domain, which can include without limitation: (i) an Insurer party domain whose values can include any data representing an Insurer which can include without limitation: (1) the name of the Insurer; and/or (2) an identifier of the Insurer other than the name which can in an exemplary Product Class of health care Products include without limitation: (A) the Payer Identification Number the National Association of Insurance Commissioners (“NAIC”) assigns to each private Insurer; (B) the Medigap Coordination of Benefits Agreement (“COBA”) Insurer Code, and/or (C) any identifier which the CMS may assign to each Insurer offering one or more Health Insurance Products in the United States pursuant to the Health Insurance Portability and Accountability Act (“HIPAA”) of 1996; (ii) an Insurer Product domain whose values can include any data representing the Insurer Product which can in an exemplary Product Class of health care Products include without limitation: (1) the name of the Insurer Product, e.g., the Insurer XYZ Preferred Provider Organization (“PPO”) Plan, the Insurer XYZ Health Maintenance Organization (“HMO”) Plan, or the Insurer XYZ High-Deductible Plan; and/or (2) an identifier of the Insurer Product which can include without limitation: (A) a standard identifier any Regulatory Agency may assign to each Insurer Product; (B) a standard identifier an industry association may assign to each Insurer Product; and/or (C) a proprietary identifier an Insurer may assign to each of its Insurer Products; and/or (iii) an Insurance domain whose values can include without limitation: (1) if a User is covered by at least one Insurer Product covering the purchase of a Product of Interest; (2) if a User is covered by at least one Insurer Product which does not cover the purchase of a Product of Interest; and/or (3) if a User is not covered by any Insurer Product covering a Product of Interest; (one or more embodiments of the invention produces a well-defined, particular, immediate, and real-world benefit to the public by determining the value in an Insurance domain because the lack of coverage for one or more expenses in a Product Class, e.g., health care, can qualify the User for Products, Retailers, and/or Producers available or selling only to Users without such coverage, e.g., some Producers, e.g., doctors, may be willing to offer Products, e.g., health care Products, only to customers electing not to use or unable to qualify for an Insurer Product, e.g., commonly referred to as Direct Primary Care or Cash-Only Practice in health care);
(i) attributes in an Employer domain, which can include without limitation: (i) an Employer party domain whose values can include any data representing an Employer which can include without limitation: (1) the name of the Employer; and/or (2) an identifier of the Employer other than then name, e.g., the United States Federal Employer Identification Number (“FEIN”) which the United States Internal Revenue Service issues to any party which withholds taxes from employee compensation; (one or more embodiments of the invention produces a well-defined, particular, immediate, and real-world benefit to the public by determining the value in an Employer domain because employment of a User with an Employer may disqualify the User from an Offer offered by the Employer);
(j) attributes in a Taxpayer domain, which can include without limitation: (i) a Taxpayer Class domain whose values can include the classes of Taxpayers whose tax treatment depends on the class, which can include without limitation a Taxpayer filing as: (1) an individual; (2) a sole proprietor; (3) a partnership; (4) a limited liability company/partnership (“LLC/LLP”); (5) a corporation; and/or (6) a Subchapter S corporation; (ii) a Taxpayer Filing Status domain which can be a subdomain of the Taxpayer Class domain whose values can include the classes of Taxpayers whose tax treatment depends on the filing status, e.g., an individual Taxpayer class can have values which can include without limitation a Taxpayer filing as: (1) single; (2) married filing jointly; (3) married filing separately; (4) head of household; or (5) qualifying widow(er) with dependent child; (iii) a Taxable Income domain whose values can include the amount and/or range of Taxable Income earned over any time period, e.g., the United States Congress can pass a statute and/or the United States Internal Revenue Service can implement a rule specifying a first set of Taxable Income values qualifying for a first tax rate, a second set of Taxable Income values qualifying for a second tax rates, and/or any additional set of Taxable Income values each qualifying for an additional tax rate; (iv) a Taxpayer Itemization domain whose values can include the classes of Taxpayers whose tax treatment depends on the class, which can include without limitation: (1) if the Taxpayer itemizes deductions; or (2) if the Taxpayer elects a standard deduction; (v) a Taxpayer Income Exclusion domain whose values can include the classes of Taxpayers whose tax treatment depends on whether the Taxpayer qualifies and/or has registered for a program allowing the Taxpayer to exclude from Taxable Income the contribution made to the program and/or value of qualifying expenses where the program can include without limitation: (1) a Tax-Favored Savings Account, which can include without limitation: (A) an Individual Retirement Account (“IRA”); (B) a Health Savings Account (“HSA”); (C) a Health Reimbursement Account (“HRA”); (D) an Archer Medical Savings Account (“MSA”); (E) a FSA; and/or (F) a Coverdell Education Savings Account (“ESA”) (where the application defines a Non-Tax-Favored Savings Account as all other savings accounts for which the Taxpayer cannot exclude from Taxable Income the contribution made to the program and/or value of qualifying expenses); and/or (2) an Other Tax-Favored Account, which can include without limitation: Employer-Provided Educational Assistance; and/or (vi) a Taxpayer Sales and Use Tax Exclusion domain whose values can include the classes of Taxpayers whose sales tax treatment depends on whether the Taxpayer qualifies and/or has registered for an exemption from a state and/or local sales tax, e.g., a Uniform Sales and Use Tax Exemption Certification by the Multistate Tax Commission.
(k) attributes in a Government Benefit domain, which can include without limitation: (i) a Government Benefit domain whose values can include any data representing a Government Benefit which can include without limitation: (1) the name of the Government Benefit, e.g., Medicare Part D; and/or (2) an identifier of the Government Benefit other than the name;
(l) attributes in a Shipper domain, which can include without limitation: (i) a Shipper party domain whose values can include any data representing a Shipper which can include without limitation: (1) the name of the Shipper; and/or (2) an identifier of the Shipper other than the name; and/or (ii) a domain of a Loyalty Program offered by a Shipper whose values can include any data representing the Loyalty Program which can include without limitation: (1) the name of the Loyalty Program, e.g., Shipper XYZ Rewards Program; and/or (2) an identifier of the Loyalty Program other than the name; and/or
(m) attributes in a Customer domain, which can include without limitation: (i) an individual; (ii) a small business with a value equal to or less than the Offer Condition Attribute Value associated with the Offer Condition Attribute limiting the Offer to a class of Users which are small businesses, e.g., an Offer can include an Offer Condition Attribute limiting the Offer to a class of Users which are businesses with 500 or fewer employees; (iii) a large business with a value equal to or more than the Offer Condition Attribute Value associated with the Offer Condition Attribute limiting the Offer to a class of Users which are large businesses, e.g., an Offer can include an Offer Condition Attribute limiting the Offer to a class of Users which are businesses with $100 million or more in revenues; (iv) a nonprofit or charitable party with a value equal to an Offer Condition Attribute Value associated with the Offer Condition Attribute limiting the Offer to a class of Users which are nonprofit or charitable parties, e.g., an Offer can include an Offer Condition Attribute limiting the Offer to a class of Users which meet the one or more conditions specified in United States Internal Revenue Code Section 501(c)(3); (v) a government party with a value equal to an Offer Condition Attribute Value associated with the Offer Condition Attribute limiting the Offer to a class of Users which are governmental parties; and/or (vi) a group of customers, of which each class of customer can include without limitation individuals, small businesses, large businesses, nonprofit or charitable parties, and/or governmental parties, with a value less than, equal to, or greater than an Offer Condition customers which have a minimum, specified, or maximum Offer Condition Attribute Value, e.g., an Offer can include an Offer Condition Attribute limiting the Offer to a group of customers where the number of individual customers is at least 500.

User Fund Account means a Fund Account held by a User and/or a User of Client Device 02100. User Fund Account can include without limitation: a Fund Account associated with a credit card, debit card, and/or charge card and held by the User administered by a Payment Issuer Server 02800; a Checking Account; a Cash Account; a Non-Cash Account; a Pass-Through Account, e.g., a Fund Account administered by a first Bank which can access funds stored in a second or other Bank); a Stored Value Account; an Electronic Benefits Transfer Account; a Non-Tax-Favored Savings Account; a Tax-Favored Savings Account like an IRA, FSA, or HSA; a Money Fund Account; an Employer Payroll Account; a Loan Account; and/or an Insurance Policy from which the User can withdraw funds as cash or in the form of a Loan. A User Fund Account can transmit one or more Withdrawal Amounts in a Transaction and/or receive one or more Deposit Amounts in a Transaction. For example, in a Transaction in which a first Qualifying Offer is in the form of points, miles, kilometers, and/or credits offered to the User and a second Qualifying Offer is in the form of cash offered to the User for selecting a Payment Method to pay for a Transaction, one or more embodiment of the invention can deposit the Deposit Amount comprising the specified points, miles, kilometers, and/or credits into a User Fund Account, e.g., a Non-Cash Account and withdraw the Withdrawal Amount from a User Fund Account, e.g., a Checking Account. A User Fund Account can include a Fund Account held by any party including without limitation: (a) an individual, e.g., a Fund Account associated with a credit card, debit card, and/or charge card held by an individual; and/or (b) a party other than an individual including without limitation: (i) a business, e.g., a Loan Account held by a business in the form of a credit line; (ii) a government, e.g., a Checking Account held by the United States Department of the Treasury; and/or (iii) a non-profit organization, e.g., a Non-Tax-Favored Savings Account held by an organization storing its cash.

A User Fund Account can qualify for withdrawal from and/or deposit to in a Transaction based on whether: (a) the qualification depends on one or more values in Transaction Attribute Value Set 06700 (“TAV-Dependent User Fund Account”); or (b) the qualification does not depend on any values in Transaction Attribute Value Set 06700 (“TAV-Independent User Fund Account”). In one example, if Transaction Attribute Value Set 06700 includes a value of an attribute which matches the value or is equal to one value in the set of values associated with an equal or equivalent User Fund Account Attribute and the User Fund Account qualifies for a withdrawal from and/or deposit to in a Transaction, the User Fund Account is a TAV-Dependent User Fund Account. In a first example, a Payroll Account can be a TAV-Independent User Fund Account if one or more embodiments of the invention can withdraw funds from and/or deposit funds to the Payroll Account independent of any values in Transaction Attribute Value Set 06700. In the example, withdrawal from the Payroll Account does not depend on the User, the User Class, the Retailer, the Producer, and/or the Product. In a second example, a FSA Account can be a TAV-Dependent User Fund Account if one or more embodiments of the invention can withdraw funds from and/or deposit funds to the FSA Account only if the value of each Transaction Attribute Value matches the value or is equal to one value in the set of values associated with every equal or equivalent User Fund Account.

User Identifier means any identifier which uniquely identifies a User within one classification system. User Identifier can identify a User as a member of a User Class. The classification systems can include without limitation: (a) an identifier whose format is determined by a standard, which can include without limitation: (i) an identifier associated with a Payment Method, e.g., an account number associated with a Payment Method issued by a Payment Issuer; (ii) an identifier uniquely identifying a Taxpayer, e.g., a Social Security Identification Number (“SSIN”) or the FEIN; and/or (iii) an identifier uniquely identifying a User in a Product Class, e.g., an identifier specified by Medicare uniquely identifying a User enabling the User to access Medicare services (“HICN”), an identifier specified by a European Health Insurance Card uniquely identifying a User enabling the User to access healthcare services during a temporary stay throughout the European Union, or an identifier uniquely identifying each individual patient in the United States whose development was authorized by the HIPAA; and/or (b) an identifier whose format is determined and used by the party assigning the identifier, e.g., a Retailer issuing a loyalty membership to a customer and assigning an identifier uniquely identifying the customer or an Insurer selling a Health Insurance Product to a customer and assigning an identifier uniquely identifying the customer. One or more embodiments of the invention can generate a universal identifier which can uniquely identify a User purchasing or using one or more Products within one classification system and map the universal identifier to a User Identifier assigned in each of one or more other classification systems (“Universal User Identifier”).

Warranty means a guarantee by any party, e.g., a Producer, Retailer, or a party other than a Producer or Retailer, to the party purchasing a Product that the Product or another Product will meet a specified quality and that the party issuing the Warranty will compensate the purchaser if the Product or another Product fails to meet the specified quality, e.g., by repairing the Product, replacing the Product, or refunding part or all of the price paid for the Product.

### Data Processing System

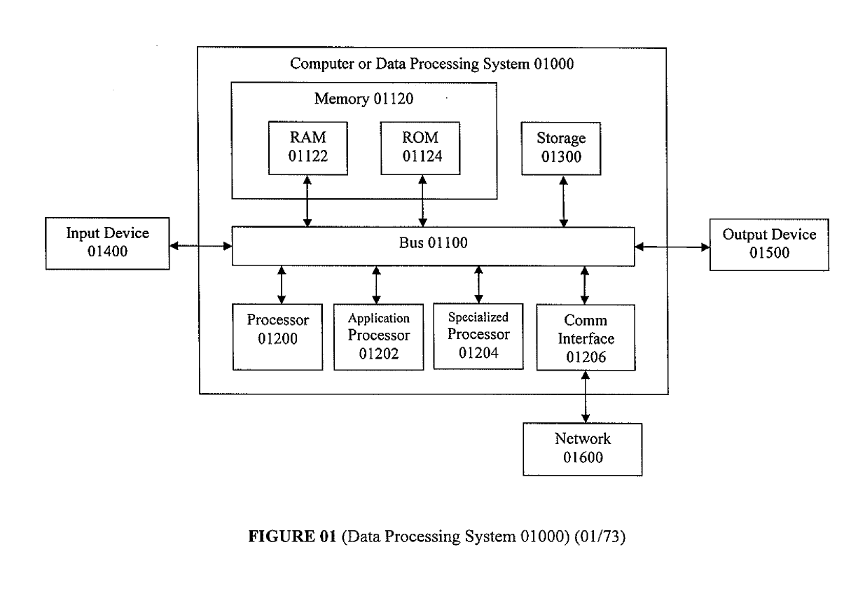

FIG. 01 depicts a block diagram of an exemplary Data Processing System 01000 that can be used to implement the entities described herein. Any number and/or type of data processing systems can implement the entities described herein and the configuration actually used depends on the specific implementation.

Data Processing System 01000 can be any class of device which can process data and/or instructions including without limitation: a personal computer, a portable computer, a tablet computer, a hand-held computer, a personal digital assistant, a set-top box (“STB”), a portable media device, a videogame player, a wireless device (which can include, but is not limited to, a wireless phone with access to a data network, e.g., the Internet, and/or a wireless phone without access to a data network, e.g., the Internet), a “smart card”, a server, a workstation, a mainframe computer, and/or any other type of device (which can include without limitation, a device located in a home, a motor vehicle, an office, a factory, and/or any other location). The type of data processing system used to implement the entities described herein depends on the specific implementation.

Data Processing System 01000 can exchange data and/or instructions with one or more other devices utilizing any protocol over any network including without limitation: Hypertext Transport Protocol (“HTTP”), File Transport Protocol (“FTP”), Simple Mail Transport Protocol (“SMTP”), Post Office Protocol (“POP”), and/or Internet Mail Access Protocol (“IMAP”) over a network, e.g., the Internet.

Data Processing System 01000 can comprise one or more components including without limitation: (a) a communications medium, wireline and/or wireless (e.g., a Bus 01100), or any other means of transmitting and/or receiving data and/or instructions among components; (b) a general- or special-purpose Processor 01200 or any other means of processing data and/or instructions; (c) a RAM Device 01122 coupled to Bus 01100 capable of storing data and/or instructions executed by Processor 01200, temporary variables, and/or other intermediate data during the execution of instructions by Processor 01200; (d) a ROM Device 01124 coupled to Bus 01100 capable of storing data and/or instructions executed by Processor 01200; (e) a Mass Storage Device 01300 (which can be a non-removable device or a removable device, each of which can include without limitation: a hard disk drive, a flash drive, a floppy disk drive, a compact disc drive, a tape drive, a magneto-optical disc drive, or a chip, e.g., a chip as part of a Subscriber Identity Module (“SIM”) card) coupled to Bus 01100 or Data Processing System 01000 capable of storing data and/or instructions executed by Processor 01200; (f) an Input Device 01400 capable of enabling the input in one or more forms any data and/or instructions, which can include without limitation: a microphone, a keyboard, a pointer, a touch-sensitive display, a camera, a scanner, a receive antenna, e.g., an near-field communications (“NFC”) antenna, and/or any other input device; (g) Output Device 01500 capable of outputting in one or more forms any data and/or instructions, which can include without limitation: a display, a speaker, a transmit antenna, e.g., an NFC antenna, and/or any other output device; and/or (h) a Communications Interface 01206 coupled to Bus 01100 or Data Processing System 01000 capable of transmitting data to and/or receiving data from other Data Processing Systems through any type of wireline and/or wireless network, Network 01600, including without limitation: a contactless network, e.g., NFC, a personal area network (“PAN”), a local area network (“LAN”), a metropolitan area network (“MAN”), and/or a wide area network (“WAN”), e.g., the Internet.

Processor 01200 can reside at a single physical location or be distributed across a plurality of physical locations, e.g., on one client and one server. The following components can include any device coupled to Bus 01100 capable of storing data and/or instructions executed by Processor 01200 including without limitation: RAM Device 01122, ROM Device 01124, Mass Storage Device 01300, a data cache, a data object, and/or any other type of short-, medium-, or long-term storage device (“Data Storage Device”). A Data Storage Device can reside at a single physical location or be distributed across a plurality of physical locations.

Communications Interface 01206 can include a modem, a network interface card, and/or any other device capable of coupling Data Processing System 01000 to any Network 01600. Communications Interface 01206 can include an antenna enabling wireless communication utilizing any wireless protocol with any Network 01600. The application defines an Antenna to include any of the components necessary to transmit and/or receive an electromagnetic field, e.g., a radio signal. Such components can include not only a physical material capable of conducting such a signal, but also any component which can execute any function needed to process such signal including without limitation: modulation, demodulation, spreading, despreading, analog-to-digital conversion (“ADC”), digital-to-analog conversion (“DAC”), compression, decompression, upconversion, and/or downconversion. Network 01600 can enable communication through wired, wireless, or combination of wired and wireless signals.

Data Processing System 01000 can implement any or all of the steps of the methods described herein through programmable logic, hard-wired logic, any combination of programmable and hard-wired logic, and/or any other type of logic. Control logic or software may be stored in a Data Storage Device and/or computer program products. In one embodiment, Data Processing System 01000 can have one or more Processors 01200 execute one or more instructions stored in RAM 01122. RAM 01122 can retrieve the instructions from any other Computer-Readable Medium, e.g., Mass Storage 01300. In another embodiment, Data Processing System 01000 can have one or more Processors 01200 execute one or more instructions that are predefined or hard-wired. In another embodiment, Data Processing System 01000 can have one or more Processors 01200 execute one or more instructions utilizing a combination of programmable and hard-wired logic.

The instructions can include code from any computer-programming language and/or scripts including without limitation: C, C++, Basic, Java, JavaScript, Pascal, Perl, Smalitalk, Structured Query Language (“SQL”), VBScript, and/or Visual Basic.

In one embodiment, the steps in any of the methods disclosed herein can be embodied in machine-executable instructions. The methods can process instructions using one or more techniques including without limitation: utilizing one or more general-purpose Processors 01200 or special-purpose Application Processors 01202 or Specialized Processors 01204 programmed with the instructions to execute the steps in any of the methods described herein, equivalent or related steps, other or additional steps, or any subset thereof; utilizing one or more hardware components that contain hardwired logic to execute the steps in any of the methods described herein, equivalent or related steps, other or additional steps, or any subset thereof; or utilizing any combination of programmed processors and/or hardware components to execute the steps in any of the methods described herein, equivalent or related steps, other or additional steps, or any subset thereof. The software can execute on any type of hardware located at one party or distributed among a plurality of parties.

The application describes the illustrated logical blocks, devices, components, modules, routines, and steps in methods in terms of their functionality and/or capability. One or more embodiments of the invention can implement the illustrated logical blocks, devices, components, modules, routines, and steps in methods as hardware, firmware, software, or any combination thereof, depending on the particular design and application.

The functionality described herein can be distributed and/or downloaded as a CPP, which can be stored on a Computer-Readable Medium. Methods described herein can be distributed from a remote computer, e.g., a server, to another computer, e.g., a client, through any wired and/or wireless channel over a network, e.g., the Internet.

### Overall System

FIG. 02A depicts a block diagram of an exemplary apparatus (e.g., a distributed apparatus performing distributed computing), Apparatus 02000A, enabling the exchange and processing of data to determine which product meets a party's needs among at least one of each of a Client Device 02100, an Exchange Server 02200, and a Retailer Server 02300, according to one embodiment. The apparatus can implement the entities described herein by utilizing a subset of the following components, any combination of the components, or additional, related, alternative, and/or equivalent components disclosed in the application. The apparatus can include without limitation the components disclosed earlier and the following new components.

Client Device 02100 is a Data Processing System 01000 which can execute one or more of the following functions including without limitation: (a) receiving from one or more Data Processing Systems 01000 data and/or instructions; (b) receiving from the User of Client Device 02100 data and/or instructions; (c) storing the data and/or instructions; (d) processing the data according to either received and/or stored instructions; (e) outputting the data in any form including without limitation: text, audio, image, video, or any combination thereof; or (f) transmitting to one or more Data Processing Systems 01000 data and/or instructions. Client Device 02100 can exchange data and/or instructions with one or more Data Processing Systems 01000 through a wireless network and/or a wireline network. Client Device 02100 can be without limitation: (a) a desktop computer; (b) a portable computer; (c) a tablet computer; (d) a wireless phone; (e) a wireline phone; (f) a television; (g) a radio; (h) an appliance; (i) an automobile; (j) a component of an automobile; or (k) any Data Processing System 01000 which can execute one or more functions of one or more of the prior devices. Client Device 02100 can be a Data Processing System 01000 associated with: (a) a single account, address, or other identifier uniquely identifying a User of Client Device 02100; or (b) a plurality of accounts, addresses, or other identifiers, each of which can uniquely identify a plurality of Users of Client Device 02100, e.g., a wireless phone which can support a plurality of SIM cards, each of which can uniquely identify a separate User of Client Device 02100. Client Device 02100 can be used by a User who is an individual consumer of the Product or a non-individual, e.g., a business, government, or non-profit entity, using the Product as part of another Product and/or distributing the Product to a consumer.

Exchange Server 02200 is a Data Processing System 01000 which can execute one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Exchange Server 02200 can exchange data and/or instructions with one or more Data Processing Systems 01000 through a wireless network and/or a wireline network. In a first embodiment, Exchange Server 02200 can be a single Data Processing System 01000. In a second embodiment, Exchange Server 02200 can be a plurality of Data Processing Systems 01000 across which Exchange Server 02200 distributes a plurality of functions. In a third embodiment, Exchange Server 02200 can be one or more clusters, each of which contain one or more Data Processing Systems 01000, across the clusters of which Exchange Server distributes a plurality of functions. In a fourth embodiment, Exchange Server 02200 can distribute a plurality of functions in a grid or cloud computing environment. In a fifth embodiment, Exchange Server 02200 can execute one or more functions statically on a given Data Processing System 01000. In a sixth environment Exchange Server 02200 can execute one or more functions dynamically among a plurality of Data Processing Systems 01000 depending on the benefits and the costs of executing a function on any given Data Processing System 01000 at any given time.

Retailer Server 02300 is a Data Processing System 01000 which can execute for a Retailer one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Retailer Server 02300 can exchange data and/or instructions with one or more Data Processing Systems 01000 through a wireless network and/or a wireline network.

In one embodiment, Client Device 02100 can exchange data and/or instructions with Retailer Server 02300 indirectly through Exchange Server 02200.

FIG. 02B depicts a block diagram of an exemplary apparatus (e.g., a distributed apparatus performing distributed computing), Apparatus 02000B, enabling the exchange and processing of data to determine which product meets a party's needs among the components of Apparatus 02000A and one or more Producer Servers 02400, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Producer Server 02400 is a Data Processing System 01000 which can execute for a Producer one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Producer Server 02400 can exchange data and/or instructions with one or more Data Processing Systems 01000 through a wireless network and/or a wireline network.

In one embodiment, Client Device 02100 can exchange data and/or instructions with Producer Server 02400 indirectly through Exchange Server 02200.

FIG. 02C depicts a block diagram of an exemplary apparatus (e.g., a distributed apparatus performing distributed computing), Apparatus 02000C, enabling the exchange and processing of data to determine which product meets a party's needs among the components of Apparatus 02000B and one or more Product Evaluation Servers 02500, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Product Evaluation Server 02500 is a Data Processing System 01000 which can execute one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Product Evaluation Server 02500 can exchange data and/or instructions with one or more Data Processing Systems 01000 through a wireless network and/or a wireline network.

In one embodiment, Client Device 02100 can exchange data and/or instructions with Product Evaluation Server 02500 indirectly through Exchange Server 02200.

Product Evaluation Server 02500 can execute functions for a party which evaluates one or more Products and whose evaluation of Products can be viewed by a Client Device 02100. Product Evaluation Server 02500 can generate data enabling a User to decide whether to purchase a Product of Interest.

FIG. 02D depicts a block diagram of an exemplary apparatus (e.g., a distributed apparatus performing distributed computing), Apparatus 02000D, enabling the exchange and processing of data, including data received, stored, processed, and/or transmitted by Product Sensor 02600, to determine which product meets a party's needs among the components of Apparatus 02000C and one or more Product Sensors 02600, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Product Sensor 02600 can execute one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Product Sensor 02600 can exchange data and/or instructions with one or more Data Processing Systems 01000 through a wireless network and/or a wireline network.

In one embodiment, Client Device 02100 can exchange data and/or instructions directly with Product Sensor 02600 or indirectly through Exchange Server 02200.

Product Sensor 02600 can receive, detect, collect, generate, measure, store, process, and/or transmit any data associated with a Product and/or execute any function associated with the Product. Product Sensor 02600 can receive, detect, collect, generate, measure, store, process, and/or transmit the value of one or more attributes of: (a) a Product; and/or (b) a first Product associated with a second or additional Product.

In a first example of a Product which is a good, Product Sensor 02600 connected to a Product which is a good, e.g., an automobile, can detect the remaining quantity of the Product which is a good, e.g., the gasoline remaining in an automobile tank, and transmit to a Data Processing System 01000, e.g., Retailer Server 02300 offering a Product of Interest, e.g., gasoline, data determining if the quantity of gasoline meets a predefined value.

In a second example of a Product which is a good, Product Sensor 02600 connected to a Product which is a good, e.g., a tire, can measure the condition of the Product, e.g., the depth of a tread on a tire, and transmit to a Data Processing System 01000, e.g., a Retailer Server 02300 offering a Product of Interest, e.g., a tire, data determining if the depth of a tread meets a predefined value.

In a third example of a Product which is a service, Product Sensor 02600 connected to a first Product which is a good, e.g., a blood pressure monitor, can detect the blood pressure level and transmit the data to a Data Processing System 01000, e.g., a Producer Server 02400 offering a second Product, i.e., a Product of Interest, which is a service, e.g., health care for the User, which can determine if the blood pressure level exceeds a predefined threshold over a predefined period to determine whether to offer the User a third Product, i.e., a Product of Interest, which is a good, e.g., an angiotensin-converting enzyme inhibitor or a calcium channel blocker.

In a fourth example of a Product which is a service, Product Sensor 02600 connected to a first Product which is a good, e.g., an automobile, can detect the velocity of the automobile and transmit the velocity and the position of the automobile to a Data Processing System 01000, e.g., an Insurer Server 02700 offering a second Product, i.e., a Product of Interest, which is a service, e.g., automobile insurance for the owner of the automobile, which can map the position of the automobile with the speed limit applicable to the position to determine a risk factor associated with the User of the automobile to enable pricing of the second Product, e.g., automobile insurance.

In a fifth example of a Product which is a good, Product Sensor 02600 can be and/or include a CPP which can automatically: (a) read any data stored in a Data Structure on a Data Processing System 01000; (b) detect any create, delete, and/or update operations on the Data Structure; and/or (c) execute one or more create, delete, and/or update operations on the Data Structure to write the value of each of one or more attributes in a Data Structure (collectively “CPP Operations”). In one embodiment, the invention can store in a Data Storage Device (defined herein) of a good, e.g., a washer, the Product Sensor 02600 including a CPP, e.g., Database Program 16110, to execute CPP Operations. For example, Product Sensor 02600 can detect any value stored in the Data Structure of the washer, e.g., the number of spin cycles executed without error, and transmit the data to a Data Processing System 01000, e.g., Exchange Server 02200, to determine whether the Product performed in accordance with a Warranty.

In a sixth example of a Product which is a service, Product Sensor 02600 can be and/or include a CPP which can automatically execute CPP Operations. In one embodiment, the invention can store in a database server storing a Data Structure associated with a Producer Server 02400 producing a service, e.g., constructing or repairing a highway, the Product Sensor 02600 including a CPP, e.g., Database Program 16110, to execute CPP Operations. For example, Product Sensor 02600 can detect any value stored in the Data Structure of the Producer Server 02400, e.g., the value associated with the wages attribute, and transmit the data to a Data Processing System 01000, e.g., Regulatory Agency Server 05100, to determine whether the Producer is paying wages in compliance with one or more minimum wage and/or prevailing wage regulations.

FIG. 02E depicts a block diagram of an exemplary apparatus (e.g., a distributed apparatus performing distributed computing), Apparatus 02000E, enabling the exchange and processing of data to determine which product meets a party's needs among the components of Apparatus 02000D and one or more Retailer Servers 02301, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Retailer Server 02301 can execute one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Retailer Server 02301 can exchange data and/or instructions with one or more Data Processing Systems 01000 through a wireless network and/or a wireline network.

In one embodiment, Client Device 02100 can exchange data and/or instructions directly with Retailer Server 02301 or indirectly through Exchange Server 02200.

Retailer Server 02301 is a class of Retailer Server 02300 which can execute functions for a Retailer that sells Products which a User of a Product of Interest can consume after the purchase of the Product of Interest. That is, after purchasing a Product of Interest, a User can consume one or more goods and/or services associated with the Product of Interest. For example, after purchasing an automobile, a User can consume a good, e.g., a new headlight replacing a defective original headlight, or a service, e.g., labor to rotate the tires.

FIG. 02F depicts a block diagram of an exemplary apparatus (e.g., a distributed apparatus performing distributed computing), Apparatus 02000F, enabling the exchange and processing of data to determine which product meets a party's needs among the components of Apparatus 02000E and one or more Insurer Servers 02700, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Insurer Server 02700 can execute for an Insurer one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Insurer Server 02700 can exchange data and/or instructions with one or more Data Processing Systems 01000 through a wireless network and/or a wireline network.

In one embodiment, Client Device 02100 can exchange data and/or instructions directly with Insurer Server 02700 or indirectly through Exchange Server 02200.

FIG. 02G depicts a block diagram of an exemplary apparatus (e.g., a distributed apparatus performing distributed computing), Apparatus 02000G, enabling the exchange and processing of data to determine which product meets a party's needs among the components of Apparatus 02000F and one or more Payment Issuer Servers 02800, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Payment Issuer Server 02800 can execute for a Payment Issuer one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Payment Issuer Server 02800 can exchange data and/or instructions with one or more Data Processing Systems 01000 through a wireless network and/or a wireline network.

In one embodiment, Client Device 02100 can exchange data and/or instructions directly with Payment Issuer Server 02800 or indirectly through Exchange Server 02200.

FIG. 02H depicts a block diagram of an exemplary apparatus (e.g., a distributed apparatus performing distributed computing), Apparatus 02000H, enabling the exchange and processing of data to determine which product meets a party's needs among the components of Apparatus 02000G and one or more Tax Servers 02900, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Tax Server 02900 can execute for a Tax Authority one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Tax Server 02900 can exchange data and/or instructions with one or more Data Processing Systems 01000 through a wireless network and/or a wireline network.

In one embodiment, Client Device 02100 can exchange data and/or instructions directly with Tax Server 02900 or indirectly through Exchange Server 02200.

In one embodiment, Tax Server 02900 can execute for a Tax Authority: (a) the receiving from one or more Data Processing Systems 01000 data and/or instructions authorizing the receiving of funds from or crediting a liability, e.g., an increase in Tax Liability, to a User Fund Account held by a User purchasing a Product of Interest; (b) the receiving from one or more Data Processing Systems 01000, e.g., a Bank or non-Bank administering the User Fund Account, the funds owed to the Tax Authority associated with a Transaction, e.g., a sales tax levied against the purchase and/or use of a Product of Interest; (c) the receiving from one or more Data Processing Systems 01000 data and/or instructions authorizing the transfer of funds to or debiting an asset, e.g., a decrease in Tax Liability, to the User Fund Account held by a User purchasing a Product of Interest; and/or (d) the transfer to one or more Data Processing System 01000, e.g., a Bank or non-Bank administering the User Fund Account, the funds owed to the User purchasing a Product of Interest qualifying for a decrease in Taxable Income or Tax Liability.

FIG. 03A depicts a block diagram of an exemplary apparatus (e.g., a distributed apparatus performing distributed computing), Apparatus 03000A, enabling the exchange and processing of data to identify one or more Qualifying Offers among at least one of each of a Client Device 02100, an Exchange Server 02200, and a Retailer Server 02300, according to one embodiment. The apparatus can implement the entities described herein by utilizing a subset of the preceding components, any combination of the components, or additional, related, alternative, and/or equivalent components disclosed in the application.

FIG. 03B depicts a block diagram of an exemplary apparatus (e.g., a distributed apparatus performing distributed computing), Apparatus 03000B, enabling the exchange and processing of data to identify one or more Qualifying Offers among the components of Apparatus 03000A and one or more Producer Servers 02400, according to one embodiment. The apparatus can implement the entities described herein by utilizing a subset of the preceding components, any combination of the components, or additional, related, alternative, and/or equivalent components disclosed in the application.

FIG. 03C depicts a block diagram of an exemplary apparatus (e.g., a distributed apparatus performing distributed computing), Apparatus 03000C, enabling the exchange and processing of data to identify one or more Qualifying Offers among the components of Apparatus 03000B and one or more Payment Issuer Servers 02800, according to one embodiment. The apparatus can implement the entities described herein by utilizing a subset of the preceding components, any combination of the components, or additional, related, alternative, and/or equivalent components disclosed in the application.

FIG. 03D depicts a block diagram of an exemplary apparatus (e.g., a distributed apparatus performing distributed computing), Apparatus 03000D, enabling the exchange and processing of data to identify one or more Qualifying Offers among the components of Apparatus 03000C and one or more Affinity Servers 03100, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Affinity Server 03100 can execute for an Affinity Party one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Affinity Server 03100 can exchange data and/or instructions with one or more Data Processing Systems 01000 through a wireless network and/or a wireline network.

In one embodiment, Client Device 02100 can exchange data and/or instructions directly with Affinity Server 03100 or indirectly through Exchange Server 02200.

FIG. 03E depicts a block diagram of an exemplary apparatus (e.g., a distributed apparatus performing distributed computing), Apparatus 03000E, enabling the exchange and processing of data to identify one or more Qualifying Offers among the components of Apparatus 03000D and one or more Insurance Servers 02700, according to one embodiment. The apparatus can implement the entities described herein by utilizing a subset of the preceding components, any combination of the components, or additional, related, alternative, and/or equivalent components disclosed in the application.

FIG. 03F depicts a block diagram of an exemplary apparatus (e.g., a distributed apparatus performing distributed computing), Apparatus 03000F, enabling the exchange and processing of data to identify one or more Qualifying Offers among the components of Apparatus 03000E and one or more Employer Servers 03200, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Employer Server 03200 can execute for an Employer one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Employer Server 03200 can exchange data and/or instructions with one or more Data Processing Systems 01000 through a wireless network and/or a wireline network.

In one embodiment, Client Device 02100 can exchange data and/or instructions directly with Employer Server 03200 or indirectly through Exchange Server 02200.

FIG. 03G depicts a block diagram of an exemplary apparatus (e.g., a distributed apparatus performing distributed computing), Apparatus 03000G, enabling the exchange and processing of data to identify one or more Qualifying Offers among the components of Apparatus 03000F and one or more Sales Tax Servers 02910, one or more Income Tax Servers 02920, and/or one or more Property Tax Servers 02930, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Sales Tax Server 02910 can execute for a Tax Authority one or more of the following functions including without limitation: (a) receiving from one or more Data Processing Systems 01000 data and/or instructions associated with a sales tax; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Sales Tax Server 02910 can exchange data and/or instructions with one or more Data Processing Systems 01000 through a wireless network and/or a wireline network.

In one embodiment, Client Device 02100 can exchange data and/or instructions directly with Sales Tax Server 02910 or indirectly through Exchange Server 02200.

While Sales Tax Server 02910 refers to a sales tax, the invention is not limited to that embodiment. One or more embodiments of the invention can support a Sales Tax Server 02910 to execute any of the functions described herein related to any class of tax on a Transaction, including without limitation: a sales tax, a receipts tax, a value-added tax, and/or a consumption tax. Sales Tax Server 02910 can execute any of the functions described herein at any level of production, distribution, and/or sale, including without limitation: a tax on a transfer between parties of raw materials, a tax on the transfer between parties of intermediate goods, a tax on the transfer between parties of finished goods, a tax on the distribution of goods and/or services, and/or a tax on the final sale of goods and/or services.

Income Tax Server 02920 can execute for a Tax Authority one or more of the following functions including without limitation: (a) receiving from one or more Data Processing Systems 01000 data and/or instructions associated with an income tax; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Income Tax Server 02920 can exchange data and/or instructions with one or more Data Processing Systems 01000 through a wireless network and/or a wireline network.

In one embodiment, Client Device 02100 can exchange data and/or instructions directly with Income Tax Server 02920 or indirectly through Exchange Server 02200.

Property Tax Server 02930 can execute for a Tax Authority one or more of the following functions including without limitation: (a) receiving from one or more Data Processing Systems 01000 data and/or instructions associated with a property tax; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Property Tax Server 02930 can exchange data and/or instructions with one or more Data Processing Systems 01000 through a wireless network and/or a wireline network.

In one embodiment, Client Device 02100 can exchange data and/or instructions directly with Property Tax Server 02930 or indirectly through Exchange Server 02200.

FIG. 03H depicts a block diagram of an exemplary apparatus (e.g., a distributed apparatus performing distributed computing), Apparatus 03000H, enabling the exchange and processing of data to identify one or more Qualifying Offers among the components of Apparatus 03000G and one or more Government Benefit Servers 03300, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Government Benefit Server 03300 can execute for a Government Benefit Authority one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Government Benefit Server 03300 can exchange data and/or instructions with one or more Data Processing Systems 01000 through a wireless network and/or a wireline network.

In one embodiment, Client Device 02100 can exchange data and/or instructions directly with Government Benefit Server 03300 or indirectly through Exchange Server 02200.

FIG. 03I depicts a block diagram of an exemplary apparatus (e.g., a distributed apparatus performing distributed computing), Apparatus 03000I, enabling the exchange and processing of data to identify one or more Qualifying Offers among the components of Apparatus 03000H and one or more Shipper Servers 03400, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Shipper Server 03400 can execute for a Shipper one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Shipper Server 03400 can exchange data and/or instructions with one or more Data Processing Systems 01000 through a wireless network and/or a wireline network.

In one embodiment, Client Device 02100 can exchange data and/or instructions directly with Shipper Server 03400 or indirectly through Exchange Server 02200.

FIG. 03J depicts a block diagram of an exemplary apparatus (e.g., a distributed apparatus performing distributed computing), Apparatus 03000J, enabling the exchange and processing of data to identify one or more Qualifying Offers among the components of Apparatus 03000I and one or more Distributor Servers 03500, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Distributor Server 03500 can execute for a Distributor one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Distributor Server 03500 can exchange data and/or instructions with one or more Data Processing Systems 01000 through a wireless network and/or a wireline network.

In one embodiment, Client Device 02100 can exchange data and/or instructions directly with Distributor Server 03500 or indirectly through Exchange Server 02200.

FIG. 03K depicts a block diagram of an exemplary apparatus (e.g., a distributed apparatus performing distributed computing), Apparatus 03000K, enabling the exchange and processing of data to identify one or more Qualifying Offers among the components of Apparatus 03000J and one or more Component Servers 03600, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Component Server 03600 can execute for a Component Vendor one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Component Server 03600 can exchange data and/or instructions with one or more Data Processing Systems 01000 through a wireless network and/or a wireline network.

In one embodiment, Client Device 02100 can exchange data and/or instructions directly with Component Server 03600 or indirectly through Exchange Server 02200.

FIG. 04A depicts a block diagram of an exemplary apparatus (e.g., a distributed apparatus performing distributed computing), Apparatus 04000A, enabling the exchange and processing of data to execute a purchase of a Product of Interest among at least one of each of a Client Device 02100, an Exchange Server 02200, a Retailer Server 02300, a Producer Server 02400, a Payment Issuer Server 02800, an Acquirer Server 02811, a Payment Network Server 02820, and a Retailer Bank Server 02830, according to one embodiment. The apparatus can implement the entities described herein by utilizing a subset of the preceding and following components, any combination of the components, or additional, related, alternative, and/or equivalent components disclosed in the application.

Apparatus 04000A illustrates an exemplary apparatus enabling the execution of one or more functions by a Payment Network, e.g., a Card Association. The apparatus can include without limitation the components disclosed earlier and the following new components.

Acquirer Server 02811 can execute for an Acquirer one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Acquirer Server 02811 can exchange data and/or instructions with one or more Data Processing Systems 01000 through a wireless network and/or a wireline network.

In one embodiment, Client Device 02100 can exchange data and/or instructions directly with Acquirer Server 02811 or indirectly through Exchange Server 02200.

Payment Network Server 02820 can execute for a Payment Network one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereat or (e) transmitting to one or more Data Processing Systems 01000 data and/or instructions. Payment Network Server 02820 can exchange data and/or instructions with one or more Data Processing Systems 01000 through a wireless network and/or a wireline network.

In one embodiment, Client Device 02100 can exchange data and/or instructions directly with Payment Network Server 02820 or indirectly through Exchange Server 02200.

Retailer Bank Server 02830 can execute for a Retailer Bank one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Retailer Bank Server 02830 can exchange data and/or instructions with one or more Data Processing Systems 01000 through a wireless network and/or a wireline network.

In one embodiment, Client Device 02100 can exchange data and/or instructions directly with Retailer Bank Server 02830 or indirectly through Exchange Server 02200.

In Apparatus 04000A, Retailer Server 02300 typically transmits an Authorization Request to Acquirer Server 02810, which can enable the Authentication, Authorization, Clearing, and Settlement of Transactions for one or more Retailer Servers 02300. Acquirer Server 02810 typically transmits the Authorization Request to Payment Network Server 02820, which can enable the Authentication, Authorization, Clearing, and Settlement of Transactions between a plurality of Retailer Servers 02300 and a plurality of Payment Issuer Servers 02800. Payment Network Server 02820 typically transmits the Authorization Request to the Payment Issuer Server 02800 managing the Payment Account issued to the customer associated with Client Device 02100 purchasing the Product of Interest from Retailer Server 02300. Payment Issuer Server 02800 typically transmits an Authorization Response authorizing the purchase through Payment Network Server 02820 to Acquirer Server 02810, which in turn transmits the Authorization Response to Retailer Server 02300. After the authorization of the purchase, Payment Network Server 02820 clears and settles a Transaction, typically along with other Transactions, between the Payment Issuer Server 02800, which in turn decreases the User Fund Account held by the customer purchasing the Product of Interest by the price of the Product of Interest, and the Retailer Bank Server 02830, which in turn increases the Retailer Fund Account held by Retailer Server 02300 by the price of the Product of Interest.

FIG. 04B depicts a block diagram of an exemplary apparatus (e.g., a distributed apparatus performing distributed computing), Apparatus 04000B, enabling the exchange and processing of data to execute a purchase of a Product of Interest and/or process one or more Qualifying Offers among at least one of each of a Client Device 02100, an Exchange Server 02200, a Retailer Server 02300, a Producer Server 02400, a Payment Issuer Server 02800, a Retailer Bank Server 02830, and a Producer Bank Server 02840, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Producer Bank Server 02840 can execute for a Producer Bank one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Producer Bank Server 02840 can exchange data and/or instructions with one or more Data Processing Systems 01000 through a wireless network and/or a wireline network.

In one embodiment, Client Device 02100 can exchange data and/or instructions directly with Producer Bank Server 02840 or indirectly through Exchange Server 02200.

Currently, different systems process a plurality of data associated with the purchase of a Product of Interest. A Card Association can enable the processing of data to Authenticate, Authorize, Clear, and Settle a Transaction. If a User wants to redeem one or more Offers associated with a Transaction, the User and/or Retailer must utilize systems other than the Card Association to redeem the Offers. In a first example, a Retailer must utilize a different system to redeem a Producer coupon. In a second example, a User must utilize a different system to process a claim against an Insurer covering part or all of the price of a Product of Interest.

Apparatus 04000B can enable the processing in a single network of one or more events associated with a Transaction (“Transaction Event”). A Transaction Event can include without limitation: (a) the Authorization by a party administering the User Fund Account, e.g., Payment Issuer Server 02800, of payment for a Transaction; (b) the transfer of funds from the accounts of one or more parties associated with a Transaction, e.g., a withdrawal of funds from the User Fund Account held by the User purchasing or using a Product of Interest and/or a deposit of funds to the Producer Fund Account held by the Producer of the Product of Interest purchased or used in a Transaction; (c) the transfer of funds to the accounts of one or more parties associated with a Transaction, e.g., a deposit of funds to the Retailer Fund Account held by the Retailer Server 02300 selling the Product of Interest; (d) the processing of any benefits, e.g., points earned, associated with a Transaction; (e) the writing of data associated with a Transaction to one or more Data Structures, e.g., the Retailer Transaction Data Structure, the Retailer Customer Data Structure, and/or the Insurer Transaction Data Structure; (f) the registration of a Transaction with one or more parties, e.g., Regulatory Agency Server 05100; and/or (g) the concurrent purchase and/or use of one or more products related to the Product of Interest, e.g., a good like a memory card with a phone or a service like a maintenance contract with an automobile.

Currently, one party, e.g., a Producer, typically makes an Offer to a User independently of one or more other parties, e.g., a Retailer. If a plurality of parties does coordinate their respective Offers, the parties typically do not customize the respective Offers for an individual User for the purchase of a given Product of Interest. A single network like Apparatus 04000B or Apparatus 04000C (described herein) can enable a plurality of parties to coordinate the generation of one or more Offers to the User for a given Product of Interest in a manner consistent with any antitrust rule.

In one exemplary case, a User can be interested in purchasing an automobile. However, the User cannot purchase and use the automobile without executing one or more events including without limitation: (a) purchasing financing, e.g., an automobile Loan, when the User does not pay in cash; (b) purchasing insurance, e.g., an automobile insurance policy; and/or (c) registering the automobile with a state. Moreover, the User may want to execute one or more other events including without limitation: (a) purchasing a warranty from the vendor of the automobile or the retailer selling the automobile; (b) purchasing a warranty or service contract for goods and/or services not covered by the vendor or retailer warranty, e.g., an emergency roadside assistance contract from an organization like the American Automobile Association (“AAA”); and/or (c) purchasing one or more goods not offered by the vendor of the automobile or the retailer selling the automobile, e.g., a satellite radio service. A single network like Apparatus 04000B or Apparatus 04000C can enable a plurality of parties to coordinate the generation of an Offer to the User for the automobile and one or more other goods and/or services related to the purchase and/or use of the automobile in a manner consistent with any antitrust rule.

FIG. 04C depicts a block diagram of an exemplary apparatus (e.g., a distributed apparatus performing distributed computing), Apparatus 04000C, enabling the exchange and processing of data to execute a purchase of a Product of Interest and/or process one or more Qualifying Offers among the components of Apparatus 04000B and one or more Other Bank Servers 02850, Insurer Servers 02700, Tax Servers 02900, Affinity Servers 03100, Employer Servers 03200, Government Benefit Servers 03300, and/or Shipper Servers 03400, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Other Bank Server 02850 can execute for any party other than a Payment Issuer, Retailer Bank, or Producer Bank one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Other Bank Server 02850 can exchange data and/or instructions with one or more Data Processing Systems 01000 through a wireless network and/or a wireline network.

In one embodiment, Client Device 02100 can exchange data and/or instructions directly with Other Bank Server 02850 or indirectly through Exchange Server 02200.

Other Bank Server 02850 can execute functions for any party other than a Payment Issuer, Retailer Bank, or Producer Bank, which can include without limitation, Insurer Server 02700, Tax Server 02900, Affinity Server 03100, Employer Server 03200, Government Benefit Server 03300, Shipper Server 03400, and/or any other server not illustrated in FIG. 04C.

FIG. 05A depicts a block diagram of an exemplary apparatus (e.g., a distributed apparatus performing distributed computing), Apparatus 05000A, enabling the exchange and processing of data to execute a purchase of a Product of Interest, process one or more Qualifying Offers, and/or execute any function related to the Product of Interest after purchase among at least one of each of a Client Device 02100, an Exchange Server 02200, a Retailer Server 02300, a Producer Server 02400, and/or a Payment Issuer Server 02800, according to one embodiment. The apparatus can implement the entities described herein by utilizing a subset of the preceding components, any combination of the components, or additional, related, alternative, and/or equivalent components disclosed in the application.

FIG. 05B depicts a block diagram of an exemplary apparatus (e.g., a distributed apparatus performing distributed computing), Apparatus 05000B, enabling the exchange and processing of data to execute a purchase of a Product of Interest, process one or more Qualifying Offers, and/or execute any function related to the Product of Interest after purchase among the components of Apparatus 05000A and one or more Affinity Servers 03100, according to one embodiment. The apparatus can implement the entities described herein by utilizing a subset of the preceding components, any combination of the components, or additional, related, alternative, and/or equivalent components disclosed in the application.

FIG. 05C depicts a block diagram of an exemplary apparatus (e.g., a distributed apparatus performing distributed computing), Apparatus 05000C, enabling the exchange and processing of data to execute a purchase of a Product of Interest, process one or more Qualifying Offers, and/or execute any function related to the Product of Interest after purchase among the components of Apparatus 05000B and one or more Insurer Servers 02700, according to one embodiment. The apparatus can implement the entities described herein by utilizing a subset of the preceding components, any combination of the components, or additional, related, alternative, and/or equivalent components disclosed in the application.

FIG. 05D depicts a block diagram of an exemplary apparatus (e.g., a distributed apparatus performing distributed computing), Apparatus 05000D, enabling the exchange and processing of data to execute a purchase of a Product of Interest, process one or more Qualifying Offers, and/or execute any function related to the Product of Interest after purchase among the components of Apparatus 05000C and one or more Employer Servers 03200, according to one embodiment. The apparatus can implement the entities described herein by utilizing a subset of the preceding components, any combination of the components, or additional, related, alternative, and/or equivalent components disclosed in the application.

FIG. 05E depicts a block diagram of an exemplary apparatus (e.g., a distributed apparatus performing distributed computing), Apparatus 05000E, enabling the exchange and processing of data to execute a purchase of a Product of Interest, process one or more Qualifying Offers, and/or execute any function related to the Product of Interest after purchase among the components of Apparatus 05000D and one or more Tax Servers 02900, Sales Tax Servers 02910, and/or Income Tax Servers 02920, according to one embodiment. The apparatus can implement the entities described herein by utilizing a subset of the preceding components, any combination of the components, or additional, related, alternative, and/or equivalent components disclosed in the application.

FIG. 05F depicts a block diagram of an exemplary apparatus (e.g., a distributed apparatus performing distributed computing), Apparatus 05000F, enabling the exchange and processing of data to execute a purchase of a Product of Interest, process one or more Qualifying Offers, and/or execute any function related to the Product of Interest after purchase among the components of Apparatus 05000E and one or more Government Benefit Servers 03300, according to one embodiment. The apparatus can implement the entities described herein by utilizing a subset of the preceding components, any combination of the components, or additional, related, alternative, and/or equivalent components disclosed in the application.

FIG. 05G depicts a block diagram of an exemplary apparatus (e.g., a distributed apparatus performing distributed computing), Apparatus 05000G, enabling the exchange and processing of data to execute a purchase of a Product of Interest, process one or more Qualifying Offers, and/or execute any function related to the Product of Interest after purchase among the components of Apparatus 05000F and one or more Distributor Servers 03500 and/or Component Servers 03600, according to one embodiment. The apparatus can implement the entities described herein by utilizing a subset of the preceding components, any combination of the components, or additional, related, alternative, and/or equivalent components disclosed in the application.

FIG. 05H depicts a block diagram of an exemplary apparatus (e.g., a distributed apparatus performing distributed computing), Apparatus 05000H, enabling the exchange and processing of data to execute a purchase of a Product of Interest, process one or more Qualifying Offers, and/or execute any function related to the Product of Interest after purchase among the components of Apparatus 05000G and one or more Product Sensors 02600 and Regulatory Agency Servers 05100, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Regulatory Agency Server 05100 can execute for a Regulatory Agency one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Regulatory Agency Server 05100 can exchange data and/or instructions with one or more Data Processing Systems 01000 through a wireless network and/or a wireline network.

In one embodiment, Client Device 02100 can exchange data and/or instructions directly with Regulatory Agency Server 05100 or indirectly through Exchange Server 02200

Currently, Regulatory Agency Server 05100 can apply uniform requirements across classes of activities or assets. For example, the state of California requires an emission check for smog testing at original registration, i.e., purchase of a new automobile, and at registration renewal, i.e., upon expiration of the existing automobile registration. Applying such uniform requirements at registration renewal increases the probability that Regulatory Agency Server 05100, e.g., California Department of Motor Vehicles (“DMV”), will at the emissions test identify: (a) automobiles already emitting significant smog because the owners have not maintained their automobiles, which would impose a cost on air quality; and/or (b) automobiles emitting smog significantly below required thresholds because the owners have maintained their automobiles, which would impose a cost on the owner's time through premature or unnecessary testing.

Apparatus 05000H can enable the exchange of data among one or more Product Sensors 02600 and Regulatory Agency Servers 05100, which can produce more efficient regulation. A Product Sensor 02600 connected to an automobile able to detect smog emission can transmit to Regulatory Agency Server 05100, e.g., a state DMV, data related to the automobile's smog emission when the emission exceeds a predefined threshold. Regulatory Agency Server 05100, e.g., a state DMV, can transmit to Product Sensor 02600 connected to an automobile data and/or instructions, e.g., data specifying an amended threshold if a state amended the emission threshold. By detecting continually at the point of origin the smog emission of an automobile and transmitting data when the emission exceeds a predefined threshold, Product Sensor 02600 can enable a Regulatory Agency to regulate automobile smog emissions more efficiently.

FIG. 05I depicts a block diagram of an exemplary apparatus (e.g., a distributed apparatus performing distributed computing), Apparatus 05000I, enabling the exchange and processing of data to execute a purchase of a Product of Interest, process one or more Qualifying Offers, and/or execute any function related to the Product of Interest after purchase among the components of Apparatus 05000H and one or more Media Devices 05200, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Media Device 05200 can execute one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Media Device 05200 can exchange data and/or instructions with one or more Data Processing Systems 01000 through a wireless network and/or a wireline network. Media Device 05200 can display one or more classes of Content, which the application defines any class of data a User can view, hear, or execute any other class of action. Content can include any data displayed on Client Device 02100 produced, sold, and/or distributed by any party including without limitation: a television network, a radio network, and/or a website.

In one embodiment, Client Device 02100 can exchange data and/or instructions directly with Media Device 05200 or indirectly through Exchange Server 02200

FIG. 05J depicts a block diagram of an exemplary apparatus (e.g., a distributed apparatus performing distributed computing), Apparatus 05000J, enabling the exchange and processing of data to execute a purchase of a Product of Interest, process one or more Qualifying Offers, and/or execute any function related to the Product of Interest after purchase among the components of Apparatus 05000I and one or more Printing Devices 05300, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components.

Printing Device 05300 can execute one or more of the following functions including without limitation: (a) receiving from one or more Data Processing Systems 01000 data and/or instructions; (b) storing the data and/or instructions; (c) processing the data according to either the received and/or stored instructions; (d) outputting the data in any form including without limitation: text, audio, image, video, or any combination thereof; or (e) transmitting to one or more Data Processing Systems 01000 data and/or instructions. Printing Device 05300 can exchange data and/or instructions with one or more Data Processing Systems 01000 through a wireless network and/or a wireline network.

In one embodiment, Client Device 02100 can exchange data and/or instructions directly with Printing Device 05300 or indirectly through Exchange Server 02200.

Printing Device 05300 can receive from one or more Data Processing Systems 01000, e.g., Producer Server 02400 or Retailer Server 02300, data and/or instructions for enabling Printing Device 05300 to produce a Product, e.g., a physical good. The data can include any data associated with producing the Product, e.g., composition of the inputs of the good, dimensions of the good, and/or mass or weight of the good. The instructions can include any instruction associated with producing the Product, e.g., a set of instructions which can cause Printing Device 05300 to output one or more layers in a shape specified.

### Overall Method

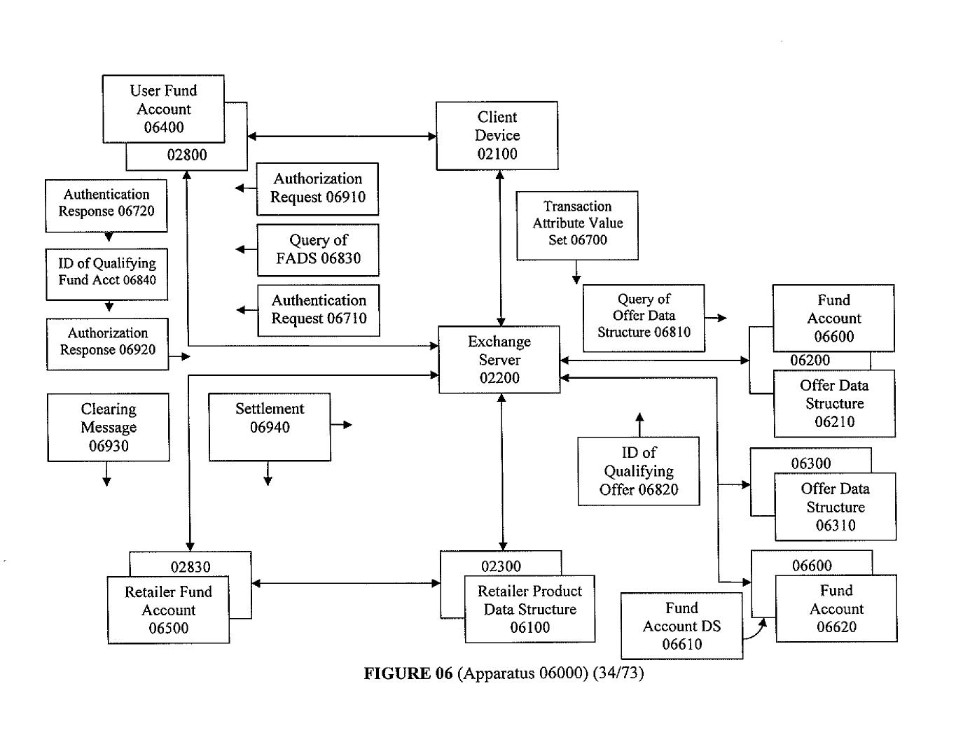

FIG. 06 depicts a block diagram of an exemplary apparatus (e.g., a distributed apparatus performing distributed computing), Apparatus 06000, enabling the exchange and processing of data to determine which Product meets a party's needs, identify one or more Retailers selling a Product of Interest, identify one or more Qualifying Offers, Authenticate one or more Data Processing Systems and/or Data Structures related to a Transaction, Authorize the withdrawal of funds from and deposit of funds to one or more Qualifying Fund Accounts, Clear a Transaction, and/or Settle a Transaction, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components, Data Structures, data, and/or instructions.

Retailer Product Data Structure 06100 can include a set of data elements associated with one or more Products offered by Retailer Server 02300. The data elements can include any data enabling one or more embodiments of the invention to determine if Retailer Server offers a Product requested in a User Query, e.g., Product Description, Retailer Price, and/or Retailer Available Units.

Server 06200 can execute one or more functions related to Offer Data Structure 06210 and Fund Account 06600. In one embodiment, one Server 06200 or other Data Processing Systems 01000 affiliated with Server 06200 can administer both an Offer Data Structure and a Fund Account, e.g., a Payment Issuer Server 02800 which can administer both an Offer Data Structure 06210 specifying one or more Offers made by Payment Issuer and a Fund Account 06600 transmitting and/or receiving funds relating to a Qualifying Offer generated from Offer Data Structure 06210 in a Transaction.

Server 06300 can execute one or more functions related to Offer Data Structure 06310 and Server 06600 can execute one or more functions related to Fund Account Data Structure 06610 and/or Fund Account 06620. In one embodiment, Server 06300 and Server 06600 can be two separate parties, even though Fund Account 06620 can transmit and/or receive funds relating to a Qualifying Offer generated from Offer Data Structure 06310. While one or more embodiments of the invention illustrates only the association of a Fund Account Data Structure 06610 with Fund Account 06620 in FIG. 06, the invention is not limited to that embodiment. One or more embodiments of the invention can enable the association of a Fund Account Data Structure with any Fund Account in this application.

Server 06200, Server 06300, and Server 06600 can each be any Data Processing System 01000 which can store an Offer Data Structure, a Fund Account Data Structure, and/or a Fund Account and can include without limitation any Data Processing System 01000 illustrated in FIG. 2H, FIG. 3K, FIG. 04C, and/or FIG. 05J. In a first example, Server 06200 can be a Payment Issuer Server 02800 administering an Offer Data Structure, a Fund Account Data Structure, and a Fund Account. In a second example, Server 06300 can be an Insurer Server 02700 administering an Offer Data Structure and Server 06600 can be a Bank Server 02850 administering a Fund Account Data Structure and the associated Fund Account.

User Fund Account 06400 can transmit, store, and/or receive any funds for a User Fund Account. In one embodiment, Payment Issuer Server 02800 can administer User Fund Account 06400.

Retailer Fund Account 06500 can transmit, store, and/or receive any funds for a Retailer Fund Account. In a first embodiment, Retailer Bank Server 02830 can administer Retailer Fund Account 06500. In a second embodiment, Acquirer Server 02811 can administer Retailer Fund Account 06500.

Transaction Attribute Value Set 06700 can include one or more values related to a candidate Transaction, including without limitation: (a) any value in a User Query received from Client Device 02100; and/or (b) any value received by, generated by, read from a local Data Structure stored on Exchange Server 02200 and/or read from a remote Data Structure stored on any other Data Processing System 01000. In a first example, a Transaction Attribute Value Set 06700 can include values in a User Query associated with a Product of Interest, e.g., “Lipitor®” and “40 milligrams”, values generated by or read from Exchange Server 02200, e.g., a timestamp of “YYYY/MM/DD” and a User Identifier associated with Client Device 02100 the User previously registered at Registration. In a second example, a Transaction Attribute Value Set 06700 can include values in a User Query associated with a Fund Account, e.g., “I want to pay for the Product from my Checking Account at Bank XYZ”, an exemplary word string received by Exchange Server 02200.

Authentication Request 06710 can be a request transmitted to a Data Processing System 01000, e.g., Party Data Structure 10210, to Authenticate any attribute of a Transaction.

Authentication Response 06720 can be a response from a Data Processing System 01000, e.g., Party Data Structure 10210, Authenticating or not Authenticating any attribute of a Transaction included in Authentication Request 06710.

Query of Offer Data Structure 06810 can be a query transmitted to one or more Offer Data Structures to identify a Qualifying Offer.

ID of Qualifying Offer 06820 can be a response from one or more Offer Data Structures identifying a Qualifying Offer.

Query of Fund Account Data Structure 06830 can be a query transmitted to one or more Fund Account Data Structures, e.g., a User Fund Account Data Structure, to identify a Qualifying Fund Account, e.g., a Qualifying User Fund Account.

ID of Qualifying Fund Account 06840 can be a response from one or more Fund Account Data Structures, e.g., a User Fund Account Data Structure, identifying a Qualifying Fund Account, e.g., a Qualifying User Fund Account.

Authorization Request 06910 can be a request transmitted to one or more administrators of a Qualifying Fund Account to Authorize the withdrawal of a Withdrawal Amount and/or the deposit of a Deposit Amount.

Authorization Response 06920 can be a response from one or more administrators of a Qualifying Fund Account Authorizing or not Authorizing the withdrawal of a Withdrawal Amount and/or deposit of a Deposit Amount.

Clearing Message 06930 can include any data and/or instructions in a Transaction Clearing Record.

Settlement 06940 can include any data and/or instructions enabling the withdrawal of the Net Withdrawal Amount from and/or deposit of Net Deposit Amount to each respective Qualifying Fund Account for one or more Transactions over any predefined Settlement cycle.

Currently, a Payment Network typically requires the origination of a request to withdraw funds from a first Fund Account from a party associated with a second Fund Account. In a first example, a Payment Network like a Card Association receives an Authorization Request from Acquirer Server 02811 specifying the amount to withdraw from Payment Issuer Server 02800. In a second example, an ACH receives a request from an originator, i.e., a party originating the request to another party to debit or credit the Fund Account of the Receiver (“Originator”), e.g., an ODFI, specifying the amount to withdraw from a Fund Account held by a receiver, i.e., a party granting another party the authority to debit or credit the Fund Account held by the receiver (“Receiver”), e.g., a Fund Account administered by an RDFI.

In contrast, one or more embodiments of the invention can utilize an Apparatus, e.g., Apparatus 06000 including Exchange Server 02200 to originate one or more Authorization Requests to each Qualifying Fund Account. An apparatus processing a Transaction among more than a single Fund Account from which to withdraw funds and a single Fund Account to which to deposit funds, e.g., Apparatus 06000 can use data to compute accurately the one or more Withdrawal Amounts withdrawn from and one or more Deposit Amounts deposited to each Qualifying Fund Account and determine the optimal set of Withdrawal Amounts and Deposit Amounts associated with each Qualifying Fund Account to optimize an objective function, e.g., minimizing the Net Price of a Qualifying Retailer/Offer Combination and/or minimizing the Total User Fund Account Withdrawal Cost.

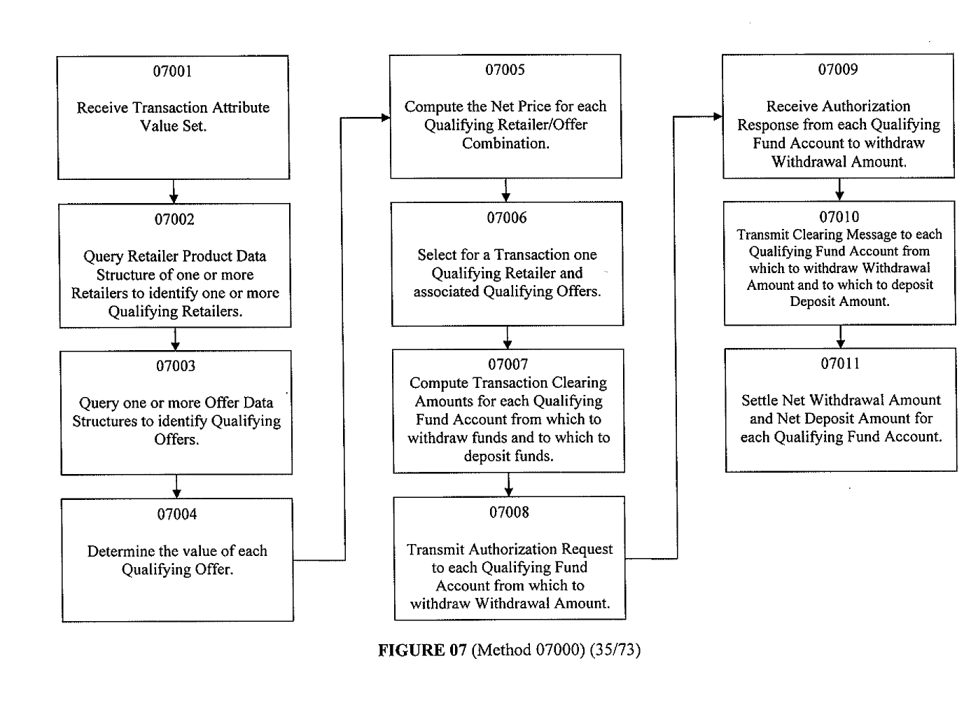

FIG. 07 depicts a flow chart of an exemplary computer-implemented method, Method 07000, that when executed can exchange and process data to determine which product meets a party's needs, identify one or more Retailers selling a Product of Interest, identify one or more Qualifying Offers, Authenticate one or more parties related to a Transaction, Authorize the withdrawal of funds from one of more Qualifying Fund Accounts, Clear a Transaction, and/or Settle a Transaction, according to one embodiment. The flowchart refers to the apparatus and structures depicted in FIG. 06. However, the method is not limited to those embodiments. The method can implement the steps described herein utilizing a subset of the components, any combination of the components, or additional, related, alternative, and/or equivalent components depicted in FIG. 06 and/or elsewhere in the application. The method can execute a subset of the steps, any combination of the steps, the steps in different order, and/or additional, related, alternative, or equivalent steps.

At 07001, Method 07000 can receive Transaction Attribute Value Set 06700.

At 07002, Method 07000 can query Retailer Product Data Structure 06100 of one or more Retailer Servers 02300 to identify one or more Qualifying Retailers.

At 07003, Method 07000 can query one or more Offer Data Structures 06210 or Offer Data Structure 06310 to identify one or more Qualifying Offers. One or more embodiments of the invention can use any method described herein to identify one or more Qualifying Offers and/or determine a Qualifying Retailer/Offer Combination which can minimize or decrease below a predefined threshold the Net Price including without limitation: (a) querying an Offer Data Structure stored locally on Exchange Server 02200; (b) transmitting a query to one or more Offer Data Structures stored on a Data Processing System 01000 other than Exchange Server 02200; and/or (c) Method 17000.

At 07004, Method 07000 can determine the Offer Value of each Qualifying Offer using any method including without limitation: (a) reading the Offer Value associated with the Qualifying Offer in an Offer Data Structure where the Offer Value is in the same format as the value of Net Price in a Qualifying Retailer/Offer Combination; and/or (b) computing the Offer Value associated with the Qualifying Offer in an Offer Data Structure where the Offer Value is in a format different from the format of the value of Net Price in a Qualifying Retailer/Offer Combination.

One or more embodiments of the invention can identify a Static Offer Value by reading in an Offer Data Structure the Offer Value associated with a Qualifying Offer.

One or more embodiments of the invention can identify a Dynamic Offer Value by generating in or outside of an Offer Data Structure an Offer Value whose value can change depending on the value of any event in an event-condition-action rule stored in an Offer Data Structure. The event can be one or more values from a Transaction Attribute Value Set 06700 or from any other source of data. This application describes herein the methods which can identify a Dynamic Offer Value, e.g., Method 17100, Method 17200, and/or Method 17300.

At 07005, Method 07000 can compute the Net Price for each Qualifying Retailer/Offer Combination. In another embodiment, Method 07000 can generate one or more combinations of Product benefits and costs (“Qualifying Product Benefit Cost Combination”) and any metric associated with each Qualifying Product Benefit Cost Combination, e.g., the value-to-price ratio illustrated by the value RA01 for Product A, RB01 for Product B, and/or RC01 for Product C in Product Comparison Window 33000. Method 07000 can transmit to Client Device 02100 the data and/or instructions enabling the display of: (a) a single Qualifying Retailer/Offer Combination or a plurality of Qualifying Retailer/Offer Combinations, e.g., a display of Offer Combination Window 32000, and/or Offer Combination Window 35000; and/or (b) a single Qualifying Product Benefit Cost Combination or a plurality of Qualifying Product Benefit Cost Combinations, e.g., a display of Product Comparison Window 33000.

At 07006, Method 07000 can select for a Transaction one Qualifying Retailer/Offer Combination. Method 07000 can select for a Transaction any or one or more Qualifying Retailer/Offer Combinations. In a preferred embodiment, Method 07000 selects for a Transaction the Qualifying Retailer/Offer Combination with the lowest Net Price, e.g., the Qualifying Retailer/Offer combination associated with Retailer A where value “A12” is less than value “B12” and value “C12” in Offer Combination Window 32000. In another embodiment, Method 07000 selects for a Transaction the Qualifying Retailer/Offer Combination associated with a Retailer Server 02800 specified by the User of Client Device 02100. For example, the User of Client Device 02100 may prefer a Qualifying Retailer/Offer Combination associated with a Retailer Server 02800 even if the Net Price is higher than another Qualifying Retailer/Offer Combination.

Method 07000 can select for a Transaction a Qualifying Retailer/Offer Combination selected by the user of Client Device 02100 or selected automatically according to a predefined rule.

At 07007, Method 07000 can compute a Transaction Clearing Amounts for each Qualifying Fund Account. Method 07000 can use any method described herein to compute a Transaction Clearing Amounts including without limitation Method 19000 and/or Method 19100.

At 07008, Method 07000 can transmit an Authorization Request 06910 to each Qualifying Fund Account from which to withdraw a Withdrawal Amount.

At 07009, Method 07000 can receive an Authorization Response 06920 from each Qualifying Fund Account either approving or rejecting the withdrawal of the Withdrawal Amount. If every Authorization Response 06920 approves the withdrawal of the Withdrawal Amount, Method 07000 can proceed to 07010. If one or more Authorization Responses 06920 rejects the withdrawal of the Withdrawal Amount, Method 07000 can proceed to: (a) 22005B and recompute the set of Qualifying Fund Accounts and associated Withdrawal Amounts as described therein; and (b) execute the remaining steps through 22150.

At 07010, Method 07000 can transmit Clearing Message 06930 to each Qualifying Fund Account Administrator from which to withdraw a Withdrawal Amount and to which to deposit a Deposit Amount.

At 07011, Method 07000 can Settle a Transaction by withdrawing the Net Withdrawal Amount from each Qualifying Fund Account for one or more Transactions during any predefined Settlement cycle and depositing the Net Deposit Amount to each Qualifying Fund Account for one or more Transactions during any predefined Settlement cycle. Method 07000 can use any method, e.g., Method 28000, to determine the set of number, combination, and/or class of Fund Transfers which minimizes the Total Settlement Cost and/or decreases the Total Settlement Cost below a predefined threshold.

One or more embodiments of the invention can apply Method 07000 or any other method described herein to execute a Transaction for the purchase of any Product. In a first example, a User who is an individual can transmit a User Query for a Product which one or more embodiments of the invention identifies as a specific book associated with an ISBN identifier. Method 07000 can enable the User to purchase the book Product at the lowest Net Price including a Qualifying Offer, e.g., an Offer for a discount from Producer Server 02400 producing the book, and minimize the Total User Fund Account Withdrawal Cost including, e.g., a Transfer Fee for withdrawing funds from a Fund Account associated with a debit card. In a second example, a User which is a business can transmit a User Query for a Product which one or more embodiments of the invention identifies as a specific semiconductor manufacturing stepper device associated with a manufacturer SKU identifier. Method 07000 can enable the User to purchase the stepper Product at the lowest Net Price including a Qualifying Offer, e.g., an Offer for a deduction for accelerated depreciation from Income Tax Server 02920, and minimize the Total User Fund Account Withdrawal Cost including, e.g., an Interest Fee for withdrawing funds from a Loan Account. In a third example, a User which is a government can transmit a User Query for a Product Class which one or more embodiments of the invention identifies as the class of services for repairing a highway associated with a NAPCS identifier. Method 07000 can enable the User to compare the Net Price of a plurality of equivalent Products including a Qualifying Offer, e.g., an Offer for a specified number of hours of labor at a cost in compliance with one or more minimum wage and/or prevailing wage regulations (which one or more embodiments of the invention can determine by querying an Offer Data Structure, e.g., a Data Structure storing data and/or instructions on the regulations, stored on Regulatory Agency Server 05100, e.g., a server administered by the United States Department of Labor or a server administered by a state department of labor), and minimize the Total User Fund Account Withdrawal Cost including, e.g., an Interest Fee for withdrawing funds from a Loan Account.

A conventional Payment Network typically connects the Fund Account of a limited class of parties. For example, a Payment Network like a Card Association can connect one or more User Fund Accounts administered typically by Payment Issuer Server 02800 and one or more Retailer Fund Accounts administered typically by Acquirer Server 02811. Not only do current Payment Networks not connect more than two classes of Fund Accounts, e.g., a User Fund Account and a Retailer Fund Account, to process the purchase of a Product, current Payment Networks do not enable the one or more functions required for the Authorization by different classes of Fund Accounts.

One or more class of parties making Offers do not enable the transfer of funds associated with a purchase of a Product in a Transaction in the same process as one or more other transfer of funds in the same Transaction. These classes of parties typically enable the transfer of funds associated with a purchase of a Product in a Transaction in a process separate from other the process of transfer of funds in the same Transaction.

In a first example, Producer Server 02400 can make an Offer for decreasing the Net Price of a Product by transmitting to a User a coupon in the form of paper or the User of Client Device 02100 a coupon in the form of a digital file. Coupon processors or clearinghouses exist to execute one of more functions including without limitation: (a) receiving one or more paper coupons from a Retailer; (b) sorting, counting, and processing the coupons; and (c) transferring funds from the party offering the coupon, e.g., Producer Server 02400, to the Retailer accepting the coupon, e.g., Retailer Server 02300.

The costs of these existing coupon processors can include without limitation: (a) requiring typically a minimum number of paper coupons transmitted by the Retailer in each physical shipment; and/or (b) delaying transfer of funds to the Retailer for a time period of typically one month or longer from the time of Transaction. While the User may benefit from the Offer Value of the coupon at the time of Transaction, the transfer of funds associated with the Qualifying Offer is processed separately from the transfer of funds associated with the purchase of the Product in a Transaction.

In a second example, Insurer Server 02700 can make an Offer for decreasing the Net Price of a Product by transmitting to a User an Offer, e.g., coverage of a Product in an Insurance Plan, to pay for part or all of the price of the Product if each Transaction Attribute Value meets each of the one or more Offer Condition Attribute Values. Insurer Server 02700 can execute one or more functions including without limitation: (a) receiving one or more forms (in the form of paper or non-paper) from one or more parties, e.g., a Retailer Server 02300 like a drugstore, a Producer Server 02400 like a hospital or a physician, and a User of the Product purchased in a Transaction; (b) processing the data; and (c) transferring funds from the Fund Account held by Insurer Server 02700 to the Fund Account held by each of the parties related to a Transaction, e.g., a transfer of funds through an ACH to a Producer Server 02400 registered to receive funds through the ACH, a transfer of funds through the transmission of a paper check to a Producer Server 02400 requesting payment in the form of a paper check, and/or a transfer of funds through the deposit of funds in a User Fund Account to the User reimbursing the User for paying the original price of the Product at Transaction.

In a third example, Employer Server 03200 can make an Offer for decreasing the Net Price of a Product by transmitting to a User an Offer, e.g., use of funds in an FSA, to pay for part or all of the price of the Product if each Transaction Attribute Value meets each of the one or more Offer Condition Attribute Values. Employer Server 03200 can execute one or more functions including without limitation: (a) receiving one or more forms (in the form of paper or non-paper) from one or more parties, e.g., a Retailer Server 02300 like a drugstore, a Producer Server 02400 like a hospital or a physician, and a User of the Product purchased in a Transaction; (b) processing the data; and (c) transferring funds from the Fund Account held by Employer Server 03200 to the Fund Account held by each of the parties related to a Transaction, e.g., a transfer of funds through an ACH to a Producer Server 02400 registered to receive funds through the ACH, a transfer of funds through the transmission of a paper check to a Producer Server 02400 requesting payment in the form of a paper check, and/or a transfer of funds through the deposit of funds in a User Fund Account to the User reimbursing the User for paying the original price of the Product at Transaction.

The costs of processing an Offer made by Insurer Server 02700 and/or Employer Server 03200 can include without limitation: (a) requiring a User to identify a Qualifying Offer independently of one or more other Qualifying Offers in a Qualifying Retailer/Offer Combination; (b) transferring funds associated with the processing of the Qualifying Offer through one or more Payment Networks independently of each other; and/or (c) increasing the complexity of Reconciliation for any party in a Transaction by requiring it to review reports in different formats from different sources.

In a fourth example, Income Tax Server 02920 can make an Offer for decreasing the Net Price of a Product by transmitting to a User an Offer, e.g., deducting from a User taxable income the expense of the Product where the Cumulative Transaction Value of expenses in a Product Class like “medical expenses” exceeds a predefined threshold, to pay for part or all of the price of the Product if each Transaction Attribute Value meets each of the one or more Offer Condition Attribute Values. Income Tax Server 02920 can execute one or more functions including without limitation: (a) receiving one or more forms (in the form of paper or non-paper) from one or more parties, e.g., a tax return transmitted by the User of the Product purchased in a Transaction; (b) processing the data; and (c) transferring funds (where the User receives a refund of income tax previously collected and where part of the refund represents a decrease in tax liability from deduction of the expense) from the Fund Account held by Income Tax Server 02920, e.g., a Fund Account held by the U.S. Treasury, to the Fund Account held by the User in one or more forms including without limitation: a paper check, direct deposit into the User Fund Account, deposit into a debit card associated with the User.

One or more embodiments of the invention can enable a single apparatus, e.g., Apparatus 06000, to execute one or more functions including without limitation: (a) identifying a Qualifying Offer associated with each Qualifying Retailer enabling a User to compare the Net Price of a plurality of Qualifying Retailer/Offer Combinations; and/or (b) redeeming each of the Qualifying Offers in a selected Qualifying Retailer/Offer Combination through a single apparatus by transferring funds from a Qualifying Fund Account held by each party making a Qualifying Offer to one or more Qualifying Fund Accounts specified in a Transaction Authorization Record.

One or more embodiments of the invention includes one or more methods described herein, e.g., Method 15000, enabling the identification of one or more Qualifying Offers.

To redeem automatically through a single apparatus, e.g., Apparatus 06000 each Qualifying Offer in a selected Qualifying Retailer/Offer Combination, one or more embodiments of the invention can execute an exemplary computer-implemented method, Method 07100, that when executed can link the Offer Data Structure from which one or more embodiments of the invention identified the Qualifying Offer and a Fund Account specified by the party making the Qualifying Offer to enable the processing of the Qualifying Offer and withdrawal and/or deposit of any Transaction Clearing Amount, according to one embodiment. Method 07100 refers to the apparatus and structures depicted in FIG. 06. However, the method is not limited to those embodiments. The method can implement the steps described herein utilizing a subset of the components, any combination of the components, or additional, related, alternative, and/or equivalent components depicted in FIG. 06 and/or elsewhere in the application. The method can execute a subset of the steps, any combination of the steps, the steps in different order, and/or additional, related, alternative, or equivalent steps.

At 07101, Method 07100 can install a CPP, e.g., Database Program 16110, on one or more Data Processing Systems 01000.

In a first embodiment, Method 07100 can install Database Program 16110 on each of one or more database servers, e.g., Retailer A Oracle DB 11g 16200, where the CPP can automatically: (a) read any data stored in a Retailer Data Structure on the database server; (b) detect any create, delete, and/or update operations on the Retailer Data Structure; and/or (c) execute one or more create, delete, and/or update operations on the Retailer Data Structure to write the value of each of one or more attributes in a Transaction Clearing Record (collectively “CPP Retailer Operations” which is a member of the class of CPP Operations). In another embodiment, Method 07100 can transmit a request to the database server for the database server instead of the CPP to execute one or more CPP Retailer Operations.

In a second embodiment, Method 07100 can install Database Program 16110 on each of one or more database servers, e.g., Insurer MS SQL 16230, where the CPP can automatically: (a) read any data stored in an Offer Data Structure, on the database server; (b) detect any create, delete, and/or update operations on the Offer Data Structure; and/or (c) execute one or more create, delete, and/or update operations on the Offer Data Structure to write the value of each of one or more attributes in a Transaction Clearing Record (collectively “CPP Offer Operations” which is a member of the class of CPP Operations). In another embodiment, Method 07100 can transmit a request to the database server for the database server instead of the CPP to execute one or more CPP Offer Operations.

In a third embodiment, Method 07100 can install Database Program 16110 on each of one or more database servers where the CPP can automatically: (a) read any data stored in a Fund Account Data Structure on the database server; (b) detect any create, delete, and/or update operations on the Fund Account Data Structure; and/or (c) execute one or more create, delete, and/or update operations on the Fund Account Data Structure to write the value of each of one or more attributes in a Transaction Clearing Record (collectively “CPP Fund Account Operations” which is a member of the class of CPP Operations). In another embodiment, Method 07100 can transmit a request to the database server for the database server instead of the CPP to execute on or more CPP Fund Account Operations.

At 07102, the party making an Offer can at Registration register a Fund Account from which one or more embodiments of the invention can withdraw a Withdrawal Amount and/or deposit a Deposit Amount associated with a Qualifying Offer which one or more embodiments of the invention identified by querying the Offer Data Structure. For example, at Registration, Server 06300, e.g., Insurer Server 02700, storing Offer Data Structure 06310, e.g., an Offer Data Structure including a set of data elements associated with one or more Offers offered by Insurer Server 02700, can register a Fund Account 06620, e.g., a Fund Account which Insurer Server 02700 set up on Server 06600, e.g., a Bank Server 02850, to transmit any Withdrawal Amount and/or receive any Deposit Amount associated with a Qualifying Offer identified at Offer Data Structure 06310. Fund Account 06620 can include without limitation: (a) a Fund Account dedicated to receiving, storing, holding, and/or transmitting funds associated with a Qualifying Offer identified at Offer Data Structure 06310; and/or (b) a Fund Account receiving, storing, holding, and/or transmitting funds for any purpose of Server 06300, e.g., a Fund Account for general corporate purposes.

At 07103, Method 07100 can receive the set of Qualifying Offers in a selected Qualifying Retailer/Offer Combination. One or more embodiments of the invention can identify a Qualifying Offer by querying through a CPP, e.g., Database Program 16110, the Offer Data Structure specifying the Offer.

At 07104, Method 07100 can associate with each Qualifying Offer in selected Qualifying Retailer/Offer Combination the Fund Account 06620 specified by the party making the Qualifying Offer for receiving, storing, holding, and/or transmitting funds associated with any Qualifying Offer identified at Offer Data Structure 06310.

At 07105, Method 07100 can generate a Transaction Authorization Record including a Qualifying Fund Account 06620 from which one or more embodiments of the invention can withdraw a Withdrawal Amount and/or a Qualifying Fund Account 06620 to which one or more embodiments of the invention can deposit a Deposit Amount.

In another embodiment, Method 07100 does not link Offer Data Structure 06310 and Fund Account 06620. While not having to link them would have fewer setup requirements, the lack of a real-time linkage can increase the probability of generating an error in redeeming a Qualifying Offer. For example, the party making a Qualifying Offer can associate the Offer with an attribute limiting the availability of the Offer, e.g., Offer Available Unit and/or Offer Available Value. Without querying the Offer Data Structure in real-time to determine if there are sufficient Offer Available Units and/or Offer Available Value to qualify the Offer, a Payment Network may Authorize a withdrawal of an Withdrawal Amount when the party making the Qualifying Offer may no longer have available units and/or value of the Offer.

In another embodiment, Method 07100 can use any method to lock a record and/or an attribute of a record in an Offer Data Structure after one or more embodiments of the invention identified a Qualifying Offer by querying the Offer Data Structure. By locking a record and/or an attribute of a record, e.g., Offer Available Unit and/or Offer Available Value, one or more embodiments of the invention can prevent other Offer Data Structure operations modifying the value of Offer Available Unit and/or Offer Available Value for some predefined time period, e.g., the same time period as the TTL value set in Method 22000.

While one or more embodiments of the invention describes how to decrease the probability of generating an error in redeeming a Qualifying Offer, the invention is not limited to that embodiment. One or more embodiments of the invention can apply the same method to any Data Structure for which the party making an Offer can limit the volume and/or value of the Offer including without limitation: (a) a Retailer Product Data Structure; and/or (b) a Fund Account Data Structure.

Current Payment Networks not only do not connect more than two classes of Fund Accounts, e.g., a User Fund Account and a Retailer Fund Account, to process the purchase of a Product, current Payment Networks do not enable Transactions in which a User can realize immediately the benefit of a Qualifying Offer from Income Tax Server 02920. Currently, if a User purchases in January of a tax year a Product whose purchase qualifies for a tax credit Offer, the User cannot realize the benefit of the Offer until he/she files an income tax return the following tax year and receives the benefit in the form of less tax owed or a larger tax refund. In other words, the User can wait as long as 18 months to realize the benefit of the Offer.

To process automatically in a single apparatus, e.g., Apparatus 06000, the immediate realization of a Qualifying Offer from Income Tax Server 02920, one or more embodiments of the invention can execute an exemplary computer-implemented method, Method 07200, that when executed can deposit funds to one or more Fund Accounts associated with redemption of a Qualifying Offer from Income Tax Server 02920, according to one embodiment. Method 07200 refers to the apparatus and structures depicted in FIG. 06. However, the method is not limited to those embodiments. The method can implement the steps described herein utilizing a subset of the components, any combination of the components, or additional, related, alternative, and/or equivalent components depicted in FIG. 06 and/or elsewhere in the application. The method can execute a subset of the steps, any combination of the steps, the steps in different order, and/or additional, related, alternative, or equivalent steps.

At 07201, Method 07200 can identify a Qualifying Offer made by Income Tax Server 02920. For example, Income Tax Server 02920 can store an Offer Data Structure including an Offer to decrease the federal income tax liability of a User purchasing a geothermal heat pump system equal to 30 percent of the Product price. If a Transaction Attribute Value associated with a Transaction Attribute equal or equivalent to every Offer Condition Attribute is equal to either (a) the Offer Condition Attribute Value associated with the Offer Condition Attribute or (b) at least one value within a set of Offer Condition Attribute Values associated with the Offer Condition Attribute, one or more embodiments of the invention determines that a Transaction qualifies for the Offer.

At 07202, Method 07200 can compute the Offer Value associated with the Qualifying Offer. For example, if a geothermal heat pump system costs $5,000, a User can qualify for a federal income tax credit equal to $1,500.

At 07203, Method 07200 can identify one or more User Fund Accounts in which the User has authorized withholding for federal income tax liability. The User can register the User Fund Accounts in which he/she authorized such withholding at Registration. One or more embodiments of the invention can query a Fund Account Data Structure to identify any Fund Account Attribute indicating the withholding for federal income tax liability.

At 07204, Method 07200 can transmit to an Administrator of a User Fund Account from which the Administrator withholds a specified amount for federal income tax liability. For example, Employer Server 03200 can administer a Payroll Account from which Employer Server 03200 withholds a specified amount for federal income tax liability.

At 07205, Method 07200 can transmit an instruction to the User Fund Account Administrator to decrease the federal income tax withholding for one or more withholding periods until the decreased withholding equals the Offer Value.

At 07206, Method 07200 can transmit to one or more Data Processing Systems 01000, e.g., the User Fund Account Administrator and/or Income Tax Server 02920, a Transaction Clearing Record including data and/or instructions confirming a Transaction qualifies for the Offer.

While one or more embodiments of the invention refers to an Offer decreasing federal income tax liability, the invention is not limited to that embodiment. One or more embodiments of the invention can process an Offer decreasing any class of tax including without limitation: income tax, sales tax, and/or property tax. One or more embodiments of the invention can process an Offer decrease a tax assessed by any Tax Authority including without limitation: federal, state, and/or local.

One or more embodiments of the invention can include enhancing the functionality of current Payment Networks in each of at least two ways: (a) adding: (i) one or more components described herein, e.g., one or more components constituting Apparatus 06000, to a current Payment Network, e.g., Apparatus 04000B; and (ii) adding one or more functions described herein, e.g., one or more methods described herein, to a current Payment Network described in Method 07300; and/or (b) using an apparatus of described herein, e.g., Apparatus 06000 and executing one or more functions described herein through a current Payment Network and executing the remaining functions through the apparatus described herein, e.g., Apparatus 06000 described in Method 07400.

One or more embodiments of the invention can include an exemplary apparatus, e.g., Apparatus 04000B, which adds one or more components of one or more embodiments of the invention to a current Payment Network, according to one embodiment. For example, Apparatus 04000B can add one or more components including without limitation: (a) Producer Server 02400; (b) Producer Bank Server 02840; (c) Other Bank Server 02850 or any User Fund Administrator administering the Fund Account of one or more holders which can include without limitation: (i) Insurer Server 02700; (ii) Tax Server 02900; (iii) Affinity Server 03100; (iv) Employer Server 03200; (v) Government Benefit Server 03300; (vi) Shipper Server 03400; and/or (vii) any other component described in Apparatus 05000J.

A conventional Payment Network adding one or more components, e.g., Apparatus 04000B, can execute an exemplary computer-implemented method, Method 07300, that can execute one or more functions described herein including without limitation: (a) Authenticating one or more Data Processing Systems 01000 and/or Data Structures related to a Transaction, e.g., Method 11000; (b) identifying one or more Qualifying Retailers through any method described herein; (c) identifying one or more Qualifying Offers through any method described herein, e.g., Method 17000; (d) Authorizing the withdrawal of funds from and/or deposit of funds to one or more Qualifying Fund Accounts, e.g., Method 22000; (e) Clearing a Transaction, e.g., Method 25000; and/or (f) Settling a Transaction, e.g., Method 28000. Method 07300 refers to the apparatus and structures depicted in FIG. 04C. However, the method is not limited to those embodiments. The method can implement the steps described herein utilizing a subset of the components, any combination of the components, or additional, related, alternative, and/or equivalent components depicted in FIG. 04C and/or elsewhere in the application. The method can execute a subset of the steps, any combination of the steps, the steps in different order, and/or additional, related, alternative, or equivalent steps.

To process automatically one or more functions described herein, one or more embodiments of the invention can include an exemplary apparatus, e.g., Apparatus 06000, and an exemplary conventional Payment Network, e.g., a Card Association and/or an ACH, according to one embodiment.

In Method 07400, one or more conventional Payment Networks can each execute one or more functions described herein depending on which conventional Payment Network can execute the function more efficiently including without limitation: (a) Authenticating one or more Data Processing Systems 01000 and/or Data Structures related to a Transaction, e.g., Method 11000; (b) identifying one or more Qualifying Retailers through any method described herein; (c) identifying one or more Qualifying Offers through any method described herein, e.g., Method 17000; (d) Authorizing the withdrawal of funds from and/or deposit of funds to one or more Qualifying Fund Accounts, e.g., Method 22000; (e) Clearing a Transaction, e.g., Method 25000; and/or (f) Settling a Transaction, e.g., Method 28000. Method 07400 refers to the apparatus and structures depicted in FIG. 04A and FIG. 06. However, the method is not limited to those embodiments. The method can implement the steps described herein utilizing a subset of the components, any combination of the components, or additional, related, alternative, and/or equivalent components depicted in FIG. 04A and FIG. 06 and/or elsewhere in the application. The method can execute a subset of the steps, any combination of the steps, the steps in different order, and/or additional, related, alternative, or equivalent steps.

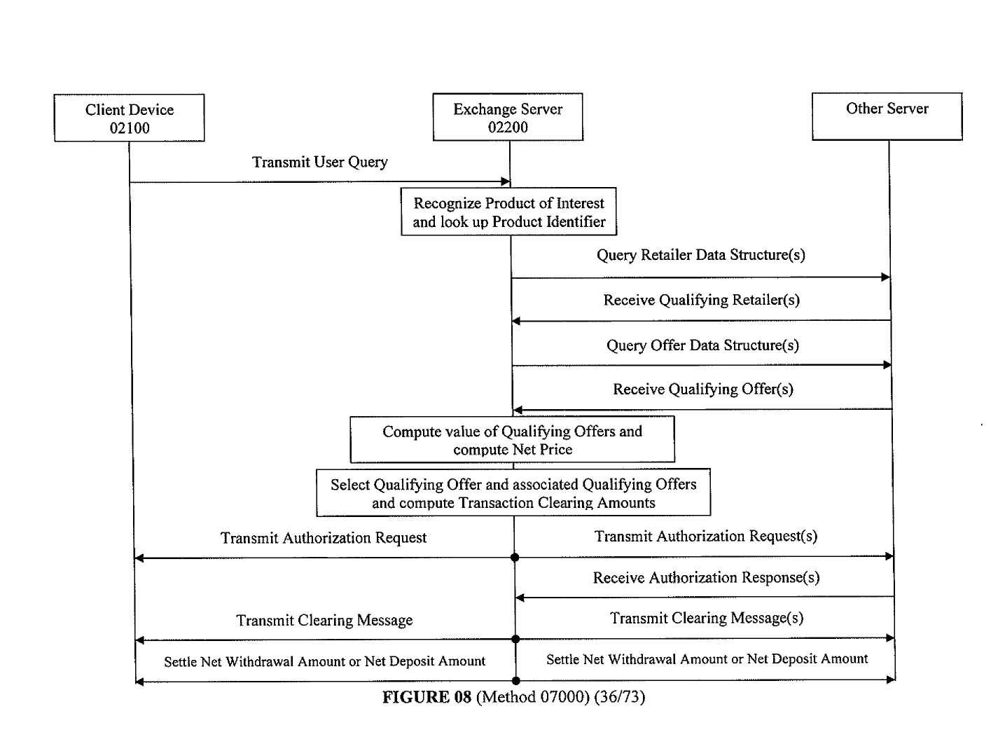

FIG. 08 depicts a chart illustrating the flow of data in and executions of functions by an exemplary computer-implemented method, Method 07000, among a Client Device 02100, Exchange Server 02200, and one or more other Data Processing Systems, according to one embodiment.

One or more embodiments of the invention produces a well-defined, particular, immediate, and real-world benefit to the public because it can decrease the number of actions one or more parties must execute to realize the benefit of Qualifying Offers associated with one Transaction.

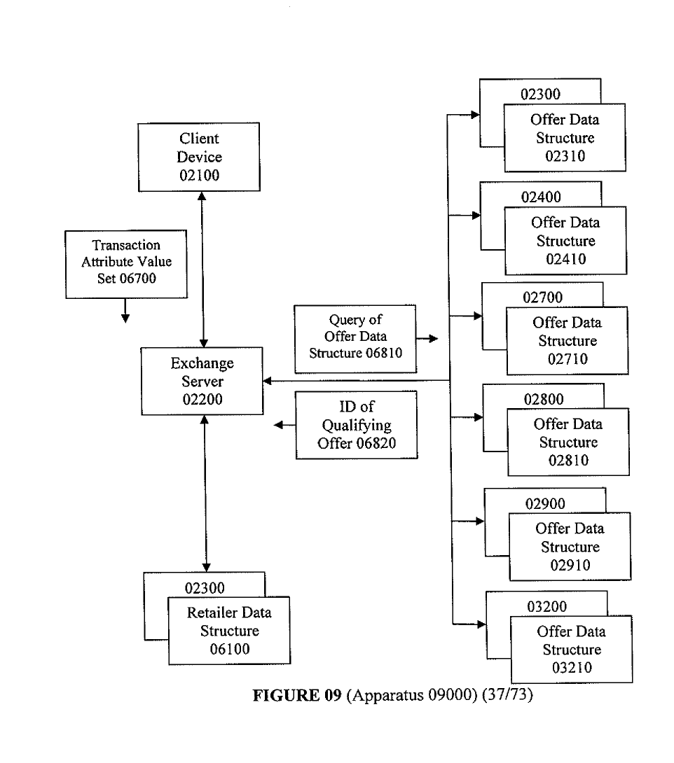

FIG. 09 depicts a block diagram of an exemplary apparatus (e.g., a distributed apparatus performing distributed computing), Apparatus 09000, enabling the exchange and processing of data to identify one or more Qualifying Offers, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components, Data Structures, data, and/or instructions.

FIG. 09 illustrates one embodiment of the invention which describes how Exchange Server 02200 can exchange data and/or instructions with one or more Data Processing Systems 01000 to identify a Qualifying Offer. In one embodiment, Exchange Server can exchange data and/or instructions with one or more Data Processing Systems 01000 which are exemplary embodiments of Server 06200 and Server 06300. These Data Processing Systems 01000 can include with limitation, Retailer Server 02300 storing Offer Data Structure 02310, Producer Server 02400 storing Offer Data Structure 02410, Insurer Server 02700 storing Offer Data Structure 02710, Payment Issuer Server 02800 storing Offer Data Structure 02810, Tax Server 02900 storing Offer Data Structure 02910, and/or Employer Server 03200 storing Offer Data Structure 03210. Exchange Server 02200 can transmit Query of Offer Data Structure 06810 to and receive an Identification of Qualifying Offer 06820 from each of one of more of these Data Processing Systems 01000. Identification of Qualifying Offer 06820 can include identification of one or more Qualifying Offers stored at a respective Offer Data Structure or identification of no Qualifying Offers. In one embodiment, Exchange Server 02200 can determine there are no Qualifying Offers if it does not receive Identification of Qualifying Offer 06820 within a predefined time period.

### Unified Authentication

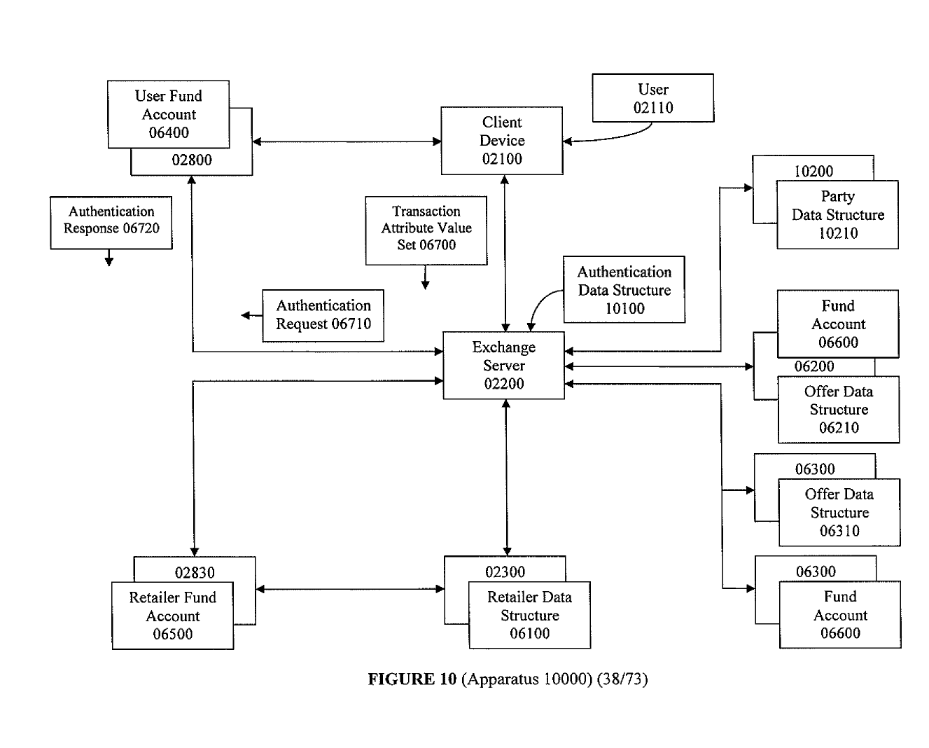

FIG. 10 depicts a block diagram of an exemplary apparatus (e.g., a distributed apparatus performing distributed computing), Apparatus 10000, enabling the exchange and processing of data to Authenticate one or more Data Processing Systems and/or Data Structures related to a Transaction, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components, Data Structures, data, and/or instructions.

Authentication Data Structure 10100 can be a Data Structure storing data related to the Authentication of one or more attributes and/or values in Transaction Attribute Value Set 06700, the User, Client Device 02100, one of more Retailer Servers 02300 offering to sell a Product of Interest, one or more Servers 06200 and/or Server 06300, one or more Offer Data Structures, one or more Fund Account Administrators, one or more Fund Account Data Structures, and/or any other component, Data Structure, data, and/or instructions related to a Transaction. Authentication Data Structure can receive, store, process, and/or transmit any data confirming or rejecting an Authentication Request 06710.

In a first example, Exchange Server 02200 can transmit an Authentication Request 06710 to Server 10200 storing Party Data Structure 10210 to Authenticate that a User is a member of a User Class. One credential received from the User in Transaction Attribute Value Set 06700 can specify that the User is a student at XYZ university. Exchange Server 02200 can transmit an Authentication Request 06710 to Server 10200 administered by university XYZ storing a Party Data Structure 10210 including data specifying all current students at the university. Server 10200 can transmit Authentication Response 06720 confirming or rejecting the membership of User in the User class of university XYZ student.

In a second example, in a Transaction for the purchase of a Product in which a Retailer, e.g., Retailer Server 02300, directed that any funds received for the sale of the Product shall be deposited in a Fund Account, e.g., Retailer Fund Account 06500, administered by a bank, e.g., Retailer Bank Server 02830, Exchange Server 02200 can transmit an Authentication Request 06710 to Retailer Bank Server 02830 storing a Fund Account Data Structure to Authenticate: (a) the association of Retailer Fund Account 06500 with Retailer Server 02300; and/or (b) the administration of Retailer Fund Account 06500 by Retailer Bank Server 02830. One method of identifying Retailer Bank Server 02830 is to confirm that one or more standard identifiers correctly identify Retailer Bank Server and the identifier(s) is current. In the United States, a financial institution must maintain identifying information with the FRB. The method can query a Data Structure storing Bank identifiers, e.g., a RTN, administered by the FRB's ACH department. If the RTN supplied by Retailer Bank Server 02830 matches the RTN registered with the FRB's ACH department, one or more embodiments of the invention can authenticate the credentials of Retailer Bank Server 02830.

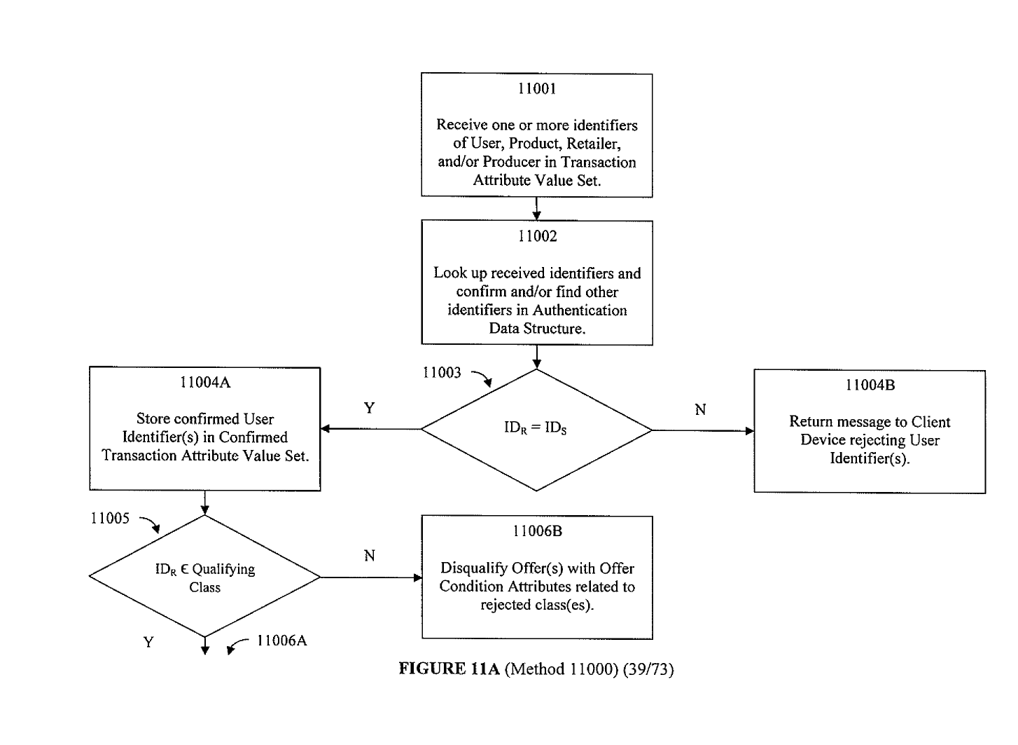

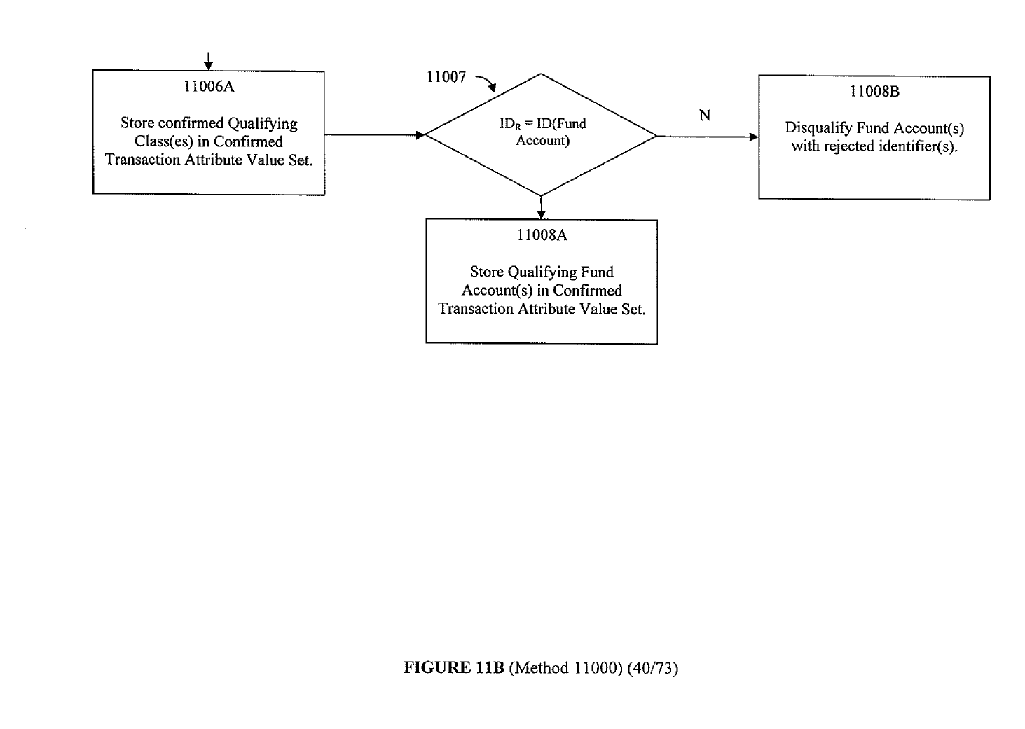

FIG. 11A and FIG. 11B depict a flow chart of an exemplary computer-implemented method, Method 11000, that when executed can exchange and process data to Authenticate one or more Data Processing Systems and/or Data Structures related to a Transaction, according to one embodiment. The flowchart refers to the apparatus and structures depicted in FIG. 10. However, the method is not limited to those embodiments. The method can implement the steps described herein utilizing a subset of the components, any combination of the components, or additional, related, alternative, and/or equivalent components depicted in FIG. 10 and/or elsewhere in the application. The method can execute a subset of the steps, any combination of the steps, the steps in different order, and/or additional, related, alternative, or equivalent steps.

At 11001, Method 11000 can receive one or more identifiers of a User, Product, Retailer of Interest, Producer of Interest, and/or any other data in Transaction Attribute Value Set 06700 which Method 11000 can Authenticate.

At 11002, Method 11000 can look up the received identifiers and confirm whether the identifier match the identifier in Authentication Data Structure 10100. Also, Method 11000 can execute one or more functions processing other data, e.g., data not in an identifier format, in Transaction Attribute Value Set 06700 to convert the data into a format which Method 11000 can Authenticate.

At 11003, Method 11000 can apply comparator logic to compare: (a) a received User Identifier, ID_{R}; with (b) any User Identifier IDₛ stored in Authentication Data Structure 10100 or any other Data Structure, e.g., Party Data Structure 10210. If the comparator logic determines a match, Method 11000 can proceed to 11004A. If the comparator logic does not determine a match, Method 11000 can proceed to 11004B, which can terminate the process for the specific Authentication Request 06710.

At 11004A, Method 11000 can store one or more confirmed User Identifiers in a Data Structure, Confirmed Transaction Attribute Value Set.

At 11005, Method 11000 can apply comparator logic to compare: (a) a received identifier related to a candidate Offer; with (b) any identifier stored in Authentication Data Structure 10100 or any other Data Structure, e.g., an Offer Data Structure. If the comparator logic determines a match, Method 11000 can proceed to 11006A. If the comparator logic does not determine a match, Method 11000 can proceed to 11006B, which can terminate the process for the specific Authentication Request 06710.

At 11006A, Method 11000 can store one or more confirmed identifiers in a Data Structure, Confirmed Transaction Attribute Value Set.

At 11007, Method 11000 can apply comparator logic to compare: (a) a received Fund Account Identifier, ID_{R}; with (b) any Fund Account Identifiers stored in Authentication Data Structure 10100 or any other Data Structure, e.g., an Offer Data Structure. For example, a User can specify in Transaction Attribute Value Set 06700 that he/she holds a Fund Account administered by Bank Server 02850. If the comparator logic determines a match, Method 11000 can proceed to 11008A. If the comparator logic does not determine a match, Method 11000 can proceed to 11008B, which can terminate the process for the specific Authentication Request 06710.

At 11008A, Method 11000 can store one or more confirmed Fund Account Identifiers in a Data Structure, Confirmed Transaction Attribute Value Set.

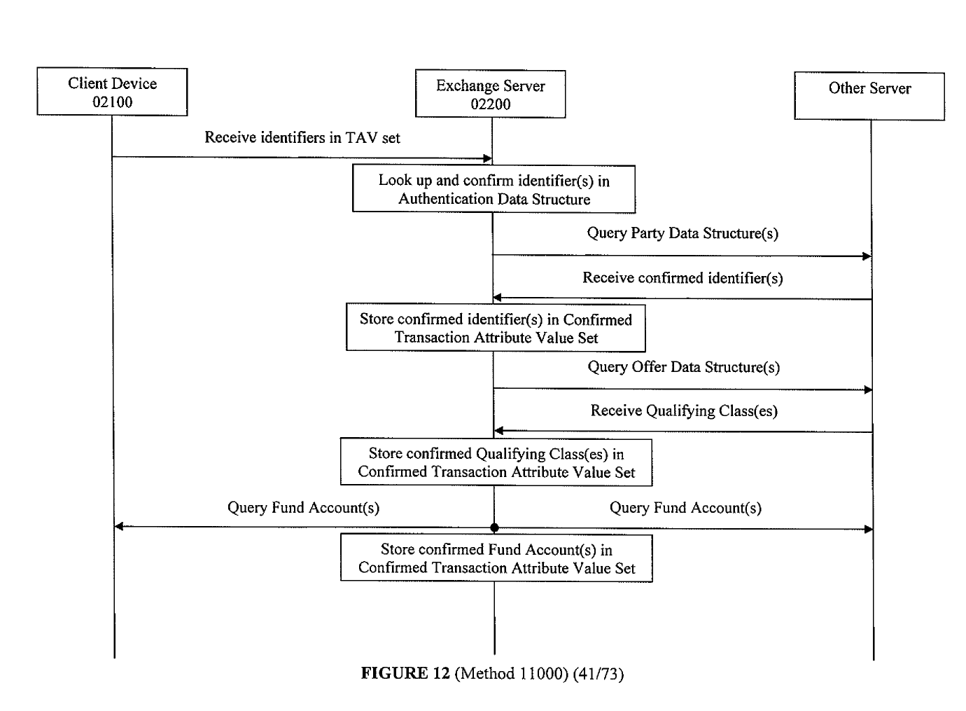

FIG. 12 depicts a chart illustrating the flow of data in and executions of functions by an exemplary computer-implemented method, Method 11000, among a Client Device 02100, Exchange Server 02200, and one or more other Data Processing Systems, according to one embodiment.

### Automatic Offer Identification

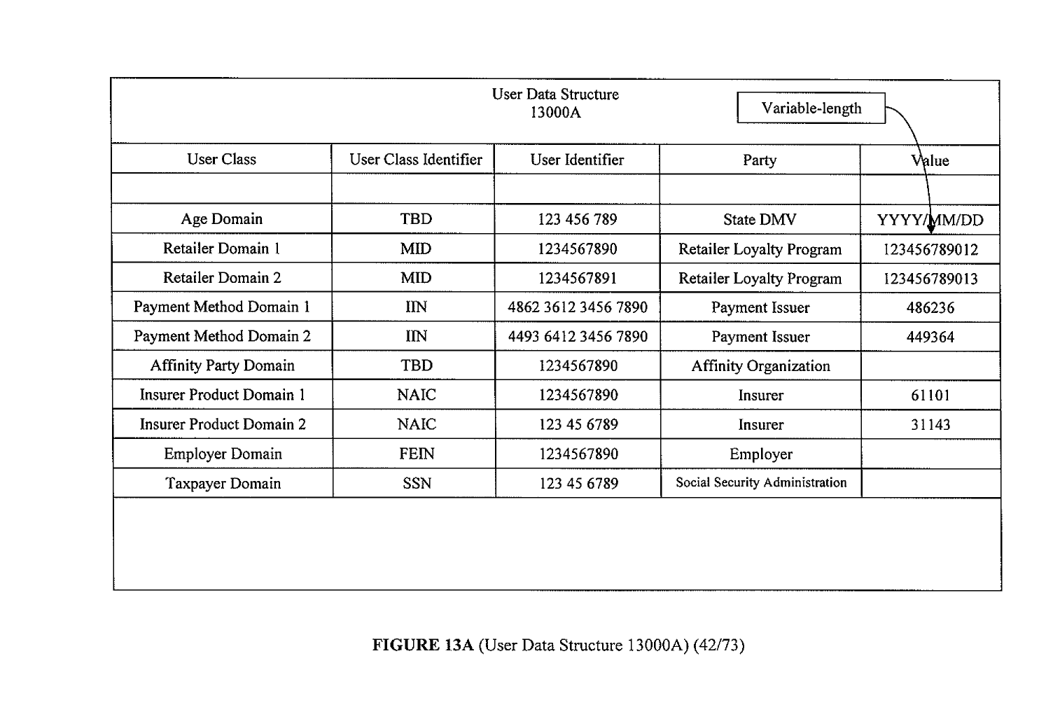

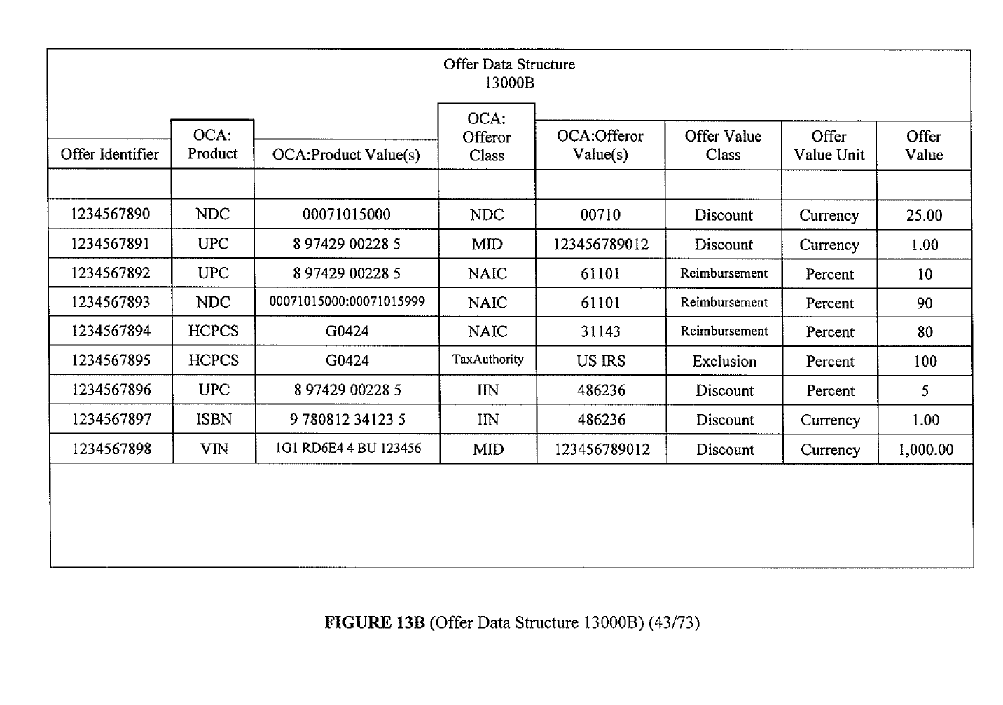

FIG. 13A depicts a diagram of an exemplary Data Structure, User Data Structure 13000A, that when stored on a Computer-Readable Medium can cause a Processor to execute any of the methods, steps, and/or instructions described herein, in general, and/or to execute User Data Structure operations, in particular, according to one embodiment. A Computer-Readable Medium encoded with User Data Structure 13000A can define structural and functional interrelationships between: (a) any data associated with a User, e.g., a User in the User Class Age Domain associated with a value of YYYY/MM/DD associated with a party, State DMV; and/or (b) any CPP disclosed herein and/or any component of a Data Processing System 01000, e.g., Exchange Server 02200, where the interrelationships permit the realization of the functionality of User Data Structure 13000A.

User Data Structure 13000A, which can be stored on a Computer-Readable Medium, can receive the one or more User Identifiers and/or the one or more User Class Identifiers from any Data Processing System 01000 including without limitation: (a) Client Device 02100; and/or (b) any Data Processing System 01000 storing a Data Structure including data associated with a program of which the User is a member, e.g., Retailer Server 02300 storing a Data Structure including data specifying that the User is a member of its Loyalty Program, Insurer Server 02700 storing a Data Structure including data specifying that the User is a customer of an Insurer Product, and/or Employer Server 03200 storing a Data Structure including data specifying that the User is an employee of Employer.

The Retailer identifier can be a variable length string. For example, different Acquirers can assign a Retailer Identifier, e.g., a MID, whose string length can differ among Acquirers and even within the same Acquirer.

After generating a User Data Structure 13000A, one or more embodiments of the invention can execute any method disclosed herein to look up User Data Structure 13000A including data which can include without limitation: (a) a value in an age domain, e.g., a value indicating an age: (i) above a predefined threshold which can qualify the User for an Offer, e.g., an Offer by a Retailer like an operator of a public bus transportation service, limited to Users with an age above the predefined threshold; or (ii) below a predefined threshold which can qualify the User for an Offer, e.g., an Offer by a Retailer like an operator of a movie theater, limited to Users with an age below the predefined threshold; (b) a value in an income domain, e.g., a value indicating an annual income below a predefined threshold which can qualify the User for an Offer, e.g., an Offer by a Government Benefit Authority like an operator of a government public housing program, limited to Users with an income below the predefined threshold; (c) a value in a geography domain, e.g., a value indicating a shipping address with a state attribute which can qualify the User for an Offer, e.g., an Offer by a Retailer limited to Users with a shipping address with a state attribute with a value other than a set of predefined states; (d) a value in a Retailer domain, e.g., a value indicating that the User is a member of a Loyalty Program offered by the Retailer which can qualify the User for an Offer, e.g., an Offer by the Retailer limited to Users who are members of the Loyalty Program, e.g., a Loyalty Program qualifying the member to buy a Sony® DSC-T110/B Cybershot Digital Camera at a price lower than the price the Retailer offers to Users who are not a member of the Loyalty Program; (e) a value in a Producer domain, e.g., a value indicating that the User is a member of a Loyalty Program offered by the Producer which can qualify the User for an Offer, e.g., an Offer by the Producer limited to Users who are members of the Loyalty Program; (f) a value in a Payment Method domain, e.g., a value indicating that the User has been issued a class of Payment Method issued by a Payment Issuer which can qualify the User for an Offer, e.g., an Offer by the Payment Issuer limited to Users to which the Payment Issuer issued a Payment Method, e.g., a Payment Method associated with an Issuer Identification Number, e.g., the “486236” Issuer Identification Number specifying a Visa® Platinum Credit Card issued by Capital One®, executed by the User to purchase a Sony® DSC-T110/B Cybershot Digital Camera qualifying the User to receive “cash back” in the User Fund Account or earn points, miles, kilometers, or credits stored in an account associated with the User administered by Capital One®; (g) a value in an Affinity Party domain, e.g., a value indicating that the User is a member of an Affinity Party which can qualify the User for an Offer, e.g., an Offer by the Affinity Party limited to Users who are members of the Affinity Party; (h) a value in an Insurer Product domain, e.g., a value indicating that the User is a member of an Insurer Product offered by the Insurer which can qualify the User for an Offer, e.g., an Offer by the Insurer limited to Users who are members of the Insurer Product, e.g., an Insurer Product qualifying the User for coverage of part or all of the price of a Product of Interest like part or all of the price of a prescription drug after a deductible and/or copayment, or part or all of the price of a pair of eyeglasses; (i) a value in an Employer domain, e.g., a value indicating that the User is an employee of an Employer which can qualify the User for an Offer, e.g., an Offer by the Employer limited to Users who are employees of the Employer; (j) a value in a Taxpayer domain, e.g., a value indicating that the User qualifies for and/or has registered for a program allowing the Taxpayer to exclude from Taxable Income the value of a qualifying expense, e.g., an HSA qualifying the User to exclude from Taxable Income qualifying expenses reimbursed by or paid by the HSA; (k) a value in a Government Benefit domain, e.g., a value indicating that the User qualifies for and/or has registered for a Government Benefit qualifying the User for receiving public funds related to a Product of Interest; and/or (l) a value in a Shipper domain, e.g., a value indicating that the User is a member of a Loyalty Program offered by the Shipper which can qualify the User for an Offer, e.g., an Offer by the Shipper limited to Users who are members of the Loyalty Program.

The functionality of User Data Structure 13000A can include without limitation: (a) enabling one or more embodiments of the invention to determine if one or more Existing Offers (defined herein) is a Qualifying Offer by comparing one or more values for each of one or more attributes in User Data Structure 13000A with one or more values or value ranges for the equal or equivalent Offer Condition Attribute in an Offer Data Structure; (b) enabling one or more embodiments of the invention to identify accurately the one or more Offer Condition Attributes associated with each Existing Offer and the associated Offer Condition Attribute Value(s); (c) enabling one or more embodiments of the invention to determine accurately the one or more Offer Condition Attributes associated with each Existing Offer for a specific User; and/or (d) enabling one or more embodiments of the invention to generate one or more New Offers (defined herein) based upon one or more values for each of one or more attributes in User Data Structure 13000A.

FIG. 13B depicts a diagram of an exemplary Data Structure, Offer Data Structure 13000B, that when stored on a Computer-Readable Medium can cause a Processor to execute any of the methods, steps, and/or instructions described herein in general, and/or to execute Offer Data Structure operations, in particular, according to one embodiment. A Computer-Readable Medium encoded with Offer Data Structure 13000B can define structural and functional interrelationships between: (a) any data associated with an Offer, e.g., an Offer by an Insurer qualifying a User for coverage of part or all of the price of a Product of Interest; and (b) any CPP disclosed herein and/or any component of a Data Processing System 01000, e.g., Exchange Server 02200, where the interrelationships permit the realization of the functionality of Offer Data Structure 13000B.

In one embodiment, Offer Data Structure 13000B can include: (a) one or more attributes illustrated in FIG. 13B; and/or (b) the value(s) or value range associated with each of the one or more attributes.

Exemplary Offer Identifier 1234567890 can be associated with one or more attributes including without limitation: (a) an Offer Condition Attribute in the Product Domain specifying the classification system uniquely classifying a Product qualifying for the Offer, e.g., the NDC; Offer Condition Attribute, e.g., the NDC equal to “00071015523” where: (i) character numbers 2-6 “00710” can be a labeler code uniquely identifying the Producer, e.g., Pfizer®; (ii) character numbers 7-9 “155” can be a product code uniquely identifying the Product produced by the Producer specified in the labeler code, e.g., Lipitor®; and/or (iii) character number 10-11 “23” can be a package code; (c) an Offer Condition Attribute in the Producer Domain specifying the classification system uniquely classifying a Producer making the Offer, e.g., the NDC; (d) an Offer Condition Attribute Value specifying the Producer making the Offer, e.g., a Producer uniquely identified by its labeler code “00710”; (e) an Offer Value Class specifying the class of Offer Value, e.g., a cash discount from the price offered by the Retailer; (1) an Offer Value Unit specifying the unit of the Offer Value; and/or (g) an Offer Value specifying the value of the Offer.

Exemplary Offer Identifier 1234567891 can be associated with one or more attributes including without limitation: (a) an Offer Condition Attribute in the Product Domain specifying the classification system uniquely classifying a Product qualifying for the Offer, e.g., the UPC; (b) an Offer Condition Attribute Value(s) specifying the value of the associated Product Domain Offer Condition Attribute, e.g., the UPC equal to “8 97429 00228 5” where: (i) character number 1“8” can be a prefix uniquely identifying the class of code, e.g., the values 0, 1, 6, 7, 8 represents most Products, the value 3 represents drugs identified by its respective NDC, and the values 5 and 9 represents coupons; (ii) character numbers 2-6 “97429” can be a Manufacturer Identifier uniquely identifying the manufacturer, e.g., Producer XYZ; (iii) character numbers 7-11 “00228” can be a product code uniquely identifying the Product produced by the Producer specified in the Manufacturer Identifier, e.g., an electronic peak flow meter; and/or (iv) character number 12“5” can be a check digit; (c) an Offer Condition Attribute in the Retailer Domain specifying the classification system uniquely classifying a Retailer making the Offer, e.g., the MID; (d) an Offer Condition Attribute Value specifying the Retailer making the Offer, e.g., a Retailer uniquely identified by its MID “123456789012”; (e) an Offer Value Class specifying the class of Offer Value, e.g., a cash discount from the price offered by the Retailer; (f) an Offer Value Unit specifying the unit of the Offer Value; and/or (g) an Offer Value specifying the value of the Offer. In a first example, Offer Data Structure 13000B can include for any record in attribute (g) a currency string specifying the value of the Offer, e.g., $1.00. In a second example, Offer Data Structure 13000B can include for any record in attribute (g) a code received by the Retailer making the Offer, e.g., a two-dimensional code like a barcode specifying a UPC Coupon Value Code, e.g., code “76” which is equivalent to a face value of $1.00.

Exemplary Offer Identifier 1234567892 can be associated with one or more attributes including without limitation: (a) an Offer Condition Attribute in the Product Domain specifying the classification system uniquely classifying a Product qualifying for the Offer, e.g., the UPC; (b) an Offer Condition Attribute Value(s) specifying the value of the associated Product Domain Offer Condition Attribute, e.g., the UPC equal to “8 97429 00228 5”; (c) an Offer Condition Attribute in the Insurer Domain specifying the classification system uniquely classifying an Insurer making the Offer, e.g., the NAIC; (d) an Offer Condition Attribute Value specifying the Insurer making the Offer, e.g., Humana® Health Plans uniquely identified by its NAIC “61101”; (e) and Offer Value Class specifying the class of Offer Value, e.g., a reimbursement as a percentage of the price paid for the Product; (f) an Offer Value Unit specifying the unit of the Offer Value; and/or (g) an Offer Value specifying the value of the Offer.

Exemplary Offer Identifier 1234567893 can be associated with one or more attributes including without limitation: (a) an Offer Condition Attribute in the Product Domain specifying the classification system uniquely classifying a Product qualifying for the Offer, e.g., the NDC; (b) an Offer Condition Attribute Value(s) specifying the value of the associated Product Domain Offer Condition Attribute, e.g., the NDC value range equal to “00071015000:00071015999”; (c) an Offer Condition Attribute in the Insurer Domain specifying the classification system uniquely classifying an Insurer making the Offer, e.g., the NAIC; (d) an Offer Condition Attribute Value specifying the Insurer making the Offer, e.g., Humana® Health Plans uniquely identified by its NAIC “61101”; (e) an Offer Value Class specifying the class of Offer Value, e.g., a reimbursement as a percentage of the price paid for the Product or an amount less the coinsurance paid by the User; (f) an Offer Value Unit specifying the unit of the Offer Value; and/or (g) an Offer Value specifying the value of the Offer.

Exemplary Offer Identifier 1234567894 can be associated with one or more attributes including without limitation: (a) an Offer Condition Attribute in the Product Domain specifying the classification system uniquely classifying a Product qualifying for the Offer, e.g., the HCPCS; (b) an Offer Condition Attribute Value(s) specifying the value of the associated Product Domain Offer Condition Attribute, e.g., the HCPCS equal to “00424”; (c) an Offer Condition Insurer making the Offer, e.g., the NAIC; (d) an Offer Condition Attribute Value specifying the Insurer making the Offer, e.g., Massachusetts—Medicare Carrier uniquely identified by its NAIC 31143; (e) an Offer Value Class specifying the class of Offer Value, e.g., a reimbursement as a percentage of the price paid for the Product or an amount less the coinsurance paid by the User; (f) an Offer Value Unit specifying the unit of the Offer Value; and/or (g) an Offer Value specifying the value of the Offer.

Exemplary Offer Identifier 1234567895 can be associated with one or more attributes including without limitation: (a) an Offer Condition Attribute in the Product Domain specifying the classification system uniquely classifying a Product qualifying for the Offer, e.g., the HCPCS; (b) an Offer Condition Attribute Value(s) specifying the value of the associated Product Domain Offer Condition Attribute, e.g., the HCPCS equal to “G0424”; (c) an Offer Condition Attribute in the Taxpayer Domain specifying the class of Tax Authority making the Offer; (d) an Offer Condition Attribute Value specifying the Tax Authority making the Offer, e.g., the IRS; (e) an Offer Value Class specifying the class of Offer Value, e.g., an exclusion from Taxable Income of an amount equal to the Offer Value for a purchase of a qualifying Product in a program, e.g., an HSA; (f) an Offer Value Unit specifying the unit of the Offer Value; and/or (g) an Offer Value specifying the value of the Offer.

Exemplary Offer Identifier 1234567896 can be associated with one or more attributes including without limitation: (a) an Offer Condition Attribute in the Product Domain specifying the classification system uniquely classifying a Product qualifying for the Offer, e.g., the UPC; (b) an Offer Condition Attribute Value(s) specifying the value of the associated Product Domain Offer Condition Attribute, e.g., the UPC equal to “8 97429 00228 5”; (c) an Offer Condition Attribute in the Payment Issuer Domain specifying the classification system uniquely classifying a Payment Issuer making the Offer, e.g., the IIN; (d) an Offer Condition Attribute Value specifying the Payment Issuer making the Offer, e.g., Capital One® uniquely identified by its ITN “486236”; (e) an Offer Value Class specifying the class of Offer Value, e.g., a cash discount from the price offered by the Retailer; (f) an Offer Value Unit specifying the unit of the Offer Value; and/or (g) an Offer Value specifying the value of the Offer.

Exemplary Offer Identifier 1234567897 can be associated with one or more attributes including without limitation: (a) an Offer Condition Attribute in the Product Domain specifying the classification system uniquely classifying a Product qualifying for the Offer, e.g., the ISBN; (b) an Offer Condition Attribute Value(s) specifying the value of the associated Product Domain Offer Condition Attribute, e.g., the ISBN equal to “9 780812 34123 5” where: (i) character numbers 1-3 “978” can be a prefix uniquely identifying the class of industry, e.g., the value 978 represents book publishing; (ii) character numbers 4-5 “08” can be a group identifier uniquely identifying the language-sharing country group, e.g., English-speaking countries; (iii) character numbers 6-9 “1234” can be a publisher code uniquely identifying the Producer producing the book; (iv) character numbers 10-12 “123” can be an item number uniquely identifying the book produced by the Producer specified in the publisher code; and (v) character number 13“5” can be a check digit; (c) an Offer Condition Attribute in the Payment Issuer Domain specifying the classification system uniquely classifying a Payment Issuer making the Offer, e.g., the IIN; (d) an Offer Condition Attribute Value specifying the Payment Issuer making the Offer, e.g., Capital One® uniquely identified by its IIN “486236”; (e) an Offer Value Class specifying the class of Offer Value, e.g., a cash discount from the price offered by the Retailer; (f) an Offer Value Unit specifying the unit of the Offer Value; and/or (g) an Offer Value specifying the value of the Offer.

Exemplary Offer Identifier 1234567898 can be associated with one or more attributes including without limitation: (a) an Offer Condition Attribute in the Product Domain specifying the classification system uniquely classifying a Product qualifying for the Offer, e.g., the VIN; (b) an Offer Condition Attribute Value(s) specifying the value of the associated Offer Condition Attribute, e.g., the YIN equal to “1G1 RD6E4 4 BU 123456” where: (i) character numbers 1-3 “1G1” are the World Manufacturer Identifier (“WMI”) uniquely identifying the Producer of the vehicle, e.g., Chevrolet® passenger vehicle; (ii) character numbers 4-8 “RD6E4” are the first five characters of the Vehicle Descriptor Section (“VDS”) uniquely identifying one or more attributes including without limitation, the automobile platform, the model, and/or the body style, e.g., a Volt model; (iii) character number 9“4” is the last character of the VDS representing a check digit; (iv) character number 10 “B” uniquely identifying the model year, e.g., 2011; (v) character number 11 “U” uniquely identifying the factory manufacturing the vehicle; and/or (vi) character numbers 12-17 “123456” uniquely identifying a specific vehicle; (c) an Offer Condition Attribute in the Retailer Domain specifying the classification system uniquely classifying a Retailer making the Offer, e.g., the MID; (d) an Offer Condition Attribute Value specifying the Retailer making the Offer, e.g., an automobile dealer uniquely identified by its MID “123456789012”; (e) an Offer Value Class specifying the class of Offer Value, e.g., a cash discount from the price offered by the Retailer; (f) an Offer Value Unit specifying the unit of the Offer Value; and/or (g) an Offer Value specifying the value of the Offer.

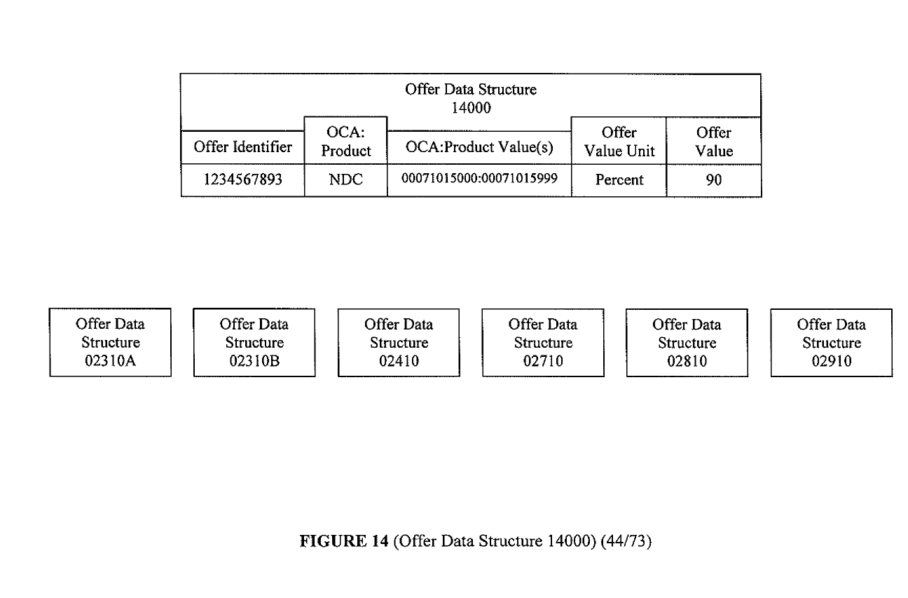

FIG. 14 depicts a diagram of an exemplary Data Structure, Offer Data Structure 14000, that when stored on a Computer-Readable Medium can cause a Processor to execute any of the methods, steps, and/or instructions described herein, in general, and/or to identify one or more Qualifying Offers, in particular, according to one embodiment.

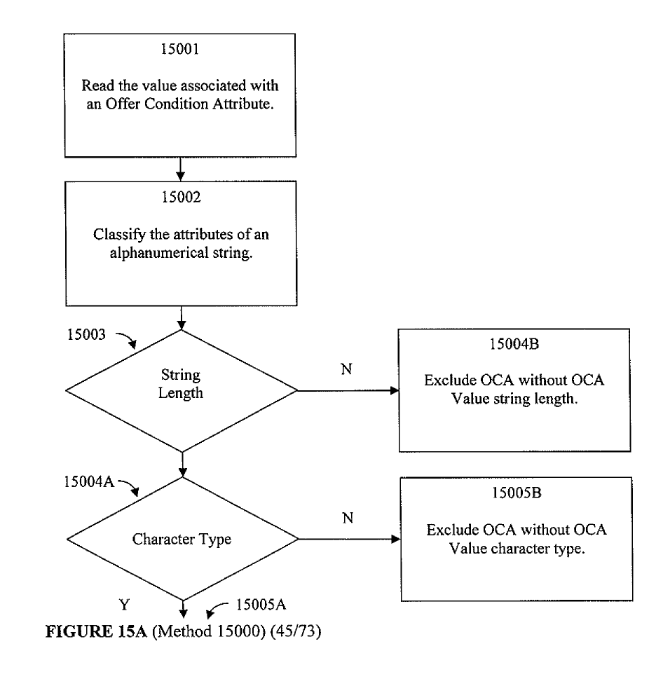

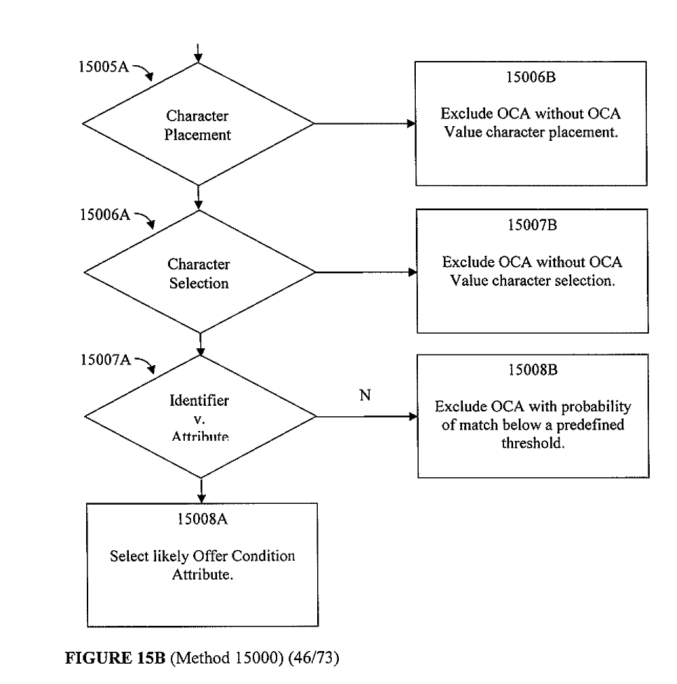

FIG. 15A and FIG. 15B depicts a diagram of a flow chart of an exemplary computer-implemented method, Method 15000, that when executed can exchange and process data to identify a plurality of equal or equivalent Offer Condition Attributes, according to one embodiment. The flowchart refers to the apparatus and structures depicted in FIG. 13A through FIG. 14. However, the method is not limited to those embodiments. The method can implement the steps described herein utilizing a subset of the components, any combination of the components, or additional, related, alternative, and/or equivalent components depicted in FIG. 13A through FIG. 14 and/or elsewhere in the application. The method can execute a subset of the steps, any combination of the steps, the steps in different order, and/or additional, related, alternative, or equivalent steps.

There is no standard for defining the naming, format, and/or structure of Offer Condition Attributes. In a first example, a first CPP can enable a user of a program to select a default name of an Offer Condition Attribute, e.g., “Start Date” while a second CPP can use a different default name for the same Offer Condition Attribute, e.g., “Begin Date”. In a second example, a CPP can enable a user of a program to use any name to label or describe an Offer Condition Attribute, e.g., “Coupon Start”.

One or more embodiments of the invention can apply comparator logic to compare the value of an attribute in a Data Structure storing data describing one or more Products offered by Retailer Server 02300, a Data Structure storing data describing one or more Offers made by any party, and/or a Data Structure storing data describing one or more Fund Accounts held by any party including without limitation: a User, Retailer Server 02300, any party making an Offer, and/or any other party executing one or more functions in a Transaction. The one or more embodiments of the invention can apply comparator logic to compare the value of an attribute in one or more of the preceding Data Structures with a value of an attribute received or transmitted by Exchange Server 02200. For example, Exchange Server 02200 can transmit a request to Authenticate, identify a Qualifying Retailer, identify a Qualifying Offer, and/or Authorize a withdrawal from or deposit to a Qualifying Fund Account. If the comparator determines a match, one or more embodiments of the invention can proceed to the next function enabling a Transaction. If the comparator does not determine a match, one or more embodiments of the invention can proceed to the next identifier, Retailer Data Structure, Offer Data Structure, Fund Account Data Structure, or any other data and/or instructions enabling a Transaction.

To determine a match between the value of an attribute received, e.g., any attribute in Transaction Attribute Value Set 06700, and a value or set of values of an attribute in any Data Structure, e.g., Retailer Data Structure, Offer Data Structure, and/or Fund Account Data Structure, one or more embodiments of the invention can determine a match among a plurality of attributes. If an attribute in a Data Structure is not the same attribute in a Transaction Attribute Value, then applying a comparator to compare the value of each attribute would not identifying a match. For example, if an Offer Data Structure specified an Offer Condition Attribute with the name “Product Identifier” and a Transaction Attribute Value Set 06700 specified an attribute with the name “Producer Identifier”, comparing the value of each attribute would not enable the identification of a Qualifying Offer.

To determine the probability that an Offer Condition Attribute specified in a first Data Structure is the same Offer Condition Attribute specified in a second Data Structure, one or more embodiments of the invention can exploit the information embedded in the Offer Condition Attribute Values. Many classes of identifiers have standard character length, character type, and character placement. While a first Data Structure may use a different name of an attribute for a health Product than a second Data Structure, the string length, character type, character placement, and/or character selection of a alphanumeric string can reveal the likely class of identifier. For example, a HCPCS identifier includes a defined set of characters, character type, character placement, and character selection. The HCPCS identifier for a primary care physician starts with an alphabet two-character string “AG” and ends with a five-digit numerical string “00100”. Reading the identifier and parsing the attributes of the identifier can increase the probability of determining the correct attribute associated with the identifier. Identifying the number, type, placement, and arrangement of an identifier can provide a less ambiguous indication of the associated attribute than the attribute name itself.

One or more embodiments of the invention can use pattern matching techniques including without limitation the use of regular expressions alone or in combination with other feature extraction and pattern classification techniques to the attribute value string or the combination of the attribute value string and one or more other strings, e.g., the associated attribute name string (in the same column) and/or the associated long- or short-description (in the same row).

At 15001, Method 15000 can read the value associated with any Offer Condition Attribute name. For example, in an Offer Data Structure administered by Insurer Server 27000 storing the Products for which an Offer can qualify, Insurer Server 27000 can assign the Offer Condition Attribute name “Provider” and store one or more records of each qualifying provider where each record can include an identifier in the format of a HCPCS code.

At 15002, Method 15000 can read the Offer Condition Attribute value and determine one or more attributes of the identifier, e.g., the number of characters, the type of characters (e.g., alphabetical and/or numerical), the placement of specific types of characters in positions (e.g., an alphabet in the first character digit), and/or the selection of the characters in a given position (e.g., the selection of an upper case two-digit alphabet string between “A” and “0”).

At 15003, Method 15000 can apply comparator logic to compare: (a) the string length of the string associated with an Offer Condition Attribute; with (b) the string length of a string in a Transaction Attribute. If the comparator logic determines a match, Method 15000 can proceed to 15004A. If the comparator logic does not determine a match, Method 15000 can proceed to 15004B and exclude the Offer Condition Attribute with a different string length.

At 15004A, Method 15000 can apply comparator logic to compare: (a) the type of characters in the string associated with an Offer Condition Attribute; with (b) the type of characters in the string associated with a Transaction Attribute. If the comparator logic determines a match, Method 15000 can proceed to 15005A. If the comparator logic does not determine a match, Method 15000 can proceed to 1500513 and exclude the Offer Condition Attribute with a different character type.

At 15005A, Method 15000 can apply comparator logic to compare: (a) the placement of characters in the string associated with an Offer Condition Attribute; with (b) the placement of characters in the string associated with a Transaction Attribute. If the comparator logic determines a match, Method 15000 can proceed to 15006A. If the comparator logic does not determine a match, Method 15000 can proceed to 15006B and exclude the Offer Condition Attribute with a different character placement.

At 15006A, Method 15000 can apply comparator logic to compare: (a) the selection of characters in the string associated with an Offer Condition Attribute; with (b) the selection of characters in the string associated with a Transaction Attribute. If the comparator logic determines a match, Method 15000 can proceed to 15007A. If the comparator logic does not determine a match, Method 15000 can proceed to 15007B and exclude the Offer Condition Attribute with a different character selection.

At 15007A, Method 15000 can apply comparator logic to compare: (a) the string associated with an Offer Condition Attribute; with (b) data in the associated row and/or column of the Data Structure. For example, Offer Data Structure can include a short- and/or long-description of a Product in the same row as the Product Identifier. Method 15000 can use one or more methods of determining the probability of association of a given identifier and the value of other attributes in the same row and/or column. If the comparator logic determines a match above a predefined threshold, Method 15000 can proceed to 15007A. If the comparator logic does not determine a match above a predefined threshold, Method 15000 can proceed to 15007B and exclude the Offer Condition Attribute.

At 15008A, Method 15000 can select a likely Offer Condition Attribute associated with the value evaluated.

While one or more embodiments of the invention select the specific attributes of an identifier in FIG. 15, the invention is not limited to those embodiments. One or more embodiments of the invention can apply the comparator logic in Method 15000 to one or more attributes of any class.

While one or more embodiments of the invention evaluate an Offer Condition Attribute in FIG. 15, the invention is not limited to that embodiment. One or more embodiments of the invention can apply the comparator logic in Method 15000 to any class of attributes including without limitation: a product attribute, and/or a Fund Account attribute.

Enabling one or more embodiments of the invention to execute function (c) produces a well-defined, particular, immediate, and real-world benefit to the public because an Existing Offer can have differing Offer Values for each of a plurality of Users even if the Offer Condition example, even if the Offer Condition Attribute Value associated with each and every Offer Condition Attribute, including the Cumulative Transaction Value Condition Attribute, were constant, the Offer Value can differ between any two Users because a first User can have a first Cumulative Transaction Value and a second User can have a second Cumulative Transaction Value. In a first example, if the first User and second User each used the same specified Payment Method, e.g., a Capital One® Visa® Platinum Credit Card associated with a Cumulative Transaction Value Condition setting a maximum cumulative value of Transactions and a Cumulative Transaction Value limit of $5,000, the Offer Value for the first User can differ from the Offer Value for the second User depending on the Cumulative Transaction Value for each User as of the purchase of the Product of Interest. In a second example, if the first User and second User each used the same Health Insurance Product, e.g., one offered by Humana® Health Plans associated with a Cumulative Transaction Value Condition setting a minimum cumulative value of Transactions and a Cumulative Transaction Value deductible of $1,500, the Offer Value for the first User can differ from the Offer Value for the second User depending on the Cumulative Transaction Value for each User as of the purchase of the Product of Interest.

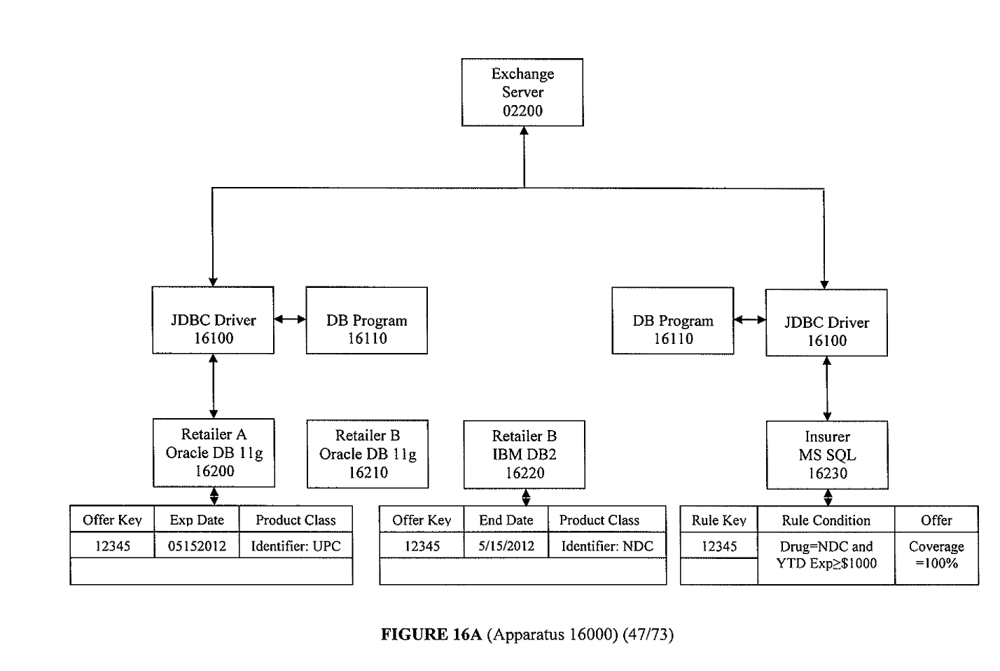

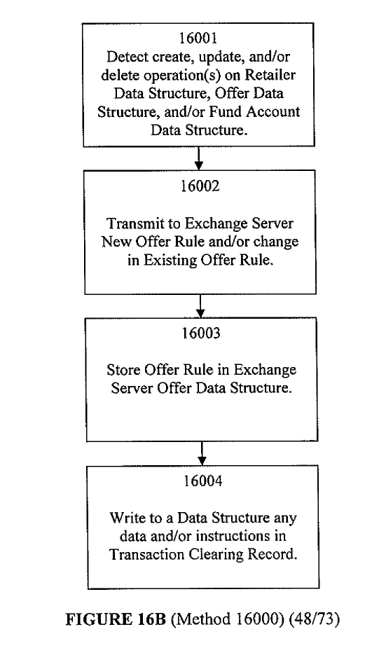

FIG. 16A depicts a block diagram of an exemplary apparatus (e.g., a distributed apparatus performing distributed computing), Apparatus 16000, enabling the exchange and processing of data to detect any creation, update, and/or deletion operation on one or more Offer Data Structures, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components, Data Structures, data, and/or instructions.

Java Database Connectivity (“JDBC”) Driver 16100 can be a CPP enabling a Java CPP to exchange data with a Data Structure. While one or more embodiments of the invention can illustrate the use of a JDBC Driver, the invention is not limited to that embodiment. One or more embodiments of the invention can use any CPP enabling another CPP to exchange data with a Data Structure including without limitation: an Open Database Connectivity (“ODBC”) driver, an ADO.NET driver and/or a JDBC-ODBC bridge utilizing the ODBC Driver to exchange data with a Data Structure.

Database Program 16110 can be a CPP enabling the automatic execution of any CPP Operations, which can include without limitation: (a) CPP Retailer Operations; (b) CPP Offer Operations; and/or (c) CPP Fund Account Operations.

Retailer A Oracle® DB 11g 16200 can be an exemplary CPP enabling the creation, reading, updating, and/or deletion of data in a Data Structure, which in this example can store data associated with an Offer limited to one or more Products in a Product Class in the UPC format and expiring on May 15, 2012 in a MMDDYYYY format.

Retailer B IBM® DB2 16220 can be an exemplary CPP enabling the creation, reading, updating, and/or deletion of data in a Data Structure, which in this example can store data associated with an Offer limited to one or more Products in a Product Class in the NDC format and expiring on May 15, 2012 in a MM/DD/YYYY format.

Insurer MS SQL 16230 can be an exemplary CPP enabling the creation, reading, updating, and/or deletion of data in a Data Structure, which in this example can store data associated with an Offer limited to one or more Products in a Product Class in the NDC format and including an event-condition-action rule with a condition component requiring both a Product in the NDC format and a Cumulative Transaction Value exceeding $1,000 during a calendar year.

FIG. 16B depicts a diagram of a flow chart of an exemplary computer-implemented method, Method 16000, that when executed can exchange and process data to detect any creation, update, and/or deletion operation on one or more Offer Data Structures, according to one embodiment. The flowchart refers to the apparatus and structures depicted in FIG. 16A. However, the method is not limited to those embodiments. The method can implement the steps described herein utilizing a subset of the components, any combination of the components, or additional, related, alternative, and/or equivalent components depicted in FIG. 16A and/or elsewhere in the application. The method can execute a subset of the steps, any combination of the steps, the steps in different order, and/or additional, related, alternative, or equivalent steps.

At 16001, Method 16000 can detect one or more create, update, and/or delete operations executed on any Data Structure including without limitation: (a) one or more Retailer Data Structures; (b) one or more Offer Data Structures; and/or (c) one or more Fund Account Data Structures.

At 16002, Method 16000 can transmit to Exchange Server 02200 any rule representing a New Offer and/or any change in a rule representing an Existing Offer.

At 16003, Method 16000 can store the one or more Offer rules in an Offer Data Structure locally accessible to Exchange Server 02200.

At 16004, Method 16000 can write to a Data Structure any data and/or instructions applicable to the Data Structure in a Transaction Clearing Record.

One or more embodiments of the invention produces a well-defined, particular, immediate, and real-world benefit to the public because: (a) installing a CPP like Database Program 16110 can enable one or more embodiments of the invention to exchange data and/or instructions with one or more existing Data Structures and automatically detect any new records and/or modification of existing records; and/or (b) detecting automatically any new records and/or modification of existing records and transmitting such data to Exchange Server 02200 for storage on a local Data Structure can decrease the time to identify one or more Qualifying Offers, since transmitting a query to and receiving a response from all Data Structures for every User Query can take a long time.

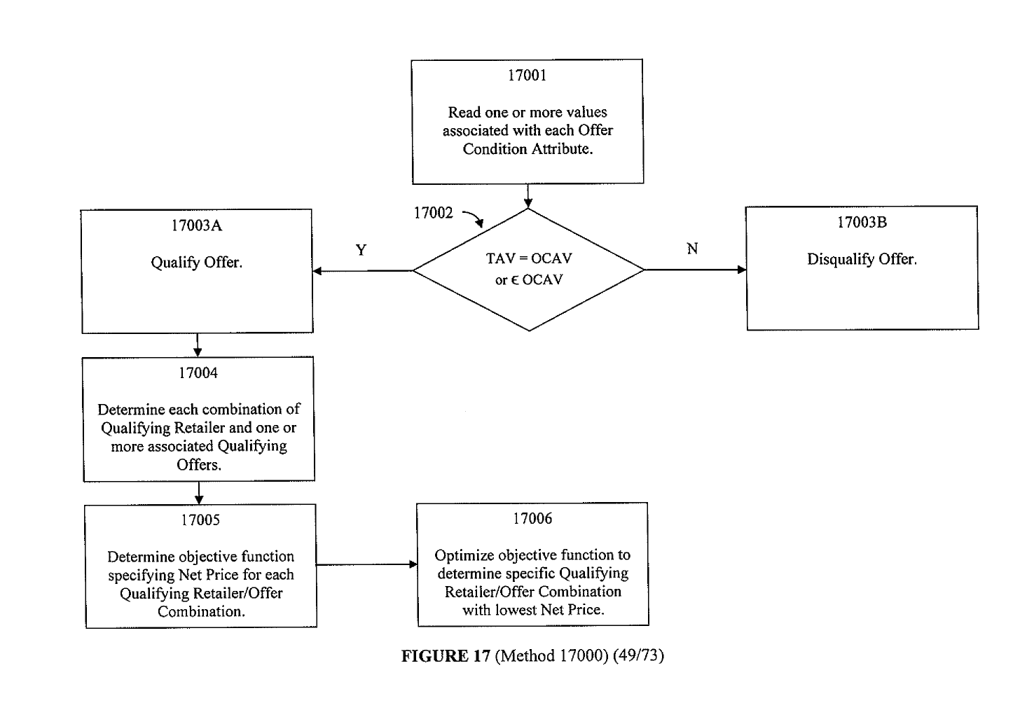

FIG. 17 depicts a diagram of a flow chart of an exemplary computer-implemented method, Method 17000, that when executed can exchange and process data to identify one or more Qualifying Offers and/or determine a Qualifying Retailer/Offer Combination which can minimize or decrease below a predefined threshold the Net Price, according to one embodiment. The flowchart refers to the apparatus and structures depicted in FIG. 13A through FIG. 16B. However, the method is not limited to those embodiments. The method can implement the steps described herein utilizing a subset of the components, any combination of the components, or additional, related, alternative, and/or equivalent components depicted in FIG. 13A through FIG. 16B and/or elsewhere in the application. The method can execute a subset of the steps, any combination of the steps, the steps in different order, and/or additional, related, alternative, or equivalent steps.

At 17001, Method 17000 can read one or more values associated with each of one or more Offer Condition Attributes associated with each Offer. In a first embodiment, Method 17000 can transmit a query to one or more Offer Data Structures stored on each Data Processing System 01000 described in Apparatus 06000, e.g., Server 06300. In a second embodiment, Method 17000 can transmit a query to one or more Offer Data Structures stored on Exchange Server 02200, which at any time before a Transaction can receive from each Offer Data Structure one or more Offers detected by Database Program 16110. Because Database Program 16110 can automatically detect any New Offer or change to an Existing Offer stored on an Offer Data Structure and transmit to Exchange Server 02200 the one or more New Offers and/or changes to one or more Existing Offers, Method 17000 can identify one or more Qualifying Offers faster by querying the Offers stored on Exchange Server 02200.

At 17002, Method 17000 can apply comparator logic to compare each Transaction Attribute Value to the Offer Condition Attribute Value (where the Offer Condition Attribute specifies a single value) or set of Offer Condition Attribute Values associated with an Offer Condition Attribute equal or equivalent to a Transaction Attribute. If the comparator logic determines an Offer Match, Method 17000 can proceed to 17003A. If the comparator logic does not determine an Offer Match, Method 17000 can proceed to 17003B, which can terminate the process for the Offer. In another embodiment, the invention can still determine an Offer Match by “relaxing” one or more Offer Condition Attributes through amending an Offer Condition Attribute Value or deleting an Offer Condition Attribute.

For example, a first Offer made by a first Payment Issuer 02800 can include an Offer Condition Attribute specifying a Cumulative Transaction Value Condition of, e.g., a maximum cumulative value of Transactions executed by a User in an account over a predefined time period like qualifying an Offer like 5% cash back of the value of Transactions in a Product Class like gasoline only if the cumulative value of gasoline Transactions is less than $500 per calendar year. A second Offer made by a second Payment Issuer 02800 can include an Offer Condition Attribute specifying a Cumulative Transaction Value Condition limiting an Offer of 2% cash back only if the cumulative value of gasoline Transactions is less than $1,000 per year ending with the anniversary of the User starting the account. Even though the first Offer would have a higher Offer Value of 5% than the second Offer associated with an Offer Value of 2%, one or more embodiments of the invention can reject the first Offer as a Qualifying Offer if the User has already executed more than $500 of gasoline Transactions in the calendar year and accept the second Offer as a Qualifying Offer if the User has executed less than $1,000 of gasoline Transactions in the account year. So a comparison of the values in Transaction Attribute Value Set 06700 including values for a Transaction Attribute of value of Transaction (equal to an amount which added to the Cumulative Transaction Value may or may not exceed the Cumulative Transaction Value Condition), a Product Class Identifier (equal to gasoline), and the date with the values of the respective equal or equivalent Offer Condition Attribute can yield two different determinations of a Qualifying Offer.

At 17004, Method 17000 can determine each candidate combination of a Qualifying Retailer and one or more associated Qualifying Offers. While one or more embodiments of the invention may identify a Qualifying Offer by executing 17002, there may be further conditions limiting the applicability of a Qualifying Offer associated with any Qualifying Retailer. For example, an Offer Condition Attribute specifying an Offer Combination Condition may limit the applicability of an Offer with a specific Retailer, e.g., Producer Server 02400 can make an Offer which can be combined with an Offer made by Retailer A, but not an Offer made by Retailer B. Method 17000 can apply further comparator logic to associate each Qualifying Offer with each Qualifying Retailer.

At 17005, Method 17000 can determine an objective function specifying the Net Price for each Qualifying Retailer/Offer Combination. Method 17000 can generate an objective function where the Net Price for each Qualifying Retailer/Offer Combination equals the sum of the Offer Values associated with each Qualifying Retailer and each of one or more Qualifying Offers in the Qualifying Retailer/Offer Combination. For example, one objective function would equal the sum of the variables specified in the first column in Offer Combination Window 32000 starting with “Retailer Price” and ending with “Sales Tax Offer”.

In general, any Qualifying Retailer/Offer Combination, o, is associated with some number M_{C} of costs cⱼ, where 1≦j≦M_{C} and some number M_{B} of benefits bₖ where 1≦k≦M_{B}. Costs associated with a Qualifying Retailer/Offer Combination can include without limitation: Retailer Server 02300 price of the Product and/or Shipper Server 03400 cost of shipping the Product. Benefits associated with a Qualifying Retailer/Offer Combination can include without limitation: Retailer Server 02300 discount for members of its Loyalty Program, Producer Server 02400 discount, and/or Insurer Server 02700 coverage for x percent of the price. Method 17000 can determine the Net Price associated with any given Qualifying Retailer/Offer Combination as an objective function:

P(o)=ψ(o)=Σⱼ₌₁^{M}^{_{B}}bⱼ(o)−Σₖ₌₁^{M}^{_{C}}Cₖ(o) (Equation 1)

where Method 17000 can determine the optimal Qualifying Retailer/Offer Combination o*:

o*=min_{oεO} arg(ψ(o)) (Equation 2)

where O represents the set of Qualifying Retailer/Offer Combinations, {o₁, o₂, . . . , o_{N}}.

Method 17000 can apply any sorting algorithm to identify o*.

At 17006, Method 17000 can optimize the objective function to determine the specific Qualifying Retailer/Offer Combination yielding the lowest Net Price or a Net Price below a predefined threshold. In a first embodiment, Method 17000 can use an exhaustive iterative search through all Qualifying Retailer/Offer Combinations. In a second embodiment, Method 17000 can use any sorting algorithm to sort and rank a plurality of Qualifying Retailer/Offer Combinations. Method 17000 can select a different sorting algorithm depending one or more factors, e.g., the types and number of Qualifying Retailer/Offer Combinations, and/or the requirements. For example, one sort algorithm may be more efficient in sorting and ranking a small number of Qualifying Retailer/Offer Combinations and another sort algorithm may be more efficient in sorting and ranking a large number of Qualifying Retailer/Offer Combinations. The set of Qualifying Retailer/Offer Combinations may be small in the case of a single Product Identifier limited to a specified distance from the User, e.g., the set of Qualifying Retailer/Offer Combinations identified in response to a User Query like “what is the lowest Net Price of Product X sold at a store within 1 mile from my location?” The set of Qualifying Retailer/Offer Combinations may be large in the case of a Product Class with relatively wide ranges for one or more attributes in the specified of Transaction Attribute Value Set 06700. In a third embodiment, Method 17000 can use any algorithm other than a sort algorithm, e.g., any algorithm in the class of evolutionary algorithms, to identify the Qualifying Retailer/Offer Combination yielding the lowest Net Price or a Net Price below a predefined threshold. After using a sort algorithm or any algorithm other than a sort algorithm to generate a list or ranking by Net Price of Qualifying Retailer/Offer Combinations, Method 17000 can select the Qualifying Retailer/Offer Combination with the lowest Net Price or select a Qualifying Retailer/Offer Combination with a Net Price below a predefined threshold, e.g., “Product X at any Net Price below $500”.

There may be cases where a User can still value the identification of a Qualifying Retailer/Offer Combination yielding not the lowest Net Price, but a Net Price below a predefined threshold. For example, a User can specify in a User Query that he/she is willing to purchase a Product with any Net Price below a predefined threshold.

To determine the Qualifying Retailer/Offer Combination with a Net Price below a predefined threshold which may not be the lowest Net Price, one or more embodiments of the invention can use one or more algorithms which can identify local minimums, but not necessarily global minimums. For example, Method 17000 can use a gradient descent algorithm to find a local minimum and use other methods to configure an objective function to increase the efficiency of identifying a local minimum.

One or more embodiments of the invention can identify not only Qualifying Offers with a Static Offer Value, but Qualifying Offers with a Dynamic Offer Value. One or more embodiments of the invention can include without limitation: (a) Method 17100 for determining an Offer Value which can maximize or increase above a predefined threshold the value of an objective function for a Producer Server 02400, e.g., the profit on the sale of the Product; (b) Method 17200 for determining an Offer Value which can maximize or increase above a predefined threshold the value of an objective function for a Retailer Server 02300, e.g., the profit on the sale of the Product; and/or (c) Method 17300 for determining an Offer Value which can maximize or increase above a predefined threshold the value of an objective function for both a Producer Server 02400 and a Retailer Server 02300, e.g., the total profit earned by both Producer Server 02400 and Retailer Server 02300 on the sale of a Product.

Method 17100 is an exemplary computer-implemented method that when executed can determine an Offer Value which can maximize or increase above a predefined threshold the value of an objective function for a Producer Server 02400, according to one embodiment. The flowchart refers to the apparatus and structures depicted in FIG. 13A through FIG. 16B. However, the method is not limited to those embodiments. The method can implement the steps described herein utilizing a subset of the components, any combination of the components, or additional, related, alternative, and/or equivalent components depicted in FIG. 13A through FIG. 16B and/or elsewhere in the application. The method can execute a subset of the steps, any combination of the steps, the steps in different order, and/or additional, related, alternative, or equivalent steps.

At 17101, Method 17100 can define an environment ENV which can comprise one or more variables and/or relationships including without limitation: (a) a Product of Interest; (b) a Producer Server 02400 of the Product of Interest; (c) a demand schedule describing the demand for the Product of Interest as a function of one or more variables, e.g., a Retailer Price for the Product of Interest; (d) a supply schedule describing the supply of the Product of Interest as a function of one or more variables, e.g., the amount of available materials or the amount of available labor; and/or (e) a set of candidate Offer Values associated with an Offer related to the Product of Interest.

For example, Method 17100 can generate a demand schedule based on one or more variables and/or relationships including without limitation, prior sales, market research, or other data available to Producer Server 02400 where a candidate Offer Value, P, can generate a unit demand, Q, for the Product of Interest of:

\hat{Q}=f(P) (Equation 3)

Based on data available to Producer Server 02400, Method 17100 can generate a supply schedule based on one or more variables and/or relationships where the cost of producing Q units of the Product of Interest can be:

C(\hat{Q})=g(\hat{Q}) (Equation 4)

At 17102, Method 17100 can determine an objective function generating a value or performance measure, μ, e.g., the expected gross profit equal to the difference between revenues and expenses (e.g., cost of Product sold) of Producer Server 02400.

A candidate value of objective function, OF(P), Method 17100 can optimize is expected gross profit, ft:

μ=\hat{π}(P)=P\hat{Q}−C(\hat{Q})=Pf(P)−g(f(P)) (Equation 5)

At 17103, Method 17100 can determine a method or an adaptive plan which can identify an optimal Offer Value, P*, which maximizes or increases above a predefined threshold the objective function, \hat{π}(P), given the environment ENV.

P*=arg(max \hat{π}(P)) (Equation 6)

Where Method 17100 can differentiate f(P) and g(\hat{Q}), it can determine the maximum through a system of differential equations:

$$\begin{matrix}\frac{d \hat{π}}{d P} = P \frac{d f}{d P} + f - \frac{d g}{d f} \frac{d f}{d P} & ( Equation 7 ) \\ \frac{{d}^{2} \hat{π}}{d {P}^{2}} = P \frac{{d}^{2} f}{d {P}^{2}} + 2 \frac{d f}{d P} - \frac{d}{d P} ( \frac{d g}{d f} \frac{d f}{d P} ) < 0 & ( Equation 8 )\end{matrix}$$

In another embodiment, Method 17100 can generate a demand schedule which reflects one or more additional variables. In one example, Method 17100 can estimate that at some nominal price, P=P₀, the likely demand for the Product of Interest is Q=Q₀. Also, Method 17100 can estimate the price elasticity of demand for the Product of Interest:

$${E}_{D} {\vert}_{P = {P}_{0}} = {E}_{D 0} = {[ \frac{\partial \hat{Q}}{\partial P} / \frac{\hat{Q}}{P} ]}_{P = {P}_{0}} \qquad ( Equation 9 )$$

Producer Server 02400 can generate a demand schedule using a sigmoid function matched to the parameters P₀, Q₀, and E_{D0}. One exemplary demand model is the logistic function:

$$S ( Q ) = \frac{1}{1 + {e}^{- β ( Q - Q 0 )}} \qquad ( Equation 10 )$$

Other exemplary demand models can include without limitation: a Gompertz curve, an arctangent function, a hyperbolic tangent, a cumulative distribution function of continuous probability density functions, and/or a bounded differentiable real function defined for all real input values and which has a positive derivative everywhere. For example, implementing the demand schedule using a logistic function can yield:

$$\hat{Q} = f ( P ) = ( {Q}_{0} - Δ Q ) + \frac{Δ Q}{1 + {e}^{- β ( P - {P}_{0} )}} \qquad ( Equation 11 )$$

Method 17100 can estimate a shape parameter β from the expected demand elasticity at P=P₀ by minimizing a second objective function with respect to β:

$$φ ( β ) = {( {E}_{D 0} - {[ \frac{\partial \hat{Q}}{\partial P} / \frac{\hat{Q}}{P} ]}_{P = {P}_{0}} )}^{2} \qquad ( Equation 12 )$$

Method 17100 can then solve the system of equations:

$$\begin{matrix}\frac{d φ}{d β} = 0 & ( Equation 13 ) \\ \frac{{d}^{2} φ}{d {β}^{2}} > 0 & ( Equation 14 )\end{matrix}$$

Method 17200 is an exemplary computer-implemented method that when executed can determine an Offer Value which can maximize or increase above a predefined threshold the value of an objective function for a Retailer Server 02300, according to one embodiment. The flowchart refers to the apparatus and structures depicted in FIG. 13A through FIG. 16B. However, the method is not limited to those embodiments. The method can implement the steps described herein utilizing a subset of the components, any combination of the components, or additional, related, alternative, and/or equivalent components depicted in FIG. 13A through FIG. 16B and/or elsewhere in the application. The method can execute a subset of the steps, any combination of the steps, the steps in different order, and/or additional, related, alternative, or equivalent steps.

At 17201, Method 17200 can define an environment ENV which can comprise one or more variables and/or relationships including without limitation: (a) a Product of Interest; (b) a Retailer Server 02300 offering the Product of Interest; (c) a demand schedule describing the demand for the Product of Interest as a function of one or more variables, e.g., a Retailer Price for the Product of Interest; (d) a supply schedule describing the supply of the Product of Interest as a function of one or more variables, e.g., the amount of inventory of the Product of Interest; and/or (e) a set of candidate Offer Values associated with an Offer related to the Product of Interest.

At 17202, Method 17100 can determine an objective function generating a value or performance measure, μ, e.g., the expected gross profit equal to the difference between revenues and expenses (e.g., cost of Product sold) of Retailer Server 02300.

A candidate value of objective function, OF(P), Method 17100 can optimize is expected gross profit:

μ=P\hat{Q}−C(\hat{Q}) (Equation 15)

At 17203, in a first embodiment, Method 17200 can execute Equation 3 through Equation 8 except Method 17200 can optimize the gross profit for Retailer Server 02300 and the cost for Retailer Server 02300 is the price Producer Server 02400 charges Retailer server 02300 for the Product of interest.

In a second embodiment, Method 17200 can optimize an objective function where the price of the Product of Interest charged by Producer Server 02400 varies by the unit volume purchased by Retailer Server 02300. For example, Producer Server 02400 can charge a price of p₁ if Retailer Server 02300 purchases a volume between quantities q₁₁ and q₁₂ units; p₂ if Retailer Server 02300 purchases a volume between quantities q₂₁ and q₂₂ units; and p₃ if Retailer Server 02300 purchases a volume between quantities q₃₁ and q₃₂ units. Given the same objective function, Method 17200 can include these additional relationships:

\hat{Q}=f(P) (Equation 16)

and

C(\hat{Q})=\hat{Q}·p(\hat{Q}) (Equation 17)

$$p ( Q ) = \{ \begin{matrix}{p}_{1} , & Q < {q}_{1} \\ {p}_{2} , & {q}_{1} \leq Q < {q}_{2} \\ {p}_{3} & Q \geq {q}_{2}\end{matrix} \qquad ( Equation 18 )$$

For example, where the cost function is not differentiable and/or there is no closed-form solution to maximizing OF, Method 17200 can determine the maximum through iteration.

Method 17300 is an exemplary computer-implemented method that when executed can determine an Offer Value which can maximize or increase above a predefined threshold the value of an objective function for a combination of Retailer Server 02300 and Producer Server 02400, according to one embodiment. The flowchart refers to the apparatus and structures depicted in FIG. 13A through FIG. 16B. However, the method is not limited to those embodiments. The method can implement the steps described herein utilizing a subset of the components, any combination of the components, or additional, related, alternative, and/or equivalent components depicted in FIG. 13A through FIG. 16B and/or elsewhere in the application. The method can execute a subset of the steps, any combination of the steps, the steps in different order, and/or additional, related, alternative, or equivalent steps.

At 17301, Method 17300 can define an environment ENV which can comprise one or more variables and/or relationships including without limitation: (a) a Product of Interest; (b) a Retailer Server 02300 offering the Product of Interest; (c) a Producer Server 02400 producing the Product of Interest; (d) a demand schedule describing the demand for the Product of Interest as a function of one or more variables, e.g., a Retailer Price for the Product of Interest; (e) a supply schedule describing the supply of the Product of Interest as a function of one or more variables, e.g., the amount of inventory of the Product of Interest held by Retailer Server 02300, the amount of inventory of the Product of Interest held by Producer Server 02400, and the production schedule of the Product of Interest for Producer Server 02400; and/or (f) a set of candidate Offer Values associated with an Offer related to the Product of Interest.

At 17302, Method 17300 can determine an objective function generating a value or performance measure, μ, e.g., the expected gross profit equal to the difference between revenues and the expenses of Producer Server 02400 and the incremental expenses (i.e., the expenses separate from the Producer Server 02400 expenses) of Retailer Server 02300.

At 17303, Method 17300 can determine a method or an adaptive plan which can identify an optimal Offer Value, P (Optimal), which maximizes or increases above a predefined threshold the objective function value, μ, given the environment ENV.

In one embodiment, Methods 17100, 17200, and 17300 can seek to optimize an objective function ψ(P) in order to identify a preferred value of the Offer Value, P*:

P*=arg( [symbol] ψ(P)) (Equation 19)

where [symbol] is a subset of all possible P for which a method satisfies additional arbitrary constraints. When a method defines P not as the absolute maximum, for example, but just a value of P for which ψ(P) falls below some threshold, a method can define [symbol] ′ as:

[symbol]

′={P|ψ(P)≦ψₘᵢₙ} (Equation 20)

Moreover, a method can define [symbol] ′ in terms of the computational procedure itself that is seeking to arrive at P*. If Ωₖ[ψ, [symbol] ′] denotes the sequential or parallel processing instructions executed by the kth step, Pₖ* represents an estimate of the method of P* at that step in the iteration:

Ωₖ[ψ, [symbol] ′]→Pₖ* (Equation 21)

where some adaptive plan, π, defines the determination of successive operations Ω₁, Ω₂, . . . , Ωₖ, . . . . In general, the adaptive plan can define some procedure for halting further computation and returning the best estimate of P* up to that point. One such halting procedure can return the last computed estimate of P*, i.e., Pₖ*, provided that the incremental difference between it and the penultimate estimate, Pₖ₋₁*, is less than some threshold, δ:

|Pₖ*−Pₖ₋₁*|≦δ (Equation 22)

A method can define another such halting condition in terms of the fractional change in āₖ* in terms of some other threshold, ε:

$$\vert \frac{{P}_{k}^{*} - {P}_{k - 1}^{*}}{{P}_{k - 1}^{*}} \vert \leq ∈ \qquad ( Equation 23 )$$

When such computational considerations are taken into account, a method can express P* as:

ā*=τ[arg( [symbol] ψ(P))] (Equation 24)

where τ represents the adaptive plan used to arrive at P*, encompassing the actual computational process used to produce an estimate to the solution of the above equation, with all the requisite processing steps and conditions.

### Automatic Fund Account Identification

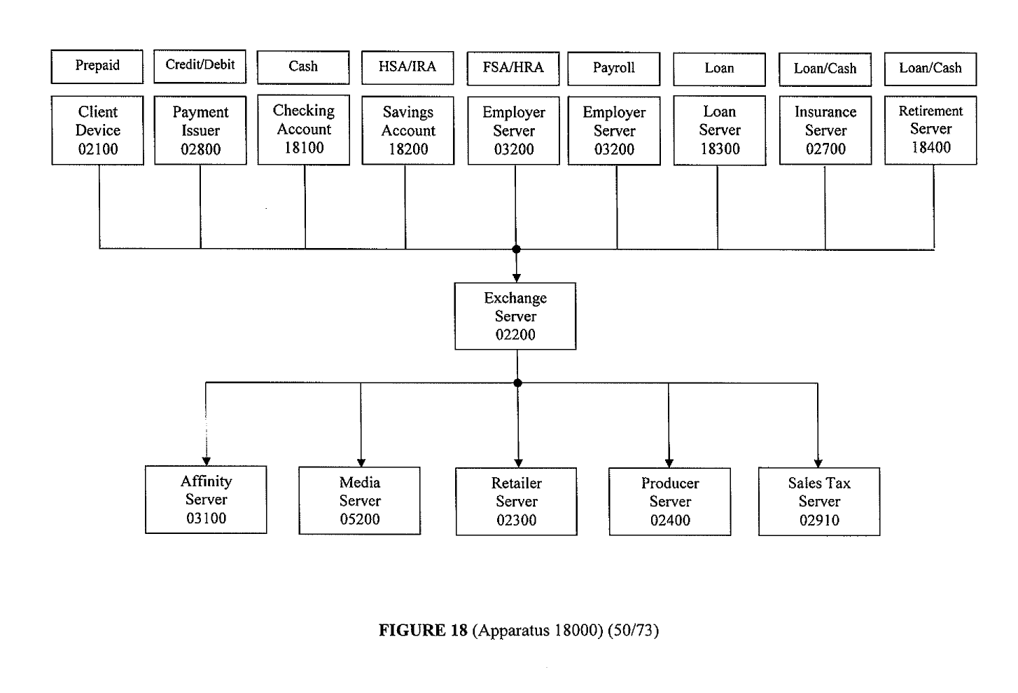

FIG. 18 depicts a block diagram of an exemplary apparatus (e.g., a distributed apparatus performing distributed computing), Apparatus 18000, enabling the exchange and processing of data to determine a set of Qualifying User Fund Accounts and Withdrawal Amounts which can minimize or decrease the Total User Fund Account Withdrawal Cost and/or maximize or increase the Total User Fund Account Withdrawal Benefit, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components, Data Structures, data, and/or instructions.

Client Device 02100 can execute one or more functions enabling the withdrawal of a Withdrawal Amount from any Fund Account stored on Client Device 02100, e.g., a Stored Value Account (e.g., holding value of a prepaid account) stored in any Data Storage Device like a memory coupled to a NFC Processor enabling transmission of any data and/or instructions enabling the withdrawal of the Withdrawal Amount.

Checking Account 18100 can be a Data Processing System 01000 administered by an Administrator of a Fund Account, e.g., a Checking Account, held by the User.

Savings Account 18200 can be a Data Processing System 01000 administered by an Administrator of a Fund Account, e.g., an HSA and/or an IRA, held by the User.

Loan Server 18300 can be a Data Processing System 01000 administered by an Administrator of a Loan Account, e.g., a credit line, held by the User.

Insurance Server 02700 can be a Data Processing System 01000 administered by an Administrator of a Loan Account, e.g., a whole life insurance Product against which the User can borrow funds, held by the User.

Retirement Server 18400 can be a Data Processing System 01000 administered by an Administrator of a retirement Fund Account, e.g., a 401(k) plan or a defined benefit pension plan, held by the User.

While one or more embodiments of the invention describes an apparatus comprising the preceding User Fund Accounts and Fund Account Administrators, the invention is not limited to that embodiment. One or more embodiments of the invention can include an apparatus comprising one or more other User Fund Accounts from which it can withdraw a Withdrawal Amount.

A Payment Network connecting more than two Fund Accounts each of which is held by parties other than a User and a Retailer Server 02300 calls for the identification of one or more Qualifying User Fund Accounts and the determination of a Withdrawal Amount from each Qualifying Fund Account. Moreover, without analyzing the Fund Account Benefit Attribute(s) and Fund Account Cost Attribute(s) of each Qualifying User Fund Account, a User is unlikely to determine an optimal Qualifying User Fund Account Combination and the Withdrawal Amount associated with each Qualifying User Fund Account.

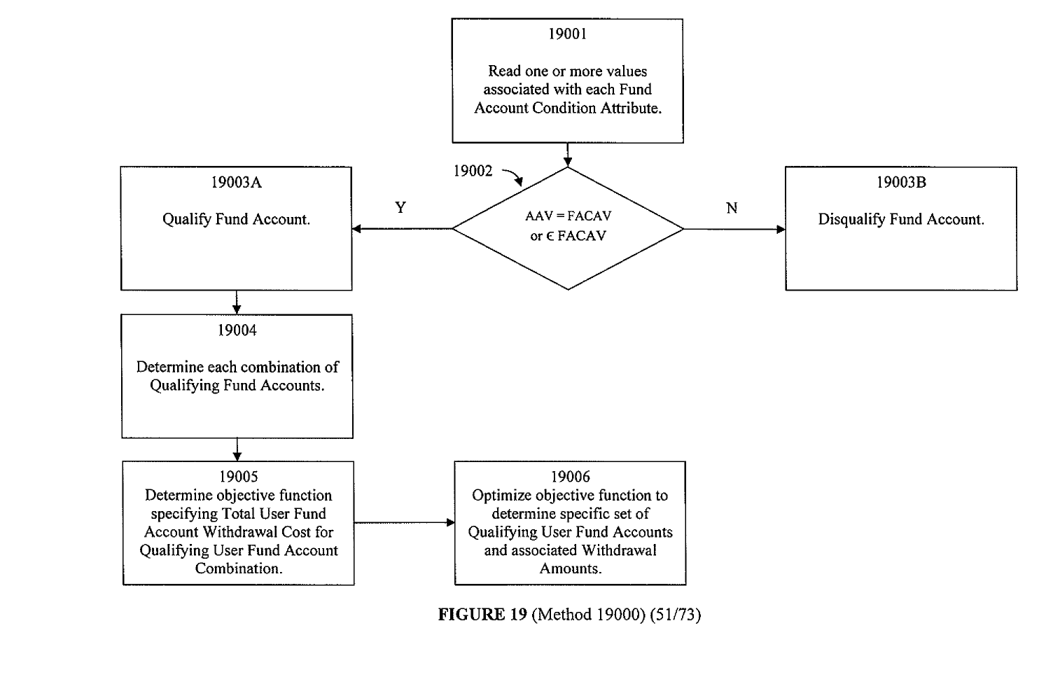

FIG. 19 depicts a diagram of a flow chart of an exemplary computer-implemented method, Method 19000, that when executed can exchange and process data to identify one or more Qualifying User Fund Accounts and determine a Qualifying User Fund Account Combination and Withdrawal Amounts thereof which can minimize or decrease below a predefined threshold the Total User Fund Account Withdrawal Cost and/or maximize or increase above a predefined threshold the Total User Fund Account Withdrawal Benefit, according to one embodiment. The flowchart refers to the apparatus and structures depicted in FIG. 18. However, the method is not limited to those embodiments. The method can implement the steps described herein utilizing a subset of the components, any combination of the components, or additional, related, alternative, and/or equivalent components depicted in FIG. 18 and/or elsewhere in the application. The method can execute a subset of the steps, any combination of the steps, the steps in different order, and/or additional, related, alternative, or equivalent steps.

At 19001, Method 19000 can read one or more values associated with each of one or more Fund Account Condition Attributes associated with each Fund Account. In a first embodiment, Method 19000 can transmit a query to one or more Fund Account Data Structures stored on each Data Processing System 01000 described in Apparatus 06000, e.g., Server 06600. In a second embodiment, Method 19000 can transmit a query to one or more Fund Account Data Structures stored on Exchange Server 02200, which at any time before a Transaction can receive from each Fund Account Data Structure one or more Fund Accounts detected by Database Program 16110. Because Database Program 16110 can automatically detect any Fund Account Condition Attributes stored on a Fund Account Data Structure and transmit to Exchange Server 02200 the one or more new Fund Account Condition Attributes and/or changes to one or more existing Fund Account Condition Attributes, Method 19000 can identify one or more Qualifying Fund Accounts faster by querying the Fund Account Condition Attributes stored on Exchange Server 02200.

At 19002, Method 19000 can apply comparator logic to compare each Authorization Attribute Value to the Fund Account Condition Attribute Value (where the Fund Account Condition Attribute specifies a single value) or set of Fund Account Condition Attribute Values associated with a Fund Account Condition Attribute equal or equivalent to the Authorization Attribute. If the comparator logic determines a Fund Account Match, Method 19000 can proceed to 19003A. If the comparator logic does not determine a Fund Account Match, Method 19000 can proceed to 19003B, which can terminate the process for the Fund Account. In another embodiment, the invention can still determine a Fund Account Match by “relaxing” one or more Fund Account Condition Attributes through amending a Fund Account Condition Attribute Value or deleting a Fund Account Condition Attribute.

At 19004, Method 19000 can determine each candidate combination of Qualifying Fund Accounts.

At 19005, Method 19000 can determine an objective function specifying the Total User Fund Account Withdrawal Cost for each Qualifying User Fund Account Combination. In another embodiment, Method 19000 can determine an objective function specifying the Total User Fund Account Withdrawal Benefit for each Qualifying User Fund Account Combination. In another embodiment, Method 19000 can determine an objective function specifying the difference between the Total User Fund Account Withdrawal Benefit and the Total User Fund Account Withdrawal Cost.

At 19006, Method 19000 can optimize the objective function to determine the specific Qualifying User Fund Account Combination and the Withdrawal Amount associated with each Qualifying User Fund Account yielding the lowest Total User Fund Account Withdrawal Cost or a Total User Fund Account Withdrawal Cost below a predefined threshold. In a first embodiment, Method 19000 can use an exhaustive iterative search through all Qualifying User Fund Account Combinations. In a second embodiment, Method 19000 can use any sorting algorithm to sort and rank a plurality of Qualifying User Fund Account Combinations. Method 19000 can select a different sorting algorithm depending one or more factors, e.g., the types and number of Qualifying User Fund Account Combinations, and/or the requirements. For example, one sort algorithm may be more efficient in sorting and ranking a small number of Qualifying User Fund Account Combinations and another sort algorithm may be more efficient in sorting and ranking a large number of Qualifying User Fund Account Combinations. In a third embodiment, Method 19000 can use any algorithm other than a sort algorithm, e.g., any algorithm in the class of evolutionary algorithms, to identify the Qualifying User Fund Account Combination and the Withdrawal Amount associated with each Qualifying User Fund Account yielding the lowest Total User Fund Account Withdrawal Cost or a Total User Fund Account Withdrawal Cost below a predefined threshold.

There may be cases where a User can still value the identification of a Qualifying User Fund Account Combination and the Withdrawal Amount associated with each Qualifying User Fund Account yielding not the lowest Total User Fund Account Withdrawal Cost, but a Total User Fund Account Withdrawal Cost below a predefined threshold. For example, a User can specify that he/she is willing to pay for a Product using a Qualifying User Fund Account Combination with any Total User Fund Account Withdrawal Cost below a predefined threshold.

To determine the Qualifying User Fund Account Combination with a Total User Fund Account Withdrawal Cost below a predefined threshold which may not be the lowest Net Price, one or more embodiments of the invention can use one or more algorithms which can identify local minimums, but not necessarily global minimums. For example, Method 19000 can use a gradient descent algorithm to find a local minimum and use other methods to configure an objective function to increase the efficiency of identifying a local minimum.

While Method 19000 describes the optimization of an objective function determining the specific Qualifying User Fund Account Combination and the Withdrawal Amount associated with each Qualifying User Fund Account yielding the lowest Total User Fund Account Withdrawal Cost or a Total User Fund Account Withdrawal Cost below a predefined threshold, the invention is not limited to that embodiment. One or more embodiments of the invention can optimize an objective function determining the specific Qualifying User Fund Account Combination and the Withdrawal Amount associated with each Qualifying User Fund Account yielding any objective function value including without limitation: (a) the highest Total User Fund Account Withdrawal Benefit or a Total User Fund Account Withdrawal Benefit above a predefined threshold; and/or (b) the largest difference between a Total User Fund Account Withdrawal Benefit and a Total User Fund Account Withdrawal Cost or the difference above a predefined threshold.

Method 19100 is an exemplary computer-implemented method that when executed can determine a Qualifying User Fund Account Combination and the Withdrawal Amount associated with each Qualifying User Fund Account which can optimize, increase above a predefined threshold, or decrease below a predefined threshold the value of an objective function, according to one embodiment. The flowchart refers to the apparatus and structures depicted in FIG. 18. However, the method is not limited to those embodiments. The method can implement the steps described herein utilizing a subset of the components, any combination of the components, or additional, related, alternative, and/or equivalent components depicted in FIG. 18 and/or elsewhere in the application. The method can execute a subset of the steps, any combination of the steps, the steps in different order, and/or additional, related, alternative, or equivalent steps.

At 19101, Method 19100 can define an environment ENV which can comprise one or more variables and/or relationships including without limitation: (a) a set of Qualifying User Fund Accounts; (b) a set of Total User Fund Account Withdrawal Benefits associated with each Qualifying User Fund Account; (c) a set of Total User Fund Account Withdrawal Costs associated with each Qualifying User Fund Account; and/or (d) a set of candidate Withdrawal Amounts each of which is associated with each Qualifying User Fund Account.

At 19102, Method 19100 can determine an objective function generating a value or performance measure, μ, e.g., a sum of Total User Fund Account Withdrawal Benefits, a sum of Total User Fund Account Withdrawal Costs, and/or the difference between the sum of Total User Fund Account Withdrawal Benefits and the sum of Total User Fund Account Withdrawal Costs.

At 19103, Method 19100 can determine a method or an adaptive plan which can identify an optimal set of Qualifying User Fund Accounts and Withdrawal Amount from each of the Qualifying User Fund Account, ā*, which maximizes or increases above a predefined threshold the objective function value, μ, given the environment ENV.

The withdrawal of funds from and/or deposit of funds to a User Fund Account can be subject to a number and/or different classes of constraints. In a first example, a Payment Issuer Server 02800 can administer a credit card assessing an interest rate of 0% below a Maximum Account Balance for a period of time, after which it assesses a 12% interest rate. In a second example, the same Payment Issuer Server 02800 or a different Payment Issuer Server 02800 can administer a credit card assessing an interest rate of 0% if the Current Account Balance is zero by a certain deadline each period and a 5% interest rate on any Current Account Balance above zero after the deadline. In a third example, a User Fund Account Administrator can implement one or more rules implementing one or more Fund Account Condition Attributes limiting a withdrawal of funds from the User Fund Account to pay for a Qualifying Product or to a Qualifying Recipient. The combination of Fund Account Benefit Attributes, Fund Account Cost Attributes, and/or Fund Account Condition Attributes can make it difficult for a User to determine an optimal set of Qualifying User Fund Accounts and the Withdrawal Amount from each Qualifying User Fund Accounts. Moreover, Fund Account Benefit Attributes and Fund Account Cost Attributes whose value can vary by time can introduce the requirement to consider the likely future behavior of the User in repaying any amount borrowed from a User Fund Account.

To identify an optimal set of Qualifying User Fund Accounts and Withdrawal Amount from each of the Qualifying User Fund Account, ā*, which maximizes or increases above a predefined threshold the objective function value, μ, given the environment ENV, Method 19100 can execute one or more of the following steps.

After identifying one or more Qualifying User Fund Accounts at 19002, Method 19100 can define a set of Qualifying User Fund Accounts from which it can withdraw a Withdrawal Amount, W:

W={w₁,w₂, . . . ,wₙ} (Equation 25)

Method 19100 can represent a specific set of the Withdrawal Amounts from each Qualifying User Fund Account as follows:

a̅ε [symbol] =[η₁,η₂, . . . ,ηₙ] (Equation 26)

where ηᵢ is the Withdrawal Amount to be allocated to the ith account within W, i.e., the share of the sum of the Withdrawal Amounts,
and the constraints:

0≦ηᵢ≦1 (Equation 27)

Σᵢ₌₁^{m}ηᵢ=1 (Equation 28)

and [symbol] is the set of all candidate sets of the Withdrawal Amounts from each Qualifying User Fund Account, given the constraints.

If the sum of the Withdrawal Amounts is d and given a withdrawal set a, then the Withdrawal Amount from each Qualifying User Fund Account is:

ξ̅=ā·d=[η₁d,η₂d, . . . ,ηₙd]=[ξ₁,ξ₂, . . . ,ξₙ] (Equation 29)

The withdrawal of each Withdrawal Amount, ξᵢ, from a Qualifying User Fund Account results in a certain Withdrawal Cost and certain Withdrawal Benefit:

cᵢ=Kᵢ(ξᵢ) (Equation 30)

bᵢ=Bᵢ(ξᵢ) (Equation 31)

where cᵢ represents the cost of a withdrawal of Withdrawal Amount ξ from the ith account, as determined by some function Kᵢ(ξᵢ) specific to that account; and bᵢ represents the benefit of a withdrawal of Withdrawal Amount ξ from the ith account, as determined by some function Bᵢ(ξᵢ) specific to that account. Costs cᵢ can include without limitation: (a) one or more Fund Account Cost Attributes; (b) any tax assessed for withdrawing funds from a Qualifying User Fund Account; and/or (c) decrease in non-cash funds, e.g., redemption of points. Benefits bᵢ can include without limitation: (a) one or more Fund Account Benefit Attributes; (b) any increase in non-cash funds, e.g., earning of points.

Method 19100 can determine an objective function generating a value or performance measure, μ, in at least three embodiments.

In a first embodiment 19102A, Method 19100 can determine an objective function that minimizes the sum of Total User Fund Account Withdrawal Costs:

μ=ψ( a̅)=Σᵢ₌₁ⁿcᵢ (Equation 32)

where Method 19100 can determine at 19103A the optimal value of ā:

a̅*=arg(min a̅ε [symbol] ′ψ( a̅)) (Equation 33)

where [symbol] ′ is a subset of [symbol] for which additional arbitrary constraints on ā are satisfied. When Method 19100 defines ā* not as, e.g., the absolute minimum, but just a value of ā* for which ψ(ā) falls below some threshold, Method 19100 then defines [symbol] ′ as:

[symbol]

′={ a̅|ψ( a̅)≦ψₘᵢₙ} (Equation 34)

When Method 19100 imposes no additional constraints, [symbol] ′= [symbol] . Moreover, Method 19100 can define [symbol] ′ in terms of the computational procedure itself that is seeking to arrive at ā*. If Ωₖ[ψ, [symbol] ′] denotes the sequential or parallel processing instructions that are executed by the kth step, āₖ* represents the estimate of Method 19100 of ā* at that step in the iteration:

Ωₖ[ψ, [symbol] ′]→ a̅ₖ* (Equation 35)

where some adaptive plan, τ, defines the determination of successive operations Ω₁, Ω₂, . . . , Ωₖ, . . . . In general, the adaptive plan can define some procedure for halting further computation and returning the best estimate of ā* up to that point. One such halting procedure can return the last computed estimate of ā*, i.e., āₖ* provided that the incremental difference between it and the penultimate estimate, āₖ₋₁*, is less than some threshold, δ:

|āₖ*−āₖ₋₁*|≦δ (Equation 36)

Method 19100 can define another halting condition in terms of the fractional change in āₖ* in terms of some other threshold, ε:

$$\vert \frac{{\overline{a}}_{k}^{*} - {\overline{a}}_{k - 1}^{*}}{{\overline{a}}_{k - 1}^{*}} \vert \leq ∈ \qquad ( Equation 37 )$$

Given such computational considerations, Method 19100 can express ā* as:

ā*=τ[arg( [symbol] ψ(ā))] (Equation 38)

where τ represents the adaptive plan used to arrive at ā*, encompassing the actual computational process used to produce an estimated solution, with all the requisite processing steps and conditions.

In a second embodiment 19102B, Method 19100 can determine an objective function that maximizes the sum of Total User Fund Account Withdrawal Benefits:

μ=ψ(ā)=Σᵢ₌₁ⁿbᵢ (Equation 39)

where Method 19100 can determine at 19103B the optimal value of a:

ā*=arg(maxψ(ā)) (Equation 40)

As with embodiment 19102A, Method 19100 can define ā* with additional arbitrary constraints:

ā*=arg( [symbol] ψ(ā)) (Equation 41)

including without limitation satisfying a threshold or tolerance condition and/or in terms of computational process:

ā*=τ[arg( [symbol] ψ)(ā))] (Equation 42)

In a third embodiment 19102C, Method 19100 can determine an objective function that maximizes the difference between the sum of Total User Fund Account Withdrawal Benefits and the sum of Total User Fund Account Withdrawal Costs:

μ=ψ(ā)=Σᵢ₌₁ⁿ(bᵢ−cᵢ) (Equation 43)

where Method 19100 can determine at 19103C the optimal value of ā:

ā*=arg(maxψ(ā)) (Equation 44)

where, as with embodiments 19102A and 19102B, Method 19100 can define ā* with additional arbitrary constraints:

ā*=arg( [symbol] ψ(ā)) (Equation 45)

as well as in terms of computational process:

ā*=τ[arg( [symbol] ψ(ā))] (Equation 46)

Method 19200 is an exemplary computer-implemented method that when executed can determine a Qualifying User Fund Account Combination and the Withdrawal Amount associated with each Qualifying User Fund Account which can optimize, increase above a predefined threshold, or decrease below a predefined threshold the value of an objective function where the objective function reflects the time value of money and/or uncertainty of future repayment, according to one embodiment. The flowchart refers to the apparatus and structures depicted in FIG. 18. However, the method is not limited to those embodiments. The method can implement the steps described herein utilizing a subset of the components, any combination of the components, or additional, related, alternative, and/or equivalent components depicted in FIG. 18 and/or elsewhere in the application. The method can execute a subset of the steps, any combination of the steps, the steps in different order, and/or additional, related, alternative, or equivalent steps.

The value of bᵢ and cᵢ can each depend on not only the one or more Fund Account Benefit Attributes and/or one or more Fund Account Cost Attributes, respectively, but also on: (a) the time when a User repays part or all of a Withdrawal Amount where the Withdrawal Amount is an increase in a liability of the User Fund Account holder, e.g., withdrawal of a Withdrawal Amount using a credit card assessing an interest rate; and/or (b) the probability that the User does not repay part or all of the Withdrawal Amount.

For example, if a User Fund Account assesses 0% interest for 6 months and the increases the interest rate to 12% after 6 months, the cost of a Withdrawal Amount for the User Fund Account will have different values for different behaviors of the User. If the User repays the Withdrawal Amount before the 6 month date, then the cost of the Withdrawal is the present value of a future payment of the principal. If the User repays the Withdrawal Amount after the 6 month date, then the cost of the Withdrawal is the present value of the future payment of the principal and the present value of the future interest fees. If the interest rate is variable, e.g., where an interest rate is linked to a reference rate, then the cost of the Withdrawal has greater uncertainty.

Where the cost of withdrawal of a Withdrawal Amount from one Qualifying User Fund Account is independent of the cost of withdrawal of a Withdrawal Amount from any other Qualifying User Fund Account, then the future value of the cost of withdraw of the Withdrawal Amount is a random variable:

cᵢ(t)=C(ξᵢ;t) (Equation 47)

where t=Time elapsed since a Transaction

Prob{cᵢ≧c|t}=∫_{-∞}^{c}f_{c}_{ᵢ}(x|t)dx (Equation 48)

and f_{c}_{ᵢ}(cᵢ|t) is the conditional probability density function of the future value of the cost of withdrawal of Withdrawal Amount ξᵢ from Qualifying User Fund Account i.

Where the benefit of withdrawal of a Withdrawal Amount from one Qualifying User Fund Account is independent of the benefit of withdrawal of a Withdrawal Amount from any other Qualifying User Fund Account, then the future value of the benefit of withdraw of the Withdrawal Amount is a random variable:

bᵢ(t)=B(ξᵢ;t) (Equation 49)

where t=Time elapsed since a Transaction

Prob{bᵢ≧b|t}=∫_{-∞}^{b}f_{b}_{ᵢ}(x|t)dx (Equation 50)

and f_{b}_{ᵢ}(bᵢ|t) is the conditional probability density function of the future value of the benefit of withdrawal of Withdrawal Amount ξᵢ from Qualifying User Fund Account i.

Where the cost and/or benefit of withdrawal of a Withdrawal Amount from one Qualifying User Fund Account is dependent on the cost and/or benefit of withdrawal of a Withdrawal Amount from any other Qualifying User Fund Account, e.g., in a market where Fund Account Administrators compete with each other in setting the Fund Account Benefit Attributes and/or Fund Account Cost Attributes, then the future value of the benefit and cost of withdraw of the Withdrawal Amount is the joint probability density function:

f_{CB}( c̅, b̅|t)=f_{CB}(c₁,c₂, . . . ,cₙ,b₁,b₂, . . . ,bₙ|t) (Equation 51)

To identify an optimal set of Qualifying User Fund Accounts and Withdrawal Amount from each of the Qualifying User Fund Account, ā*, which maximizes or increases above a predefined threshold the net present value of objective function value, μ, given the environment ENV, Method 19200 can execute one or more of the following steps.

One or more embodiments of the invention can select as an objective function any of one or more number of statistics of any multivariate function including without limitation: mean, mode (maximum likelihood value), percentile, and/or confidence limit.

In one embodiment, Method 19200 can select the expected value of the difference between the sum of the net present value of the Total User Fund Account Withdrawal Benefits and the sum of the net present value of the Total User Fund Account Withdrawal Costs as an objective function to measure the performance of a candidate set of Qualifying User Fund Accounts and Withdrawal Amount from each of the Qualifying User Fund Account, ā*:

ψ(ā;t)=∫_{-∞}^{+∞}[(Σᵢ₌₁ⁿbᵢ(t))−(Σᵢ₌₁ⁿcᵢ(t))]f_{CB}( c̅, b̅|t)dc₁ . . . dbₙ (Equation 52)

μ=v[ψ(ā;t)] (Equation 53)

where v[x(t)] is the function Method 19200 uses to compute net present value. Method 19200 can identify an optimal set of Qualifying User Fund Accounts and Withdrawal Amount from each of the Qualifying User Fund Account, ā*:

ā=arg(max v[ψ(ā;t)]) (Equation 54)

where, as is the case with other embodiments, Method 19200 can define ā* with additional arbitrary constraints:

ā*=arg( [symbol] v[ψ(ā;t)]) (Equation 55)

as well as in terms of computational process:

ā=τ[arg( [symbol] v[ψ(ā;t)])] (Equation 56)

In another embodiment, Method 19200 can select the maximum likelihood value of the sum of the net present value of the Total User Fund Account Withdrawal Costs as an objective function to measure the performance of a candidate set of Qualifying User Fund Accounts and Withdrawal Amount from each of the Qualifying User Fund Account, ā*:

ψ(ā;t)=Σᵢ₌₁ⁿarg[max f_{c}_{ᵢ}(cᵢ|t)] (Equation 57)

μ=v[ψ(ā;t)] (Equation 58)

where

f_{c}( c̅|t)=∫_{-∞}^{+∞}f_{CB}( c̅, b̅|t)db₁ . . . dbₙ (Equation 59)

ā*=arg(min v[ψ(ā;t)]) (Equation 60)

where, as is the case with other embodiments, Method 19200 can define ā* with additional arbitrary constraints:

ā*=arg( [symbol] v[ψ(ā;t)]) (Equation 61)

as well as in terms of computational process:

ā*=τ[arg( [symbol] v[ψ(ā;t)])] (Equation 62)

In one or more embodiments, the invention identifies an optimal set of Qualifying User Fund Accounts and Withdrawal Amount from each of the Qualifying User Fund Account, ā*, given all Qualifying User Fund Accounts. In other embodiments, the invention can identify ā* given a subset of all Qualifying User Fund Accounts. For example, a Qualifying User Fund Account may have one or more Fund Account Condition Attributes with values that differ so much from values in the equal or equivalent Fund Account Condition Attribute associated with other Qualifying User Fund Accounts that one or more embodiments of the invention can assume that it is unnecessary to evaluate the Qualifying User Fund Account. In one example, a Qualifying User Fund Account can have a Fund Account Condition Attribute of an Interest Fee of 100% which makes it unlikely that one or more embodiments of the invention would include the Qualifying User Fund Account in ā*.

To identify ā* given a subset of all Qualifying User Fund Accounts, Method 19200 can define the set of all possible subsets of Was the power set:

[symbol]

(W)={U|U⊂W} (Equation 63)

For example, if W comprises just three Qualifying User Fund Accounts:

$$\begin{matrix}W = \{ {w}_{1} , {w}_{2} , {w}_{3} \} \\ then \text{:} & ( Equation 64 ) \\ \begin{matrix}𝒫 ( W ) = \{ \begin{matrix}W , \{ {w}_{1} , {w}_{2} \} , \{ {w}_{1} , {w}_{3} \} , \\ \{ {w}_{2} , {w}_{3} \} , \{ {w}_{1} \} , \{ {w}_{2} \} , \{ {w}_{3} \} , φ\end{matrix} \} \\ = \{ {U}_{1} , {U}_{2} , … , {U}_{8} \}\end{matrix} \\ where \text{:} & ( Equation 65 ) \\ {U}_{1} = W \\ {U}_{2} = \{ {w}_{1} , {w}_{2} \} \\ {U}_{3} = \{ {w}_{1} , {w}_{3} \} \\ ⋮ \\ {U}_{8} = φ & ( Equation 66 )\end{matrix}$$

and φ represents the empty set, i.e. no Qualifying User Fund Accounts.

In one embodiment, the invention can identify ā* for each of one or more subsets of all Qualifying User Fund Accounts. This embodiment can still optimize the value of the objective function above a predefined threshold and/or below a predefined threshold.

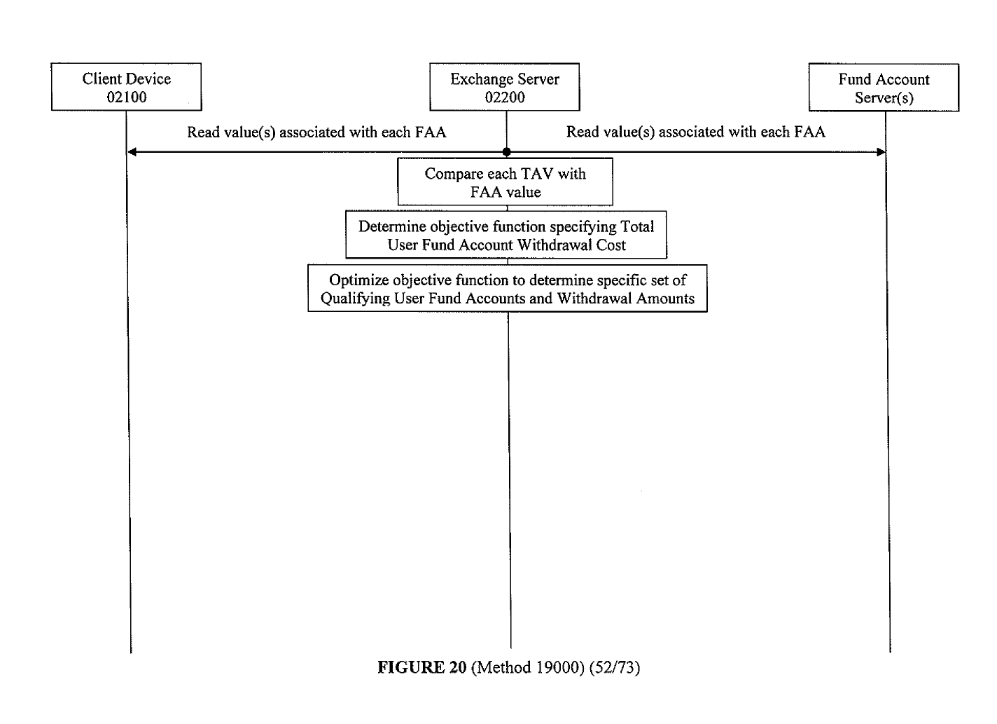

FIG. 20 depicts a chart illustrating the flow of data in and executions of functions by an exemplary computer-implemented method, Method 19000, among a Client Device 02100, Exchange Server 02200, and one or more other Data Processing Systems, according to one embodiment.

One or more embodiments of the invention produces a well-defined, particular, immediate, and real-world benefit to the public because it can automate the determination of a Qualifying User Fund Account Combination and the Withdrawal Amount associated with each Qualifying User Fund Account which can optimize, increase above a predefined threshold, and/or minimize below a predefined threshold an objective function.

### Unified Authorization

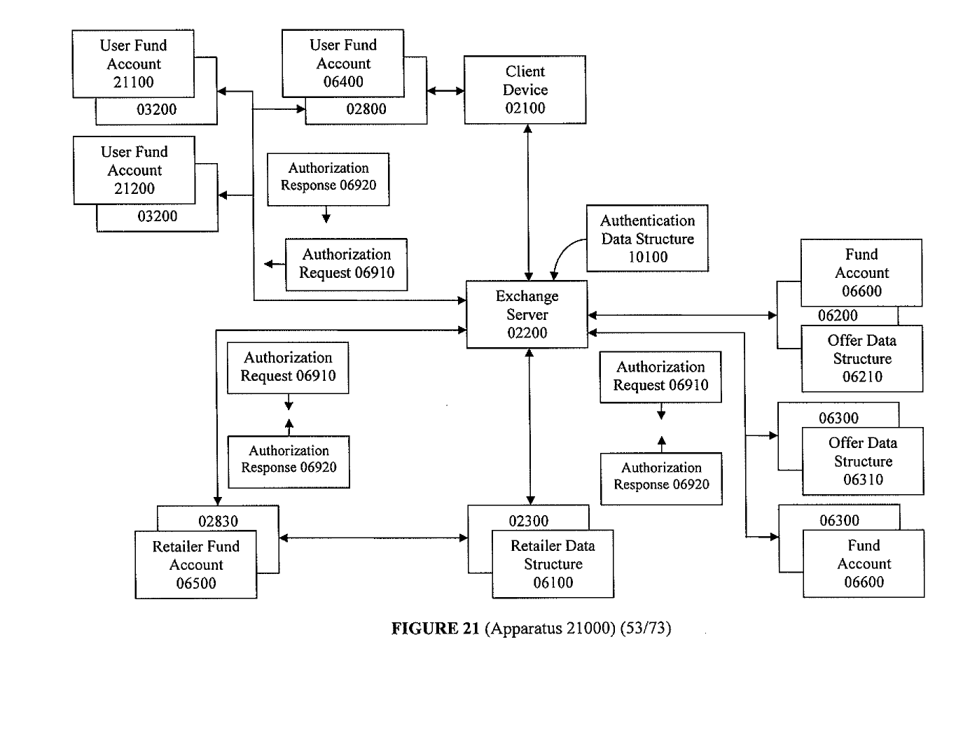

FIG. 21 depicts a block diagram of an exemplary apparatus (e.g., a distributed apparatus performing distributed computing), Apparatus 21000, enabling the exchange and processing of data to Authorize the withdrawal of funds from one or more Qualifying Fund Accounts, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following components, Data Structures, data, and/or instructions.

User Fund Account 21100 and User Fund Account 21200 can each be separate Fund Accounts associated with a User and in this example administered by the same Fund Account Administrator, e.g., Employer Server 03200. For example, Employer Server 03200 can administer User Fund Account 21100 as a Fund Account storing funds dedicated to an FSA account for the employees of the Employer and User Fund Account 21200 as a Fund Account storing funds for general corporate purposes from which the Employer can pay the payroll for the employee. While the same Fund Account Administrator administers User Fund Account 21100 and User Fund Account 21200 in this example, the invention is not limited to this embodiment. One or more embodiments of the invention can enable the Authorization of withdrawal of funds from one or more Qualifying Fund Accounts, each of which can be administered by the same or different Fund Account Administrators.

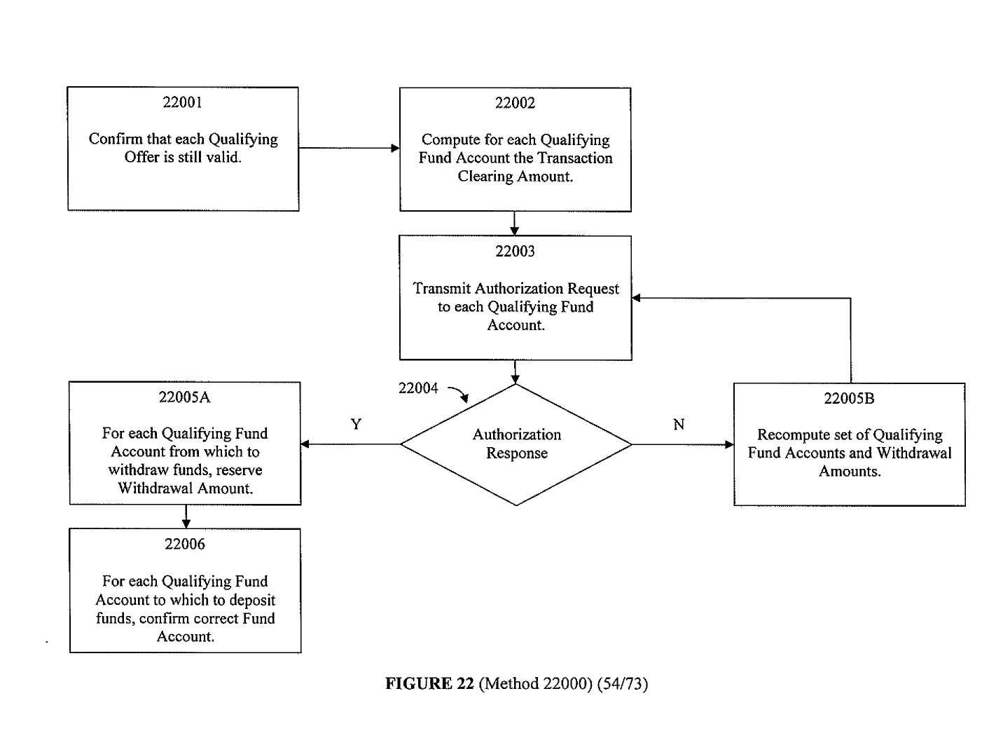

FIG. 22 depicts a flow chart of an exemplary computer-implemented method, Method 22000, that when executed can exchange and process data to Authorize the withdrawal of funds from one of more Qualifying Fund Accounts, according to one embodiment. The flowchart refers to the apparatus and structures depicted in FIG. 21. However, the method is not limited to those embodiments. The method can implement the steps described herein utilizing a subset of the components, any combination of the components, or additional, related, alternative, and/or equivalent components depicted in FIG. 21 and/or elsewhere in the application. The method can execute a subset of the steps, any combination of the steps, the steps in different order, and/or additional, related, alternative, or equivalent steps.

At 22001, Method 22000 can confirm that each Qualifying Offer, Retailer Price, and Retailer Available Unit(s) is still valid. At 07006, Method 07000 can select for a Transaction one Qualifying Retailer/Offer Combination, e.g., a combination associated with the lowest Net Price. However, between the time one or more embodiments of the invention can present to a User or User of Client Device 02100 the results of 07140, e.g., Offer Combination Window 32000, and the time one or more embodiments of the invention executes Method 07000 at 07005, one or more parties making a Qualifying Offer can change the Offer Condition Attributes and/or the Offer Value or the number of Retailer Available Units can fall below the number of units of the Product of Interest specified in the User Query. In one embodiment, Method 22000 can confirm the validity of each Qualifying Offer, Offer Available Unit(s), Offer Available Value(s), Retailer Price, and/or Retailer Available Unit(s) by applying comparator logic to: (a) compare the time at 22100 with a timestamp associated with a Qualifying Offer, e.g., a time-to-live (“TTL”) value specifying the time when an Offer is no longer valid; and/or (b) classify as a Qualifying Offer the one or more Offers for which the time at 22001 is earlier than the timestamp and, therefore, still valid. To synchronize the confirmation of the availability of Offer Available Unit(s), Offer Available Value(s), and/or Retailer Available Unit(s), Method 22000 can set the TTL value to equal the same length of time when Method 07100 can lock a record and/or attribute of a record in the Offer Data Structure and/or Retailer Product Data Structure from which one or more embodiments of the invention queried to identify a Qualifying Offer and/or a Qualifying Retailer.

At 22002, Method 22000 can compute for each Qualifying Fund Account a Transaction Clearing Amount by executing one or more of the following functions.

Method 22000 can generate a Transaction Authorization Record specifying at least each Qualifying Fund Account in a Transaction, a Transaction Fee Fund Account held by a Transaction Enabler, the Deposit Amount for a Qualifying Fund Account, and any Transaction Fee(s). The sum of the Withdrawal Amount for each Qualifying Fund Account in a Transaction should equal the sum of the Deposit Amount for each Qualifying Fund Account in a Transaction and a Transaction Fee for each Transaction Enabler.

After selecting or receiving the selection of a Qualifying Retailer for a Transaction, one or more embodiments of the invention can identify the one or more Fund Accounts to which the Qualifying Retailer can Authorize at Registration or Transaction the withdrawal of the Withdrawal Amount and/or deposit of the Deposit Amount computed in a Transaction Clearing Record. One or more embodiments of the invention can determine the Deposit Amount by using any method including without limitation: computing the product of: (a) the Retailer Price specified in the selected Qualifying Retailer/Offer Combination; and (b) the number of units of the selected Product in a Transaction.

After selecting or receiving the selection of the set of one or more Qualifying Offers for a Transaction, one or more embodiments of the invention can identify the one or more Fund Accounts from which the party making a Qualifying Offer can Authorize at Registration or Transaction the withdrawal of a Withdrawal Amount or to which the party making a Qualifying Offer can Authorize at Registration or Transaction the deposit of a Deposit Amount. One or more embodiments of the invention can determine the Withdrawal Amount or Deposit Amount by using any method including without limitation: (a) reading the Offer Value associated with the Qualifying Offer in an Offer Data Structure where the Offer Value is in the same format as the value of Net Price in the selected Qualifying Retailer/Offer Combination; (b) computing the Offer Value associated with the Qualifying Offer in an Offer Data Structure where the Offer Value is in a format different from the format of the value of Net Price in the selected Qualifying Retailer/Offer Combination; and/or (c) reading the respective Withdrawal Amount or Deposit Amount determined by Method 19000.

After selecting or receiving the selection of the set of one or more Qualifying User Fund Accounts for a Transaction, one or more embodiments of the invention can determine the Withdrawal Amount or Deposit Amount for each Qualifying User Fund Account by reading the respective Withdrawal Amount or Deposit Amount determined by any method, e.g., Method 19000.

At 22003, Method 22000 can transmit an Authorization Request to each Qualifying Fund Account specified in a Transaction Authorization Record. In a first embodiment, Method 22000 can transmit an Authorization Request 06910 to each Qualifying Fund Account specified in a Transaction Authorization Record. In a second embodiment, for a Qualifying Fund Account held by a party making a Qualifying Offer in the Qualifying Retailer/Offer Combination, Method 22000 can Authorize the withdrawal of a Withdrawal Amount from the associated Qualifying Fund Account as follows. At any time before 22003, e.g., at Registration, a party making an Offer can: (a) register with Exchange Server 02200 the Fund Account from which one or more embodiments of the invention can withdraw a Withdrawal Amount; (b) register the Authorization of the withdrawal from the Fund Account of any amount of funds equal to the Offer Value of a Qualifying Offer and as long as the value of each of the Offer Available Unit and/or the Offer Available Value in its Offer Data Structure is still positive; and (c) register with the Fund Account Administrator permission for Exchange Server 02200 to withdraw a Withdrawal Amount for a Qualifying Offer. For example, where a Producer Server 02400 makes an Offer to decrease the price of a Product by $100 and Producer Server 02400 specified in its Offer Data Structure that the Offer Available Unit is 582, one or more embodiments of the invention can automatically withdraw a Withdrawal Amount for a Qualifying Offer by reading at 22003 the Offer Available Unit attribute, confirming that the attribute value is positive, and transmitting to the Qualifying Fund Account Administrator a record confirming that the attribute value is positive.

Exchange Server 02200 can transmit an Authorization Request to one or more Qualifying Fund Accounts. In a conventional Card Association, a conventional Retailer Server 02830 typically transmits an Authorization Request. In a conventional ACH, a receiver typically Authorizes a Withdrawal Amount from its Fund Account. Because a conventional Card Association and a conventional ACH process the transfer of funds between two parties, these systems can rely on one of the two parties to Authorize a Transaction. However, at least where a plurality of Fund Accounts must transmit funds and/or a plurality of Fund Accounts must receive funds, Exchange Server 02200 transmission of the Authorization Request to the plurality of Qualifying Fund Accounts from which to withdraw a Withdrawal Amount can yield benefits including increased efficiency.

At 22004, Method 22000 can receive from the Qualifying Fund Account an Authorization Response 06920 either approving or rejecting the withdrawal of the Withdrawal Amount. If Authorization Response 06920 approves the withdrawal of the Withdrawal Amount, Method 22000 can proceed to 22005A. If the Authorization Response 06920 rejects the withdrawal of the Withdrawal Amount, Method 22000 can proceed to 22005B.

In a first embodiment, Method 22000 can reserve the Withdrawal Amount for each Qualifying Fund Account from which it receives an Authorization Response 06920 approving the withdrawal of the Withdrawal Amount, because the Qualifying Fund Account Administrator determines that the Authorization Request 06910 meets all Fund Account Condition Attributes.

In a second embodiment, Method 22000 can execute the Authorization function for one or more Qualifying Fund Accounts through another Payment Network, e.g., a Card Association and/or an ACH. For such Qualifying Fund Accounts, Method 22000 would execute Authorization using the protocols set for the other Payment Network. For example, an ACH typically requires that an ODFI may not originate an ACH transaction requesting the withdrawal of funds from an RDFI without the Receiver granting authority. The ACH operated by the FRB and the Electronic Payments Network (“EPN”) requires the Receiver to transmit to the Originator the authority to originate an ACH transaction, which can be in one or more forms including without limitation: written, oral, and/or electronic.

One or more embodiments of the invention can obtain the authority from the party holding a Qualifying User Fund Account from which to withdraw funds and/or to which to deposit funds by using one or more methods including without limitation: (a) obtaining a written, oral, and/or electronic authority through existing methods; (b) obtaining from the holder of the User Fund Account an electronic authority at Registration to approve prior to one or more Transactions the withdrawal of funds from and/or deposit of funds to a Qualifying User Fund Account; and/or (c) obtaining from the holder of the User Fund Account an electronic authority at the time of Transaction to approve the withdrawal of a Withdrawal Amount from each Qualifying User Fund Account and/or deposit of a Deposit Amount to each Qualifying User Fund Account by associating an agreement and User acceptance of the agreement with the User selection of a function authorizing a Transaction, e.g., selecting a “BUY” button in Offer Combination Window 32000 or speaking the word “BUY” after receiving Offer Combination Window 32000 on a Client Device 02100.

At 22005B, Method 22000 can recompute the set of Qualifying Fund Accounts and each associated Withdrawal Amount. If at least one Qualifying Fund Account transmits an Authorization Response 06920 rejecting the withdrawal of the Withdrawal Amount, the sum of the sum of the Withdrawal Amount for each Qualifying Fund Account in a Transaction would be less than the sum of the Deposit Amount for each Qualifying Fund Account in a Transaction and a Transaction Fee for each Transaction Enabler. One or more embodiments of the invention can include a rule Data Structure specifying one or more rules for determining the set of Qualifying Fund Accounts and each associated Withdrawal Amount upon receiving one or more an Authorization Responses 06920 rejecting the withdrawal of a Withdrawal Amount. In a first example, if a Qualifying Fund Account transmits an Authorization Response 06920 rejecting the withdrawal of a Withdrawal Amount for a Qualifying Offer made by Producer Server 02400, a rule can specify that Method 22000 shall recompute the set of Qualifying Fund Accounts to exclude the Qualifying Fund Account held by Producer Server 02400 and add the Withdrawal Amount to the total amount of funds to be withdrawn from one or more Qualifying User Fund Accounts by recomputing Method 19000. In a second example, if a Qualifying Fund Account transmits an Authorization Response 06920 rejecting the withdrawal of a Withdrawal Amount for a Qualifying Offer which is an Offer specified in an Offer Priority Condition limiting the applicability of the Offer depending on a rule specified in the Offer Condition Attribute Value specifying the sequence in which a plurality of Offers should be applied in a Transaction, a rule can specify that Method 22000 shall recompute the set of Qualifying Fund Accounts to select the next Qualifying Fund Account specified in the Offer Priority Condition and withdraw the Withdrawal Amount from the next Qualifying Fund Account. For example, if an Offer Priority Condition specifies that Medicare pays first any expense incurred for Medicare cost-sharing and the Qualifying Fund Account held by the party administering Medicare transmits an Authorization Response 06920 rejecting the withdrawal of a Withdrawal Amount, Method 22000 can execute a rule selecting the Qualifying Fund Account held by the party administering Medicaid for withdrawal of the Withdrawal Amount.

After recomputing the set of Qualifying Fund Accounts and associated Withdrawal Amounts, Method 22000 can proceed to 22003 to transmit an Authorization Request 06910 to all Qualifying Fund Accounts or just those Qualifying Fund Accounts associated with an amended Withdrawal Amount.

In a conventional Card Association or a conventional ACH connecting two Fund Accounts for each Transaction, the receiving of an Authorization Response rejecting the withdrawal of the Withdrawal Amount means the rejection of the entire Transaction. Because one or more embodiments of the invention can separately withdraw a Withdrawal Amount from each of a plurality of Qualifying Fund Accounts, and Method 22000 includes 22005B enables the recomputation of the set of Qualifying Fund Accounts and their associated Withdrawal Amounts.

At 22005A, Method 22000 can reserve the Withdrawal Amount for each Qualifying Fund Account transmitting an Authorization Response 06920 approving the withdrawal of the Withdrawal Amount. For most Qualifying Fund Accounts, the Qualifying Fund Account Administrator would execute the function of comparing the Withdrawal Amount with the Current Account Balance, reserving the Withdrawal Amount if the Withdrawal Amount is less than the Current Account Balance, and then transmitting an Authorization Response 06920 approving the withdrawal of the Withdrawal Amount. For one or more Qualifying Fund Accounts, one or more embodiments of the invention can enable a party other than the Qualifying Fund Account Administrator to reserve the Withdrawal Amount. For example, if a Qualifying Offer is in the form other than cash, one or more embodiments of the invention can execute a Non-Cash Funds Transfer by executing a write operation directly on the Data Structure storing the value of the Non-Cash Funds.

At 22006, Method 22000 can confirm with each Qualifying Fund Account specified in a Transaction Authorization Record the correct Qualifying Fund Account and the associated Deposit Amount. Confirming the correct Qualifying Fund Account and the associated Deposit Amount can decrease and/or minimize the number of errors in any Reconciliation 27200. If a party expecting a Deposit Amount in a Transaction receives the Deposit Amount in a Fund Account different from the Fund Account it specified at Registration, an error will result which potentially increases the cost of Reconciliation 27200.

One or more embodiments of the invention can enable a single network, e.g., Apparatus 06000, to execute not only a Concurrent Authorization, but also Prior Authorization and/or Post Authorization.

For a Qualifying Retailer/Offer Combination with at least one Qualifying Retailer or one Qualifying Offer requiring approval to withdraw a Withdrawal Amount before Product Good Reception or Product Service Reception, Method 22000 can execute one or more functions including without limitation: (a) executing Authorization for each Qualifying Fund Account not requiring a Prior Authorization and then waiting for approval to withdraw the Withdrawal Amount from the party requiring Prior Authorization; and/or (b) waiting for approval to withdraw the Withdrawal Amount from the party requiring Prior Authorization and upon receiving the approval confirming that the other Qualifying Offers remain valid and then executing Authorization for all Qualifying Fund Accounts.

For a Qualifying Retailer/Offer Combination with at least one Qualifying Retailer or one Qualifying Offer requiring approval to withdraw a Withdrawal Amount after Product Good Reception or Product Service Reception (e.g., an Insurer Server 02700 providing a User authority to use a Product like an emergency care service) and agreeing to approve a Withdrawal Amount after Product Good Reception or Product Service Reception, Method 22000 can execute one or more functions including without limitation: (a) analyzing the set of Offer Condition Attributes specified by the party requiring Post Authorization, comparing the value(s) in Transaction Attribute Value Set 06700 to the value(s) associated with each Offer Condition Attribute equal or equivalent to a Transaction Attribute, estimating a probability that the party requiring Post-Authorization will Authorize the withdrawal of the Withdrawal Amount given the value(s) in Transaction Attribute Value Set 06700, approving a loan for the Withdrawal Amount if the probability exceeds a predefined threshold, and rejecting a Transaction if the probability does not exceed a predefined threshold; and/or (b) where the Post Authorization depends on the matching of one or more Offer Condition Attributes associated with a Product outcome, e.g., a patient decreasing his/her blood pressure level below a predefined threshold which Product Sensor 02600 can detect and transmit to Exchange Server 02200 or a general contractor maintaining its wages for one or more class of employees above a predefined threshold like minimum wage or prevailing wage which Product Sensor 02600 can detect and transmit to Exchange Server 02200 and/or Regulatory Agency Server 05100: (i) receiving the value associated with an Attribute equal or equivalent to the unmet Offer Condition Attribute; (ii) comparing the received value with the value of the equal or equivalent Offer Condition Attribute; (iii) qualifying the Offer if there is a match; (iv) writing to the Offer Data Structure held by the party making the Offer that it is a Qualifying Offer; and/or (v) writing to the Fund Account Data Structure held by the party making the Offer any credentials required to obtain Authorization.

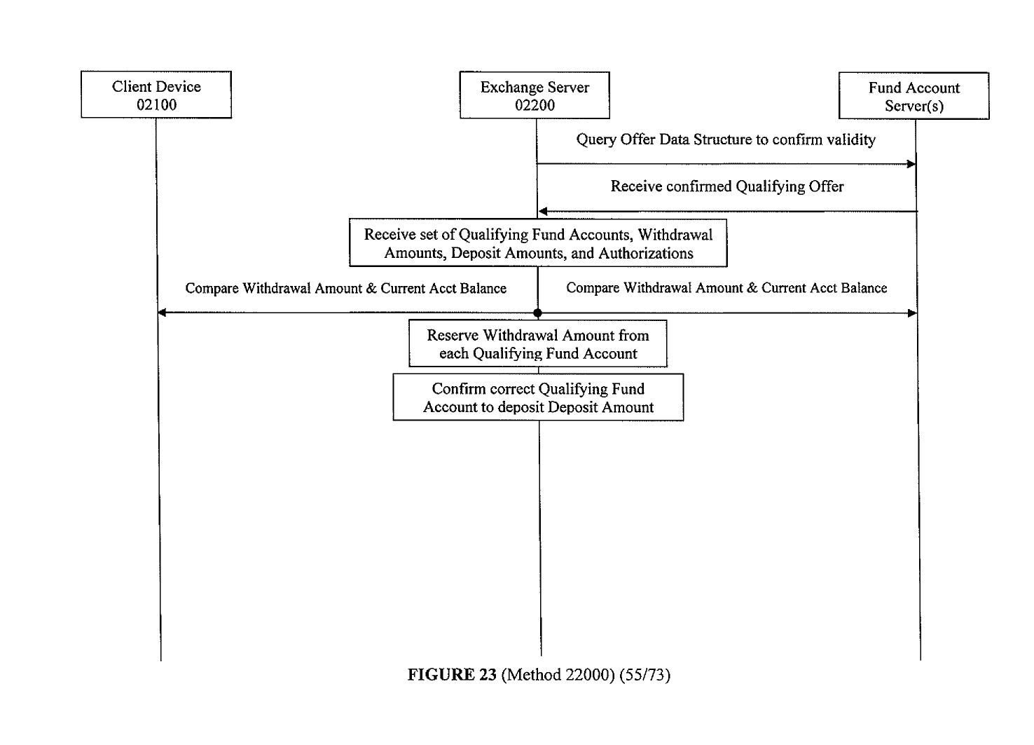

FIG. 23 depicts a chart illustrating the flow of data in and executions of functions by an exemplary computer-implemented method, Method 22000, among a Client Device 02100, Exchange Server 02200, and one or more other Data Processing Systems, according to one embodiment.

One or more embodiments of the invention produces a well-defined, particular, immediate, and real-world benefit to the public because it can enable: (a) a User to make a single Authorization instead of having to make a separate Authorization for each class of Qualifying Offers; (b) the generation of a Qualifying Retailer/Offer Combination satisfying an Offer Condition Attribute specifying an Offer Combination Condition and/or Offer Priority Condition which would be more difficult to satisfy in processing a plurality of Offers with the Offer Condition Attributes in separate networks; and/or (c) a party to generate an Offer Value optimizing an objective function across a plurality of classes of Offers.

### Unified Clearing

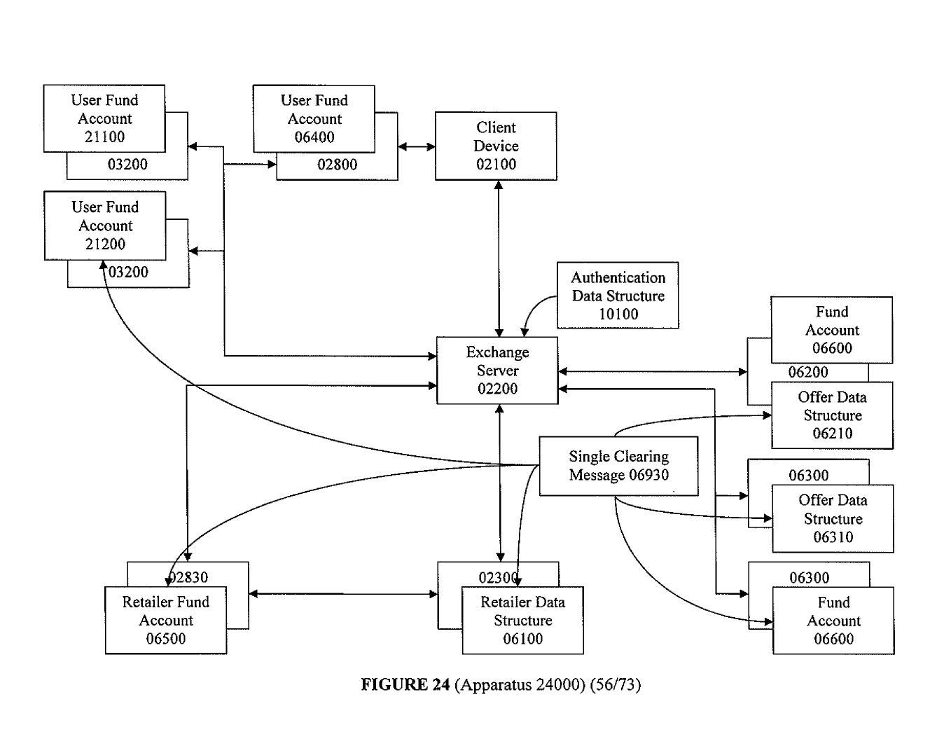

FIG. 24 depicts a block diagram of an exemplary apparatus (e.g., a distributed apparatus performing distributed computing), Apparatus 24000, enabling the exchange and processing of data to Clear a Transaction, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components, Data Structures, data, and/or instructions.

A single Clearing Message 06930 can include any data and/or instructions in a Transaction Clearing Record. One or more embodiments of the invention can include in a Clearing Message 06930 part or all of the data and/or instructions in a Transaction Clearing Record. While the invention illustrates in FIG. 24 the transmission of a single Clearing Message 06930 to the specific Data Processing Systems 01000, the Data Structures, and/or the Fund Accounts illustrated, the invention is not limited to that embodiment. One or more embodiments of the invention can enable the transmission of a single Clearing Message 06930 to any Data Processing System 01000, Data Structure, and/or Fund Account.

A conventional Payment Network typically requires a conventional Retailer Server after receiving an Authorization Response 06720 originate a message clearing a Transaction. Because current Payment Networks typically deposit funds to a single Fund Account, e.g., Retailer Fund Account held by a conventional Retailer Server, a conventional Payment Network can rely on that party to originate a clearing message.

Because one or more embodiments of the invention can enable the withdrawal of funds from and the deposit of funds to a plurality of Fund Accounts, one or more embodiments of the invention utilizes an Exchange Server 02200 to originate a single Clearing Message 06930 for transmission to each Qualifying Fund Account. A single apparatus Clearing a Transaction among more than a single Fund Account from which to withdraw funds and a single Fund Account to which to deposit funds, e.g., Apparatus 06000, can use a centralized Data Processing System 01000, e.g., Exchange Server 02200, to generate a single Clearing Message 06930 providing the data to Clear a Transaction.

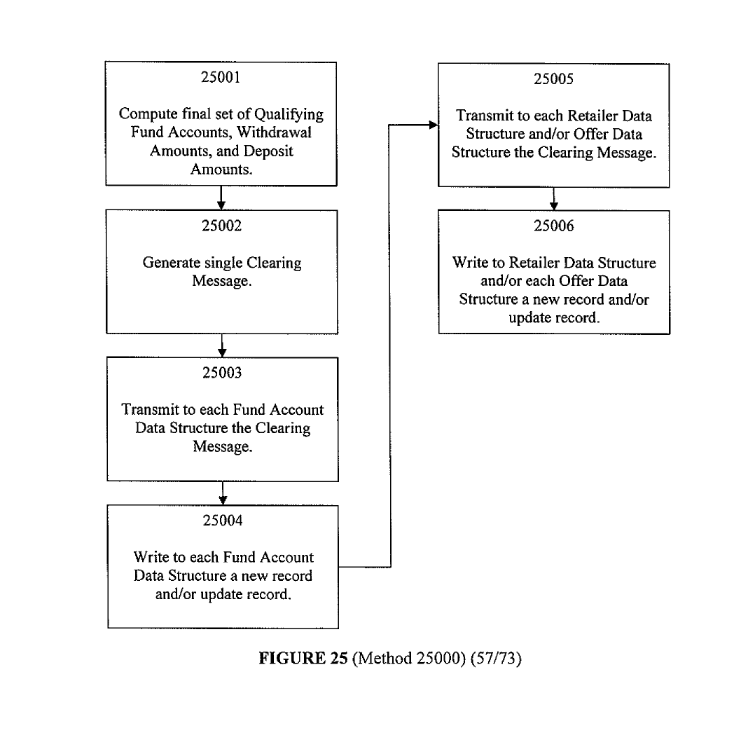

FIG. 25 depicts a flow chart of an exemplary computer-implemented method, Method 25000, that when executed can exchange and process data to Clear a Transaction, according to one embodiment. The flowchart refers to the apparatus and structures depicted in FIG. 24. However, the method is not limited to those embodiments. The method can implement the steps described herein utilizing a subset of the components, any combination of the components, or additional, related, alternative, and/or equivalent components depicted in FIG. 24 and/or elsewhere in the application. The method can execute a subset of the steps, any combination of the steps, the steps in different order, and/or additional, related, alternative, or equivalent steps.

At 25001, Method 25000 can compute a final set of Qualifying Fund Accounts, a Withdrawal Amount associated with each Qualifying Fund Account from which one or more embodiments of the invention withdraws a Withdrawal Amount, and a Deposit Amount associated with each Qualifying Fund Account to which one or more embodiments of the invention deposits a Deposit Amount. Method 25000 can use the data in a Transaction Authorization Record to obtain this data.

At 25002, Method 25000 can generate a single Clearing Message 06930 which can include any data and/or instructions contained in a Transaction Clearing Record. Method 25000 can transmit part or all of the data and/or instructions contained in a Transaction Clearing Record to each Data Processing System 01000, Data Structure, and/or Fund Account for a Transaction. Transaction Clearing Record can include all the data and/or instructions required to Clear a single Transaction.

At 25003, Method 25000 can transmit the Clearing Message 06930 to each Fund Account Data Structure associated with each Qualifying Fund Account.

At 25004, Method 25000 can write to each Fund Account Data Structure associated with each Qualifying Fund Account the respective data in the Clearing Message 06930. In a first embodiment, Method 25000 can transmit the Clearing Message 06930 to the Fund Account Administrator, which in turn can relay or process the data and/or instructions in Clearing Message 06930 to the Qualifying Fund Account for processing. For example, one Bank Server 02850 can administer a Qualifying Fund Account held by a first party to which one or more embodiments of the invention deposits a Deposit Amount and a Qualifying Fund Account held by a second party from which one or more embodiments of the invention withdraws a Withdrawal Amount. In a second embodiment, Method 25000 can transmit the Clearing Message 06930 directly to each Qualifying Fund Account for further processing. For example, if a Qualifying Fund Account has an associated Fund Account Data Structure on which a previously installed CPP, e.g., Database Program 16110, can execute CPP Fund Account Operations, one or more embodiments of the invention can execute any instruction in the Clearing Message 06930 directly on the Fund Account Data Structure, e.g., updating the Current Account Balance of the Qualifying Fund Account.

At 25005, Method 25000 can transmit the Clearing Message 06930 to each Retailer Data Structure associated with the Qualifying Retailer and/or Offer Data Structure associated with each Qualifying Offer in the selected Qualifying Retailer/Offer Combination.

At 25006, Method 25000 can write to each Retailer Data Structure associated with the Qualifying Retailer and/or each Offer Data Structure associated with each Qualifying Offer in the selected Qualifying Retailer/Offer Combination the respective data in the Clearing Message 06930. In a first embodiment, Method 25000 can transmit the Clearing Message 06930 to Retailer Server 02300 and/or each Data Processing System 01000 storing the Offer Data Structure, which in turn can relay or process the data and/or instructions in Clearing Message 06930 to the Retailer Data Structure and/or Offer Data Structure for processing. In a second embodiment, Method 25000 can transmit the Clearing Message 06930 directly to each Retailer Data Structure and/or Offer Data Structure for further processing. For example, if a Qualifying Offer has an associated Offer Data Structure on which a previously installed CPP, e.g., Database Program 16110, can execute CPP Offer Operations, one or more embodiments of the invention can execute any instruction in the Clearing Message 06930 directly on the Offer Data Structure, e.g., updating the Offer Available Unit or Offer Available Value attribute.

By generating a single Clearing Message 06930, transmitting Clearing Message 06930 to each Data Processing System 01000, Data Structure, and/or Fund Account related to the execution of a Transaction, and executing the instructions in Clearing Message 06930 on each respective Retailer Data Structure, Offer Data Structure, and/or Fund Account Data Structure, one or more embodiments of the invention can process a Transaction in fewer steps, at lower cost, and/or with fewer errors than generating, transmitting, and executing instructions in a clearing message in a plurality of Payment Networks each processing a different class of Offers.

For example, a User can purchase one or more Products in a single Transaction and attempt to redeem one or more Offers which can qualify for a Transaction. A Card Association can process the transfer of funds between a Payment Issuer 02800 and an Acquirer 02811. A Coupon Network can process the transfer of funds between a Fund Account held by a party making an Offer in the form of paper coupons and a Fund Account held by a party redeeming the paper coupons, e.g., a Retailer Server 02300. An ACH can process the transfer of funds between a Fund Account held by an Insurer Server 02700 paying for part or all of the price of a Product and a Fund Account held by a Producer 02400 seeking reimbursement for the Product.

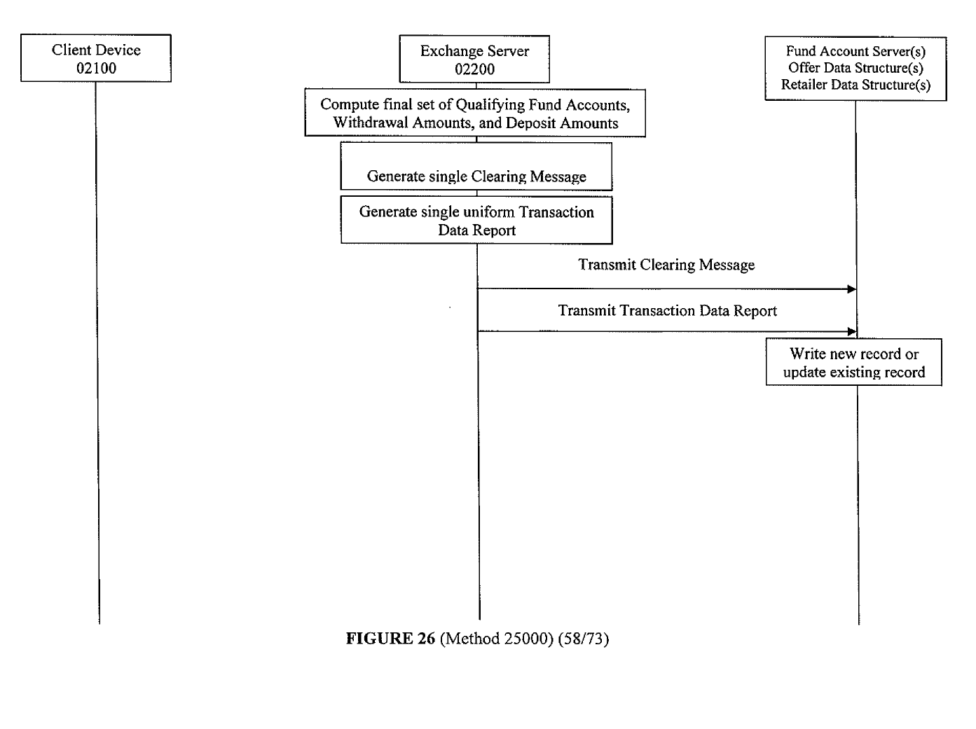

FIG. 26 depicts a chart illustrating the flow of data in and executions of functions by an exemplary computer-implemented method, Method 25000, among a Client Device 02100, Exchange Server 02200, and one or more other Data Processing Systems, according to one embodiment.

One or more embodiments of the invention produces a well-defined, particular, immediate, and real-world benefit to the public because generating, transmitting, receiving, and/or processing a single Clearing Message 06930 can: (a) ensure the generation, reception, and processing of all the data and/or instructions required to Clear and Settle a Transaction and decrease the probability of requiring a plurality of Settlements of a single Transaction; (b) decrease duplication of data in a plurality of clearing messages; (c) decrease the probability of a plurality of clearing messages missing one or more data and/or instructions because one Payment Network assumes another Payment Network provides the data and/or instructions; (d) eliminate the probability of a party receiving data for any attribute and/or instructions which differ in a plurality of clearing messages; and/or (e) ensure that a party receives the data and/or instructions in a Transaction Clearing Record once and in a uniform format, which can decrease the time and effort for Reconciliation 27200. Adding data describing additional attributes of a Transaction, e.g., in an addendum file, does not mitigate the costs of Clearing a Transaction through a plurality of Payment Networks each processing a different class of Offers.

### Unified Settlement

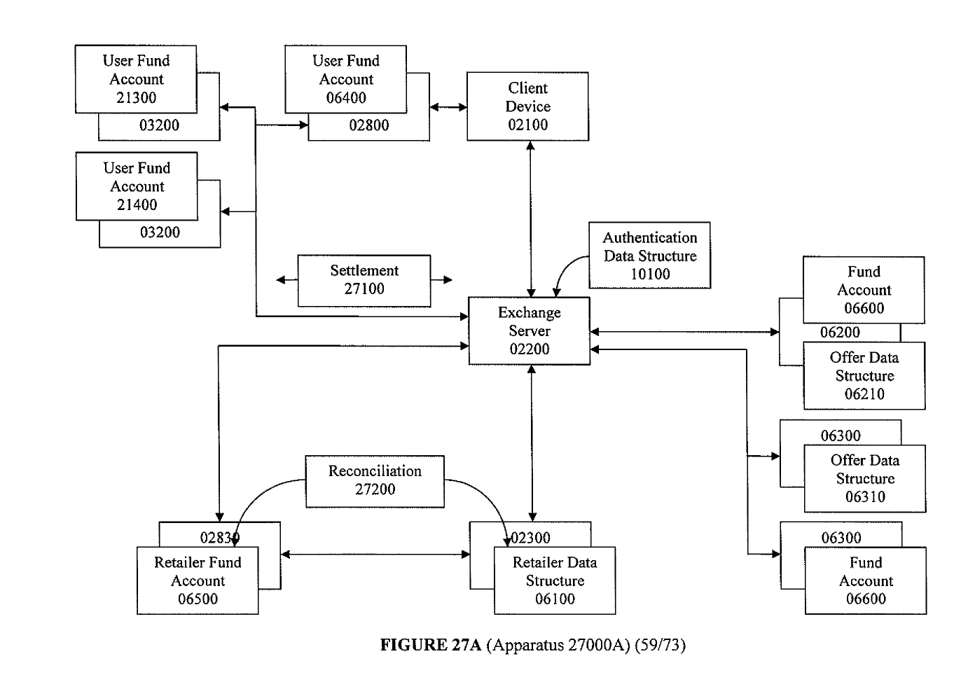

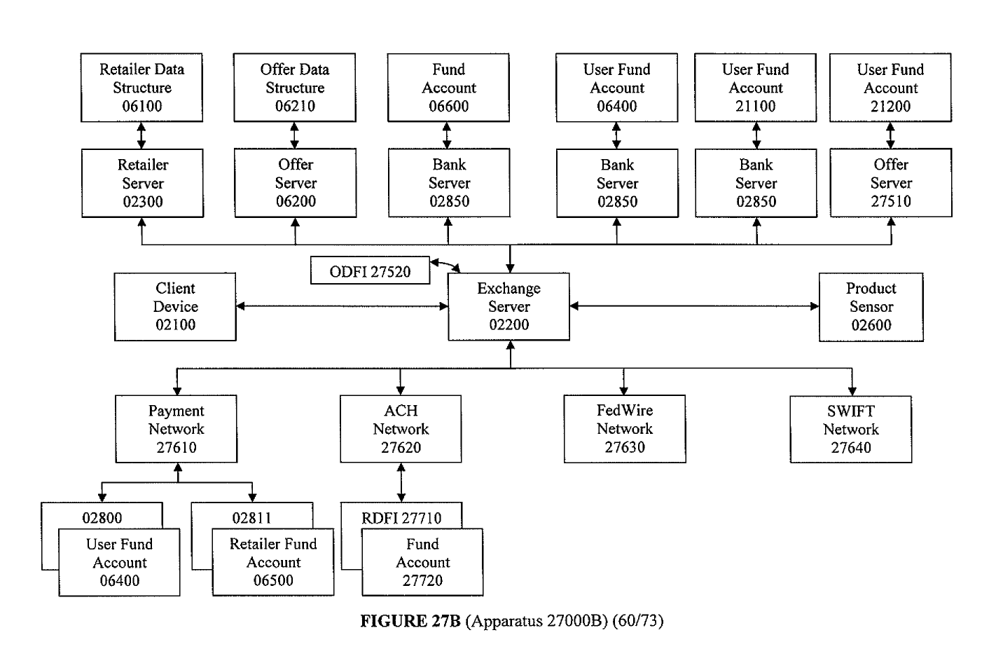

FIG. 27A depicts a block diagram of an exemplary apparatus (e.g., a distributed apparatus performing distributed computing), Apparatus 27000A, enabling the exchange and processing of data to Settle a Transaction, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components, Data Structures, data, and/or instructions.

Settlement 27100 can be a set of instructions executing one or more functions of: (a) computing the Net Withdrawal Amount or Net Deposit Amount for any Qualifying Fund Account during a predefined Settlement cycle; (b) withdrawing the Net Withdrawal Amount from a Qualifying Fund Account for which the sum of all Deposit Amounts is less than the sum of all Withdrawal Amounts for the one or more Transactions during a predefined Settlement cycle; and/or (c) depositing the Net Deposit Amount to a Qualifying Fund Account for which the sum of all Deposit Amounts is greater than the sum of all Withdrawal Amounts for the one or more Transactions during a predefined Settlement cycle. In a first embodiment,

Reconciliation 27200 can be a Data Structure, data, and/or instructions enabling a party holding a Fund Account from which one or more embodiments of the invention withdraws a Withdrawal Amount and/or a party holding a Fund Account to which one or more embodiments of the invention deposits a Deposit Amount to reconcile data including without limitation: (a) data in a Retailer Data Structure; (b) data in an Offer Data Structure; (c) data in a Fund Account Data Structure; (d) a Withdrawal Amount; (e) data associated with the Fund Account from which one or more embodiments of the invention withdraws a Withdrawal Amount; (f) a Deposit Amount; and/or (g) data associated with the Fund Account to which one or more embodiments of the invention deposits a Deposit Amount.

Currently, a Payment Network typically allows or may require each Transaction Enabler to record the receipt of and/or withdraw a Transaction Fee at the point where it transfers funds in a Transaction. Because current Payment Networks typically withdraw funds from a single Fund Account, e.g., User Fund Account held by a User, and deposit funds to a single Fund Account, e.g., a Fund Account held by Retailer Server 02300, a current Payment Network can rely on that system of Transaction Fee withdrawal.

Because one or more embodiments of the invention can enable the withdrawal of funds from and the deposit of funds to a plurality of Fund Accounts, one or more embodiments of the invention utilizes an Exchange Server 02200 to determine an allocation of Transaction Fees for any single Transaction. A single apparatus Settling a Transaction among more than a single Fund Account from which to withdraw funds and a single Fund Account to which to deposit funds, e.g., Apparatus 06000, can use a centralized Data Processing System 01000, e.g., Exchange Server 02200, to generate a single Settlement 27100 processing the transfer of funds to Settle a Transaction.

FIG. 27B depicts a block diagram of an exemplary apparatus (e.g., a distributed apparatus performing distributed computing), Apparatus 27000B, enabling the exchange and processing of data to Authorize, Clear, and/or Settle a Transaction where one or more functions can be executed in one or more other Payment Networks, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components, Data Structures, data, and/or instructions.

Offer Server 27510 can be a Data Processing System 01000 administered by an Administrator of a Fund Account, e.g., User Fund Account 21200 storing funds in the form of non-cash, held by a User.

ODFI 27520 can be a Data Processing System 01000 administered by an ODFI administering a Fund Account, which can originate a Transaction executed through an ACH.

Payment Network 27610 can be a Payment Network which can execute one or more functions in a Transaction.

ACH Network 27620 can be an ACH which can execute one or more functions in a Transaction.

Fedwire® Network can be the Fedwire® Funds Service or any network executing one or more functions equal or equivalent to the Fedwire® Funds Service.

SWIFT Network 27640 can be a Payment Network executing one or more functions in a Transaction.

RDFI 27710 can be a Data Processing System 01000 administered by an RDFI administering a Fund Account, which can receive a Transaction executed through an ACH.

Fund Account 27720 can be a Fund Account held by a Receiver and administered by RDFI 27710.

One or more Card Associations (not illustrated).

One or more Electronic Funds Transfer (“EFT”) Networks, e.g., STAR or NYCE (not illustrated).

One or more local, country, and/or regional EFT Networks (not illustrated).

Apparatus 27000B can implement one or more interfaces to one or more other Payment Networks executing the transfer of funds of either: (a) one or more Withdrawal Amounts from a Qualifying Fund Account; and/or (b) one or more Deposit Amounts to a Qualifying Fund Account.

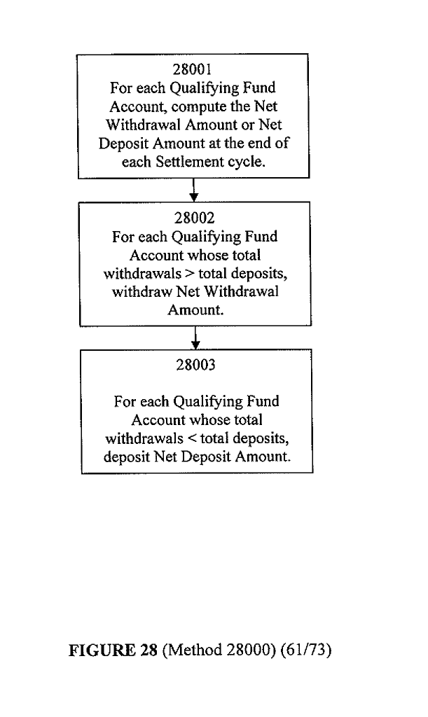

FIG. 28 depicts a flow chart of an exemplary computer-implemented method, Method 28000, that when executed can exchange and process data to Settle a Transaction, according to one embodiment. The flowchart refers to the apparatus and structures depicted in FIG. 27A and FIG. 27B. However, the method is not limited to those embodiments. The method can implement the steps described herein utilizing a subset of the components, any combination of the components, or additional, related, alternative, and/or equivalent components depicted in FIG. 27A and FIG. 27B and/or elsewhere in the application. The method can execute a subset of the steps, any combination of the steps, the steps in different order, and/or additional, related, alternative, or equivalent steps.

At 28001, Method 28000 can compute for each Qualifying Fund Account the Net Withdrawal Amount or the Net Deposit Amount which for any Qualifying Fund Account equals the sum of all Deposit Amounts and the sum of all Withdrawal Amounts for the one or more Transactions processed in a single apparatus (e.g., a distributed apparatus performing distributed computing), e.g., Apparatus 06000, during a predefined Settlement cycle.

At 28002, Method 28000 can withdraw the Net Withdrawal Amount from each Qualifying Fund Account for which the sum of all Deposit Amounts is less than the sum of all Withdrawal Amounts for the one or more Transactions processed in a single apparatus (e.g., a distributed apparatus performing distributed computing), e.g., Apparatus 06000, during a predefined Settlement cycle.

At 28003, Method 28000 can deposit the Net Deposit Amount to each Qualifying Fund Account for which the sum of all Deposit Amounts is greater than the sum of all Withdrawal Amounts for the one or more Transactions during a predefined Settlement cycle.

In a first embodiment, the invention can execute 28002 and 28003 in a single apparatus (e.g., a distributed apparatus performing distributed computing), e.g., Apparatus 06000.

In a second embodiment, the invention can execute 28002 and 28003 by executing one or more functions in an apparatus (e.g., a distributed apparatus performing distributed computing), e.g., Apparatus 06000, and one or more functions in one or more other apparatuses including without limitation: a Card Association, an ACH, Fedwire® Funds Service, and/or a SWIFT Network.

Method 28100 is an exemplary computer-implemented method that when executed can enable the exchange and processing of data to Authorize, Clear, and/or Settle a Transaction where one or more functions can be executed in one or more conventional Payment Networks, according to one embodiment. The flowchart refers to the apparatus and structures depicted in FIG. 27A and FIG. 27B. However, the method is not limited to those embodiments. The method can implement the steps described herein utilizing a subset of the components, any combination of the components, or additional, related, alternative, and/or equivalent components depicted in FIG. 27A and FIG. 27B and/or elsewhere in the application. The method can execute a subset of the steps, any combination of the steps, the steps in different order, and/or additional, related, alternative, or equivalent steps.

At 28101, Method 28100 can determine if a Qualifying Fund Account can receive a Deposit Amount through another Payment Network and/or can transmit a Withdrawal Amount through a conventional Payment Network.

At 28102, Method 28100 can compute the Withdrawal Amount and/or Deposit Amount for each Qualifying Fund Account which can transmit and/or receive funds, respectively through a conventional Payment Network.

At 28103, Method 28100 can transmit part or all of a Transaction Clearing Record to the conventional Payment Network which can process the withdrawal of a Withdrawal Amount and/or deposit of a Deposit Amount to the Qualifying Fund Account, e.g., a Qualifying Fund Account administered by an Administrator which is a member of the Payment Network.

At 28104, Method 28100 can generate and/or transmit a Transaction Clearing Record for those Qualifying Fund Accounts whose holders and/or Administrators elect to use for Settlement an EFT Network, Card Association, or conventional Payment Network, e.g., Visa® or MasterCard®, which can then Clear and Settle one or more Transactions through the respective conventional Payment Network or EFT Network.

One or more embodiments of the invention can generate an interface enabling the transfer of data and/or instructions between an apparatus described herein, e.g., Apparatus 06000, and one or more conventional Payment Networks and/or EFT Networks. One or more embodiments of the invention can generate an interface for any one or more functions including without limitation: Authentication, Authorization, Clearing, and/or Settlement. In a first embodiment, the invention can generate an interface enabling the conversion of any data and/or instructions generated in one or more apparatuses described herein, e.g., Apparatus 06000, to the format(s) required by a conventional Payment Network or EFT Network. In a second embodiment, the invention can generate an open interface enabling the conversion of any data and/or instructions generated in a conventional Payment Network or EFT Network to the format(s) required by one or more apparatuses described herein, e.g., Apparatus 06000.

For example, an ACH requires an Originator originating an ACH transaction to obtain from the Receiver an authorization to withdraw funds from the Receiver Fund Account administered by an RDFI. The ACH requires the Originator to enter a Standard Entry Class (“SEC”) code associated with the class of received authorization including without limitation: (a) a written authorization, e.g., Point-of-Purchase (“POP”) like a paper check received by a Retailer Server 02300; (b) an oral authorization, e.g., Telephone-initiated entry (“TEL”) like an oral authorization by voice communication; and/or (c) an electronic authorization, e.g., Web-initiated entry (“WEB”) like an electronic authorization received through an electronic network like the Internet. In the example of complying with the ACH Receiver authorization requirements, one or more embodiments of the invention can generate an interface transferring to an ACH an Authorization Response 06920 if the Authorization Response 06920 is already in the SEC code format required by the ACH or converting an Authorization Response 06920 to the SEC code format if the Authorization Response 06920 is not in the SEC code format.

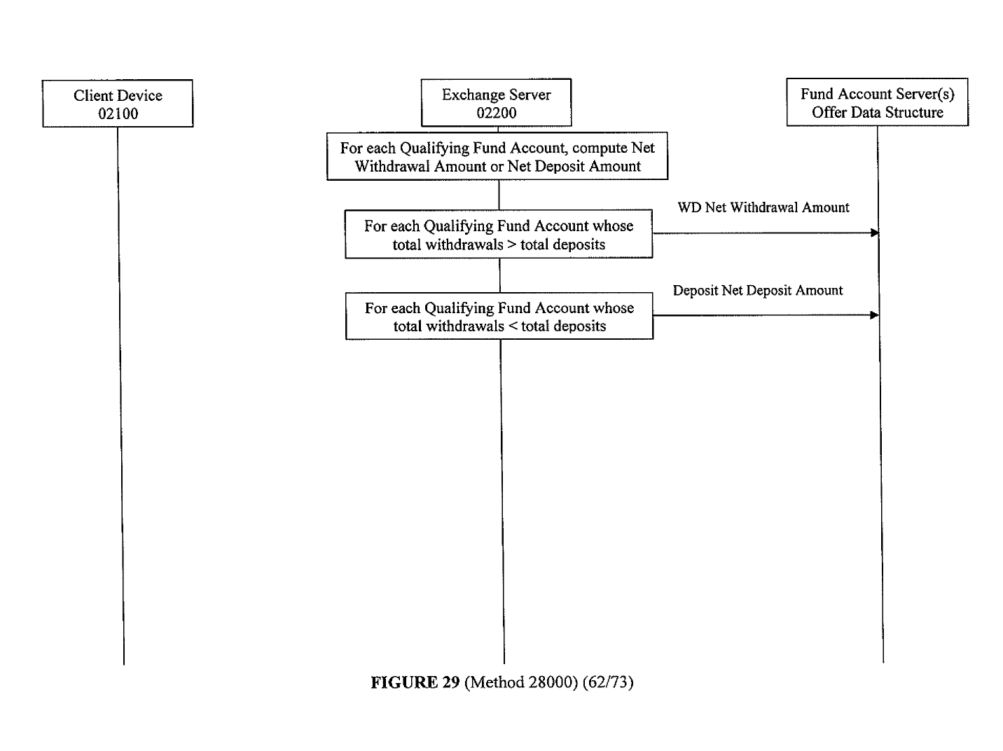

FIG. 29 depicts a chart illustrating the flow of data in and executions of functions by an exemplary computer-implemented method, Method 28000, among a Client Device 02100, Exchange Server 02200, and one or more other Data Processing Systems, according to one embodiment.

One or more embodiments of the invention produces a well-defined, particular, immediate, and real-world benefit to the public because Settling one or more Transactions through a single apparatus, e.g., Apparatus 06000, can: (a) enable a single Settlement of all classes of Offers while Settling one or more Transactions through a plurality of Payment Networks each of which processes a different class of Offers can lead to multiple Settlements at different times; (b) enable a net Settlement for all parties executing one or more functions in a Transaction on any Settlement cycle; (c) enable all parties executing one or more functions in a Transaction to Settle among each party, e.g., a User and/or User of Client Device 02100, a Retailer Server 02300, a Producer Server 02400, an Insurer Server 02700, an Employer Server 03200, and a Tax Server 02900 can Settle all transfers of funds with any other party in the same Transaction; (d) eliminate a plurality of Settlement entries and Settlement times which could affect the flow of funds among the parties in the same Transaction; (e) eliminate the possibility of a Settlement of fewer than all elements of a Transaction which would cause a plurality of Settlements for a single Transaction; and/or (f) decrease the cost of Reconciliation 27200 through a single Settlement, e.g., by eliminating the possibility of different elements of a Transaction recorded in a Qualifying Fund Account as separate Transactions which would increase the cost of Reconciliation 27200 and customer service resolving the recordings.

### Exemplary Implementations of the Invention

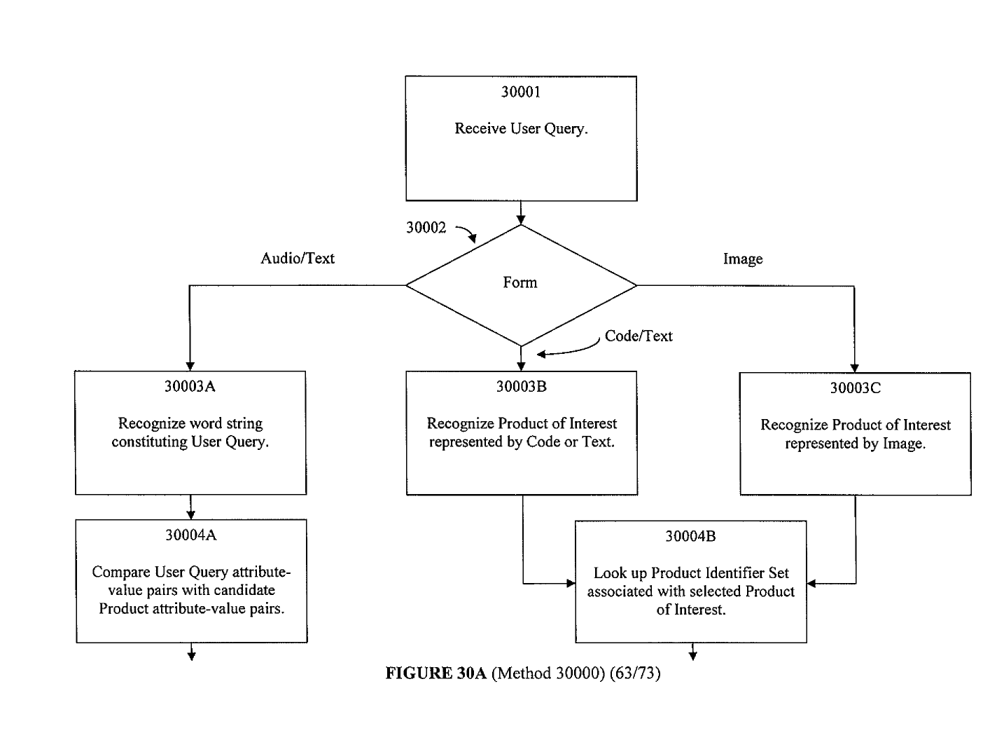

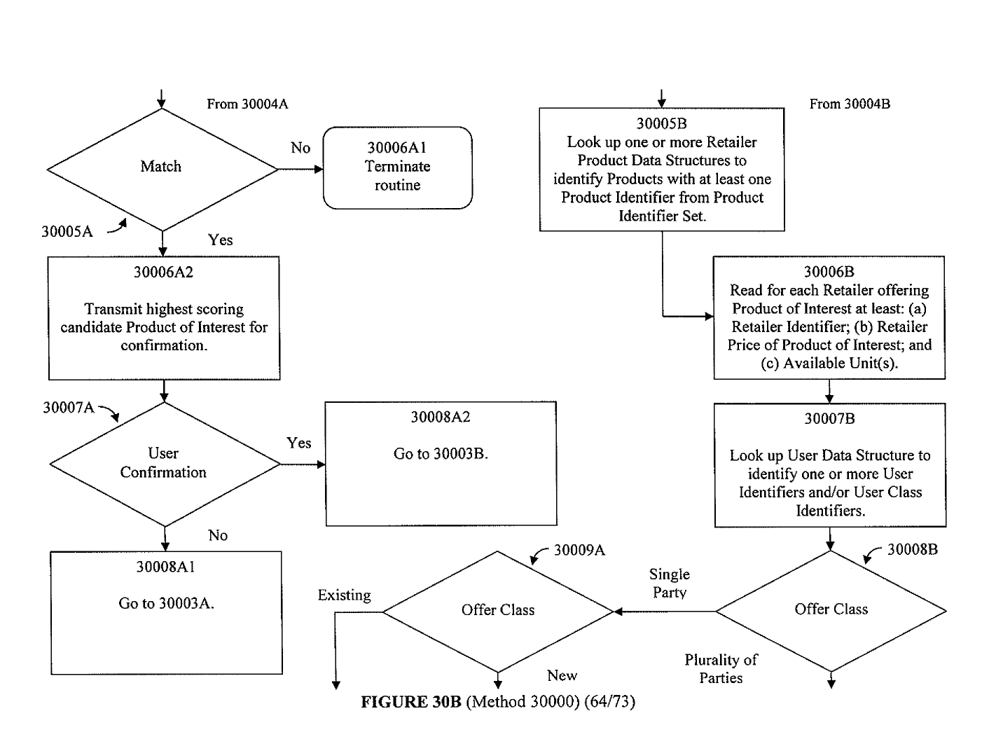

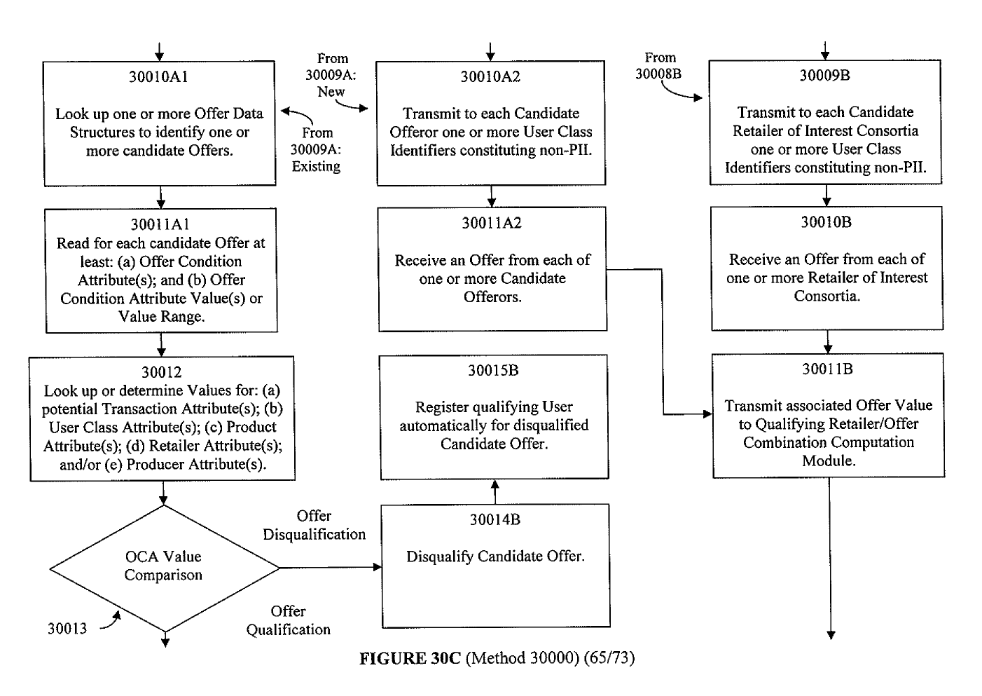

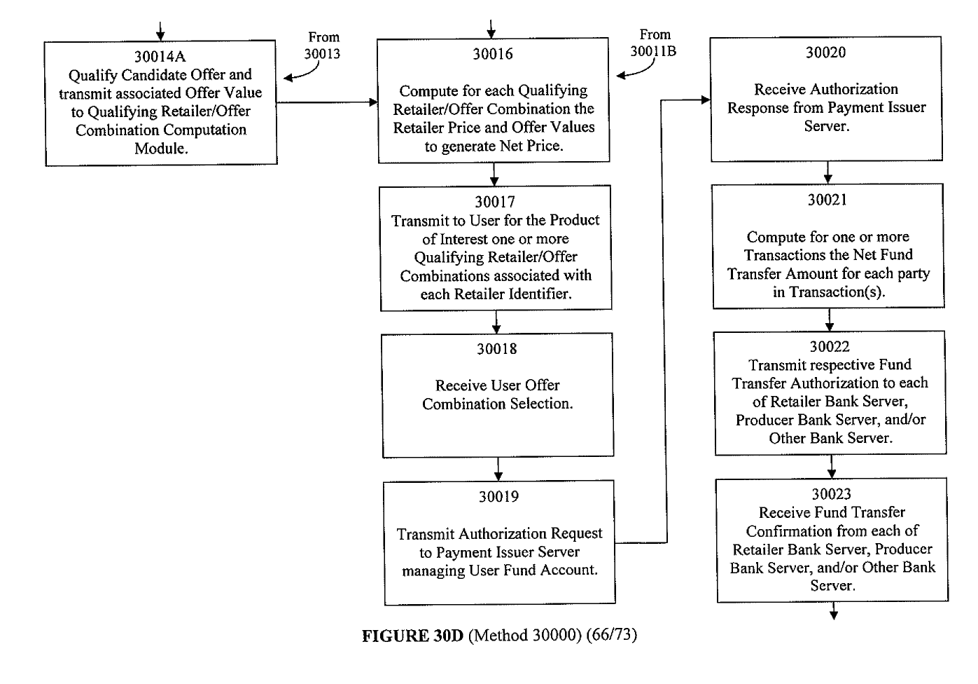

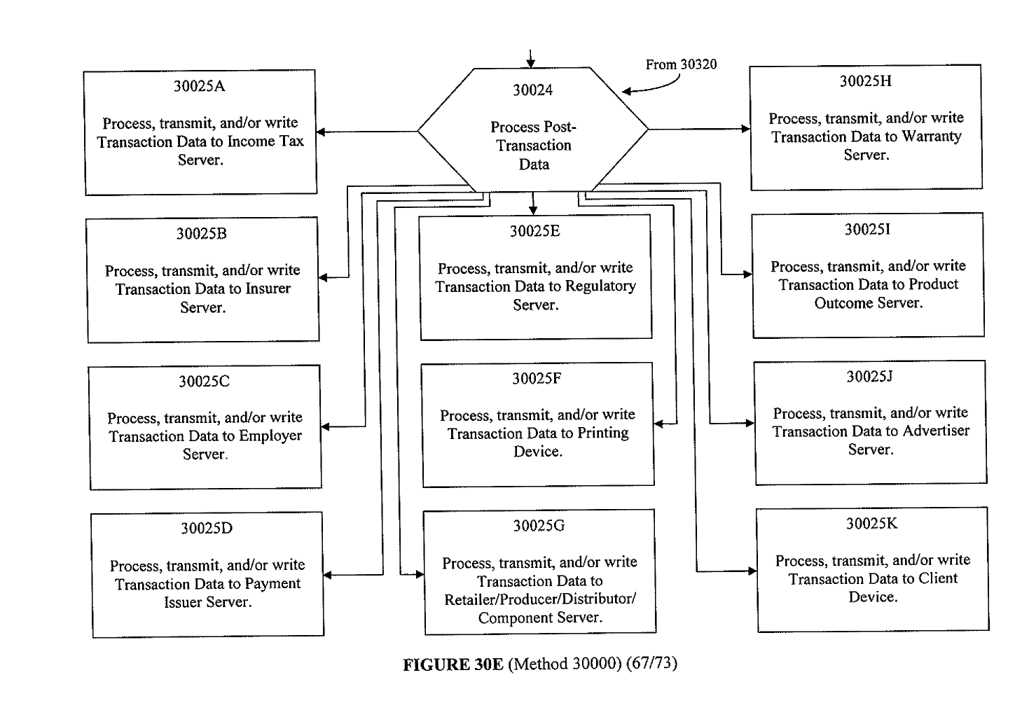

FIG. 30A through FIG. 30E depict a flow chart of an exemplary computer-implemented method, Method 30000, that when executed can exchange and process data to determine a Product of Interest meeting a party's needs, identify one or more Qualifying Offers, execute the purchase of at least the Product of Interest, process the one or more Qualifying Offers, transfer funds among a plurality of Qualifying Fund Accounts, and execute any function related to the Product of Interest after purchase, according to one embodiment. The flowchart refers to the apparatus and structures depicted in FIG. 01 through FIG. 29. However, the method is not limited to those embodiments. The method can implement the steps described herein utilizing a subset of the components, any combination of the components, or additional, related, alternative, and/or equivalent components depicted in FIG. 01 through FIG. 29 and/or elsewhere in the application. The method can execute a subset of the steps, any combination of the steps, the steps in different order, and/or additional, related, alternative, or equivalent steps.

At 30001, Method 30000 can receive from any Client Device 02100 a User Query, which the application defines to mean a query about a Product of Interest originating from or relayed through a Client Device 02100. Client Device 02100 can transmit a User Query originating in any form including without limitation: (a) speech, e.g., a string, i.e., a sequence of characters, of one or more words constituting a speech utterance spoken by the User of Client Device 02100, describing a Product of Interest received by one or more Input Devices 01400, e.g., a microphone, of Client Device 02100; (b) audio, e.g., an audio signal transmitted by a speaker like a television or radio, describing a Product of Interest received by one or more Input Devices 01400, e.g., a microphone, of Client Device 02100; (c) text inputted in any form including without limitation: (i) inputted by the User of Client Device 02100, e.g., a word string typed, written, or inputted in any other form by the User of Client Device 02100, describing or specifying a Product of Interest received by one or more Input Devices 01400, e.g., a keyboard or touch-sensitive display, of Client Device 02100; and/or (ii) received from Client Device 02100 which can originate from an action executed by the User of Client Device 02100 other than the User input, e.g., an alphanumeric string associated with a Product of Interest like a hypertext reference including a unique identifier of the Product of Interest, specifying the Product of Interest read by one or more CPP, e.g., a browser, in Client Device 02100; (d) image, e.g., a still or moving image capturing the image of a Product of Interest received by one or more Input Devices 01400, e.g., a still or moving image camera, of Client Device 02100; and/or (e) code, e.g., a two-dimensional code like a barcode, a three-dimensional code like a QR code, or a n-dimensional code where n is any number other than two or three, describing or identifying a Product of Interest received by one or more Input Devices 01400, e.g., a still or moving image camera, a barcode reader, a NFC reader, a wireless transceiver, or a wireline transceiver, of Client Device 02100. A User Query can comprise a word string specifying a single Product of Interest, a plurality of Products of Interest, a Product Class, and/or value(s) or value range of one or more attributes of a Product. A User Query can comprise: (a) a word string specifying one or more Products of Interest; or (b) a word string specifying one or more Products of Interest and one or more words related to the Product of Interest, which in turn can include without limitation: (i) a word string which the User intends to act upon the Product of Interest, e.g., the word “buy” or “send”; (ii) a word string which the User intends to be the recipient of the Product of Interest, e.g., the word string “to mom”; and/or (iii) a word string which the User intends to be one or more attributes related to the act on the Product of Interest, e.g., the word string “on Mother's Day.”

A User Query can originate from any source associated with Client Device 02100 including without limitation: (a) an action executed by the User of Client Device 02100; and/or (b) an action executed by Client Device 02100 other than an action by the User of Client Device 02100, e.g., Client Device 02100 can be a Data Processing System 01000 connected to an automobile which automatically transmits a User Query in any form including without limitation speech, audio, text, image, and/or code about a Product of Interest like gasoline when the level of gasoline falls below a predefined threshold.

A User Query that does not specify a Product of Interest can be in the form of a structured User Query or an unstructured User Query. That is, a User of Client Device 02100 can transmit a query for another party, e.g., Exchange Server 02200, to identify a Product of Interest whose value(s) at least meet the value(s) for one or more attributes specified in the User Query.

A Structured User Query means a query by the User of Client Device 02100 comprising a word string representing one or more ordered pairs:

SQ={(Attribute₁,value₁ᵢ),(Attribute₂,value₂ᵢ), . . . (Attributeₙ,valueₙᵢ)}, n≧1 (Equation 67)

where Attributeₙ is the nth attribute of a Product, valueᵢ is one or more values, e.g., a value range, in a domain of the Product attribute, and i is the number of candidate values for any Product attribute. For example, a Structured User Query can comprise a word string, “color equals blue, transmission equals automatic” where blue is one color among the i number of colors offered by an automobile Producer and automatic is one of two classes of transmission offered by the automobile Producer.

An Unstructured User Query means a query by the User of Client Device 02100 comprising a word string including no ordered pairs:

UQ={word₁,word₂, . . . wordₙ}, n≧1 (Equation 68)

where wordₙ is a word related to: (a) one or more Attributes of a Product; and/or (b) one or more values for any Product attribute. For example, an Unstructured User Query can comprise a word string, “What car has a blue exterior, automatic transmission, is a plug-in, and gets at least 40 miles per gallon?”

At 30002, Method 06000 can determine the form of the User Query by applying comparator logic to identify the form. Comparator logic can identify the form by comparing data in an incoming signal with data in a Data Structure, which can be stored on a Computer-Readable Medium, specifying different types of objects or streams and their representation. The form can include without limitation: (a) speech; (b) audio; (c) text; (d) image; and/or (e) code, i.e., any form other than speech, audio, text, and/or image. In a first example, Method 30000 can determine the form of the User Query by reading the object type or stream identifier in a network packet header, which can include a field specifying the type of object or stream. The value in the field can represent an audio object or stream or an image object or stream. In a second example, Method 30000 can determine the form of the User Query by identifying the type of Input Device 01400 receiving the User Query, e.g., an Input Device 01400 which is a microphone would indicate that the User Query is in the form of speech or audio.

One or more embodiments of the invention discloses herein methods enabling the 1 recognition of a Product of Interest specified in a User Query in which the User Query is in the form of speech, audio, text, image, and/or code. However, the invention is not limited to that embodiment. One or more embodiments of the invention can use any method known by those skilled in the art to recognize a Product of Interest specified in a User Query in which the User Query is any form.

At 30003A, Method 30000 can recognize the word string constituting the User Query by using any speech recognition or text recognition method known by those skilled in the art. For example, Method 30000 can use any speech recognition method disclosed in U.S. patent application Ser. No. 12/370,536 to recognize the word string constituting the User Query.

At 30004A, Method 30000 can identify one or more candidate Products of Interest specified in the User Query by applying comparator logic to compare: (a) the word string constituting the User Query, which can include a Structured User Query or an Unstructured User Query; with (b) the one or more words in Attributes and values of Attributes of Products in any product Data Structure, e.g., a Retailer Product Data Structure 06100.

For example, in the exemplary Unstructured User Query depicted at 30001, Method 30000 can apply one or more logic to: (a) classify each of the recognized words, e.g., “blue”, “exterior”, “automatic”, and “40” to each of a word class including without limitation: (i) Attribute class; (ii) Value class; and/or (iii) Not Attribute nor Value class; (b) infer one or more candidate Attributes to associate with a recognized value unaccompanied by a recognized Attribute; and/or (c) compute a score estimating the probability of each recognized word belonging to the assigned word class. Method 30000 can compare the assigned Attributes and values in the Unstructured User Query with the Attributes and values of Attributes in one or more Retailer Product Data Structures 06100 to identify the candidate Products of Interest, generate a score for each candidate Product of Interest, and select the highest scoring candidate Product of Interest or n number of the highest scoring candidate Products of Interest.

At 30005A, Method 30000 can: (a) identify a Product which matches a word string specifying a single Product of Interest, where: (i) the Product can be associated with a Product Identifier and/or a Universal Product Identifier; and/or (ii) the User Query includes a word string specifying a single Product of Interest; (b) identify a plurality of Products which match a plurality of word strings specifying a plurality of Products of Interest, e.g., in a shopping list of a plurality of Products of Interest, where the User Query includes a plurality of word strings specifying a plurality of Products of Interest; or (c) present the highest scoring candidate Product of Interest or n number of the highest scoring candidate Products of Interest, where the User Query is a Structured User Query or an Unstructured User Query. In one embodiment, Method 30000 can limit the candidate Products of Interest to one or more candidate Products of Interest each of which is associated with at least one Product Identifier and/or a Universal Product Identifier.

At 30006A1, Method 30000 can terminate the routine in the examples where the User Query includes at least one word string specifying at least a single Product of Interest and Method 30000 cannot identify in one or more Retailer Product Data Structures 06100 at least one candidate Product of Interest matching at least a single Product of Interest specified in the User Query. Method 30000 can transmit to Client Device 02100 a message specifying the absence of a match.

At 30006A2, Method 30000 can: (a) where the User Query includes at least one word string specifying at least a single Product of Interest, transmit to Client Device 02100 the candidate Product of Interest matching at least a single Product of Interest specified in the User Query; or (b) where the User Query is a Structured User Query or an Unstructured User Query, transmit to Client Device 02100 the highest scoring candidate Product of Interest or n number of the highest scoring candidate Products of Interest.

At 30007A, Method 30000 can receive from Client Device 02100 the User confirmation. If Method 30000 receives from Client Device 02100 a confirmation that the candidate Product of Interest equals the Product of Interest in the User Query, Method 30000 can at 30008A2 go to 30004B. If Method 30000 receives from Client Device 02100 a confirmation that the candidate Product of Interest does not equal the Product of Interest in the User Query, Method 30000 can transmit to Client Device 02100 a request to provide additional data associated with the Product of Interest and at 30008A1 go to 30003A to recognize a new word string constituting the User Query.

At 30003B, Method 30000 can recognize the Product of Interest represented by any code and/or text received from Client Device 02100 by applying comparator logic. Comparator logic can recognize the Product of Interest by: (a) comparing the data format of a string extracted from the received code and/or text with data in a Data Structure, which can be stored on a Computer-Readable Medium, specifying different data formats associated with Product Identifiers and/or Universal Product Identifiers; and/or (h) reading the data format specified in a string extracted from the received code and/or text. After determining the data format of the extracted string, the logic can look up the Product associated with the matching string in the identified Product Identifier classification system.

In a first example, Method 30000 can extract from the received code and/or text a string which either: (a) includes a n-digit integer string in the same data format associated with a Product Identifier classification system; and/or (b) includes a n-digit integer string and also specifies the data format associated with a Product Identifier classification system. In the case of (a), Method 30000 can read a Data Structure specifying one or more data formats each of which is associated with a Product Identifier classification system, e.g., a twelve-digit integer string used by the UPC. In the case of (b), Method 30000 can read the data format specified in the string, e.g., the UPC. After determining that the extracted twelve-digit integer string is a UPC, Method 30000 can look up the Product associated with the identified UPC.

In a second example, Method 30000 can extract from the received code and/or text a string which either: (a) includes a five-digit alphanumeric string, e.g., G0424, and/or (b) includes a five-digit alphanumeric string, e.g., G0424, and also specifies the data format associated with a Product Identifier classification system, e.g., a ten-digit alphanumeric string used by the HCPCS. In the case of (a), Method 30000 can read a Data Structure specifying one or more data formats each of which is associated with a Product Identifier classification system, e.g., a ten-digit alphanumeric string used by the UPC. In the case of (b), Method 30000 can read the data format specified in the string, e.g., the HCPCS. After determining that the extracted ten-digit alphanumeric string is a HCPCS, Method 30000 can look up the Product associated with the identified HCPCS, e.g., “Pulmonary Rehabilitation, Including Exercise (Includes Monitoring), One Hour Per Session, Up To Two Sessions Per Day”.

Method 30000 can recognize the Product of Interest represented by any form other than code and/or text received from Client Device 02100 at 30003C, the one or more steps starting at 30003A, and/or any other step by applying the same comparator logic disclosed in 30003B.

At 30003C, Method 30000 can recognize the Product of Interest represented by any image received from Client Device 02100 by using any image recognition method known by those skilled in the art.

At 30004B, Method 30000 can look up a set of one or more Product Identifiers (“Product Identifier Set”) associated with the selected Product of Interest. Method 30000 can generate a Product Identifier Set comprising for one or more Products: (a) any Product Identifier assigned to a unique Product in a classification system of Product Identifiers where only one classification system uniquely identifies a Product; and (b) a mapping of any Product Identifier assigned to a unique Product in a first classification system of Product Identifiers with any Product Identifier assigned to the same unique Product in a second and/or additional classification system of Product Identifiers where Method 30000 can map any Product Identifier: (i) to a Universal Product Identifier generated by one or more embodiments of the invention; or (ii) as a member, instance, and/or object of a Universal Product Identifier.

Method 30000 can generate a Data Structure stored on a Computer-Readable Medium which defines structural and functional interrelationships between: (a) the Product Identifiers and/or Universal Product Identifiers; and/or (b) other data stored in the Data Structure and a Data Processing System 01000, e.g., Exchange Server 02200, where the interrelationships permit the identification of one or more Product Identifiers in a second and/or additional classification system of Product Identifiers associated with a Product Identifier in a first classification system of Product Identifiers.

One or more embodiments of the invention produces a well-defined, particular, immediate, and real-world benefit to the public because generating and reading a Data Structure of a Product Identifier Set can increase the probability of identifying the selected Product of Interest offered by a plurality of Retailers using different Product classification systems. A single Product of Interest may be associated with a plurality of classes of Product Identifiers, each of which uniquely identifies the single Product of Interest in its own classification system. For example, Sony® produces a digital camera, Sony® DSC-T110/B Cybershot Digital Camera. There are at least three different Product Identifiers for the camera including without limitation: (a) a SKU assigned by Sony®, “DSC-T110/B”; (b) a UPC assigned by Sony®, “027242813366”; (c) an ASIN assigned by a first Retailer, “B004H8FNI0”; and (d) a DPCI assigned by a second Retailer, “056-10-0799”. If Method 30000 queries one or more Retailer Product Data Structures 06100 for only the UPC assigned by Sony® for the camera, it would not identify Retailers which use a Product classification system other than the UPC to classify its Products.

One or more embodiments of the invention produces a well-defined, particular, immediate, and real-world benefit to the public because generating and reading a Data Structure of a Product Identifier Set including a Universal Product Identifier can enable Data Processing Systems 01000 other than the Data Processing System 01000 generating a Universal Product Identifier, e.g., Exchange Server 02200, to identify resources associated with a Product of Interest even if the Data Processing System 01000 cannot read or access a Product classification system.

At 30005B, Method 30000 can look up one or more Retailer Product Data Structures 06100 to identify a Product offered by each Retailer associated with at least one Product Identifier and/or one Universal Product Identifier in the Product Identifier Set associated with the selected Product of Interest. Method 30000 can query: (a) the one or more Retailer Product Data Structures 06100 within some defined time period following identification of the at least one Product Identifier and/or one Universal Product Identifier; and/or (b) the data from the one or more Retailer Product Data Structures 06100 downloaded to another Data Structure, e.g., a Data Structure stored on Exchange Server 02200 to enable faster querying. In a first example, Method 30000 can query a set of n number of Retailer Product Data Structures 06100 of which m number of Retailers where m≦n stored at least one Product Identifier identifying the Sony® DSC-T110/B Cybershot Digital Camera. In a second example, Method 30000 can query a set of n number of Retailer Product Data Structures of which m number of Retailers where m≦n stored at least one Universal Product Identifier identifying the combination of one or more goods and/or one or more services treating the condition COPD.

At 30006B, Method 30000 can for each Retailer offering the Product of Interest read from the Retailer Product Data Structure 06100 at least: (a) a Retailer Identifier associated with the Retailer; (b) the Retailer Price; and/or (c) the Retailer Available Units. For example, the manufacturer's suggested retailer price (“MSRP”) of the Sony® DSC-T110/B Cybershot Digital Camera can be $219.99. A Retailer can offer to sell the camera for a Retailer Price of $199.99.

At 30007B, Method 30000 can look up a User Data Structure 13000A depicted in FIG. 13A which can include without limitation: (a) one or more User Identifiers associated with the User of Client Device 02100; and/or (b) one or more User Class Identifiers associated with: (i) the User of Client Device 02100; and/or (ii) the User Identifier associated with the User of Client Device 02100.

At 30008B, Method 30000 can determine whether to identify one or more Qualifying Offers offered: (a) individually by each of one or more single parties; and/or (b) jointly by each of a plurality of parties.

At 30009A, Method 30000 can determine whether to identify one or more Qualifying Offers offered individually by a single party which can include without limitation: (a) one or more existing Offers; and/or (b) one or more new Offers.

An Existing Offer is an Offer which exists at or before the time Method 30000 receives a User Query. That is, a single party or plurality of parties making an Existing Offer sets before or at the time Method 30000 receives a User Query: (a) the one or more attributes of an Existing Offer which can include without limitation: (i) the Offer Value; and/or (ii) the one or more Offer Offer. For example, Producer Server 02400 can set before the time Method 30000 receives a User Query the one or more attributes of an Existing Offer and the value(s) or value ranges of each attribute, e.g., an Offer to sell Product XYZ at a unit price of P₁ where the unit price is set before Method 30000 receives the User Query.

An Existing Offer can have any form including without limitation: (a) a static form (“Static Existing Offer”), i.e., where the one or more attributes of an Existing Offer and/or the value(s) or value range of each attribute can be constant; and/or (b) a dynamic form, (“Dynamic Existing Offer”), i.e., where the one or more attributes of an Existing Offer and/or the value(s) or value range of each attribute can be changed by the single party or plurality of parties making an Existing Offer. A single party or plurality of parties can make a Dynamic Existing Offer by generating a rule which specifies how to change the one or more attributes and/or value(s) or value range of each attribute depending on the value of any input received.

The input received can be related to any factor including without limitation: (a) the User, e.g., a value associated with a User Action Condition like the User reducing his/her frequency of smoking to a predefined threshold of cigarettes per time period; (b) the single party or plurality of parties making a Dynamic Existing Offer, e.g., a value associated with a Producer like the cost of producing a Product of Interest; and/or (c) any factor other than one related to a User or the single party or plurality of parties making a Dynamic Existing Offer.

For example, a single party or plurality of parties can specify before the time Method 30000 receives a User Query a rule changing one or more attributes of an Existing Offer and/or the value(s) or value range of each attribute depending on, e.g., (a) a value associated with a User Action Condition like a value indicating that the User has not reduced his/her frequency of smoking to a predefined threshold of cigarettes per time period which can lead to a higher Offer Value; and/or (b) a value associated with a Producer like the cost of producing a Product of Interest like a value indicating a reduction in the cost of producing a smoking cessation good.

A New Offer is an Offer which exists after the time Method 30000 receives a User Query. That is, a single party or plurality of parties making a New Offer sets after the time Method 30000 receives a User Query: (a) the one or more attributes of a New Offer which can include without limitation: (i) the Offer Value; and/or (ii) the one or more Offer Condition Attributes; and/or (b) the value(s) or value range of each attribute of the New Offer. For example, Producer Server 02400 can set after the time Method 30000 receives a User Query the one or more attributes of a New Offer and the value(s) or value ranges of each attribute, e.g., an Offer to sell Product XYZ at a unit price of P₂ where the unit price is set after Method 30000 receives the User Query. Producer Server 02400 can vary the unit price for reasons which can include without limitation: (a) reasons associated with the party purchasing and/or using Product XYZ, e.g., one or more embodiments of the invention classifying the User into a specific Loyalty class; (b) reasons associated with the Producer, e.g., a decrease in the unit price of a component offered by Component Server 03600 enabling Producer to decrease P₂; and/or (c) reasons associated with a party other than the party purchasing and/or using Product XYZ or the Producer, e.g., a decrease in the unit price of a Product which can serve as a substitute for Product XYZ.

In one or more embodiments, a Qualifying Offer is an Offer where: (a) the Offer Condition Attribute Value(s) associated with each and every Offer Condition Attribute either: (i) is equal to the value(s) of the potential Transaction Attribute equal or equivalent to the Offer Condition Attribute; or (ii) includes the value(s) of the potential Transaction Attribute equal or equivalent to the Offer Condition Attribute; and/or (b) the Offer Condition Attribute Value Range associated with each and every Offer Condition Attribute includes the value(s) of the potential Transaction Attribute equal or equivalent to the Offer Condition Attribute. For example, if an Offer includes two Offer Condition Attributes of which the first is a Product condition in an NDC format and the Offer Condition Attribute Value is the set of NDC identifiers 00071015000:00071015999 and the second is a User Class condition in an Insurer domain and NAIC Payer Identification Number format and the Offer Condition Attribute Value is 61101, the Offer will be a Qualifying Offer only if the value of a Transaction Attribute equal or equivalent to the Product condition is an NDC identifier within the set of NDC identifiers 00071015000:00071015999 and the value of the potential Transaction Attribute equal or equivalent to the User Class condition is a NAIC Payer Identification Number equal to 61101. That is, a Transaction where the Product of Interest purchased is Lipitor® in one or more strengths and the User purchasing the Product of Interest is a customer of a Health Insurance Product offered by Humana® Health Plans will qualify for the Offer and its associated Offer Value, e.g., coverage of the total unit price of the Product of Interest less a fixed co-payment.

At 30010A1, Method 30000 can look up one or more Offer Data Structures 13000B to identify one or more candidate Existing Offers. Method 30000 can query: (a) the one or more Offer Data Structures 13000B stored on a Data Processing System 01000, e.g., Retailer Server 02300 or Insurer Server 02700, within some defined time period following identification of the at least one Product Identifier and/or one Universal Product Identifier; and/or (b) the data from the one or more Offer Data Structures 13000B downloaded to another Data Structure, e.g., a Data Structure stored on Exchange Server 02200, to enable faster querying.

In one embodiment, Method 30000 can: (a) at 30011A1 read for each Offer stored in an Offer Data Structure 13000B: (i) all Offer Condition Attributes associated with each Offer; and/or (ii) the Offer Condition Attribute Value(s) or value range associated with each Offer Condition Attribute; (b) at 30012 look up or determine the value(s) specified by each Offer Condition Attribute associated with each Offer, which can include without limitation: (i) the value(s) of any potential Transaction Attribute; (ii) the value(s) of any attribute associated with the User Class identified at 30007B; (iii) the value(s) of any Product Attribute associated with the Product of Interest identified at 30004B; (iv) the value(s) of any Retailer Attribute associated with the one or more Retailers identified at 30005B; and/or (v) the value(s) of any other attributes; and/or (c) at 30013 apply comparator logic to determine whether any Offer is a Qualifying Offer.

Method 30000 can determine Candidate Offers by utilizing any identifier and/or set of identifiers, which can include without limitation: (a) a User Identifier associated with the User of Client Device 02100; (b) a User Class Identifier associated with the User of Client Device 02100; (c) a Product Identifier and/or Universal Product Identifier associated with the Product of Interest; (d) a Product Class Identifier associated with the Product of Interest and/or Universal Product Identifier; (e) a Retailer Identifier associated with a Retailer which Method 30000 identifies as offering to sell the Product of Interest; and/or (f) a Retailer Class Identifier associated with a Retailer which Method 30000 identifies as offering to sell the Product of Interest (collectively, “Candidate Offer Identifiers”).

One or more embodiments of the invention discloses herein methods enabling the identification of one or more Offers associated with any identifier and/or set of identifiers including without limitation: a User Identifier, a User Class Identifier, a Product Identifier, a Universal Product Identifier, a Product Class Identifier; a Retailer Identifier, and/or a Retailer Class Identifier. However, the invention is not limited to that embodiment. One or more embodiments of the invention can use any method to identify one or more Qualifying Offers associated with any class of identifier.

Method 30000 can query: (a) the one or more Offer Data Structures 13000B within some predefined time period following identification of the at least one Product Identifier and/or one Universal Product Identifier; (b) the one or more Offer Data Structures within some predefined time period following identification of the at least one Retailer Identifier; or (c) the data from the one or more Offer Data Structures downloaded to another Data Structure, e.g., a Data Structure stored on Exchange Server 02200 to enable faster querying.

Method 30000 can generate a set of Candidate Offers including any Offer stored in any Offer Data Structure including at least one identifier equal to and/or one set of identifiers including any Candidate Offer Identifier.

One or more embodiments of the invention can use any method known by those skilled in the art to determine if a Transaction Attribute Value associated with each Transaction Attribute equal or equivalent to every Offer Condition Attribute associated with an Offer is equal to either: (a) the Offer Condition Attribute Value associated with the Offer Condition Attribute; or (b) at least one value within a set of Offer Condition Attribute Values associated with the Offer Condition Attribute. These methods can include without limitation: (a)

At 30025E, Method 30000 can process, transmit, and/or write any Transaction Data to one or more Data Structures stored on Regulatory Agency Server 05100.

For example, a User can authorize another party, e.g., another individual or an organization, to receive funds from a Government Benefit Authority Server 03300, e.g., Social Security benefits, on his/her behalf (“Authorized Funds Recipient”). The Authorized Funds Recipient should use the Social Security benefits to pay for one or more Products required by the User. The Social Security Administration (“SSA”) requires the Authorized Funds Recipient to maintain records of these Transactions. One or more embodiments of the invention can produce a well-defined, particular, immediate, and real-world benefit to the public because: (a) it can create a record of all Transactions associated with the Authorized Funds Recipient and/or the User, which would help the Authorized Funds Recipient and/or the User to maintain records of the Products purchased for use by the User; and/or (b) each Transaction Data Report would include data specifying the one or more Products purchased in a Transaction and/or Retailer selling the one or more Products, which one or more embodiments of the invention can compare with any data in records maintained by the User and/or Authorized Funds Recipient.

One or more embodiments of the invention discloses herein methods enabling the identification of one or more Offers associated with any identifier and/or set of identifiers including without limitation: a User Identifier, a User Class Identifier, a Product Identifier, a Universal Product Identifier, a Product Class Identifier; a Retailer Identifier, and/or a Retailer Class Identifier. However, the invention is not limited to that embodiment. One or more embodiments of the invention can use any method to identify one or more Qualifying Offers associated with any class of identifier.

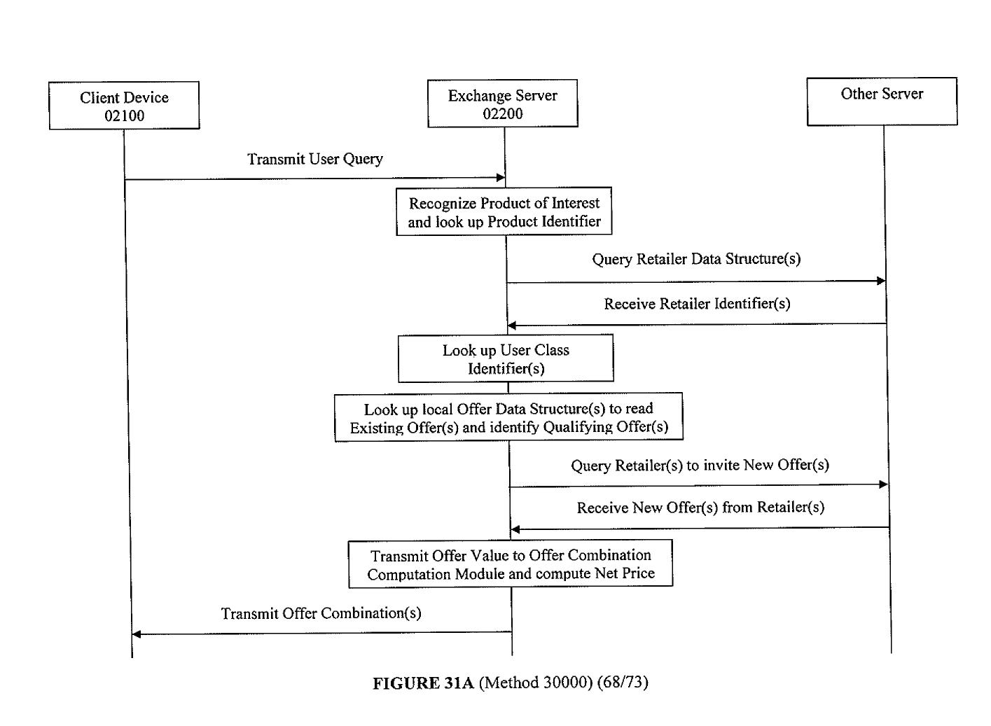

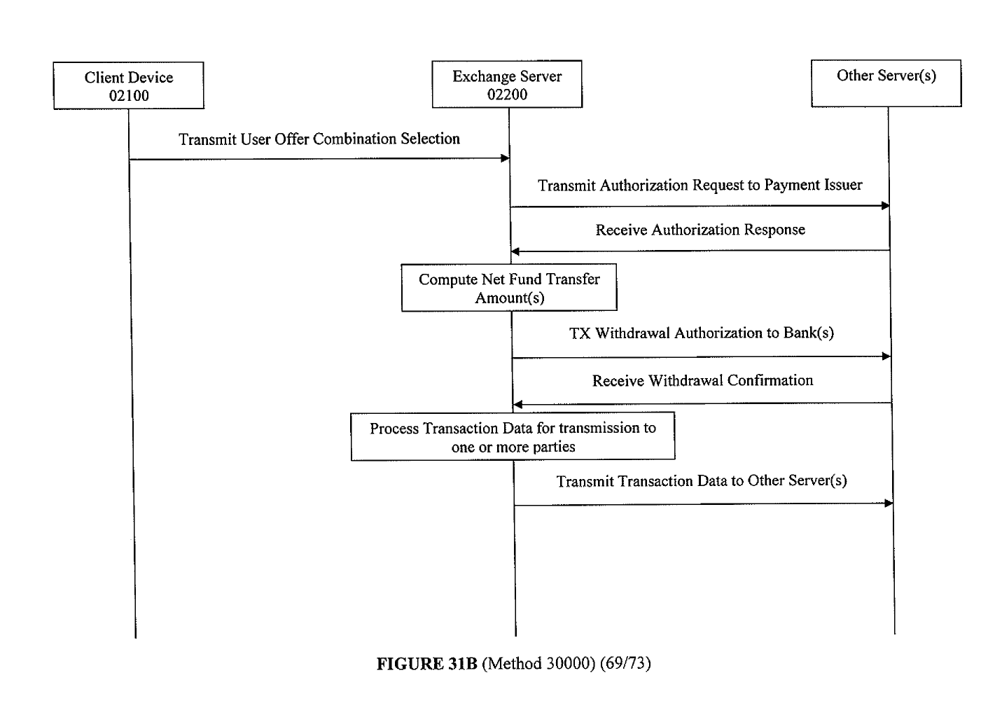

FIG. 31A and FIG. 31B depict a chart illustrating the flow of data in and execution of functions by an exemplary computer-implemented method, Method 30000, among a Client Device 02100, Exchange Server 02200, and one or more other Date Processing Systems, according to one embodiment.

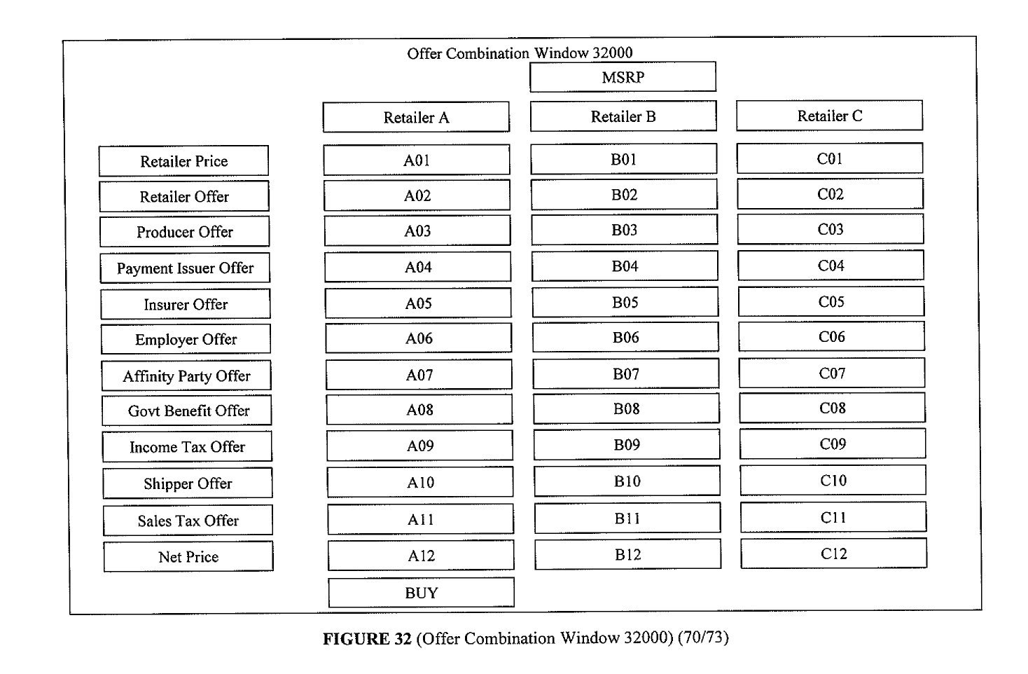

FIG. 32 depicts a diagram of an exemplary display of data, Offer Combination Window 32000, comparing the Retailer Price and value(s) of associated Qualifying Offers for each of a plurality of candidate Retailers of Interest, according to one embodiment.

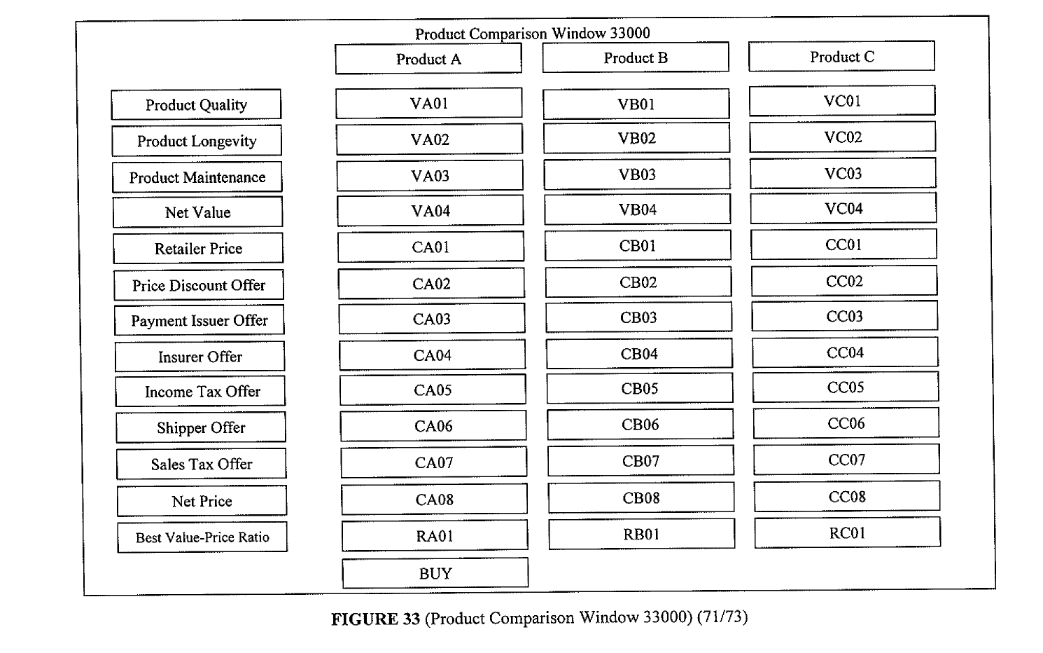

FIG. 33 depicts a diagram of an exemplary display of data, Product Comparison Window 33000, comparing the benefits and costs of each of a plurality of candidate Products of Interest, according to one embodiment.

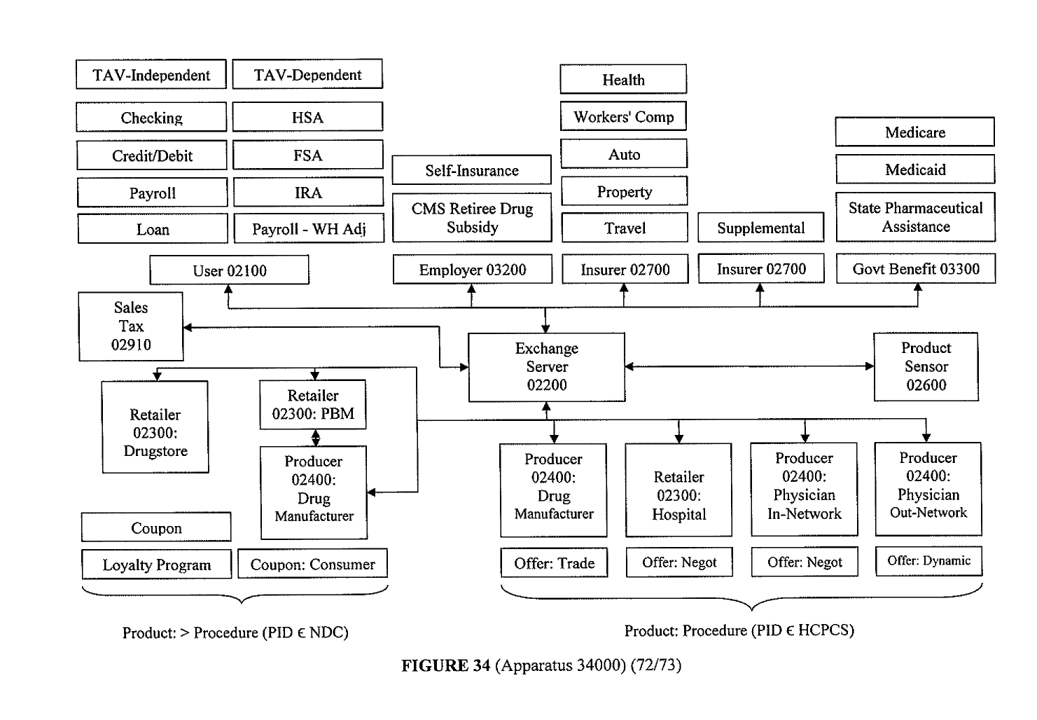

FIG. 34 depicts a block diagram of an exemplary apparatus (e.g., a distributed apparatus performing distributed computing), Apparatus 34000, enabling the exchange and processing of data to identify one or more Qualifying Offers, execute the purchase of at least the Product of Interest, process the one or more Qualifying Offers, transfer funds among a plurality of Qualifying Fund Accounts, and execute any function related to the Product of Interest after purchase where the Product of Interest is a health Product comprising one or more goods and/or one or more services, according to one embodiment. The apparatus can implement the entities described herein by utilizing a subset of the preceding and following components, any combination of the components, or additional, related, alternative, and/or equivalent components disclosed in the application. The apparatus can include without limitation the components disclosed earlier and the following new components, Data Structures, data, and/or instructions.

In one embodiment, a User and/or User of Client Device 02100 can be interested in a Product of Interest comprising not a single good or single service, but a combination of a plurality of goods, a combination of a plurality of services, a combination of one good and one or more services, or a combination of one or more goods and one service. One or more embodiments of the invention can associate a Product Identifier with each good and/or service or a Universal Product Identifier for a plurality of goods and/or services which collectively can constitute a single Product for which there may or may not be an existing identifier. For example, one or more embodiments of the invention can assign a Universal Product Identifier to combinations of goods and/or services which are commonly requested in a User Query, e.g., a User with diabetes may commonly request two separate drugs in a User Query like the metformin drug and the glipizide drug (a member of the class of sulfonylureas drugs). A Producer Server 02400 offering both drugs can make an Offer for the combination of drugs or two Producer Servers 02400 separately offering each drug can jointly make an Offer for the combination of drugs.

In one embodiment illustrated in FIG. 34, a User and/or User of Client Device 02100 can transmit a User Query for a Product or a combination of Products in the form of: (a) a procedure executed by one or more: (i) Producer Servers 02400, e.g., a first physician who is a member of a network administered by Insurer 02700 which in turn administers a Health Insurance Product used by User, and/or a second physician who is not a member of the network administered by Insurer 02700; and/or a drug manufacturer offering a drug used in the procedure; (ii) one or more Retailer Servers 02300, e.g., a hospital providing the facility, equipment, and/or services for executing the procedure; and/or (b) a Product used after the procedure, e.g., a drug administered after the procedure offered by a first Retailer Server 02300, e.g., a drugstore, and/or a drug offered by Producer Server 02400, e.g., a drug manufacturer which offers its drug through a second Retailer Server 02300, e.g., a pharmacy benefit manager (“PBM”). The first Product, e.g., a procedure, can be associated with a Product Identifier which is a member of the HCPCS Product Class Identifier. The second Product, e.g., a drug, can be associated with a Product Identifier which is a member of the NDC Product Class Identifier.

In one embodiment, the invention can identify the combination of goods and/or services by using any method described herein, e.g., using Method 30000 to: (a) recognize one or more Products specified in a User Query in the form of speech at 30003A through 30008A2; (b) recognize one or more Products specified in a User Query in the form of code or text at 30003B; and/or (c) recognize one or more Products specified in a User Query in the form of an image.

The Retailer Servers 02300 and/or Producer Servers 02400 each offering one or more Products constituting the combination of goods and/or services requested in the User Query can make an Offer associated with the Product. Retailer Server 02300, e.g., a hospital, can offer not only a Retailer Price for the procedure identified by the HCPCS Product Identifier which can be a Static Offer negotiated between the hospital and Insurer Server 02700 or a Dynamic Offer generated by the hospital, but also a separate Offer discounting the Retailer Price. Each Producer Server 02300 can make an Offer which can be a Static Offer negotiated between each Producer Server 02300 and Insurer Server 02700 or a Dynamic Offer generated by each Producer Server 02300. A Producer Server 02400, e.g., a drug manufacturer offering a drug used in the procedure, can offer the Product not only to a User who is a consumer of the Product, e.g., the procedure, but also a User who is a business using the Product in the procedure, e.g., the hospital. A Retailer Server 02300, e.g., a drugstore, can offer a coupon or Loyalty Program. A Producer Server 02400, e.g., a drug manufacturer offering a drug used after the procedure, can offer a coupon.

One or more embodiments of the invention can identify Qualifying User Fund Accounts to pay for the one or more Products. TAV-Independent User Fund Accounts can include without limitation: (a) a Checking Account; (b) a credit card or debit card; (c) a Payroll Account; and/or a Loan Account. TAV-Dependent User Fund Accounts can include without limitation: (a) an HSA; (b) an FSA; (c) an IRA; and/or (d) a Payroll Account—Tax Withholding Adjustment.

One or more embodiments of the invention can identify one or more Qualifying Offers, including without limitation: (a) one or more Qualifying Offers made by Employer Server 03200, which can include without limitation: (i) any coverage of the price of a Product through an Insurance Product offered directly by Employer Server 03200; and/or (ii) any coverage of the price of a drug Product offered by Employer Server 03200 under Medicare (“Retiree Drug Subsidy”); (b) one or more Qualifying Offers made by Insurer Server 02700, which can include coverage of the price of a Product from any Product including without limitation: (i) Health Insurance Product; (ii) a Workers' Compensation Insurance Product; (iii) Automobile Insurance Product; (iv) Property Insurance Product; and/or (v) Travel Insurance Product; (c) one or more Qualifying Offers made by Insurer Server 02700, which can include coverage of the price of a Product from any Supplemental Insurance Product; and/or (d) one or more Qualifying Offers made by Government Benefit Server 03300, which can include without limitation: (i) Medicare; (ii) Medicaid; and/or (iii) any program offered by a Government Benefit Server covering part or all of the price of a Health Product, e.g., a program offered by a state of the United States paying for the price of a drug Product (“State Pharmaceutical Assistance”).

One or more embodiments of the invention can use any method described herein to: (a) identify one or more Products, e.g., a Health Product identified by a HCPCS Product Identifier, specified in a User Query; (b) identify one or more Qualifying Retailers, e.g., a hospital offering the Product of Interest; (c) identify one or more Qualifying Producers, e.g. a physician who is a member of a network administered by Insurer 02700 which in turn administers a Health Insurance Product used by User, (d) identify one or more Qualifying Offers, e.g., any coverage of the price of a Product by Health Insurance Product; (e) identify one or more Qualifying Fund Accounts associated with each of the Qualifying Retailers, Qualifying Producers, Qualifying Offers, and Qualifying User Fund Accounts; (f) Authenticate, Authorize, Clear, and/or Settle a Transaction; and/or (g) execute one or more functions related to the Product after purchase.

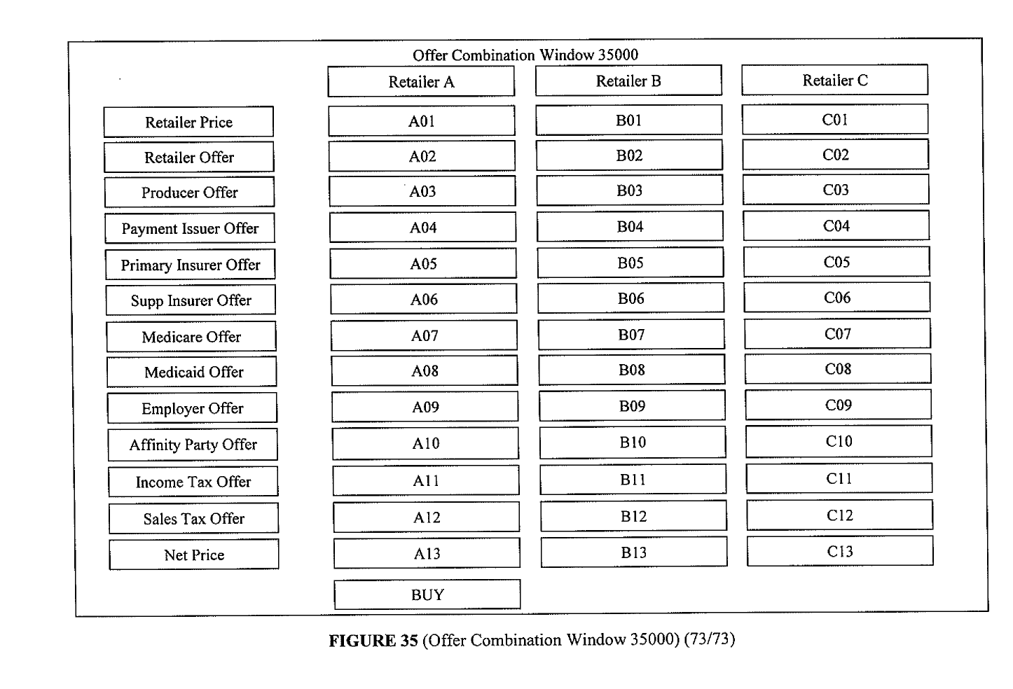

FIG. 35 depicts an exemplary display of data comparing the Retailer Price and value(s) of associated Qualifying Offers for each of a plurality of candidate Retailers of Interest where the Product of Interest is a health Product comprising one or more goods and/or one or more services, according to one embodiment.

### General

While the application illustrates various embodiments, the application presents the embodiments by way of example only, and not limitation. For example, some embodiments illustrated in the figures include a Property Tax Server 02930 along with Sales Tax Server 02910 and Income Tax Server 02920 while other embodiments illustrated in the figures include only Sales Tax Server 02910 and Income Tax Server 02920. It will be apparent to a person skilled in the relevant art that various changes in form and detail can be made therein without departing from the spirit and scope of the invention. Thus, the breadth and scope of the claims should not be limited by any of the above-described exemplary embodiments, but should be defined only in accordance with the following claims and their equivalents.

The application includes headings herein for reference and to aid in locating certain sections. The application does not intend these headings to limit the scope of the concepts described therein. The application may apply the concepts in other sections throughout the entire specification.

The application illustrates data, folders, directories, instructions, functions, AOM, and/or CPPs (collectively “Data/Instructions”) as stored and/or executed on one or more Data Processing Systems operated by one or more entities offering an object to one or more customers. However, the invention is not limited to that embodiment. One or more embodiments of the invention can enable a third party to store and/or execute the Data/Instructions and make them available to any entity over a private or public network, e.g., the Internet. For example, a third party, e.g., a cloud provider, can provision to one or more entities a shared pool of computing resources storing and/or executing the Data/Instructions dynamically and on-demand.

The application illustrates how to format data, assign names to variables, and assign names to values that are written in the English language. However, the invention is not limited to that embodiment. One or more embodiments of the invention can write the data, variables, and values in any language. One or more embodiments of the invention can modify the apparatuses, methods, and/or CPPs to operate with data, variables, and values in any language.

The application illustrates how to recognize one or more word sequences spoken in the English language. However, the invention is not limited to that embodiment. One or more embodiments of the invention can recognize one or more word sequences spoken in any language.

The application illustrates the execution of one or more functions related to one or more identifiers commonly used in the United States. However, the invention is not limited to that embodiment. One or more embodiments of the invention can execute one or more functions related to one or more identifiers used in any jurisdiction.

The application illustrates how to determine the most probable objective, solution, or outcome, e.g., the most probable word string uttered by a User, the most probable Object of Interest in a User Query, or the most probable Class of Objects. The application executes methods and/or algorithms to determine these probabilities by specifying objective functions including one or more terms, e.g., conditional probabilities. However, the invention is not limited to that embodiment. One or more embodiments of the invention can enable the determination of any objective, solution, or outcome by specifying and executing any method and/or algorithm including without limitation: (a) Bayes' theorem, e.g., to express the relationship between two conditional probabilities, and/or to utilize probabilities to classify objects or determine the relationship among Classes of Objects; and/or (b) neural networks, e.g., to express the relationship among objects in a plurality of layers of Classes of Objects. One or more embodiments of the invention can utilize any method, algorithm, or combination of methods and/or algorithms to determine any objective, solution, or outcome in the most effective means available.

The application discloses embodiments to enable a person skilled in the relevant art to make and use one or more embodiments of the invention. Various modifications to these embodiments will be readily apparent to a person skilled in the relevant art. One or more embodiments of the invention may apply the generic principles defined herein to other embodiments without departing from the spirit or scope of the invention. Thus, the invention does not intend to limit the embodiments shown herein, but accords the widest scope consistent with the principles and novel features disclosed herein.

The application reference to “invention” herein can refer to one or more embodiments.

What is claimed is:

1. A computing apparatus, comprising:
at least one processor; and
at least one memory including computer program code, the at least one memory and the computer program code configured to, with the at least one processor, cause the apparatus at least to perform:
receive a set of transaction attribute values, wherein said set of transaction attribute values comprises a product identifier and a user identifier, wherein said product identifier is associated with a product;
determine, via query of at least one retailer data structure, a price corresponding to said product;
identify, via query of at least one offer data structure, one or more qualifying offers corresponding to said product;
select for a transaction at least one qualifying offer of said one or more qualifying offers;
select for the transaction a qualifying retailer associated with the selected at least one qualifying offer;
compute, for each of one or more fund accounts from which to withdraw funds and for each of one or more fund accounts to which to deposit funds, a transaction clearing amount;
transmit, to each of the fund accounts from which to withdraw funds, a request to authorize withdrawal of the corresponding one of said computed transaction clearing amounts;
receive, from each of the fund accounts from which to withdraw funds, an authorization to withdraw the corresponding one of said computed transaction clearing amounts; and
transmit, to each of the fund accounts to which to deposit funds, the corresponding one of said computed transaction clearing amounts.

2. The apparatus of claim 1, wherein said at least one offer data structure comprises at least one retailer offer data structure,
wherein said at least one offer data structure comprises at least one producer offer data structure,
wherein said at least one offer data structure comprises at least one shipper offer data structure,
wherein said at least one offer data structure comprises at least one payment issuer offer data structure,
wherein said at least one offer data structure comprises at least one insurer offer data structure,
wherein said at least one offer data structure comprises at least one employer offer data structure,
wherein said at least one offer data structure comprises at least one affinity party offer data structure,
wherein said at least one offer data structure comprises at least one government benefit authority offer data structure,
wherein said at least one offer data structure comprises at least one sales tax authority offer data structure,
wherein said at least one offer data structure comprises at least one income tax authority offer data structure, and
wherein said at least one offer data structure comprises at least one property tax authority offer data structure.

3. The apparatus of claim 1, wherein the at least one memory and the computer program code are further configured to, with the at least one processor, cause the apparatus to:
perform, in view of the user identifier, user authentication;
authenticate, in view of the user identifier, a user device;
authenticate a user class identifier transaction attribute value of said set of transaction attribute values; and
authenticate a qualifying offer of said one or more qualifying offers,
wherein said user authentication, said user device authentication, said user class identifier transaction attribute value authentication, and said qualifying offer authentication are performed within one process.

4. The apparatus of claim 1, wherein the at least one memory and the computer program code are further configured to, with the at least one processor, cause the apparatus to:
compare one or more offer condition attribute values of an offer condition attribute with one or more identifier standards; and
determine, based on the comparison, a class of offer condition attributes.

5. The apparatus of claim 1, wherein the at least one memory and the computer program code are further configured to, with the at least one processor, cause the apparatus to:
identify said one or more qualifying offers by determining a candidate offer of the at least one offer data structure to be a qualifying offer where each offer condition attribute value of said candidate offer equals a corresponding transaction attribute value of said set of transaction attribute values, and where each offer condition attribute value set of said candidate offer includes a corresponding transaction attribute value of said set of transaction attribute values.

6. The apparatus of claim 5,
wherein a product identifier offer condition attribute value of said candidate offer equals a product identifier transaction attribute value of said set of transaction attribute values,
wherein a product identifier offer condition attribute value set of said candidate offer includes a product identifier transaction attribute value of said set of transaction attribute values,
wherein a product class identifier offer condition attribute value of said candidate offer equals a product class identifier transaction attribute value of said set of transaction attribute values,
wherein a product class identifier offer condition attribute value set of said candidate offer includes a product class identifier transaction attribute value of said set of transaction attribute values,
wherein a product property offer condition attribute value of said candidate offer equals a product property transaction attribute value of said set of transaction attribute values,
wherein a product property offer condition attribute value set of said candidate offer includes a product property transaction attribute value of said set of transaction attribute values,
wherein a product action offer condition attribute value of said candidate offer equals a product action transaction attribute value of said set of transaction attribute values,
wherein a product action offer condition attribute value set of said candidate offer includes a product action transaction attribute value of said set of transaction attribute values,
wherein a user identifier offer condition attribute value of said candidate offer equals a user identifier transaction attribute value of said set of transaction attribute values,
wherein a user identifier offer condition attribute value set of said candidate offer includes a user identifier transaction attribute value of said set of transaction attribute values,
wherein a user class identifier offer condition attribute value of said candidate offer equals a user class identifier transaction attribute value of said set of transaction attribute values,
wherein a user class identifier offer condition attribute value set of said candidate offer includes a user class identifier transaction attribute value of said set of transaction attribute values,
wherein a user property offer condition attribute value of said candidate offer equals a user property transaction attribute value of said set of transaction attribute values,
wherein a user property offer condition attribute value set of said candidate offer includes a user property transaction attribute value of said set of transaction attribute values,
wherein a user action offer condition attribute value of said candidate offer equals a user action transaction attribute value of said set of transaction attribute values,
wherein a user action offer condition attribute value set of said candidate offer includes a user action transaction attribute value of said set of transaction attribute values,
wherein a retailer identifier offer condition attribute value of said candidate offer equals a retailer identifier transaction attribute value of said set of transaction attribute values,
wherein a retailer identifier offer condition attribute value set of said candidate offer includes a retailer identifier transaction attribute value of said set of transaction attribute values,
wherein a retailer class identifier offer condition attribute value of said candidate offer equals a retailer class identifier transaction attribute value of said set of transaction attribute values,
wherein a retailer class identifier offer condition attribute value set of said candidate offer includes a retailer class identifier transaction attribute value of said set of transaction attribute values,
wherein a producer identifier offer condition attribute value of said candidate offer equals a producer identifier transaction attribute value of said set of transaction attribute values,
wherein a producer identifier offer condition attribute value set of said candidate offer includes a producer identifier transaction attribute value of said set of transaction attribute values,
wherein a producer class identifier offer condition attribute value of said candidate offer equals a producer class identifier transaction attribute value of said set of transaction attribute values,
wherein a producer class identifier offer condition attribute value set of said candidate offer includes a producer class identifier transaction attribute value of said set of transaction attribute values,
wherein a producer/retailer property offer condition attribute value of said candidate offer equals a producer/retailer property transaction attribute value of said set of transaction attribute values,
wherein a producer/retailer property offer condition attribute value set of said candidate offer includes a producer/retailer property transaction attribute value of said set of transaction attribute values,
wherein a producer/retailer action offer condition attribute value of said candidate offer equals a producer/retailer action transaction attribute value of said set of transaction attribute values, and
wherein a producer/retailer action offer condition attribute value set of said candidate offer includes a producer/retailer action transaction attribute value of said set of transaction attribute values,

7. The apparatus of claim 6,
wherein a product identifier offer condition attribute value of said candidate offer comprises a Global Trade Item Number identifier, a Universal Product Code identifier, a European Article Number identifier, a Japanese Article Number identifier, a GS1 DataBar identifier, an Electronic Product Code identifier, a Stock Keeping Unit identifier, a Code on Dental Procedures and Nomenclature identifier, a Diagnosis-Related Group identifier, a National Drug Code identifier, a Current Procedural Terminology identifier, a Healthcare Common Procedure Coding System identifier, an Anatomical Therapeutic Chemical Classification System identifier, an International Standard Book Number identifier, an International Standard Serial Number identifier, a Vehicle Identification Number identifier, a Multiple Listing Service identifier, or a Real Property Unique Identifier,
wherein a product identifier transaction attribute value of said set of transaction attribute values comprises a Global Trade Item Number identifier, a Universal Product Code identifier, a European Article Number identifier, a Japanese Article Number identifier, a GS1 DataBar identifier, an Electronic Product Code identifier, a Stock Keeping Unit identifier, a Code on Dental Procedures and Nomenclature identifier, a Diagnosis-Related Group identifier, a National Drug Code identifier, a Current Procedural Terminology identifier, a Healthcare Common Procedure Coding System identifier, an Anatomical Therapeutic Chemical Classification System identifier, an International Standard Book Number identifier, an International Standard Serial Number identifier, a Vehicle Identification Number identifier, a Multiple Listing Service identifier, or a Real Property Unique Identifier,
wherein a product class identifier offer condition attribute value of said candidate offer comprises a Standard Industrial Classification identifier, a North American Industry Classification System identifier, a North American Product Classification System identifier, an International Statistical Classification of Diseases and Related Health Problems identifier, or a Major Diagnostic Category identifier,
wherein a product class identifier transaction attribute value of said set of transaction attribute values comprises a Standard Industrial Classification identifier, a North American Industry Classification System identifier, a North American Product Classification System identifier, an International Statistical Classification of Diseases and Related Health Problems identifier, or a Major Diagnostic Category identifier,
wherein a user identifier offer condition attribute value of said candidate offer comprises an identifier associated with a payment method, a Social Security Identification Number identifier, a Federal Employer Identification Number identifier, or a driver license identifier,
wherein a user identifier transaction attribute value of said set of transaction attribute values comprises an identifier associated with a payment method, a Social Security Identification Number identifier, a Federal Employer Identification Number identifier, or a driver license identifier,
wherein a retailer identifier offer condition attribute value of said candidate offer comprises a Merchant Identifier or a Payer Identification Number identifier,
wherein a retailer identifier transaction attribute value of said set of transaction attribute values comprises a Merchant Identifier or a Payer Identification Number identifier,
wherein a retailer class identifier offer condition attribute value of said candidate offer comprises a Merchant Category Code identifier, a Standard Industrial Classification identifier, a North American Industry Classification System identifier, or a North American Product Classification System identifier,
wherein a retailer class identifier transaction attribute value of said set of transaction attribute values comprises a Merchant Category Code identifier, a Standard Industrial Classification identifier, a North American Industry Classification System identifier, or a North American Product Classification System identifier,
wherein a producer identifier offer condition attribute value of said candidate offer comprises a GS1 Manufacturer ID identifier, a Labeler Code identifier, a National Provider Identifier, or a Data Universal Numbering System identifier,
wherein a producer identifier transaction attribute value of said set of transaction attribute values comprises a GS1 Manufacturer ID identifier, a Labeler Code identifier, a National Provider Identifier, or a Data Universal Numbering System identifier,
wherein a producer class identifier offer condition attribute value of said candidate offer comprises a Standard Industrial Classification identifier, a North American Industry Classification System identifier, or a North American Product Classification System identifier, and
wherein a producer class identifier transaction attribute value of said set of transaction attribute values comprises a Standard Industrial Classification identifier, a North American Industry Classification System identifier, or a North American Product Classification System identifier.

8. The apparatus of claim 1, wherein the at least one memory and the computer program code are further configured to, with the at least one processor, cause the apparatus to:
identify one or more qualifying offers including an offer combination condition and an offer priority condition.

9. The apparatus of claim 1, wherein the at least one memory and the computer program code are further configured to, with the at least one processor, cause the apparatus to:
read, from said at least one offer data structure, a static offer value.

10. The apparatus of claim 1, wherein the at least one memory and the computer program code are further configured to, with the at least one processor, cause the apparatus to:
generate a dynamic offer value.

11. The apparatus of claim 1, wherein the at least one memory and the computer program code are further configured to, with the at least one processor, cause the apparatus to:
determine a constraint limiting a qualifying retailer/offer combination;
determine an objective function specifying a net price of a product of interest given a set of qualifying retailers and qualifying offers associated with each of one or more qualifying retailers; and
determine a specific set of a qualifying retailer and associated qualifying offers which minimizes, or decreases below a predefined threshold, the net price subject to the constraint.

12. The apparatus of claim 1, wherein the at least one memory and the computer program code are further configured to, with the at least one processor, cause the apparatus to:
determine a supply schedule limiting a supply of a product of interest by a producer;
determine a demand schedule for the product of interest;
determine an objective function specifying revenues and expenses of the producer based on a set of candidate offer values; and
determine an optimal offer value maximizing for the producer the objective function, or increasing the objective function above a predefined threshold, subject to determined constraints.

13. The apparatus of claim 1, wherein the at least one memory and the computer program code are further configured to, with the at least one processor, cause the apparatus to:
determine a supply schedule limiting a supply of a product of interest by a retailer;
determine a demand schedule for the product of interest;
determine an objective function specifying revenues and expenses of the retailer based on a set of candidate offer values; and
determine an optimal offer value maximizing for the retailer the objective function, or increasing the objective function above a predefined threshold, subject to determined constraints.

14. The apparatus of claim 1,
wherein the at least one memory and the computer program code are further configured to, with the at least one processor, cause the apparatus to:
identify one or more qualified user fund accounts, wherein one or more of said fund accounts from which to withdraw funds and said fund accounts to which to deposit funds comprise the one or more qualified user fund accounts.

15. The apparatus of claim 14
wherein the one or more qualified user fund accounts comprise one or more payment issuer managed user fund accounts,
wherein the one or more qualified user fund accounts comprise one or more checking accounts,
wherein the one or more qualified user fund accounts comprise one or more cash accounts,
wherein the one or more qualified user fund accounts comprise one or more pass-through accounts,
wherein the one or more qualified user fund accounts comprise one or more stored value accounts,
wherein the one or more qualified user fund accounts comprise one or more electronic benefits transfer accounts,
wherein the one or more qualified user fund accounts comprise one or more non-tax favored savings accounts,
wherein the one or more qualified user fund accounts comprise one or more tax-favored savings accounts,
wherein the one or more qualified user fund accounts comprise one or more money fund accounts,
wherein the one or more qualified user fund accounts comprise one or more employer payroll accounts,
wherein the one or more qualified user fund accounts comprise one or more loan accounts, and
wherein the one or more qualified user fund accounts comprise one or more insurance policies.

16. The apparatus of claim 15
wherein the one or more qualified user fund accounts comprise one or more payment issuer managed credit cards, wherein corresponding to one or more of the credit cards are one or more of a current account balance fund account attribute, a maximum account balance fund account attribute, and an interest fee fund account cost attribute,
wherein the one or more qualified user fund accounts comprise one or more payment issuer managed debit cards, wherein corresponding to one or more of the debit cards are one or more of a current account balance fund account attribute and an insufficient funds fee fund account cost attribute,
wherein the one or more qualified user fund accounts comprise one or more checking accounts, wherein corresponding to one or more of the checking accounts are one or more of a current account balance fund account attribute, a minimum current account balance maintenance benefit fund account benefit attribute, and an insufficient funds fee fund account cost attribute,
wherein the one or more qualified user fund accounts comprise one or more cash accounts, wherein corresponding to one or more of the cash accounts are one or more of a current account balance fund account attribute, a minimum current account balance maintenance benefit fund account benefit attribute, and an insufficient funds fee fund account cost attribute,
wherein the one or more qualified user fund accounts comprise one or more stored value accounts, wherein corresponding to one or more of the stored value accounts are one or more of an expiration date fund account attribute, a current account balance fund account attribute, a maximum account balance fund account attribute, an origination fee fund account cost attribute and a transaction transfer fee fund account cost attribute,
wherein the one or more qualified user fund accounts comprise one or more electronic benefits transfer accounts, wherein corresponding to one or more of the electronic benefits transfer accounts are one or more of an expiration date fund account attribute, a qualifying product identifier fund account attribute, a qualifying recipient identifier fund account attribute, a current account balance fund account attribute, an origination fee fund account cost attribute, and a transaction transfer fee fund account cost attribute,
wherein the one or more qualified user fund accounts comprise one or more non-tax favored savings accounts, wherein corresponding to one or more of the non-tax favored savings accounts are one or more of a qualifying product identifier fund account attribute, a current account balance fund account attribute, an interest fee fund account cost attribute, and a penalty fee fund account cost attribute,
wherein the one or more qualified user fund accounts comprise one or more tax favored savings accounts, wherein corresponding to one or more of the tax favored savings accounts are one or more of a qualifying product identifier fund account attribute, a qualifying recipient identifier fund account attribute, a current account balance fund account attribute, an interest fee fund account cost attribute, and a penalty fee fund account cost attribute,
wherein the one or more qualified user fund accounts comprise one or more money fund accounts, wherein corresponding to one or more of the money fund accounts are one or more of a current account balance fund account attribute, an interest fee fund account cost attribute, and a penalty fee fund account cost attribute,
wherein the one or more qualified user fund accounts comprise one or more employer payroll accounts, wherein corresponding to one or more of the employer payroll accounts are one or more of a current account balance fund account attribute and a transfer fee fund account cost attribute,
wherein the one or more qualified user fund accounts comprise one or more loan accounts, wherein corresponding to one or more of the loan accounts are one or more of a current account balance fund account attribute, a maximum account balance fund account attribute, an origination fee fund account cost attribute, and an interest fee fund account cost attribute, and
wherein the one or more qualified user fund accounts comprise one or more insurance policies, wherein corresponding to one or more of the insurance policies are one or more of a current account balance fund account attribute, a maximum account balance fund account attribute, an origination fee fund account cost attribute, an interest fee fund account cost attribute, and a penalty fee fund account cost attribute.

17. The apparatus of claim 1, wherein the at least one memory and the computer program code are further configured to, with the at least one processor, cause the apparatus to
determine a constraint limiting combination of qualifying user fund accounts;
determine an objective function specifying a difference between a total user fund account withdrawal benefit and a total user fund account withdrawal cost, given a set of qualifying user fund accounts; and
determine a specific set of qualifying user fund accounts and withdrawal amounts maximizing for the objective function, or increasing the objective function above a predefined threshold, subject to the constraint.

18. The apparatus of claim 1, wherein the at least one memory and the computer program code are further configured to, with the at least one processor, cause the apparatus to:
compute for the transaction a withdrawal amount from each qualifying fund account of said fund accounts from which to withdraw funds; and
compute for the transaction a deposit amount to each qualifying fund account of said fund accounts to which to deposit funds.

19. The apparatus of claim 1, wherein the at least one memory and the computer program code are further configured to, with the at least one processor, cause the apparatus to:
authorize, clear, and settle: funds transfer between a qualifying user fund account managed by a payment issuer and a qualifying retailer fund account managed by an acquirer through an existing network exchanging data between payment issuers and acquirers; funds transfer among all other qualifying fund accounts by directly withdrawing funds from and depositing funds to such fund accounts; and processing of any other transaction events not supported by said existing network.

20. The apparatus of claim 1, wherein the at least one memory and the computer program code are further configured to, with the at least one processor, cause the apparatus to:
authorize, clear, and settle: (funds transfer among a plurality of qualifying user fund accounts through an automated clearing house or similar network; funds transfer among all other qualifying fund accounts by directly withdrawing funds from and depositing funds to such fund accounts; and processing of any other transaction events not supported by said automated clearing house or similar network.

21. The apparatus of claim 1, wherein the at least one memory and the computer program code are further configured to, with the at least one processor, cause the apparatus to:
authorize, clear, and settle funds transfer among all qualifying fund accounts by: (directly withdrawing funds from and depositing funds to each said qualifying fund account; and processing any other transaction events.

22. The apparatus of claim 1, wherein the at least one memory and the computer program code are further configured to, with the at least one processor, cause the apparatus to:
authorize in one process funds withdrawal from one or more qualifying fund accounts and funds deposit to one or more qualifying fund accounts.

23. The apparatus of claim 1, wherein the at least one memory and the computer program code are further configured to, with the at least one processor, cause the apparatus to:
clear in one process the funds withdrawal from one or more qualifying fund accounts and the funds deposit to one or more qualifying fund accounts.

24. The apparatus of claim 1, wherein the at least one memory and the computer program code are further configured to, with the at least one processor, cause the apparatus to:
settle in one process funds withdrawal from one or more qualifying fund accounts and funds deposit to one or more qualifying fund accounts.

25. A distributed computing apparatus, comprising:
one or more retailer computing apparatuses, wherein said retailer computing apparatuses store retailer data;
one or more offer data computing apparatuses, wherein said offer computing apparatuses store offer data;
one or more fund account computing apparatuses, wherein said fund account computing apparatuses store fund account data; and
an exchange computing apparatus, comprising:
at least one processor; and
at least one memory including computer program code, the at least one memory and the computer program code configured to, with the at least one processor, cause the apparatus at least to perform:
exchange and process of said retailer data, said offer data, and said fund account data with said one or more retailer computing apparatuses, said one or more offer data computing apparatuses, and said one or more fund account computing apparatuses.
